(19) United States
(12) Patent Application Publication
(10) Pub. No.: US 2021/0356279 A1
(43) Pub. Date: Nov. 18, 2021

(54) A Method and Apparatus for Optimal Navigation to Multiple Locations

(71) Applicant: NNG Software Developing and Commercial LLC., Budapest (HU)

(72) Inventor: Norman Szigeti, Tatabánya (HU)

(21) Appl. No.: 17/251,789

(22) PCT Filed: May 8, 2019
(86) PCT No.: PCT/IB2019/000359

§ 371 Date: Dec. 12, 2020

Related U.S. Application Data
(60) Provisional application No. 62/695,059, filed on Jul. 8, 2018.
(60) Provisional application No. 62/774,272, filed on Dec. 2, 2018.

(51) Int. Cl. G01C 21/34; G06Q 10/04; G06Q 30/06; H04W 4/02; H04W 4/40

(52) U.S. Cl. CPC G01C 21/343; G01C 21/3453; H04W 4/40; G06Q 30/0639; H04W 4/025; G06Q 10/047

(57) ABSTRACT

A method for freeing an end user of a navigation system from the burden of selection concrete points by using optimal planning and guidance using GNSS or GPS geographic localization is described. Multiple items, such as products, services, or attributes such as category of venue (e.g., restaurant or bar), are input or selected by the user. Using a products and attributes database, the system identifies potential geographical locations where the required products or services are available, or where a venue of the specified category (such as bar) can be found. An optimal route to optimally arrive at all geographical locations required for the required products, services, or attributes, is calculated, and may include returning to the origin location or to a destination location defined by the user, and the selection may be based on estimated travel distance, estimated travel time, estimated fuel efficiency, or opening hours of stores.

### RELATED APPLICATION

This patent application claims priority from U.S. Provisional Application Ser. No. 62/695,059, filed on Jul. 8, 2018 and U.S. Provisional Application Ser. No. 62/774,272, filed on Dec. 2, 2018, which are all hereby incorporated herein by reference in their entirety.

### TECHNICAL FIELD

This disclosure relates generally to an apparatus and method for optimal navigation route planning for satisfying multiple tasks such as fetching multiple items or other attributes associated with multiple locations, and in particular identifying and optimizing the multiple locations and the order of arriving therein.

### BACKGROUND

Unless otherwise indicated herein, the materials described in this section are not prior art to the claims in this application and are not admitted to be prior art by inclusion in this section.

FIG. 1 shows a block diagram that illustrates a system 10 including a computer system 11, and an associated Internet 22 connection. Such configuration is typically used for computers (hosts) connected to the Internet 22 and executing a server, or a client (or a combination) software. The computer system 11 may be used as a portable electronic device such as a notebook/laptop computer, a media player (e.g., MP3 based or video player), a desktop computer, a laptop computer, a cellular phone, a Personal Digital Assistant (PDA), an image processing device (e.g., a digital camera or video recorder), any other handheld or fixed location computing devices, or a combination of any of these devices. Note that while FIG. 1 illustrates various components of the computer system 11, it is not intended to represent any particular architecture or manner of interconnecting the components.

Network computers, handheld computers, cell phones and other data processing systems that have fewer or more components, may also be used. For example, the computer system 11 of FIG. 1 may be an Apple Macintosh computer, an Power Book, or an IBM compatible PC. The computer system 11 may include a bus 13, an interconnect, or other communication mechanism for communicating information, and a processor 12, commonly in the form of an integrated circuit, coupled to the bus 13 for processing information, and for executing the computer executable instructions. The computer system 11 may also include a main memory 15a, such as a Random Access Memory (RAM), or other dynamic storage device, coupled to the bus 13 for storing information and instructions to be executed by the processor 12. The main memory 15a also may be used for storing temporary variables or other intermediate information during execution of instructions to be executed by the processor 12.

The computer system 11 further includes a Read Only Memory (ROM) 15b (or other non-volatile memory) or other static storage device coupled to the bus 13 for storing static information and instructions for the processor 12. A storage device 15c, that may be a magnetic disk or optical disk, such as a hard disk drive (HDD) for reading from and writing to a hard disk, a magnetic disk drive for reading from and writing to a magnetic disk, and/or an optical disk drive (such as DVD) for reading from and writing to a removable optical disk, is coupled to the bus 13 for storing information and instructions. The hard disk drive, magnetic disk drive, and optical disk drive may be connected to the system bus 13 by a hard disk drive interface, a magnetic disk drive interface, and an optical disk drive interface, respectively. The drives and their associated computer-readable media provide non-volatile storage of computer readable instructions, data structures, program modules and other data for the general-purpose computing devices.

Typically, the computer system 11 includes an Operating System (OS) stored in a non-volatile storage 15b for managing the computer resources and provides the applications and programs with access to the computer resources and interfaces. An operating system commonly processes system data and user input, and responds by allocating and managing tasks and internal system resources, such as controlling and allocating memory, prioritizing system requests, controlling input and output devices, facilitating networking and managing files. Non-limiting examples of operating systems are Microsoft Windows, Mac OS X, and Linux.

The computer system 11 may be coupled via the bus 13 to a display 17, such as a Cathode Ray Tube (CRT), a Liquid Crystal Display (LCD), a flat screen monitor, a touch screen monitor or similar means for displaying text and graphical data to a user. The display 17 may be connected via a video adapter for supporting the display. The display 17 allows a user to view, enter, and/or edit information that is relevant to the operation of the system 10. An input device 18, including alphanumeric and other keys, is coupled to the bus 13 for communicating information and command selections to the processor 12. Another type of user input device is a cursor control 18a, such as a mouse, a trackball, or cursor direction keys for communicating direction information and command selections to the processor 12 and for controlling cursor movement on the display 17. This cursor control 18a typically has two degrees of freedom in two axes, a first axis (e.g., x) and a second axis (e.g., y), that allows the device to specify positions in a plane.

The computer system 11 may be used for implementing the methods and techniques described herein. According to one embodiment, these methods and techniques are performed by the computer system 11 in response to the processor 12 executing one or more sequences of one or more instructions contained in the main memory 15a. Such instructions may be read into the main memory 15a from another computer-readable medium, such as the storage device 15c. Execution of the sequences of instructions contained in the main memory 15a causes the processor 12 to perform the process steps described herein. In alternative embodiments, hard-wired circuitry may be used in place of or in combination with software instructions to implement the arrangement. Thus, embodiments of the invention are not limited to any specific combination of hardware circuitry and software.

The term “processor” is used herein to include, but not limited to, any integrated circuit or any other electronic device (or collection of electronic devices) capable of performing an operation on at least one instruction, including, without limitation, a microprocessor (μP), a microcontroller (μC), a Digital Signal Processor (DSP), or any combination thereof. A processor, such as the processor 12, may further be a Reduced Instruction Set Core (RISC) processor, a Complex Instruction Set Computing (CISC) microprocessor, a Microcontroller Unit (MCU), or a CISC-based Central Processing Unit (CPU). The hardware of the processor 12 may be integrated onto a single substrate (e.g., silicon “die”), or distributed among two or more substrates. Furthermore, various functional aspects of the processor 12 may be implemented solely as a software (or firmware) associated with the processor 12.

A memory can store computer programs or any other sequence of computer readable instructions, or data, such as files, text, numbers, audio and video, as well as any other form of information represented as a string or structure of bits or bytes. The physical means of storing information may be electrostatic, ferroelectric, magnetic, acoustic, optical, chemical, electronic, electrical, or mechanical. A memory may be in the form of an Integrated Circuit (IC, a.k.a. chip or microchip). Alternatively or in addition, a memory may be in the form of a packaged functional assembly of electronic components (module). Such module may be based on a Printed Circuit Board (PCB) such as PC Card according to Personal Computer Memory Card International Association (PCMCIA) PCMCIA 2.0 standard, or a Single In-line Memory Module (SIMM) or a Dual In-line Memory Module (DIMM), standardized under the JEDEC JESD-21C standard. Further, a memory may be in the form of a separately rigidly enclosed box such as an external Hard-Disk Drive (HDD).

Various forms of computer-readable media may be involved in carrying one or more sequences of one or more instructions to the processor 12 for execution. For example, the instructions may initially be carried on a magnetic disk of a remote computer. The remote computer can load the instructions into its dynamic memory and send the instructions over a telephone line using a modem. A modem local to the computer system 11 can receive the data on the telephone line and use an infrared transmitter to convert the data to an infrared signal. An infrared detector can receive the data carried in the infrared signal, and appropriate circuitry may place the data on the bus 13. The bus 13 carries the data to the main memory 15a, from which the processor 12 retrieves and executes the instructions. The instructions received by the main memory 15a may optionally be stored on the storage device 15c either before or after execution by the processor 12.

The computer system 11 commonly includes a communication interface 9 coupled to the bus 13. The communication interface 9 provides a two-way data communication coupling to a network link 8 that is connected to a Local Area Network (LAN) 14. For example, the communication interface 9 may be an Integrated Services Digital Network (ISDN) card or a modem to provide a data communication connection to a corresponding type of telephone line. As another non-limiting example, the communication interface 9 may be a Local Area Network (LAN) card to provide a data communication connection to a compatible LAN. For example, Ethernet-based connection based on IEEE802.3 standard may be used, such as 10/100BaseT, 1000BaseT (gigabit Ethernet), 10 gigabit Ethernet (10GE or 10 GbE or 10 GigE per IEEE Std. 802.3ae-2002as standard), 40 Gigabit Ethernet (40 GbE), or 100 Gigabit Ethernet (100 GbE as per Ethernet standard IEEE P802.3ba). These technologies are described in Cisco Systems, Inc. Publication number 1-587005-001-3 (6/99), “Internetworking Technologies Handbook”, Chapter 7: “Ethernet Technologies”, pages 7-1 to 7-38, which is incorporated in its entirety for all purposes as if fully set forth herein. In such a case, the communication interface 9 typically includes a LAN transceiver or a modem, such as a Standard Microsystems Corporation (SMSC) LAN91C111 10/100 Ethernet transceiver, described in the Standard Microsystems Corporation (SMSC) data-sheet “LAN91C111 10/100 Non-PCI Ethernet Single Chip MAC+PHY” Data-Sheet, Rev. 15 (Feb. 20, 2004), which is incorporated in its entirety for all purposes as if fully set forth herein.

An Internet Service Provider (ISP) 16 is an organization that provides services for accessing, using, or participating in the Internet 22. The Internet Service Provider 16 may be organized in various forms, such as commercial, community-owned, non-profit, or otherwise privately owned. Internet services, typically provided by ISPs, include Internet access, Internet transit, domain name registration, web hosting, and collocation. ISPs may engage in peering, where multiple ISPs interconnect at peering points or Internet exchange points (IXs), allowing routing of data between each network, without charging one another for the data transmitted—data that would otherwise have passed through a third upstream ISP, incurring charges from the upstream ISP. ISPs requiring no upstream and having only customers (end customers and/or peer ISPs) are referred to as Tier 1 ISPs.

An arrangement 10a of a computer system connected to the Internet 22 is shown in FIG. 1a. A computer system or a workstation 7 includes a main unit box 6 with an enclosed motherboard that has the processor 12 and the memories 15a, 15b, and 15c are mounted. The workstation 7 may include a keyboard 2 (corresponding to the input device 18), a printer 4, a computer mouse 3 (corresponding to the cursor control 18a), and a display 5 (corresponding to the display 17). FIG. 1a further illustrates various devices connected via the Internet 22, such as a client device #1 24, a client device #2 24a, a data server #1 23a, a data server #2 23b, and the workstation 7, connected to the Internet 22 over a LAN 14 and via the router or gateway 19 and the ISP 16.

The client device #1 24 and the client device #2 24a may communicate over the Internet 22 for exchanging or obtaining data from the data server #1 23a and the data server #2 23b. In one example, the servers are HTTP servers, sometimes known as web servers.

The term “computer-readable medium” (or “machine-readable medium”) is used herein to include, but not limited to, any medium or any memory, that participates in providing instructions to a processor, (such as the processor 12) for execution, or any mechanism for storing or transmitting information in a form readable by a machine (e.g., a computer). Such a medium may store computer-executable instructions to be executed by a processing element and/or control logic and data, which is manipulated by a processing element and/or control logic, and may take many forms, including but not limited to, non-volatile medium, volatile medium, and transmission medium. Transmission media includes coaxial cables, copper wire, and fiber optics, including the wires that comprise the bus 13. Transmission media may also take the form of acoustic or light waves, such as those generated during radio-wave and infra-red data communications, or other form of propagating signals (e.g., carrier waves, infrared signals, digital signals, etc.). Common forms of computer-readable media include a floppy disk, a flexible disk, hard disk, magnetic tape, or any other magnetic medium, a CD-ROM, any other optical medium, punch-cards, paper-tape, any other physical medium with patterns of holes, a RAM, a PROM, and EPROM, a FLASH-EPROM, any other memory chip or cartridge, a carrier wave as described hereinafter, or any other medium from which a computer may read.

Various forms of computer-readable media may be involved in carrying one or more sequences of one or more instructions to the processor 12 for execution. For example, the instructions may initially be carried on a magnetic disk of a remote computer. The remote computer may load the instructions into its dynamic memory and send the instructions over a telephone line using a modem. A modem local to the computer system 11 can receive the data on the telephone line, using an infrared transmitter to convert the data to an infrared signal. An infrared detector can receive the data carried in the infrared signal and appropriate circuitry may place the data on the bus 13. The bus 13 carries the data to the main memory 15a, from which the processor 12 retrieves and executes the instructions. The instructions received by the main memory 15a may optionally be stored on the storage device 15c either before or after execution by the processor 12.

The Internet is a global system of interconnected computer networks that use the standardized Internet Protocol Suite (TCP/IP), including Transmission Control Protocol (TCP) and the Internet Protocol (IP), to serve billions of users worldwide. It is a network of networks that consists of millions of private, public, academic, business, and government networks, of local to global scope, that are linked by a broad array of electronic and optical networking technologies. The Internet carries a vast range of information resources and services, such as the interlinked hypertext documents on the World Wide Web (WWW) and the infrastructure to support electronic mail. The Internet backbone refers to the principal data routes between large, strategically interconnected networks and core routers on the Internet. These data routers are hosted by commercial, government, academic, and other high-capacity network centers, the Internet exchange points and network access points that interchange Internet traffic between the countries, continents and across the oceans of the world. Traffic interchange between Internet service providers (often Tier 1 networks) participating in the Internet backbone exchange traffic by privately negotiated interconnection agreements, primarily governed by the principle of settlement-free peering.

The Internet Protocol is responsible for addressing hosts and routing datagrams (packets) from a source host to the destination host across one or more IP networks. For this purpose, the Internet Protocol defines an addressing system that has two functions: Identifying hosts addresses and providing a logical location service. Each packet is tagged with a header that contains the meta-data for the purpose of delivery. This process of tagging is also called encapsulation. IP is a connectionless protocol for use in a packet-switched Link Layer network, and does not need circuit setup prior to transmission. The aspects of guaranteeing delivery, proper sequencing, avoidance of duplicate delivery, and data integrity are addressed by an upper transport layer protocol (e.g., TCP—Transmission Control Protocol and UDP—User Datagram Protocol).

The Hypertext Transfer Protocol (HTTP) is an application protocol for distributed, collaborative, hypermedia information systems, commonly used for communication over the Internet. HTTP is the protocol to exchange or transfer hypertext, which is a structured text that uses logical links (hyperlinks) between nodes containing text. HTTP version 1.1 was standardized as RFC 2616 (June 1999), which was replaced by a set of standards (obsoleting RFC 2616), including RFC 7230—HTTP/1.1: Message Syntax and Routing, RFC 7231—HTTP/1.1: Semantics and Content, RFC 7232—HTTP/1.1: Conditional Requests, RFC 7233—HTTP/1.1: Range Requests, RFC 7234—HTTP/1.1: Caching, and RFC 7235—HTTP/1.1: Authentication. HTTP functions as a request-response protocol in the client-server computing model. A web browser, for example, may be the client and an application running on a computer hosting a website may be the server. The client submits an HTTP request message to the server. The server, which provides resources such as HTML files and other content, or performs other functions on behalf of the client, returns a response message to the client. The response contains completion status information about the request and may further contain a requested content in its message body. A web browser is an example of a User Agent (UA). Other types of user agent include the indexing software used by search providers (web crawlers), voice browsers, mobile apps and other software that accesses, consumes, or displays web content.

User. The term “user” is used herein to include, but not limited to, the principal using a client to interactively retrieve and render resources or resource manifestation, such as a person using a web browser, a person using an e-mail reader, or a person using a display such as the display 17.

The term ‘client’ typically refers to an application (or a device executing the application) used for retrieving or rendering resources, or resource manifestations, such as a web browser, an e-mail reader, or a Usenet reader, while the term ‘server’ typically refers to an application (or a device executing the application) used for supplying resources or resource manifestations, and typically offers (or hosts) various services to other network computers and users. These services are usually provided through ports or numbered access points beyond the server's network address. Each port number is usually associated with a maximum of one running program, which is responsible for handling requests to that port. A daemon, being a user program, can in turn access the local hardware resources of that computer by passing requests to the operating system kernel.

A mobile operating system (also referred to as mobile OS), is an operating system that operates a smartphone, tablet, PDA, or another mobile device. Modern mobile operating systems combine the features of a personal computer operating system with other features, including a touchscreen, cellular, Bluetooth, Wi-Fi, GPS mobile navigation, camera, video camera, speech recognition, voice recorder, music player, near field communication and infrared blaster. Currently, the popular mobile OSs include Android, Symbian, Apple iOS, BlackBerry, MeeGo, Windows Phone, and Bada. Mobile devices with mobile communications capabilities (e.g. smartphones) typically contain two mobile operating systems: a main user-facing software platform is supplemented by a second low-level proprietary real-time operating system that operates the radio and other hardware.

Android is a Linux-based, open source mobile operating system (OS) based on the Linux kernel that is currently offered by Google. With a user interface based on direct manipulation, Android is designed primarily for touchscreen mobile devices such as smartphones and tablet computers with specialized user interfaces for televisions (Android TV), cars (Android Auto), and wrist watches (Android Wear). The OS uses touch inputs that loosely correspond to real-world actions, such as swiping, tapping, pinching, and reverse pinching to manipulate on-screen objects, and a virtual keyboard. Despite being primarily designed for touchscreen input, it also has been used in game consoles, digital cameras, and other electronics. The response to user input is designed to be immediate and provides a fluid touch interface, often using the vibration capabilities of the device to provide haptic feedback to the user. Internal hardware such as accelerometers, gyroscopes and proximity sensors are used by some applications to respond to additional user actions. For example, adjusting the screen from portrait to landscape depending on the device orientation, or allowing the user to steer a vehicle in a racing game by rotating the device, a process that simulates control of a steering wheel.

Android devices boot to the homescreen, the primary navigation and information point on the device, which is similar to the desktop found on PCs. The homescreens on Android are typically made up of app icons and widgets. App icons launch the associated app, whereas widgets display live, auto-updating content such as the weather forecast, the user's email inbox, or a news ticker directly on the homescreen. A homescreen may be made up of several pages that the user can swipe back and forth between pages. A heavily-customizable Android homescreen interface allows the user to adjust the look and feel of the device to their liking. Third-party apps available on Google Play and other app stores can extensively re-theme the homescreen, and even mimic the look of other operating systems, such as Windows Phone. The Android OS is described in a publication entitled: “Android Tutorial”, downloaded from tutorialspoint.com on July 2014, which is incorporated in its entirety for all purposes as if fully set forth herein.

iOS (previously iPhone OS) from Apple Inc. (headquartered in Cupertino, Calif., U.S.A.) is a mobile operating system distributed exclusively for Apple hardware. The user interface of the iOS is based on the concept of direct manipulation, using multi-touch gestures. Interface control elements consist of sliders, switches, and buttons. Interaction with the OS includes gestures such as swipe, tap, pinch, and reverse pinch, all of which have specific definitions within the context of the iOS operating system and its multi-touch interface. Internal accelerometers are used by some applications to respond to shaking the device (one common result is the undo command), or rotating it in three dimensions (one common result is switching from portrait to landscape mode). The iOS is described in a publication entitled: “IOS Tutorial”, downloaded from tutorialspoint.com on July 2014, which is incorporated in its entirety for all purposes as if fully set forth herein.

RTOS. A Real-Time Operating System (RTOS) is an Operating System (OS) intended to serve real-time applications that process data as it comes in, typically without buffer delays. Processing time requirements (including any OS delay) are typically measured in tenths of seconds or shorter increments of time, and is a time bound system which has well defined fixed time constraints. Processing is commonly to be done within the defined constraints, or the system will fail. They either are event driven or time sharing, where event driven systems switch between tasks based on their priorities while time sharing systems switch the task based on clock interrupts. A key characteristic of an RTOS is the level of its consistency concerning the amount of time it takes to accept and complete an application's task; the variability is jitter. A hard real-time operating system has less jitter than a soft real-time operating system. The chief design goal is not high throughput, but rather a guarantee of a soft or hard performance category. An RTOS that can usually or generally meet a deadline is a soft real-time OS, but if it can meet a deadline deterministically it is a hard real-time OS. An RTOS has an advanced algorithm for scheduling, and includes a scheduler flexibility that enables a wider, computer-system orchestration of process priorities. Key factors in a real-time OS are minimal interrupt latency and minimal thread switching latency; a real-time OS is valued more for how quickly or how predictably it can respond than for the amount of work it can perform in a given period of time.

Common designs of RTOS include event-driven, where tasks are switched only when an event of higher priority needs servicing; called preemptive priority, or priority scheduling, and time-sharing, where task are switched on a regular clocked interrupt, and on events; called round robin. Time sharing designs switch tasks more often than strictly needed, but give smoother multitasking, giving the illusion that a process or user has sole use of a machine. In typical designs, a task has three states: Running (executing on the CPU); Ready (ready to be executed); and Blocked (waiting for an event, I/O for example). Most tasks are blocked or ready most of the time because generally only one task can run at a time per CPU. The number of items in the ready queue can vary greatly, depending on the number of tasks the system needs to perform and the type of scheduler that the system uses. On simpler non-preemptive but still multitasking systems, a task has to give up its time on the CPU to other tasks, which can cause the ready queue to have a greater number of overall tasks in the ready to be executed state (resource starvation).

RTOS concepts and implementations are described in an Application Note No. RES05B00008-0100/Rec. 1.00 published January 2010 by Renesas Technology Corp. entitled: “R8C Family—General RTOS Concepts”, in JAJA Technologfy Review article published February 2007 [1535-5535/$32.00] by The Association for Laboratory Automation [doi:10.1016/j.jala.2006.10.016] entitled: “An Overview of Real-Time Operating Systems”, and in Chapter 2 entitled: “Basic Concepts of Real Time Operating Systems” of a book published 2009 [ISBN-978-1-4020-9435-4] by Springer Science+Business Media B.V. entitled: “Hardware-Dependent Software—Principles and Practice”, which are all incorporated in their entirety for all purposes as if fully set forth herein.

QNX. One example of RTOS is QNX, which is a commercial Unix-like real-time operating system, aimed primarily at the embedded systems market. QNX was one of the first commercially successful microkernel operating systems and is used in a variety of devices including cars and mobile phones. As a microkernel-based OS, QNX is based on the idea of running most of the operating system kernel in the form of a number of small tasks, known as Resource Managers. In the case of QNX, the use of a microkernel allows users (developers) to turn off any functionality they do not require without having to change the OS itself; instead, those services will simply not run.

FreeRTOS. FreeRTOS™ is a free and open-source Real-Time Operating system developed by Real Time Engineers Ltd., designed to fit on small embedded systems and implements only a very minimalist set of functions: very basic handle of tasks and memory management, and just sufficient API concerning synchronization. Its features include characteristics such as preemptive tasks, support for multiple microcontroller architectures, a small footprint (4.3 Kbytes on an ARM7 after compilation), written in C, and compiled with various C compilers. It also allows an unlimited number of tasks to run at the same time, and no limitation about their priorities as long as used hardware can afford it.

FreeRTOS™ provides methods for multiple threads or tasks, mutexes, semaphores and software timers. A tick-less mode is provided for low power applications, and thread priorities are supported. Four schemes of memory allocation are provided: allocate only; allocate and free with a very simple, fast, algorithm; a more complex but fast allocate and free algorithm with memory coalescence; and C library allocate and free with some mutual exclusion protection. While the emphasis is on compactness and speed of execution, a command line interface and POSIX-like IO abstraction add-ons are supported. FreeRTOS™ implements multiple threads by having the host program call a thread tick method at regular short intervals.

The thread tick method switches tasks depending on priority and a round-robin scheduling scheme. The usual interval is 1/1000 of a second to 1/100 of a second, via an interrupt from a hardware timer, but this interval is often changed to suit a particular application. FreeRTOS™ is described in a paper by Nicolas Melot (downloaded 7/2015) entitled: “Study of an operating system: FreeRTOS—Operating systems for embedded devices”, in a paper (dated Sep. 23, 2013) by Dr. Richard Wall entitled: “Carebot PIC32 MX7ck implementation of Free RTOS”, FreeRTOS™ modules are described in web pages entitled: “FreeRTOS™ Modules” published in the www.freertos.org web-site dated 26 Nov. 2006, and FreeRTOS kernel is described in a paper published 1 Apr. 2007 by Rich Goyette of Carleton University as part of ‘SYSC5701: Operating System Methods for Real-Time Applications’, entitled: “An Analysis and Description of the Inner Workings of the FreeRTOS Kernel”, which are all incorporated in their entirety for all purposes as if fully set forth herein.

SafeRTOS. SafeRTOS was constructed as a complementary offering to FreeRTOS, with common functionality but with a uniquely designed safety-critical implementation. When the FreeRTOS functional model was subjected to a full HAZOP, weakness with respect to user misuse and hardware failure within the functional model and API were identified and resolved. Both SafeRTOS and FreeRTOS share the same scheduling algorithm, have similar APIs, and are otherwise very similar, but they were developed with differing objectives. SafeRTOS was developed solely in the C language to meet requirements for certification to IEC61508. SafeRTOS is known for its ability to reside solely in the on-chip read only memory of a microcontroller for standards compliance. When implemented in hardware memory, SafeRTOS code can only be utilized in its original configuration, so certification testing of systems using this OS need not re-test this portion of their designs during the functional safety certification process.

VxWorks. VxWorks is an RTOS developed as proprietary software and designed for use in embedded systems requiring real-time, deterministic performance and, in many cases, safety and security certification, for industries, such as aerospace and defense, medical devices, industrial equipment, robotics, energy, transportation, network infrastructure, automotive, and consumer electronics. VxWorks supports Intel architecture, POWER architecture, and ARM architectures. The VxWorks may be used in multicore asymmetric multiprocessing (AMP), symmetric multiprocessing (SMP), and mixed modes and multi-OS (via Type 1 hypervisor) designs on 32- and 64-bit processors. VxWorks comes with the kernel, middleware, board support packages, Wind River Workbench development suite and complementary third-party software and hardware technologies. In its latest release, VxWorks 7, the RTOS has been re-engineered for modularity and upgradeability so the OS kernel is separate from middleware, applications and other packages. Scalability, security, safety, connectivity, and graphics have been improved to address Internet of Things (IoT) needs.

μC/OS. Micro-Controller Operating Systems (MicroC/OS, stylized as μC/OS) is a real-time operating system (RTOS) that is a priority-based preemptive real-time kernel for microprocessors, written mostly in the programming language C, and is intended for use in embedded systems. MicroC/OS allows defining several functions in C, each of which can execute as an independent thread or task. Each task runs at a different priority, and runs as if it owns the central processing unit (CPU). Lower priority tasks can be preempted by higher priority tasks at any time. Higher priority tasks use operating system (OS) services (such as a delay or event) to allow lower priority tasks to execute. OS services are provided for managing tasks and memory, communicating between tasks, and timing.

A server device (in server/client architecture) typically offers information resources, services, and applications to clients, using a server dedicated or oriented operating system. A server device may consist of, be based on, include, or be included in the work-station 7, the computer system 10, or the computer 11. Current popular server operating systems are based on Microsoft Windows (by Microsoft Corporation, headquartered in Redmond, Wash., U.S.A.), Unix, and Linux-based solutions, such as the ‘Windows Server 2012’ server operating system, which is a part of the Microsoft ‘Windows Server’ OS family, that was released by Microsoft in 2012. ‘Windows Server 2012’ provides enterprise-class datacenter and hybrid cloud solutions that are simple to deploy, cost-effective, application-specific, and user-centric, and is described in Microsoft publication entitled: “Inside-Out Windows Server 2012”, by William R. Stanek, published 2013 by Microsoft Press, which is incorporated in its entirety for all purposes as if fully set forth herein.

Unix operating system is widely used in servers. It is a multitasking, multiuser computer operating system that exists in many variants, and is characterized by a modular design that is sometimes called the “Unix philosophy”, meaning the OS provides a set of simple tools, which each performs a limited, well-defined function, with a unified filesystem as the primary means of communication, and a shell scripting and command language to combine the tools to perform complex workflows. Unix was designed to be portable, multi-tasking and multi-user in a time-sharing configuration, and Unix systems are characterized by various concepts: the use of plain text for storing data, a hierarchical file system, treating devices and certain types of Inter-Process Communication (IPC) as files, the use of a large number of software tools, and small programs that can be strung together through a command line interpreter using pipes, as opposed to using a single monolithic program that includes all of the same functionality. Unix operating system consists of many utilities along with the master control program, the kernel. The kernel provides services to start and stop programs, handles the file system and other common “low level” tasks that most programs share, and schedules access to avoid conflicts when programs try to access the same resource, or device simultaneously. To mediate such access, the kernel has special rights, reflected in the division between user-space and kernel-space. Unix is described in a publication entitled: “UNIX Tutorial” by tutorialspoint.com, downloaded on July 2014, which is incorporated in its entirety for all purposes as if fully set forth herein.

A client device (in server/client architecture) typically receives information resources, services, and applications from servers, and is using a client dedicated or oriented operating system. The client device may consist of, be based on, include, or be included in, the workstation 7, the computer system 10 or the computer 11. Current popular client operating systems are based on Microsoft Windows (by Microsoft Corporation, headquartered in Redmond, Wash., U.S.A.), which is a series of graphical interface operating systems developed, marketed, and sold by Microsoft. Microsoft Windows is described in Microsoft publications entitled: “Windows Internals—Part 1” and “Windows Internals—Part 2”, by Mark Russinovich, David A. Solomon, and Alex Ioescu, published by Microsoft Press in 2012, which are both incorporated in their entirety for all purposes as if fully set forth herein. Windows 8 is a personal computer operating system developed by Microsoft as part of Windows NT family of operating systems, that was released for general availability on October 2012, and is described in Microsoft Press 2012 publication entitled: “Introducing Windows 8—An Overview for IT Professionals” by Jerry Honeycutt, which is incorporated in its entirety for all purposes as if fully set forth herein.

Vehicle. A vehicle is a mobile machine that transports people or cargo. Most often, vehicles are manufactured, such as wagons, bicycles, motor vehicles (motorcycles, cars, trucks, buses), railed vehicles (trains, trams), watercraft (ships, boats), aircraft and spacecraft. The vehicle may be designed for use on land, in fluids, or be airborne, such as bicycle, car, automobile, motorcycle, train, ship, boat, submarine, airplane, scooter, bus, subway, train, or spacecraft. A vehicle may consist of, or may comprise, a bicycle, a car, a motorcycle, a train, a ship, an aircraft, a boat, a spacecraft, a boat, a submarine, a dirigible, an electric scooter, a subway, a train, a trolleybus, a tram, a sailboat, a yacht, or an airplane. Further, a vehicle may be a bicycle, a car, a motorcycle, a train, a ship, an aircraft, a boat, a spacecraft, a boat, a submarine, a dirigible, an electric scooter, a subway, a train, a trolleybus, a tram, a sailboat, a yacht, or an airplane.

A vehicle may be a land vehicle typically moving on the ground, using wheels, tracks, rails, or skies. The vehicle may be locomotion-based where the vehicle is towed by another vehicle or an animal. Propellers (as well as screws, fans, nozzles, or rotors) are used to move on or through a fluid or air, such as in watercrafts and aircrafts. The system described herein may be used to control, monitor or otherwise be part of, or communicate with, the vehicle motion system. Similarly, the system described herein may be used to control, monitor or otherwise be part of, or communicate with, the vehicle steering system. Commonly, wheeled vehicles steer by angling their front or rear (or both) wheels, while ships, boats, submarines, dirigibles, airplanes and other vehicles moving in or on fluid or air usually have a rudder for steering. The vehicle may be an automobile, defined as a wheeled passenger vehicle that carries its own motor, and primarily designed to run on roads, and have seating for one to six people. Typically automobiles have four wheels, and are constructed to principally transport of people.

Human power may be used as a source of energy for the vehicle, such as in non-motorized bicycles. Further, energy may be extracted from the surrounding environment, such as solar powered car or aircraft, a street car, as well as by sailboats and land yachts using the wind energy. Alternatively or in addition, the vehicle may include energy storage, and the energy is converted to generate the vehicle motion. A common type of energy source is a fuel, and external or internal combustion engines are used to burn the fuel (such as gasoline, diesel, or ethanol) and create a pressure that is converted to a motion. Another common medium for storing energy are batteries or fuel cells, which store chemical energy used to power an electric motor, such as in motor vehicles, electric bicycles, electric scooters, small boats, subways, trains, trolleybuses, and trams.

Aircraft. An aircraft is a machine that is able to fly by gaining support from the air. It counters the force of gravity by using either static lift or by using the dynamic lift of an airfoil, or in a few cases, the downward thrust from jet engines. The human activity that surrounds aircraft is called aviation. Crewed aircraft are flown by an onboard pilot, but unmanned aerial vehicles may be remotely controlled or self-controlled by onboard computers. Aircraft may be classified by different criteria, such as lift type, aircraft propulsion, usage and others.

Aerostats are lighter than air aircrafts that use buoyancy to float in the air in much the same way that ships float on the water. They are characterized by one or more large gasbags or canopies filled with a relatively low-density gas such as helium, hydrogen, or hot air, which is less dense than the surrounding air. When the weight of this is added to the weight of the aircraft structure, it adds up to the same weight as the air that the craft displaces. Heavier-than-air aircraft, such as airplanes, must find some way to push air or gas downwards, so that a reaction occurs (by Newton's laws of motion) to push the aircraft upwards. This dynamic movement through the air is the origin of the term aerodyne. There are two ways to produce dynamic upthrust: aerodynamic lift and powered lift in the form of engine thrust.

Aerodynamic lift involving wings is the most common, with fixed-wing aircraft being kept in the air by the forward movement of wings, and rotorcraft by spinning wing-shaped rotors sometimes called rotary wings. A wing is a flat, horizontal surface, usually shaped in cross-section as an aerofoil. To fly, air must flow over the wing and generate lift. A flexible wing is a wing made of fabric or thin sheet material, often stretched over a rigid frame. A kite is tethered to the ground and relies on the speed of the wind over its wings, which may be flexible or rigid, fixed, or rotary.

Gliders are heavier-than-air aircraft that do not employ propulsion once airborne. Take-off may be by launching forward and downward from a high location, or by pulling into the air on a tow-line, either by a ground-based winch or vehicle, or by a powered “tug” aircraft. For a glider to maintain its forward air speed and lift, it must descend in relation to the air (but not necessarily in relation to the ground). Many gliders can ‘soar’—gain height from updrafts such as thermal currents. Common examples of gliders are sailplanes, hang gliders and paragliders. Powered aircraft have one or more onboard sources of mechanical power, typically aircraft engines although rubber and manpower have also been used. Most aircraft engines are either lightweight piston engines or gas turbines. Engine fuel is stored in tanks, usually in the wings but larger aircraft also have additional fuel tanks in the fuselage.

A propeller aircraft use one or more propellers (airscrews) to create thrust in a forward direction. The propeller is usually mounted in front of the power source in tractor configuration but can be mounted behind in pusher configuration. Variations of propeller layout include contra-rotating propellers and ducted fans. A Jet aircraft use airbreathing jet engines, which take in air, burn fuel with it in a combustion chamber, and accelerate the exhaust rearwards to provide thrust. Turbojet and turbofan engines use a spinning turbine to drive one or more fans, which provide additional thrust. An afterburner may be used to inject extra fuel into the hot exhaust, especially on military “fast jets”. Use of a turbine is not absolutely necessary: other designs include the pulse jet and ramjet. These mechanically simple designs cannot work when stationary, so the aircraft must be launched to flying speed by some other method. Some rotorcrafts, such as helicopters, have a powered rotary wing or rotor, where the rotor disc can be angled slightly forward so that a proportion of its lift is directed forwards. The rotor may, similar to a propeller, be powered by a variety of methods such as a piston engine or turbine. Experiments have also used jet nozzles at the rotor blade tips.

A vehicle may include a hood (a.k.a. bonnet), which is the hinged cover over the engine of motor vehicles that allows access to the engine compartment (or trunk on rear-engine and some mid-engine vehicles) for maintenance and repair. A vehicle may include a bumper, which is a structure attached, or integrated to, the front and rear of an automobile to absorb impact in a minor collision, ideally minimizing repair costs. Bumpers also have two safety functions: minimizing height mismatches between vehicles and protecting pedestrians from injury. A vehicle may include a cowling, which is the covering of a vehicle's engine, most often found on automobiles and aircraft. A vehicle may include a dashboard (also called dash, instrument panel, or fascia), which is a control panel placed in front of the driver of an automobile, housing instrumentation and controls for operation of the vehicle. A vehicle may include a fender that frames a wheel well (the fender underside). Its primary purpose is to prevent sand, mud, rocks, liquids, and other road spray from being thrown into the air by the rotating tire. Fenders are typically rigid and can be damaged by contact with the road surface. Instead, flexible mud flaps are used close to the ground where contact may be possible. A vehicle may include a quarter panel (a.k.a. rear wing), which is the body panel (exterior surface) of an automobile between a rear door (or only door on each side for two-door models) and the trunk (boot) and typically wraps around the wheel well. Quarter panels are typically made of sheet metal, but are sometimes made of fiberglass, carbon fiber, or fiber-reinforced plastic. A vehicle may include a rocker, which is the body section below the base of the door openings. A vehicle may include a spoiler, which is an automotive aerodynamic device whose intended design function is to ‘spoil’ unfavorable air movement across a body of a vehicle in motion, usually described as turbulence or drag. Spoilers on the front of a vehicle are often called air dams. Spoilers are often fitted to race and high-performance sports cars, although they have become common on passenger vehicles as well. Some spoilers are added to cars primarily for styling purposes and have either little aerodynamic benefit or even make the aerodynamics worse. The trunk (a.k.a. boot) of a car is the vehicle's main storage compartment. A vehicle door is a type of door, typically hinged, but sometimes attached by other mechanisms such as tracks, in front of an opening, which is used for entering and exiting a vehicle. A vehicle door can be opened to provide access to the opening, or closed to secure it. These doors can be opened manually, or powered electronically. Powered doors are usually found on minivans, high-end cars, or modified cars. Car glass includes windscreens, side and rear windows, and glass panel roofs on a vehicle. Side windows can be either fixed or be raised and lowered by depressing a button (power window) or switch or using a hand-turned crank.

The lighting system of a motor vehicle consists of lighting and signaling devices mounted or integrated to the front, rear, sides, and in some cases, the top of a motor vehicle. This lights the roadway for the driver and increases the conspicuity of the vehicle, allowing other drivers and pedestrians to see a vehicle's presence, position, size, direction of travel, and the driver's intentions regarding direction and speed of travel. Emergency vehicles usually carry distinctive lighting equipment to warn drivers and indicate priority of movement in traffic. A headlamp is a lamp attached to the front of a vehicle to light the road ahead. A chassis consists of an internal framework that supports a manmade object in its construction and use. An example of a chassis is the underpart of a motor vehicle, consisting of the frame (on which the body is mounted).

Autonomous car. An autonomous car (also known as a driverless car, self-driving car, or robotic car) is a vehicle that is capable of sensing its environment and navigating without human input. Autonomous cars use a variety of techniques to detect their surroundings, such as radar, laser light, GPS, odometry, and computer vision. Advanced control systems interpret sensory information to identify appropriate navigation paths, as well as obstacles and relevant signage. Autonomous cars have control systems that are capable of analyzing sensory data to distinguish between different cars on the road, which is very useful in planning a path to the desired destination. Among the potential benefits of autonomous cars is a significant reduction in traffic collisions; the resulting injuries; and related costs, including a lower need for insurance. Autonomous cars are also predicted to offer major increases in traffic flow; enhanced mobility for children, the elderly, disabled and poor people; the relief of travelers from driving and navigation chores; lower fuel consumption; significantly reduced needs for parking space in cities; a reduction in crime; and the facilitation of different business models for mobility as a service, especially those involved in the sharing economy.

Modern self-driving cars generally use Bayesian Simultaneous Localization And Mapping (SLAM) algorithms, which fuse data from multiple sensors and an off-line map into current location estimates and map updates. SLAM with Detection and Tracking of other Moving Objects (DATMO), which also handles things such as cars and pedestrians, is a variant being developed by research at Google. Simpler systems may use roadside Real-Time Locating System (RTLS) beacon systems to aid localization. Typical sensors include LIDAR and stereo vision, GPS and IMU. Visual object recognition uses machine vision including neural networks.

The term ‘Dynamic driving task’ includes the operational (steering, braking, accelerating, monitoring the vehicle and roadway) and tactical (responding to events, determining when to change lanes, turn, use signals, etc.) aspects of the driving task, but not the strategic (determining destinations and waypoints) aspect of the driving task. The term ‘Driving mode’ refers to a type of driving scenario with characteristic dynamic driving task requirements (e.g., expressway merging, high speed, cruising, low speed traffic jam, closed-campus operations, etc.). The term ‘Request to intervene’ refers to notification by the automated driving system to a human driver that s/he should promptly begin or resume performance of the dynamic driving task.

The SAE International standard J3016, entitled: “Taxonomy and Definitions for Terms Related to On-Road Motor Vehicle Automated Driving Systems” [Revised 2016-09], which is incorporated in its entirety for all purposes as if fully set forth herein, describes six different levels (ranging from none to fully automated systems), based on the amount of driver intervention and attentiveness required, rather than the vehicle capabilities. The levels are further described in a table 20a in FIG. 2a. Level 0 refers to automated system issues warnings but has no vehicle control, while Level 1 (also referred to as “hands on”) refers to driver and automated system that shares control over the vehicle. An example would be Adaptive Cruise Control (ACC) where the driver controls steering and the automated system controls speed. Using Parking Assistance, steering is automated while speed is manual. The driver must be ready to retake full control at any time. Lane Keeping Assistance (LKA) Type II is a further example of level 1 self-driving.

In Level 2 (also referred to as “hands off”), the automated system takes full control of the vehicle (accelerating, braking, and steering). The driver must monitor the driving and be prepared to immediately intervene at any time if the automated system fails to respond properly. In Level 3 (also referred to as “eyes off”), the driver can safely turn their attention away from the driving tasks, e.g. the driver can text or watch a movie. The vehicle will handle situations that call for an immediate response, like emergency braking. The driver must still be prepared to intervene within some limited time, specified by the manufacturer, when called upon by the vehicle to do so. A key distinction is between level 2, where the human driver performs part of the dynamic driving task, and level 3, where the automated driving system performs the entire dynamic driving task. Level 4 (also referred to as “mind off”) is similar to level 3, but no driver attention is ever required for safety, i.e., the driver may safely go to sleep or leave the driver's seat. Self-driving is supported only in limited areas (geofenced) or under special circumstances, such as traffic jams. Outside of these areas or circumstances, the vehicle must be able to safely abort the trip, i.e., park the car, if the driver does not retake control. In Level 5 (also referred to as “wheel optional”), no human intervention is required. An example would be a robotic taxi.

An autonomous vehicle and systems having an interface for payloads that allows integration of various payloads with relative ease are disclosed in U.S. Patent Application Publication No. 2007/0198144 to Norris et al. entitled: “Networked multi-role robotic vehicle”, which is incorporated in its entirety for all purposes as if fully set forth herein. There is a vehicle control system for controlling an autonomous vehicle, receiving data, and transmitting a control signal on at least one network. A payload is adapted to detachably connect to the autonomous vehicle, the payload comprising a network interface configured to receive the control signal from the vehicle control system over the at least one network. The vehicle control system may encapsulate payload data and transmit the payload data over the at least one network, including Ethernet or CAN networks. The payload may be a laser scanner, a radio, a chemical detection system, or a Global Positioning System unit. In certain embodiments, the payload is a camera mast unit, where the camera communicates with the autonomous vehicle control system to detect and avoid obstacles. The camera mast unit may be interchangeable, and may include structures for receiving additional payload components.

Automotive electronics. Automotive electronics involves any electrically-generated systems used in vehicles, such as ground vehicles. Automotive electronics commonly involves multiple modular ECUs (Electronic Control Unit) connected over a network such as Engine Control Modules (ECM) or Transmission Control Modules (TCM). Automotive electronics or automotive embedded systems are distributed systems, and according to different domains in the automotive field, they can be classified into Engine electronics, Transmission electronics, Chassis electronics, Active safety, Driver assistance, Passenger comfort, and Entertainment (or infotainment) systems.

One of the most demanding electronic parts of an automobile is the Engine Control Unit. Engine controls demand one of the highest real time deadlines, as the engine itself is a very fast and complex part of the automobile. The computing power of the engine control unit is commonly the highest, typically a 32-bit processor, that typically controls in real-time in a diesel engine the Fuel injection rate, Emission control, NOx control, Regeneration of oxidation catalytic converter, Turbocharger control, Throttle control, and Cooling system control. In a gasoline engine, the engine control typically involves Lambda control, OBD (On-Board Diagnostics), Cooling system control, Ignition system control, Lubrication system control, Fuel injection rate control, and Throttle control.

An engine ECU typically connects to, or includes, sensors that actively monitor in real-time engine parameters such as pressure, temperature, flow, engine speed, oxygen level and NOx level, plus other parameters at different points within the engine. All these sensor signals are analyzed by the ECU, which has the logic circuits to do the actual controlling. The ECU output is commonly connected to different actuators for the throttle valve, EGR valve, rack (in VGTs), fuel injector (using a pulse-width modulated signal), dosing injector, and more.

Transmission electronics involves control of the transmission system, mainly the shifting of the gears for better shift comfort and to lower torque interrupt while shifting. Automatic transmissions use controls for their operation, and many semi-automatic transmissions having a fully automatic clutch or a semi-auto clutch (declutching only). The engine control unit and the transmission control typically exchange messages, sensor signals and control signals for their operation. Chassis electronics typically includes many sub-systems that monitor various parameters and are actively controlled, such as ABS—Anti-lock Braking System, TCS—Traction Control System, EBD—Electronic Brake Distribution, and ESP—Electronic Stability Program. Active safety systems involve modules that are ready-to-act when there is a collision in progress, or used to prevent it when it senses a dangerous situation, such as Air bags, Hill descent control, and Emergency brake assist system. Passenger comfort systems involve, for example, Automatic climate control, Electronic seat adjustment with memory, Automatic wipers, Automatic headlamps—adjusts beam automatically, and Automatic cooling—temperature adjustment. Infotainment systems include systems such as Navigation system, Vehicle audio, and Information access.

Automotive electric and electronic technologies and systems are described in a book published by Robert Bosch GmbH (5^{th} Edition, July 2007) entitled: “Bosch Automotive Electric and Automotive Electronics” [ISBN—978-3-658-01783-5], which is incorporated in its entirety for all purposes as if fully set forth herein.

ADAS. Advanced Driver Assistance Systems, or ADAS, are automotive electronic systems to help the driver in the driving process, such as to increase car safety and more generally, road safety using a safe Human-Machine Interface (HMI). Advanced driver assistance systems (ADAS) are developed to automate/adapt/enhance vehicle systems for safety and better driving. Safety features are designed to avoid collisions and accidents by offering technologies that alert the driver to potential problems, or to avoid collisions by implementing safeguards and taking over control of the vehicle. Adaptive features may automate lighting, provide adaptive cruise control, automate braking, incorporate GPS/traffic warnings, connect to smartphones, alert driver to other cars or dangers, keep the driver in the correct lane, or show what is in blind spots.

There are many forms of ADAS available; some features are built into cars or are available as an add-on package. ADAS technology can be based upon, or use, vision/camera systems, sensor technology, car data networks, Vehicle-to-vehicle (V2V), or Vehicle-to-Infrastructure systems (V2I), and leverage wireless network connectivity to offer improved value by using car-to-car and car-to-infrastructure data. ADAS technologies or applications comprise: Adaptive Cruise Control (ACC), Adaptive High Beam, Glare-free high beam and pixel light, Adaptive light control such as swiveling curve lights, Automatic parking, Automotive navigation system with typically GPS and TMC for providing up-to-date traffic information, Automotive night vision, Automatic Emergency Braking (AEB), Backup assist, Blind Spot Monitoring (BSM), Blind Spot Warning (BSW), Brake light or traffic signal recognition, Collision avoidance system (such as Precrash system), Collision Imminent Braking (CIB), Cooperative Adaptive Cruise Control (CACC), Crosswind stabilization, Driver drowsiness detection, Driver Monitoring Systems (DMS), Do-Not-Pass Warning (DNPW), Electric vehicle warning sounds used in hybrids and plug-in electric vehicles, Emergency driver assistant, Emergency Electronic Brake Light (EEBL), Forward Collision Warning (FCW), Heads-Up Display (HUD), Intersection assistant, Hill descent control, Intelligent speed adaptation or Intelligent Speed Advice (ISA), Intelligent Speed Adaptation (ISA), Intersection Movement Assist (IMA), Lane Keeping Assist (LKA), Lane Departure Warning (LDW) (a.k.a. Line Change Warning—LCW), Lane change assistance, Left Turn Assist (LTA), Night Vision System (NVS), Parking Assistance (PA), Pedestrian Detection System (PDS), Pedestrian protection system, Pedestrian Detection (PED), Road Sign Recognition (RSR), Surround View Cameras (SVC), Traffic sign recognition, Traffic jam assist, Turning assistant, Vehicular communication systems, Autonomous Emergency Braking (AEB), Adaptive Front Lights (AFL), or Wrong-way driving warning.

ADAS is further described in Intel Corporation 2015 Technical White Paper (0115/MW/HBD/PDF 331817-001US) by Meiyuan Zhao of Security & Privacy Research, Intel Labs entitled: “Advanced Driver Assistant System—Threats, Requirements, Security Solutions”, and in a PhD Thesis by Alexandre Dugarry submitted on June 2004 to the Cranfield University, School of Engineering, Applied Mathematics and Computing Group, entitled: “Advanced Driver Assistance Systems—Information Management and Presentation”, which are both incorporated in their entirety for all purposes as if fully set forth herein.

ACC. Autonomous cruise control (ACC; also referred to as ‘adaptive cruise control’ or ‘radar cruise control’) is an optional cruise control system for road vehicles that automatically adjusts the vehicle speed to maintain a safe distance from vehicles ahead. It makes no use of satellite or roadside infrastructures or of any cooperative support from other vehicles. The vehicle control is imposed based on sensor information from on-board sensors only. Cooperative Adaptive Cruise Control (CACC) further extends the automation of navigation by using information gathered from fixed infrastructure such as satellites and roadside beacons, or mobile infrastructure such as reflectors or transmitters on the back of other vehicles. These systems use either a radar or laser sensor setup allowing the vehicle to slow when approaching another vehicle ahead and accelerate again to the preset speed when traffic allows. ACC technology is widely regarded as a key component of any future generations of intelligent cars. The impact is equally on driver safety as on economizing capacity of roads by adjusting the distance between vehicles according to the conditions. Radar-based ACC often feature a pre-crash system, which warns the driver and/or provides brake support if there is a high risk of a collision. In certain cars it is incorporated with a lane maintaining system which provides power steering assist to reduce steering input burden in corners when the cruise control system is activated.

Adaptive High Beam. Adaptive High Beam Assist is Mercedes-Benz′ marketing name for a headlight control strategy that continuously automatically tailors the headlamp range so the beam just reaches other vehicles ahead, thus always ensuring maximum possible seeing range without glaring other road users. It provides a continuous range of beam reach from a low-aimed low beam to a high-aimed high beam, rather than the traditional binary choice between low and high beams. The range of the beam can vary between 65 and 300 meters, depending on traffic conditions. In traffic, the low beam cutoff position is adjusted vertically to maximize seeing range while keeping glare out of leading and oncoming drivers' eyes. When no traffic is close enough for glare to be a problem, the system provides full high beam. Headlamps are adjusted every 40 milliseconds by a camera on the inside of the front windscreen which can determine distance to other vehicles. The adaptive high beam may be realized with LED headlamps.

Automatic parking. Automatic parking is an autonomous car-maneuvering system that moves a vehicle from a traffic lane into a parking spot to perform parallel, perpendicular or angle parking. The automatic parking system aims to enhance the comfort and safety of driving in constrained environments where much attention and experience is required to steer the car. The parking maneuver is achieved by means of coordinated control of the steering angle and speed, which takes into account the actual situation in the environment to ensure collision-free motion within the available space. The car is an example of a non-holonomic system where the number of control commands available is less than the number of coordinates that represent its position and orientation.

Automotive night vision. An automotive night vision system uses a thermographic camera to increase a driver's perception and seeing distance in darkness or poor weather beyond the reach of the vehicle's headlights. Active systems use an infrared light source built into the car to illuminate the road ahead with light that is invisible to humans. There are two kinds of active systems: gated and non-gated. The gated system uses a pulsed light source and a synchronized camera that enable long ranges (250 m) and high performance in rain and snow. Passive infrared systems do not use an infrared light source, instead they capture thermal radiation already emitted by the objects, using a thermographic camera.

Blind spot monitor. The blind spot monitor is a vehicle-based sensor device that detects other vehicles located to the driver's side and rear. Warnings can be visual, audible, vibrating or tactile. Blind spot monitors may include more than monitoring the sides of the vehicle, such as ‘Cross Traffic Alert’, which alerts drivers backing out of a parking space when traffic is approaching from the sides. BLIS is an acronym for Blind Spot Information System, a system of protection developed by Volvo, and produced a visible alert when a car entered the blind spot while a driver was switching lanes, using two door mounted lenses to check the blind spot area for an impending collision.

Collision avoidance system. A collision avoidance system (a.k.a. Precrash system) is an automobile safety system designed to reduce the severity of an accident. Such forward collision warning system or collision mitigating system typically uses radar (all-weather) and sometimes laser and camera (both sensor types are ineffective during bad weather) to detect an imminent crash. Once the detection is done, these systems either provide a warning to the driver when there is an imminent collision or take action autonomously without any driver input (by braking or steering or both). Collision avoidance by braking is appropriate at low vehicle speeds (e.g. below 50 km/h), while collision avoidance by steering is appropriate at higher vehicle speeds. Cars with collision avoidance may also be equipped with adaptive cruise control, and use the same forward-looking sensors.

Intersection assistant. Intersection assistant is an advanced driver assistance system for city junctions that are a major accident blackspot. The collisions here can mostly be put down to driver distraction or misjudgement. While humans often react too slowly, assistance systems are immune to that brief moment of shock. The system monitors cross traffic in an intersection/road junction. If this anticipatory system detects a hazardous situation of this type, it prompts the driver to start emergency braking by activating visual and acoustic warnings and automatically engaging brakes.

Lane Departure Warning system. A lane departure warning system is a mechanism designed to warn the driver when the vehicle begins to move out of its lane (unless a turn signal is on in that direction) on freeways and arterial roads. These systems are designed to minimize accidents by addressing the main causes of collisions: driver error, distractions, and drowsiness. There are two main types of systems: Systems which warn the driver (lane departure warning, LDW) if the vehicle is leaving its lane (visual, audible, and/or vibration warnings), and systems which warn the driver and, if no action is taken, automatically take steps to ensure the vehicle stays in its lane (Lane Keeping System, LKS). Lane warning/keeping systems are based on video sensors in the visual domain (mounted behind the windshield, typically integrated beside the rear mirror), laser sensors (mounted on the front of the vehicle), or Infrared sensors (mounted either behind the windshield or under the vehicle).

ADASIS. The Advanced Driver Assistance System Interface Specification (ADASIS) forum was established in May 2001 by a group of car manufacturers, in-vehicle system developers and map data companies with the primary goal of developing a standardized map data interface between stored map data and ADAS applications. Main objectives of the ADASIS Forum are to define an open standardized data model and structure to represent map data in the vicinity of the vehicle position (i.e. the ADAS Horizon), in which map data is delivered by a navigation system or a general map data server, and to define an open standardized interface specification to provide ADAS horizon data (especially on a vehicle CAN bus) and enable ADAS applications to access the ADAS Horizon and position-related data of the vehicle. Using ADASIS, the available map data may not only be used for routing purposes but also to enable advanced in-vehicle applications. The area of potential features reaches from headlight control up to active safety applications (ADAS). With the ongoing development of navigation based ADAS features the interface to access the so-called ADAS Horizon is of rising importance. The ADASIS protocol is described in ADASIS Forum publication 200v2.0.3-D2.2-ADASIS_v2_Specification.0 dated December 2013 and entitled: “ADASIS v2 Protocol—Version 2.0.3.0”, which is incorporated in its entirety for all purposes as if fully set forth herein. Built-in vehicle sensors may be used to capture the vehicle's environment are limited to a relatively short range. However, the available digital map data can be used as a virtual sensor to look more forward on the path of the vehicle. The digital map contains attributes attached to the road segments, such as road geometry, functional road class, number of lanes, speed limits, traffic signs, etc. The “road ahead” concept is basically called Most Probable Path (or Most Likely Path) derived from the ADAS Horizon. For each street segment, the probability of driving through this segment is assigned and given by the ADASIS protocol.

ECU. In automotive electronics, an Electronic Control Unit (ECU) is a generic term for any embedded system that controls one or more of the electrical system or subsystems in a vehicle such as a motor vehicle. Types of ECU include Electronic/engine Control Module (ECM) (sometimes referred to as Engine Control Unit—ECU, which is distinct from the generic ECU—Electronic Control Unit), Airbag Control Unit (ACU), Powertrain Control Module (PCM), Transmission Control Module (TCM), Central Control Module (CCM), Central Timing Module (CTM), Convenience Control Unit (CCU), General Electronic Module (GEM), Body Control Module (BCM), Suspension Control Module (SCM), Door Control Unit (DCU), Powertrain Control Module (PCM), Electric Power Steering Control Unit (PSCU), Seat Control Unit, Speed Control Unit (SCU), Suspension Control Module (SCM), Telematic Control Unit (TCU), Telephone Control Unit (TCU), Transmission Control Unit (TCU), Brake Control Module (BCM or EBCM; such as ABS or ESC), Battery management system, control unit, or control module.

A microprocessor or a microcontroller serves as a core of an ECU, and uses a memory such as SRAM, EEPROM, and Flash. An ECU is power fed by a supply voltage, and includes or connects to sensors using analog and digital inputs. In addition to a communication interface, an ECU typically includes a relay, H-Bridge, injector, or logic drivers, or outputs for connecting to various actuators.

ECU technology and applications is described in the M. Tech. Project first stage report (EE696) by Vineet P. Aras of the Department of Electrical Engineering, Indian Institute of Technology Bombay, dated July 2004, entitled: “Design of Electronic Control Unit (ECU) for Automobiles—Electronic Engine Management system”, and in National Instruments paper published Nov. 7, 2009 entitled: “ECU Designing and Testing using National Instruments Products”, which are both incorporated in their entirety for all purposes as if fully set forth herein. ECU examples are described in a brochure by Sensor-Technik Wiedemann Gmbh (headquartered in Kaufbeuren, Germany) dated 20110304 GB entitled “Control System Electronics”, which is incorporated in its entirety for all purposes as if fully set forth herein. An ECU or an interface to a vehicle bus may use a processor such as the MPC5748G controller available from Freescale Semiconductor, Inc. (headquartered in Tokyo, Japan, and described in a data sheet Document Number MPC5748G Rev. 2, 05/2014 entitled: “MPC5748 Microcontroller Datasheet”, which is incorporated in its entirety for all purposes as if fully set forth herein.

Virtualization. The term virtualization typically refers to the technology that allows for the creation of software-based virtual machines that can run multiple operating systems from a single physical machine. In one example, virtual machines can be used to consolidate the workloads of several under-utilized servers to fewer machines, perhaps a single machine (server consolidation), providing benefits (perceived or real, but often cited by vendors) such as savings on hardware, environmental costs, management, and administration of the server infrastructure. Virtualization scheme allows for the creation of substitutes for real resources, that is, substitutes that have the same functions and external interfaces as their counterparts, but that differ in attributes, such as size, performance, and cost. These substitutes are called virtual resources, and their users are typically unaware of the substitution.

Virtualization is commonly applied to physical hardware resources by combining multiple physical resources into shared pools from which users receive virtual resources. With virtualization, you can make one physical resource look like multiple virtual resources. Virtual resources can have functions or features that are not available in their underlying physical resources. Virtualization can provide the benefits of consolidation to reduce hardware cost, such as to efficiently access and manage resources to reduce operations and systems management costs while maintaining needed capacity, and to have a single server function as multiple virtual servers. In addition, virtualization can provide optimization of workloads, such as to respond dynamically to the application needs of its users, and to increase the use of existing resources by enabling dynamic sharing of resource pools. Further, virtualization may be used for IT flexibility and responsiveness, such as by having a single, consolidated view of, and easy access to, all available resources in the network, regardless of location, and reducing the management of your environment by providing emulation for compatibility and improved interoperability.

Virtual machine (VM). Virtual machine is a representation of a real machine using software that provides an operating environment which can run or host a guest operating system. In one example, a virtual machine may include a self-contained software emulation of a machine, which does not physically exist, but shares resources of an underlying physical machine. Like a physical computer, a virtual machine runs an operating system and applications. Multiple virtual machines can operate concurrently on a single host system. There are different kinds of virtual machines, each with different functions: System virtual machines (also termed full virtualization VMs) provide a substitute for a real machine. They provide functionality needed to execute entire operating systems. A hypervisor uses native execution to share and manage hardware, allowing for multiple environments which are isolated from one another, yet exist on the same physical machine. Modern hypervisors use hardware-assisted virtualization, virtualization-specific hardware, primarily from the host CPUs. Process virtual machines are designed to execute computer programs in a platform-independent environment. Some virtual machines, such as QEMU, are designed to also emulate different architectures and allow execution of software applications and operating systems written for another CPU or architecture. Operating-system-level virtualization allows the resources of a computer to be partitioned via the kernel's support for multiple isolated user space instances, which are usually called containers and may look and feel like real machines to the end users.

Guest Operating System. A guest operating system is an operating system running in a virtual machine environment that would otherwise run directly on a separate physical system. Operating-system-level virtualization, also known as containerization, refers to an operating system feature in which the kernel allows the existence of multiple isolated user-space instances. Such instances, called containers, partitions, Virtualization Engines (VEs) or jails (FreeBSD jail or chroot jail), may look like real computers from the point of view of programs running in them. A computer program running on an ordinary operating system can see all resources (connected devices, files and folders, network shares, CPU power, quantifiable hardware capabilities) of that computer. However, programs running inside a container can only see the container's contents and devices assigned to the container. In addition to isolation mechanisms, the kernel often provides resource-management features to limit the impact of one container's activities on other containers. With operating-system-virtualization, or containerization, it is possible to run programs within containers, to which only parts of these resources are allocated. A program expecting to see the whole computer, once run inside a container, can only see the allocated resources and believes them to be all that is available. Several containers can be created on each operating system, to each of which a subset of the computer's resources is allocated. Each container may contain any number of computer programs. These programs may run concurrently or separately, even interact with each other.

Hypervisor. Hypervisor commonly refers to a thin layer of software that generally provides virtual partitioning capabilities which runs directly on hardware, but underneath higher-level virtualization services. The hypervisor typically manages virtual machines, allowing them to interact directly with the underlying hardware. System virtualization creates many virtual systems within a single physical system. Virtual systems are independent operating environments that use virtual resources. System virtualization can be approached through hardware partitioning or hypervisor technology. Hardware partitioning subdivides a physical server into fractions, each of which can run an operating system. These fractions are typically created with coarse units of allocation, such as whole processors or physical boards. This type of virtualization allows for hardware consolidation, but does not have the full benefits of resource sharing and emulation offered by hypervisors. Hypervisors use a thin layer of code in software or firmware to achieve fine-grained, dynamic resource sharing. Because hypervisors provide the greatest level of flexibility in how virtual resources are defined and managed, they are the primary technology for system virtualization.

Virtual Machine Monitor. A Virtual Machine Monitor (VMM) is computer software, firmware or hardware that creates and runs virtual machines. A computer on which a hypervisor runs one or more virtual machines is called a host machine, and each virtual machine is called a guest machine. The hypervisor presents the guest operating systems with a virtual operating platform and manages the execution of the guest operating systems. Multiple instances of a variety of operating systems may share the virtualized hardware resources: for example, Linux, Windows, and macOS instances can all run on a single physical x86 machine. This contrasts with operating-system-level virtualization, where all instances (usually called containers) must share a single kernel, though the guest operating systems can differ in user space, such as different Linux distributions with the same kernel. Typically, a VMM refers to a software that runs in a layer between a hypervisor or host operating system and one or more virtual machines that provides the virtual machines abstraction to the guest operating systems. With full virtualization, the VMM exports a virtual machine abstraction identical to the physical machine, so the standard operating system can run just as they would on physical hardware.

Hardware virtualization or platform virtualization refers to the creation of a virtual machine that acts like a real computer with an operating system. Software executed on these virtual machines is separated from the underlying hardware resources. In hardware virtualization, the host machine is the actual machine on which the virtualization takes place, and the guest machine is the virtual machine. The words host and guest are used to distinguish the software that runs on the physical machine from the software that runs on the virtual machine. The software or firmware that creates a virtual machine on the host hardware is called a hypervisor or Virtual Machine Manager. Different types of hardware virtualization include full-virtualization, where almost complete simulation of the actual hardware to allow software, which typically consists of a guest operating system, to run unmodified, and Para-virtualization, where a hardware environment is not simulated; however, the guest programs are executed in their own isolated domains, as if they are running on a separate system. Guest programs need to be specifically modified to run in this environment.

Hardware-assisted virtualization is a way of improving overall efficiency of virtualization. It involves CPUs that provide support for virtualization in hardware, and other hardware components that help improve the performance of a guest environment. Hardware virtualization can be viewed as part of an overall trend in enterprise IT that includes autonomic computing, a scenario in which the IT environment will be able to manage itself based on perceived activity, and utility computing, in which computer processing power is seen as a utility that clients can pay for only as needed. The usual goal of virtualization is to centralize administrative tasks while improving scalability and overall hardware-resource utilization. With virtualization, several operating systems can be run in parallel on a single central processing unit (CPU). This parallelism tends to reduce overhead costs and differs from multitasking, which involves running several programs on the same OS. Using virtualization, an enterprise can better manage updates and rapid changes to the operating system and applications without disrupting the user.

Server Virtualization. Server virtualization is a virtualization technique that involves partitioning a physical server into a number of small, virtual servers with the help of virtualization software. In server virtualization, each virtual server runs multiple operating system instances at the same time. A Virtual Private Server (VPS) is a virtual machine sold as a service by an Internet hosting service, that runs its own copy of an Operating System (OS), and customers may have superuser-level access to that operating system instance, so they can install almost any software that runs on that OS. For many purposes they are functionally equivalent to a dedicated physical server, and being software-defined, are able to be much more easily created and configured. They are typically priced much lower than an equivalent physical server. However, as they share the underlying physical hardware with other VPS's, performance may be lower, depending on the workload of any other executing virtual machines. Dedicated Servers may also be more efficient with CPU dependent processes such as hashing algorithms.

Application Virtualization. Application virtualization is software technology that encapsulates computer programs from the underlying operating system on which it is executed. A fully virtualized application is not installed in the traditional sense, although it is still executed as if it were. The application behaves at runtime like it is directly interfacing with the original operating system and all the resources managed by it, but can be isolated or sandboxed to varying degrees. Application virtualization is layered on top of other virtualization technologies, allowing computing resources to be distributed dynamically in real-time. In this context, the term “virtualization” commonly refers to the artifact being encapsulated (application), which is quite different from its meaning in hardware virtualization, where it refers to the artifact being abstracted (physical hardware).

Network Virtualization. Network Virtualization refers to the process of combining hardware and software network resources to create a single pool of resources that make up a virtual network that can be accessed without regard to the physical component. Network virtualization typically involves combining hardware and software network resources and network functionality into a single, software-based administrative entity, a virtual network. Network virtualization involves platform virtualization, often combined with resource virtualization. Network virtualization is categorized as either external virtualization, combining many networks or parts of networks into a virtual unit, or internal virtualization, providing network-like functionality to software containers on a single network server.

Storage Virtualization. Storage virtualization refers to the process of consolidating the physical storage from multiple network storage devices so that it appears to be a single storage unit. Within the context of a storage system, there are two primary types of virtualization that can occur: Block virtualization used in this context refers to the abstraction (separation) of logical storage (partition) from physical storage so that it may be accessed without regard to physical storage or heterogeneous structure. This separation allows the administrators of the storage system greater flexibility in how they manage storage for end users. File virtualization addresses the NAS challenges by eliminating the dependencies between the data accessed at the file level and the location where the files are physically stored. This provides opportunities to optimize storage use and server consolidation and to perform non-disruptive file migrations.

Desktop Virtualization. Desktop virtualization refers to the process of virtualizing desktop computers using virtualization software, such that the desktop computer and the associated operating system and applications are separated from the physical client device that is used to access it. Desktop virtualization is software technology that separates the desktop environment and associated application software from the physical client device that is used to access it.

Desktop virtualization can be used in conjunction with application virtualization and user profile management systems, now termed “user virtualization,” to provide a comprehensive desktop environment management system. In this mode, all the components of the desktop are virtualized, which allows for a highly flexible and much more secure desktop delivery model. In addition, this approach supports a more complete desktop disaster recovery strategy as all components are essentially saved in the data center and backed up through traditional redundant maintenance systems. If a user's device or hardware is lost, the restore is straightforward and simple, because the components will be present at login from another device. In addition, because no data is saved to the user's device, if that device is lost, there is much less chance that any critical data can be retrieved and compromised. Virtual Desktop Infrastructure (VDI)—The practice of hosting a desktop environment within a virtual machine that runs on a centralized or remote server.

An example of a virtualization architecture 900 is shown in FIG. 2b, where three virtual machines are exemplified. A Virtual Machine (VM) #1 910a provides virtualization for the application 901a that uses the guest OS 902a, which in turn interfaces with the virtual hardware 903a that emulates the actual hardware. Similarly, a Virtual Machine (VM) #2 910b provides virtualization for the application 901b that uses the guest OS 902b, which in turn interfaces with the virtual hardware 903b that emulates the associated actual hardware, and a Virtual Machine (VM) #3 910c provides virtualization for the application 901c that uses the guest OS 902c, which in turn interfaces with the virtual hardware 903c that emulates the associated actual hardware. The abstraction layer is provided by VMM 904, allowing of hardware-independence of operating system and applications, provisioning on any single physical system, and managing the applications and the OSs as a single encapsulated unit.

A hosted architecture 900a for virtualization is shown in FIG. 2c, where a wide range of actual host hardware 906 may be used by implementing a host operating system 905 layer between the actual hardware 906 and the VMM 904. Such configuration relies on the host OS 905 for device support and physical resource management. In contrast, a bare-metal architecture 900b is shown in FIG. 2d, where a hypervisor layer (in addition to, or as part of, the VMM 904) is used as the first layer, allowing the VMM 904 to have direct access to the hardware resources, hence providing more efficient, and greater scalability, robustness, and performance.

Cloud computing and virtualization is described in a book entitled “Cloud Computing and Virtualization” authored by Dac-Nhuong Le (Faculty of Information Technology, Haiphong University, Haiphong, Vietnam), Raghvendra Kumar (Department of Computer Science and Engineering, LNCT, Jabalpur, India), Gia Nhu Nguyen (Graduate School, Duy Tan University, Da Nang, Vietnam), and Jyotir Moy Chatterjee (Department of Computer Science and Engineering at GD-RCET, Bhilai, India), and published 2018 by John Wiley & Sons, Inc. [ISBN 978-1-119-48790-6], which is incorporated in its entirety for all purposes as if fully set forth herein. The book describes the adoption of virtualization in data centers creates the need for a new class of networks designed to support elasticity of resource allocation, increasing mobile workloads and the shift to production of virtual workloads, requiring maximum availability. Building a network that spans both physical servers and virtual machines with consistent capabilities demands a new architectural approach to designing and building the IT infrastructure. Performance, elasticity, and logical addressing structures must be considered as well as the management of the physical and virtual networking infrastructure. Once deployed, a network that is virtualization-ready can offer many revolutionary services over a common shared infrastructure. Virtualization technologies from VMware, Citrix and Microsoft encapsulate existing applications and extract them from the physical hardware. Unlike physical machines, virtual machines are represented by a portable software image, which can be instantiated on physical hardware at a moment's notice. With virtualization, comes elasticity where computer capacity can be scaled up or down on demand by adjusting the number of virtual machines actively executing on a given physical server. Additionally, virtual machines can be migrated while in service from one physical server to another.

Extending this further, virtualization creates “location freedom” enabling virtual machines to become portable across an ever-increasing geographical distance. As cloud architectures and multi-tenancy capabilities continue to develop and mature, there is an economy of scale that can be realized by aggregating resources across applications, business units, and separate corporations to a common shared, yet segmented, infrastructure. Elasticity, mobility, automation, and density of virtual machines demand new network architectures focusing on high performance, addressing portability, and the innate understanding of the virtual machine as the new building block of the data center. Consistent network-supported and virtualization-driven policy and controls are necessary for visibility to virtual machines' state and location as they are created and moved across a virtualized infrastructure.

Virtualization technologies in data center environments are described in a eBook authored by Gustavo Alessandro Andrade Santana and published 2014 by Cisco Systems, Inc. (Cisco Press) [ISBN-13: 978-1-58714-324-3] entitled: “Data Center Virtualization Fundamentals”, which is incorporated in its entirety for all purposes as if fully set forth herein. PowerVM technology for virtualization is described in IBM RedBook entitled: “IBM PowerVM Virtualization—Introduction and Configuration” published by IBM Corporation June 2013, and virtualization basics is described in a paper by IBM Corporation published 2009 entitled: “Power Systems—Introduction to virtualization”, which are both incorporated in their entirety for all purposes as if fully set forth herein.

Wireless. Any embodiment herein may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth (RTM), Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Any wireless network or wireless connection herein may be operating substantially in accordance with existing IEEE 802.11, 802.11a, 802.11b, 802.11g, 802.11k, 802.11n, 802.11r, 802.16, 802.16d, 802.16e, 802.20, 802.21 standards and/or future versions and/or derivatives of the above standards. Further, a network element (or a device) herein may consist of, be part of, or include, a cellular radio-telephone communication system, a cellular telephone, a wireless telephone, a Personal Communication Systems (PCS) device, a PDA device that incorporates a wireless communication device, or a mobile/portable Global Positioning System (GPS) device. Further, a wireless communication may be based on wireless technologies that are described in Chapter 20: “Wireless Technologies” of the publication number 1-587005-001-3 by Cisco Systems, Inc. (7/99) entitled: “Internetworking Technologies Handbook”, which is incorporated in its entirety for all purposes as if fully set forth herein. Wireless technologies and networks are further described in a book published 2005 by Pearson Education, Inc. William Stallings [ISBN: 0-13-191835-4] entitled: “Wireless Communications and Networks—second Edition”, which is incorporated in its entirety for all purposes as if fully set forth herein.

Wireless networking typically employs an antenna (a.k.a. aerial), which is an electrical device that converts electric power into radio waves, and vice versa, connected to a wireless radio transceiver. In transmission, a radio transmitter supplies an electric current oscillating at radio frequency to the antenna terminals, and the antenna radiates the energy from the current as electromagnetic waves (radio waves). In reception, an antenna intercepts some of the power of an electromagnetic wave in order to produce a low voltage at its terminals that is applied to a receiver to be amplified. Typically an antenna consists of an arrangement of metallic conductors (elements), electrically connected (often through a transmission line) to the receiver or transmitter. An oscillating current of electrons forced through the antenna by a transmitter will create an oscillating magnetic field around the antenna elements, while the charge of the electrons also creates an oscillating electric field along the elements. These time-varying fields radiate away from the antenna into space as a moving transverse electromagnetic field wave. Conversely, during reception, the oscillating electric and magnetic fields of an incoming radio wave exert force on the electrons in the antenna elements, causing them to move back and forth, creating oscillating currents in the antenna. Antennas can be designed to transmit and receive radio waves in all horizontal directions equally (omnidirectional antennas), or preferentially in a particular direction (directional or high gain antennas). In the latter case, an antenna may also include additional elements or surfaces with no electrical connection to the transmitter or receiver, such as parasitic elements, parabolic reflectors or horns, which serve to direct the radio waves into a beam or other desired radiation pattern.

ISM. The Industrial, Scientific and Medical (ISM) radio bands are radio bands (portions of the radio spectrum) reserved internationally for the use of radio frequency (RF) energy for industrial, scientific and medical purposes other than telecommunications. In general, communications equipment operating in these bands must tolerate any interference generated by ISM equipment, and users have no regulatory protection from ISM device operation. The ISM bands are defined by the ITU-R in 5.138, 5.150, and 5.280 of the Radio Regulations. Individual countries use of the bands designated in these sections may differ due to variations in national radio regulations. Because communication devices using the ISM bands must tolerate any interference from ISM equipment, unlicensed operations are typically permitted to use these bands, since unlicensed operation typically needs to be tolerant of interference from other devices anyway. The ISM bands share allocations with unlicensed and licensed operations; however, due to the high likelihood of harmful interference, licensed use of the bands is typically low. In the United States, uses of the ISM bands are governed by Part 18 of the Federal Communications Commission (FCC) rules, while Part 15 contains the rules for unlicensed communication devices, even those that share ISM frequencies. In Europe, the ETSI is responsible for governing ISM bands.

Commonly used ISM bands include a 2.45 GHz band (also known as 2.4 GHz band) that includes the frequency band between 2.400 GHz and 2.500 GHz, a 5.8 GHz band that includes the frequency band 5.725-5.875 GHz, a 24 GHz band that includes the frequency band 24.000-24.250 GHz, a 61 GHz band that includes the frequency band 61.000-61.500 GHz, a 122 GHz band that includes the frequency band 122.000-123.000 GHz, and a 244 GHz band that includes the frequency band 244.000-246.000 GHz.

ZigBee. ZigBee is a standard for a suite of high-level communication protocols using small, low-power digital radios based on an IEEE 802 standard for Personal Area Network (PAN). Applications include wireless light switches, electrical meters with in-home-displays, and other consumer and industrial equipment that require a short-range wireless transfer of data at relatively low rates. The technology defined by the ZigBee specification is intended to be simpler and less expensive than other WPANs, such as Bluetooth. ZigBee is targeted at Radio-Frequency (RF) applications that require a low data rate, long battery life, and secure networking. ZigBee has a defined rate of 250 kbps suited for periodic or intermittent data or a single signal transmission from a sensor or input device.

ZigBee builds upon the physical layer and medium access control defined in IEEE standard 802.15.4 (2003 version) for low-rate WPANs. The specification further discloses four main components: network layer, application layer, ZigBee Device Objects (ZDOs), and manufacturer-defined application objects, which allow for customization and favor total integration. The ZDOs are responsible for a number of tasks, which include keeping of device roles, management of requests to join a network, device discovery, and security. Because ZigBee nodes can go from a sleep to active mode in 30 ms or less, the latency can be low and devices can be responsive, particularly compared to Bluetooth wake-up delays, which are typically around three seconds. ZigBee nodes can sleep most of the time, thus the average power consumption can be lower, resulting in longer battery life.

There are three defined types of ZigBee devices: ZigBee Coordinator (ZC), ZigBee Router (ZR), and ZigBee End Device (ZED). ZigBee Coordinator (ZC) is the most capable device and forms the root of the network tree and might bridge to other networks. There is exactly one defined ZigBee coordinator in each network, since it is the device that started the network originally. It is able to store information about the network, including acting as the Trust Center & repository for security keys. ZigBee Router (ZR) may be running an application function as well as may be acting as an intermediate router, passing on data from other devices. ZigBee End Device (ZED) contains functionality to talk to a parent node (either the coordinator or a router). This relationship allows the node to be asleep a significant amount of the time, thereby giving long battery life. A ZED requires the least amount of memory, and therefore can be less expensive to manufacture than a ZR or ZC.

The protocols build on recent algorithmic research (Ad-hoc On-demand Distance Vector, neuRFon) to automatically construct a low-speed ad-hoc network of nodes. In most large network instances, the network will be a cluster of clusters. It can also form a mesh or a single cluster. The current ZigBee protocols support beacon and non-beacon enabled networks. In non-beacon-enabled networks, an unslotted CSMA/CA channel access mechanism is used. In this type of network, ZigBee Routers typically have their receivers continuously active, requiring a more robust power supply. However, this allows for heterogeneous networks in which some devices receive continuously, while others only transmit when an external stimulus is detected.

In beacon-enabled networks, the special network nodes called ZigBee Routers transmit periodic beacons to confirm their presence to other network nodes. Nodes may sleep between the beacons, thus lowering their duty cycle and extending their battery life. Beacon intervals depend on the data rate; they may range from 15.36 milliseconds to 251.65824 seconds at 250 Kbit/s, from 24 milliseconds to 393.216 seconds at 40 Kbit/s, and from 48 milliseconds to 786.432 seconds at 20 Kbit/s. In general, the ZigBee protocols minimize the time the radio is on to reduce power consumption. In beaconing networks, nodes only need to be active while a beacon is being transmitted. In non-beacon-enabled networks, power consumption is decidedly asymmetrical: some devices are always active while others spend most of their time sleeping.

Except for the Smart Energy Profile 2.0, current ZigBee devices conform to the IEEE 802.15.4-2003 Low-Rate Wireless Personal Area Network (LR-WPAN) standard. The standard specifies the lower protocol layers—the PHYsical layer (PHY), and the Media Access Control (MAC) portion of the Data Link Layer (DLL). The basic channel access mode is “Carrier Sense, Multiple Access/Collision Avoidance” (CSMA/CA), that is, the nodes talk in the same way that people converse; they briefly check to see that no one is talking before they start. There are three notable exceptions to the use of CSMA. Beacons are sent on a fixed time schedule, and do not use CSMA. Message acknowledgments also do not use CSMA. Finally, devices in Beacon Oriented networks that have low latency real-time requirement, may also use Guaranteed Time Slots (GTS), which by definition do not use CSMA.

Z-Wave. Z-Wave is a wireless communications protocol by the Z-Wave Alliance (http://www.z-wave.com) designed for home automation, specifically for remote control applications in residential and light commercial environments. The technology uses a low-power RF radio embedded or retrofitted into home electronics devices and systems, such as lighting, home access control, entertainment systems and household appliances. Z-Wave communicates using a low-power wireless technology designed specifically for remote control applications. Z-Wave operates in the sub-gigahertz frequency range, around 900 MHz. This band competes with some cordless telephones and other consumer electronics devices, but avoids interference with WiFi and other systems that operate on the crowded 2.4 GHz band. Z-Wave is designed to be easily embedded in consumer electronics products, including battery-operated devices such as remote controls, smoke alarms, and security sensors.

Z-Wave is a mesh networking technology where each node or device on the network is capable of sending and receiving control commands through walls or floors, and use intermediate nodes to route around household obstacles or radio dead spots that might occur in the home. Z-Wave devices can work individually or in groups, and can be programmed into scenes or events that trigger multiple devices, either automatically or via remote control. The Z-wave radio specifications include bandwidth of 9,600 bits or 40 Kbit/s, fully interoperable, GFSK modulation, and a range of approximately 100 feet (or 30 meters) assuming “open air” conditions, with reduced range indoors depending on building materials, etc. The Z-Wave radio uses the 900 MHz ISM band: 908.42 MHz (United States); 868.42 MHz (Europe); 919.82 MHz (Hong Kong); and 921.42 MHz (Australia/New Zealand).

Z-Wave uses a source-routed mesh network topology and has one or more master controllers that control routing and security. The devices can communicate to another by using intermediate nodes to actively route around, and circumvent household obstacles or radio dead spots that might occur. A message from node A to node C can be successfully delivered even if the two nodes are not within range, providing that a third node B can communicate with nodes A and C. If the preferred route is unavailable, the message originator will attempt other routes until a path is found to the “C” node. Therefore, a Z-Wave network can span much farther than the radio range of a single unit; however, with several of these hops, a delay may be introduced between the control command and the desired result. In order for Z-Wave units to be able to route unsolicited messages, they cannot be in sleep mode. Therefore, most battery-operated devices are not designed as repeater units. A Z-Wave network can consist of up to 232 devices with the option of bridging networks if more devices are required.

WWAN. Any wireless network herein may be a Wireless Wide Area Network (WWAN) such as a wireless broadband network, and the WWAN port may be an antenna and the WWAN transceiver may be a wireless modem. The wireless network may be a satellite network, the antenna may be a satellite antenna, and the wireless modem may be a satellite modem. The wireless network may be a WiMAX network such as according to, compatible with, or based on, IEEE 802.16-2009, the antenna may be a WiMAX antenna, and the wireless modem may be a WiMAX modem. The wireless network may be a cellular telephone network, the antenna may be a cellular antenna, and the wireless modem may be a cellular modem. The cellular telephone network may be a Third Generation (3G) network, and may use UMTS W-CDMA, UMTS HSPA, UMTS TDD, CDMA2000 1×RTT, CDMA2000 EV-DO, or GSM EDGE-Evolution. The cellular telephone network may be a Fourth Generation (4G) network and may use or be compatible with HSPA+, Mobile WiMAX, LTE, LTE-Advanced, MBWA, or may be compatible with, or based on, IEEE 802.20-2008.

WLAN. Wireless Local Area Network (WLAN), is a popular wireless technology that makes use of the Industrial, Scientific and Medical (ISM) frequency spectrum. In the US, three of the bands within the ISM spectrum are the A band, 902-928 MHz; the B band, 2.4-2.484 GHz (a.k.a. 2.4 GHz); and the C band, 5.725-5.875 GHz (a.k.a. 5 GHz). Overlapping and/or similar bands are used in different regions such as Europe and Japan. In order to allow interoperability between equipment manufactured by different vendors, few WLAN standards have evolved, as part of the IEEE 802.11 standard group, branded as WiFi (www.wi-fi.org). IEEE 802.11b describes a communication using the 2.4 GHz frequency band and supporting communication rate of 11 Mb/s, IEEE 802.11a uses the 5 GHz frequency band to carry 54 MB/s and IEEE 802.11g uses the 2.4 GHz band to support 54 Mb/s. The WiFi technology is further described in a publication entitled: “WiFi Technology” by Telecom Regulatory Authority, published on July 2003, which is incorporated in its entirety for all purposes as if fully set forth herein. The IEEE 802 defines an ad-hoc connection between two or more devices without using a wireless access point: the devices communicate directly when in range. An ad hoc network offers peer-to-peer layout and is commonly used in situations such as a quick data exchange or a multiplayer LAN game, because the setup is easy and an access point is not required.

A node/client with a WLAN interface is commonly referred to as STA (Wireless Station/Wireless client). The STA functionality may be embedded as part of the data unit, or alternatively be a dedicated unit, referred to as bridge, coupled to the data unit. While STAs may communicate without any additional hardware (ad-hoc mode), such network usually involves Wireless Access Point (a.k.a. WAP or AP) as a mediation device. The WAP implements the Basic Stations Set (BSS) and/or ad-hoc mode based on Independent BSS (IBSS). STA, client, bridge and WAP will be collectively referred to hereon as WLAN unit. Bandwidth allocation for IEEE 802.11g wireless in the U.S. allows multiple communication sessions to take place simultaneously, where eleven overlapping channels are defined spaced 5 MHz apart, spanning from 2412 MHz as the center frequency for channel number 1, via channel 2 centered at 2417 MHz and 2457 MHz as the center frequency for channel number 10, up to channel 11 centered at 2462 MHz. Each channel bandwidth is 22 MHz, symmetrically (+/−11 MHz) located around the center frequency. In the transmission path, first the baseband signal (IF) is generated based on the data to be transmitted, using 256 QAM (Quadrature Amplitude Modulation) based OFDM (Orthogonal Frequency Division Multiplexing) modulation technique, resulting a 22 MHz (single channel wide) frequency band signal. The signal is then up converted to the 2.4 GHz (RF) and placed in the center frequency of required channel, and transmitted to the air via the antenna. Similarly, the receiving path comprises a received channel in the RF spectrum, down converted to the baseband (IF) wherein the data is then extracted.

In order to support multiple devices and using a permanent solution, a Wireless Access Point (WAP) is typically used. A Wireless Access Point (WAP, or Access Point—AP) is a device that allows wireless devices to connect to a wired network using Wi-Fi, or related standards. The WAP usually connects to a router (via a wired network) as a standalone device, but can also be an integral component of the router itself. Using Wireless Access Point (AP) allows users to add devices that access the network with little or no cables. A WAP normally connects directly to a wired Ethernet connection, and the AP then provides wireless connections using radio frequency links for other devices to utilize that wired connection. Most APs support the connection of multiple wireless devices to one wired connection. Wireless access typically involves special security considerations, since any device within a range of the WAP can attach to the network. The most common solution is wireless traffic encryption. Modern access points come with built-in encryption such as Wired Equivalent Privacy (WEP) and Wi-Fi Protected Access (WPA), typically used with a password or a passphrase. Authentication in general, and a WAP authentication in particular, is used as the basis for authorization, which determines whether a privilege may be granted to a particular user or process, privacy, which keeps information from becoming known to non-participants, and non-repudiation, which is the inability to deny having done something that was authorized to be done based on the authentication. An authentication in general, and a WAP authentication in particular, may use an authentication server that provides a network service that applications may use to authenticate the credentials, usually account names and passwords of their users. When a client submits a valid set of credentials, it receives a cryptographic ticket that it can subsequently be used to access various services. Authentication algorithms include passwords, Kerberos, and public key encryption.

Prior art technologies for data networking may be based on single carrier modulation techniques, such as AM (Amplitude Modulation), FM (Frequency Modulation), and PM (Phase Modulation), as well as bit encoding techniques such as QAM (Quadrature Amplitude Modulation) and QPSK (Quadrature Phase Shift Keying). Spread spectrum technologies, to include both DSSS (Direct Sequence Spread Spectrum) and FHSS (Frequency Hopping Spread Spectrum) are known in the art. Spread spectrum commonly employs Multi-Carrier Modulation (MCM) such as OFDM (Orthogonal Frequency Division Multiplexing). OFDM and other spread spectrum are commonly used in wireless communication systems, particularly in WLAN networks.

Bluetooth. Bluetooth is a wireless technology standard for exchanging data over short distances (using short-wavelength UHF radio waves in the ISM band from 2.4 to 2.485 GHz) from fixed and mobile devices, and building personal area networks (PANs). It can connect several devices, overcoming problems of synchronization. A Personal Area Network (PAN) may be according to, compatible with, or based on, Bluetooth™ or IEEE 802.15.1-2005 standard. A Bluetooth controlled electrical appliance is described in U.S. Patent Application No. 2014/0159877 to Huang entitled: “Bluetooth Controllable Electrical Appliance”, and an electric power supply is described in U.S. Patent Application No. 2014/0070613 to Garb et al. entitled: “Electric Power Supply and Related Methods”, which are both incorporated in their entirety for all purposes as if fully set forth herein. Any Personal Area Network (PAN) may be according to, compatible with, or based on, Bluetooth™ or IEEE 802.15.1-2005 standard. A Bluetooth controlled electrical appliance is described in U.S. Patent Application No. 2014/0159877 to Huang entitled: “Bluetooth Controllable Electrical Appliance”, and an electric power supply is described in U.S. Patent Application No. 2014/0070613 to Garb et al. entitled: “Electric Power Supply and Related Methods”, which are both incorporated in their entirety for all purposes as if fully set forth herein.

Bluetooth operates at frequencies between 2402 and 2480 MHz, or 2400 and 2483.5 MHz including guard bands 2 MHz wide at the bottom end and 3.5 MHz wide at the top. This is in the globally unlicensed (but not unregulated) Industrial, Scientific and Medical (ISM) 2.4 GHz short-range radio frequency band. Bluetooth uses a radio technology called frequency-hopping spread spectrum. Bluetooth divides transmitted data into packets, and transmits each packet on one of 79 designated Bluetooth channels. Each channel has a bandwidth of 1 MHz. It usually performs 800 hops per second, with Adaptive Frequency-Hopping (AFH) enabled. Bluetooth low energy uses 2 MHz spacing, which accommodates 40 channels. Bluetooth is a packet-based protocol with a master-slave structure. One master may communicate with up to seven slaves in a piconet. All devices share the master's clock. Packet exchange is based on the basic clock, defined by the master, which ticks at 312.5 μs intervals. Two clock ticks make up a slot, of 625 μs, and two slots make up a slot pair of 1250 μs. In the simple case of single-slot packets the master transmits in even slots and receives in odd slots. The slave, conversely, receives in even slots and transmits in odd slots. Packets may be 1, 3 or 5 slots long, but in all cases the master's transmission begins in even slots and the slave's in odd slots.

A master Bluetooth device can communicate with a maximum of seven devices in a piconet (an ad-hoc computer network using Bluetooth technology), though not all devices reach this maximum. The devices can switch roles, by agreement, and the slave can become the master (for example, a headset initiating a connection to a phone necessarily begins as master—as initiator of the connection—but may subsequently operate as slave). The Bluetooth Core Specification provides for the connection of two or more piconets to form a scatternet, in which certain devices simultaneously play the master role in one piconet and the slave role in another. At any given time, data can be transferred between the master and one other device (except for the little-used broadcast mode). The master chooses which slave device to address; typically, it switches rapidly from one device to another in a round-robin fashion. Since it is the master that chooses which slave to address, whereas a slave is supposed to listen in each receive slot, being a master is a lighter burden than being a slave. Being a master of seven slaves is possible; being a slave of more than one master is difficult.

Bluetooth Low Energy. Bluetooth low energy (Bluetooth LE, BLE, marketed as Bluetooth Smart) is a wireless personal area network technology designed and marketed by the Bluetooth Special Interest Group (SIG) aimed at novel applications in the healthcare, fitness, beacons, security, and home entertainment industries. Compared to Classic Bluetooth, Bluetooth Smart is intended to provide considerably reduced power consumption and cost while maintaining a similar communication range. Bluetooth low energy is described in a Bluetooth SIG published Dec. 2, 2014 standard Covered Core Package version: 4.2, entitled: “Master Table of Contents & Compliance Requirements—Specification Volume 0”, and in an article published 2012 in Sensors [ISSN 1424-8220] by Carles Gomez et al. [Sensors 2012, 12, 11734-11753; doi:10.3390/s120211734] entitled: “Overview and Evaluation of Bluetooth Low Energy: An Emerging Low-Power Wireless Technology”, which are both incorporated in their entirety for all purposes as if fully set forth herein.

Bluetooth Smart technology operates in the same spectrum range (the 2.400 GHz-2.4835 GHz ISM band) as Classic Bluetooth technology, but uses a different set of channels. Instead of the Classic Bluetooth 79 1-MHz channels, Bluetooth Smart has 40 2-MHz channels. Within a channel, data is transmitted using Gaussian frequency shift modulation, similar to Classic Bluetooth's Basic Rate scheme. The bit rate is 1 Mbit/s, and the maximum transmit power is 10 mW. Bluetooth Smart uses frequency hopping to counteract narrowband interference problems. Classic Bluetooth also uses frequency hopping but the details are different; as a result, while both FCC and ETSI classify Bluetooth technology as an FHSS scheme, Bluetooth Smart is classified as a system using digital modulation techniques or a direct-sequence spread spectrum. All Bluetooth Smart devices use the Generic Attribute Profile (GATT). The application programming interface offered by a Bluetooth Smart aware operating system will typically be based around GATT concepts.

Cellular. Cellular telephone network may be according to, compatible with, or may be based on, a Third Generation (3G) network that uses UMTS W-CDMA, UMTS HSPA, UMTS TDD, CDMA2000 1×RTT, CDMA2000 EV-DO, or GSM EDGE-Evolution. The cellular telephone network may be a Fourth Generation (4G) network that uses HSPA+, Mobile WiMAX, LTE, LTE-Advanced, MBWA, or may be based on or compatible with IEEE 802.20-2008.

DSRC. Dedicated Short-Range Communication (DSRC) is a one-way or two-way short-range to medium-range wireless communication channels specifically designed for automotive use and a corresponding set of protocols and standards. DSRC is a two-way short-to-medium range wireless communications capability that permits very high data transmission critical in communications-based active safety applications. In Report and Order FCC-03-324, the Federal Communications Commission (FCC) allocated 75 MHz of spectrum in the 5.9 GHz band for use by intelligent transportations systems (ITS) vehicle safety and mobility applications. DSRC serves a short to medium range (1000 meters) communications service and supports both public safety and private operations in roadside-to-vehicle and vehicle-to-vehicle communication environments by providing very high data transfer rates where minimizing latency in the communication link and isolating relatively small communication zones is important. DSRC transportation applications for Public Safety and Traffic Management include Blind spot warnings, Forward collision warnings, Sudden braking ahead warnings, Do not pass warnings, Intersection collision avoidance and movement assistance, Approaching emergency vehicle warning, Vehicle safety inspection, Transit or emergency vehicle signal priority, Electronic parking and toll payments, Commercial vehicle clearance and safety inspections, In-vehicle signing, Rollover warning, and Traffic and travel condition data to improve traveler information and maintenance services.

The European standardization organization European Committee for Standardization (CEN), sometimes in co-operation with the International Organization for Standardization (ISO) developed some DSRC standards: EN 12253:2004 Dedicated Short-Range Communication—Physical layer using microwave at 5.8 GHz (review), EN 12795:2002 Dedicated Short-Range Communication (DSRC)—DSRC Data link layer: Medium Access and Logical Link Control (review), EN 12834:2002 Dedicated Short-Range Communication—Application layer (review), EN 13372:2004 Dedicated Short-Range Communication (DSRC)—DSRC profiles for RTTT applications (review), and EN ISO 14906:2004 Electronic Fee Collection—Application interface. An overview of the DSRC/WAVE technologies is described in a paper by Yunxin (Jeff) Li (Eveleigh, NSW 2015, Australia) downloaded from the Internet on July 2017, entitled: “An Overview of the DSRC/WAVE Technology”, and the DSRC is further standardized as ARIB STD—T75 VERSION 1.0, published September 2001 by Association of Radio Industries and Businesses Kasumigaseki, Chiyoda-ku, Tokyo 100-0013, Japan, entitled: “DEDICATED SHORT-RANGE COMMUNICATION SYSTEM—ARIB STANDARD Version 1.0”, which are both incorporated in their entirety for all purposes as if fully set forth herein.

IEEE 802.11p. The IEEE 802.11p standard is an example of DSRC and is a published standard entitled: “Part 11: Wireless LAN Medium Access Control (MAC) and Physical Layer (PHY) Specifications Amendment 6: Wireless Access in Vehicular Environments”, that adds wireless access in vehicular environments (WAVE), a vehicular communication system, for supporting Intelligent Transportation Systems (ITS) applications. It includes data exchange between high-speed vehicles and between the vehicles and the roadside infrastructure, so called V2X communication, in the licensed ITS band of 5.9 GHz (5.85-5.925 GHz). IEEE 1609 is a higher layer standard based on the IEEE 802.11p, and is also the base of a European standard for vehicular communication known as ETSI ITS-G5.2. The Wireless Access in Vehicular Environments (WAVE/DSRC) architecture and services necessary for multi-channel DSRC/WAVE devices to communicate in a mobile vehicular environment is described in the family of IEEE 1609 standards, such as IEEE 1609.1-2006 Resource Manager, IEEE Std 1609.2 Security Services for Applications and Management Messages, IEEE Std 1609.3 Networking Services, IEEE Std 1609.4 Multi-Channel Operation IEEE Std 1609.5 Communications Manager, as well as IEEE P802.11p Amendment: “Wireless Access in Vehicular Environments”.

As the communication link between the vehicles and the roadside infrastructure might exist for only a short amount of time, the IEEE 802.11p amendment defines a way to exchange data through that link without the need to establish a Basic Service Set (BSS), and thus, without the need to wait for the association and authentication procedures to complete before exchanging data. For that purpose, IEEE 802.11p enabled stations use the wildcard BSSID (a value of all 1s) in the header of the frames they exchange, and may start sending and receiving data frames as soon as they arrive on the communication channel. Because such stations are neither associated nor authenticated, the authentication and data confidentiality mechanisms provided by the IEEE 802.11 standard (and its amendments) cannot be used. These kinds of functionality must then be provided by higher network layers. IEEE 802.11p standard uses channels within the 75 MHz bandwidth in the 5.9 GHz band (5.850-5.925 GHz). This is half the bandwidth, or double the transmission time for a specific data symbol, as used in 802.11a. This allows the receiver to better cope with the characteristics of the radio channel in vehicular communications environments, e.g., the signal echoes reflected from other cars or houses.

Smartphone. A mobile phone (also known as a cellular phone, cell phone, smartphone, or hand phone) is a device which can make and receive telephone calls over a radio link whilst moving around a wide geographic area, by connecting to a cellular network provided by a mobile network operator. The calls are to and from the public telephone network, which includes other mobiles and fixed-line phones across the world. The Smartphones are typically hand-held and may combine the functions of a personal digital assistant (PDA), and may serve as portable media players and camera phones with high-resolution touch-screens, web browsers that can access, and properly display, standard web pages rather than just mobile-optimized sites, GPS navigation, Wi-Fi, and mobile broadband access. In addition to telephony, the Smartphones may support a wide variety of other services such as text messaging, MMS, email, Internet access, short-range wireless communications (infrared, Bluetooth), business applications, gaming and photography.

An example of a contemporary smartphone is model iPhone 6 available from Apple Inc., headquartered in Cupertino, Calif., U.S.A. and described in iPhone 6 technical specification (retrieved 10/2015 from www.apple.com/iphone-6/specs/), and in a User Guide dated 2015 (019-00155/2015-06) by Apple Inc. entitled: “iPhone User Guide For iOS 8.4 Software”, which are both incorporated in their entirety for all purposes as if fully set forth herein. Another example of a smartphone is Samsung Galaxy S6 available from Samsung Electronics headquartered in Suwon, South-Korea, described in the user manual numbered English (EU), 03/2015 (Rev. 1.0) entitled: “SM-G925F SM-G925FQ SM-G9251 User Manual” and having features and specification described in “Galaxy S6 Edge—Technical Specification” (retrieved 10/2015 from www.samsung.com/us/explore/galaxy-s-6-features-and-specs), which are both incorporated in their entirety for all purposes as if fully set forth herein.

Android is an open source and Linux-based mobile operating system (OS) based on the Linux kernel that is currently offered by Google. With a user interface based on direct manipulation, Android is designed primarily for touchscreen mobile devices such as smartphones and tablet computers, with specialized user interfaces for televisions (Android TV), cars (Android Auto), and wrist watches (Android Wear). The OS uses touch inputs that loosely correspond to real-world actions, such as swiping, tapping, pinching, and reverse pinching to manipulate on-screen objects, and a virtual keyboard. Despite being primarily designed for touchscreen input, it also has been used in game consoles, digital cameras, and other electronics. The response to user input is designed to be immediate and provides a fluid touch interface, often using the vibration capabilities of the device to provide haptic feedback to the user. Internal hardware such as accelerometers, gyroscopes and proximity sensors are used by some applications to respond to additional user actions, for example, adjusting the screen from portrait to landscape depending on how the device is oriented, or allowing the user to steer a vehicle in a racing game by rotating the device by simulating control of a steering wheel.

Android devices boot to the homescreen, the primary navigation and information point on the device, which is similar to the desktop found on PCs. Android homescreens are typically made up of app icons and widgets; app icons launch the associated app, whereas widgets display live, auto-updating content such as the weather forecast, the user's email inbox, or a news ticker directly on the homescreen. A homescreen may be made up of several pages that the user can swipe back and forth between, though Android's homescreen interface is heavily customizable, allowing the user to adjust the look and feel of the device to their tastes. Third-party apps available on Google Play and other app stores can extensively re-theme the homescreen, and even mimic the look of other operating systems, such as Windows Phone. The Android OS is described in a publication entitled: “Android Tutorial”, downloaded from tutorialspoint.com on July 2014, which is incorporated in its entirety for all purposes as if fully set forth herein.

iOS (previously iPhone OS) from Apple Inc. (headquartered in Cupertino, Calif., U.S.A.) is a mobile operating system distributed exclusively for Apple hardware. The user interface of the iOS is based on the concept of direct manipulation, using multi-touch gestures. Interface control elements consist of sliders, switches, and buttons. Interaction with the OS includes gestures such as swipe, tap, pinch, and reverse pinch, all of which have specific definitions within the context of the iOS operating system and its multi-touch interface. Internal accelerometers are used by some applications to respond to shaking the device (one common result is the undo command) or rotating it in three dimensions (one common result is switching from portrait to landscape mode). The iOS OS is described in a publication entitled: “105 Tutorial”, downloaded from tutorialspoint.com on July 2014, which is incorporated in its entirety for all purposes as if fully set forth herein.

An apparatus for protecting a vehicle electronic system is disclosed in U.S. Patent Application Publication No. 2015/0020152 to Litichever et al. entitled: “Security system and method for protecting a vehicle electronic system”, which is incorporated in its entirety for all purposes as if fully set forth herein. The protecting is by selectively intervening in the communications path in order to prevent the arrival of malicious messages at ECUs, in particular at the safety critical ECUs. The security system includes a filter, which prevents illegal messages sent by any system or device communicating over a vehicle communications bus from reaching their destination. The filter may, at its discretion according to preconfigured rules, send messages as is, block messages, change the content of the messages, request authentication or limit the rate such messages can be delivered, by buffering the messages and sending them only in preconfigured intervals.

A mobile application on a mobile device communicates with a head-unit of a navigation system is disclosed in U.S. Pat. No. 8,762,059 to Balogh entitled: “Navigation system application for mobile device”, which is incorporated in its entirety for all purposes as if fully set forth herein. The mobile application may retrieve data such as map data, user input data, and other data and communicate the updates to the head unit. By retrieving map data through the mobile application, the head unit may be updated much easier than systems of the prior art. The data may be retrieved through cellular networks, Wi-Fi networks, or other networks which accessible to a user and compatible with the mobile device. Updates may be stored in the mobile device and automatically uploaded to the navigation system head unit when the user is in the vicinity of the head unit. The mobile application may establish a logical connection with one or more head units. The logical connection bounds the mobile application to the head unit and allows for data sharing and synchronization.

Systems and methods for promoting connectivity between a mobile communication device having a touch screen and a vehicle touch screen installed in a vehicle are disclosed in U.S. Pat. No. 9,535,602 to Gutentag et al. entitled: “System and method for promoting connectivity between a mobile communication device and a vehicle touch screen”, which is incorporated in its entirety for all purposes as if fully set forth herein. According to an embodiment, a system may include a controller configured to: connect to the mobile communication device and to the vehicle touch screen. The controller may also be configured to receive video signal of a current screen video image shown on the touch screen of the mobile communication device and transmit the current video image to the vehicle touch screen, causing a corresponding video image of the current screen video image to be displayed on the vehicle touch screen. The controller may further be configured to receive a signal indicative of a touch action that was performed on the vehicle touch screen, and cause the mobile communication device to respond as if a touch action corresponding to the touch action that was performed on the vehicle touch screen was performed on the touch screen of the mobile communication device.

A system and method for connection management between a consumer device and a vehicle is disclosed in U.S. Patent Application Publication No. 2013/0106750 to Kurosawa entitled: “Connecting Touch Screen Phones in a Vehicle”, which is incorporated in its entirety for all purposes as if fully set forth herein. The connection management is performed automatically using a computing device, e.g., an application executing on a smartphone. The system and method configure the vehicle and consumer device in a manner that the screen display of the consumer device is mirrored on a touch panel of the in-vehicle computer system and the consumer device is controlled remotely by the user using the touch panel of the in-vehicle computer system.

A multi-screen display device and program of the same is disclosed in U.S. Patent Application Publication No. 2009/0171529 to Hayatoma entitled: “Multi-screen display device and program of the same”, which is incorporated in its entirety for all purposes as if fully set forth herein. Any navigation device herein may be based on, or may comprise, the navigation system described therein. The multi display screen is constituted of a wide-screen displaying simultaneously two or more of a navigation search control screen setting necessary requirements to search for a route from a place of departure to a destination of a vehicle, a navigation map screen displaying the position of the vehicle on a map, a night vision screen recognizing an object on a road at night by infrared, a back guide monitor screen for recognizing a rear side of the vehicle, a blind corner monitor screen for recognizing an orthogonal direction of the vehicle, and a hands-free transmission/reception screen of a car phone. Screens to be displayed on the multi-display screen constituted of the wide screen is selected according to a vehicle driving state detected in a vehicle driving state detecting unit, and a display on the multi-display screen of a “screen 1”, a “screen 2”, and a “screen 3” constituted of the wide screen is determined according to the vehicle driving state detected in the vehicle driving state detecting unit.

An engine control device and method for use in a vehicle incorporating an internal combustion engine and a motor that are capable of transmitting motive power to an axle is disclosed in U.S. Patent Application Publication No. 2010/0280737 to Ewert et al. entitled: “Engine Control Device and Method for a Hybrid Vehicle”, which is incorporated in its entirety for all purposes as if fully set forth herein. The device has an engine utilization reduction portion configured to reduce the power supplied by the engine when a requested engine power is above a predefined engine power minimum value when the device is in a hybrid mode thereby increasing power provided by the electric motor. The device also may have a computer readable engine off portion configured to prevent the engine from starting or consuming fuel thereby causing the vehicle to be directionally powered by the electric motor only. The device may also have a warm up portion configured to operate the engine in warmup mode and limit the power supplied by the engine when the engine temperature is below a predefined engine operating temperature thereby reducing emissions during engine warmup.

A handsfree apparatus is disclosed in U.S. Patent Application Publication No. 2010/0210315 to Miyake entitled: “Handsfree Apparatus”, which is incorporated in its entirety for all purposes as if fully set forth herein. The apparatus notifies a user of the reception of a mail if the reception of the mail by a cellular phone happens during a call, and stores an unread history of the received mail in a memory unit if a mail content display operation is not performed. Further, the handsfree apparatus notifies the user of the unread history of the received mail when Bluetooth connection link to the cellular phone having received the mail is disconnected, thereby enabling the received mail to be recognized by the user.

A system and method for implementing cross-network synchronization of nodes on a vehicle bus is disclosed in U.S. Patent Application Publication No. 2012/0278507 to Menon et al. entitled: “Cross-network synchronization of application s/w execution using flexray global time”, which is incorporated in its entirety for all purposes as if fully set forth herein. The system and method include periodically sampling a notion of time from a first network, transmitting a message from the first network to a node on a second network, wherein the message includes the notion of time, and updating a local clock on the second network node based on the notion of time in the message.

Methods and devices supporting the management of a plurality of electronic devices and processing of update information for updating software and/or firmware in the electronic devices are disclosed in U.S. Patent Application Publication No. 2012/0210315 to Kapadekar et al. entitled: “Device management in a network”, which is incorporated in its entirety for all purposes as if fully set forth herein. Prompting of users may be made using a language associated with the electronic device, and authorization to update an electronic device may be secured using a subscriber identity module.

An in-car information system that includes a portable information terminal and an in-car device is disclosed in U.S. Patent Application Publication No. 2013/0298052 to NARA et al. entitled: “In-Car Information System, Information Terminal, And Application Execution Method”, which is incorporated in its entirety for all purposes as if fully set forth herein. The information terminal identifies a specific application being executed in the foreground and transmits restriction information pertaining to the particular application to the in-car device. The in-car device either allows or disallows, based upon the restriction information transmitted from the information terminal, image display corresponding to the application being executed in the foreground and transmission of operation information corresponding to an input operation.

A vehicle control system that includes a display device located in a vehicle. The display device displays a plurality of display icons with one of the display icons representing an active display icon is disclosed in U.S. Patent Application Publication No. 2015/0378598 to Takeshi entitled: “Touch control panel for vehicle control system”, which is incorporated in its entirety for all purposes as if fully set forth herein. A touchpad is located in the vehicle remote from the display device. The touchpad provides virtual buttons corresponding to the display icons that have relative orientations corresponding to the display icons. The touchpad establishes a home location on the touchpad based on a location where a user of the vehicle touches the touchpad. The home location corresponds to the active display icon such that the virtual button representing the active display icon is located at the home location and the other virtual buttons are oriented about the home location.

A WiFi wireless rear view parking system comprises a main body, a camera sensor, a Wifi transmission module, a mobile personal electronics device, is disclosed in U.S. Patent Application Publication No. 2016/0127693 to Chung entitled: “WiFi Wireless Rear View Parking System”, which is incorporated in its entirety for all purposes as if fully set forth herein. The main body is installed at a license plate of an automobile. The camera sensor is provided in the main body for sensing images and video of rear regions of the automobile and generating images and video data. The Wifi transmission module transmits the image and video data from the camera. The mobile personal electronic device is for receiving image and video data transmitted by the Wifi transmission module and displaying them. The WiFi wireless rear view parking system provides rear view of the automobile to a driver. The mobile personal electronic device includes a smartphone.

An image display device, which detects image characteristic information from an image of a screen provided by a mobile terminal, is disclosed in U.S. Patent Application Publication No. 2012/0242687 to CHOI entitled: “Image processing apparatus and image processing method”, which is incorporated in its entirety for all purposes as if fully set forth herein. The device extracts a characteristic area based on the image characteristic information, and automatically magnifies or reduces the extracted characteristic area and displays the same, to thereby allow a user to conveniently and effectively view the image provided from the mobile terminal in a vehicle. The image display device includes: a communication unit configured to receive an image from a mobile terminal; a controller configured to detect image characteristic information of the received image, extract a first area on the basis of the detected image characteristic information, determine an image processing scheme with respect to the extracted first area, and process an image corresponding to the extracted first area according to the determined image processing scheme; and a display unit configured to display the processed image.

A system and method in a building or vehicle for an actuator operation in response to a sensor according to a control logic are disclosed in U.S. Patent Application Publication No. 2013/0201316 to Binder et al. entitled: “System and method for server based control”, which is incorporated in its entirety for all purposes as if fully set forth herein. The system comprising a router or a gateway communicating with a device associated with the sensor and a device associated with the actuator over in-building or in-vehicle networks, and an external Internet-connected control server associated with the control logic implementing a PID closed linear control loop and communicating with the router over external network for controlling the in-building or in-vehicle phenomenon. The sensor may be a microphone or a camera, and the system may include voice or image processing as part of the control logic. A redundancy is used by using multiple sensors or actuators, or by using multiple data paths over the building or vehicle internal or external communication. The networks may be wired or wireless, and may be BAN, PAN, LAN, WAN, or home networks.

A system that includes a database that stores an expert knowledgebase, and one or more servers configured to implement an expert system, is disclosed in U.S. Pat. No. 8,600,831 to Xiao et al. entitled: “Automated automobile maintenance using a centralized expert system”, which is incorporated in its entirety for all purposes as if fully set forth herein. The one or more servers receive sensor data associated with sensors from automobile maintenance systems associated with respective ones of multiple automobiles, and analyze the sensor data, using the expert system and the expert knowledgebase, to diagnose whether the multiple automobiles require maintenance and/or repair. The one or more servers send, via a network, results of the analysis of the sensor data to service stations for scheduling maintenance and/or repair of the multiple automobiles.

The Wireless Integrated Network Sensor Next Generation (WINS NG) nodes provide distributed network and Internet access to sensors, controls, and processors that are deeply embedded in equipment, facilities, and the environment, and are disclosed in U.S. Patent Application Publication No. 2015/0046582 to Gelvin et al. entitled: “Apparatus for internetworked wireless integrated network sensors (wins)”, which is incorporated in its entirety for all purposes as if fully set forth herein. The WINS NG network is a new monitoring and control capability for applications in transportation, manufacturing, health care, environmental monitoring, and safety and security. The WINS NG nodes combine microsensor technology, low power distributed signal processing, low power computation, and low power, low cost wireless and/or wired networking capability in a compact system. The WINS NG networks provide sensing, local control, remote reconfigurability, and embedded intelligent systems in structures, materials, and environments.

Geolocation. Geolocation is the identification or estimation of the real-world geographic location of an object, such as a mobile phone or an Internet-connected computer terminal. Typically, geolocation involves the generation of a set of geographic coordinates that may be used to determine a meaningful location, such as a street address. For either geolocating or positioning, the locating engine often uses Radio-Frequency (RF) location methods, for example Time-Difference-Of-Arrival (TDOA) for precision, where the TDOA often utilizes mapping displays or other geographic information system. When a GPS signal is unavailable, geolocation applications can use information from cell towers to triangulate the approximate position.

Internet and computer geolocation can be performed by associating a geographic location with the Internet Protocol (IP) address, MAC address, RFID, hardware embedded article/production number, embedded software number (such as UUID, Exif/IPTC/XMP or modern steganography), invoice, Wi-Fi positioning system, device fingerprint, canvas fingerprinting, or device GPS coordinates. Geolocation may work by automatically looking up an IP address on a WHOIS service and retrieving the registrant's physical address. IP address location data can include information such as country, region, city, postal/zip code, latitude, longitude, and timezone.

Location may further be determined by one or more ranging or angulating methods, such as Angle of arrival (AoA), Line-of-Sight (LoS), Time of arrival (ToA), Multilateration (Time difference of arrival) (TDoA), Time-of-flight (ToF), Two-way ranging (TWR), Symmetrical Double Sided—Two Way Ranging (SDS-TWR), or Near-field electromagnetic ranging (NFER).

An Angle-of-Arrival (AoA) method may be used for determining the direction of propagation of a Radio-Frequency (RF) wave incident on an antenna array. AoA determines the direction by measuring the Time-Difference-of-Arrival (TDOA) at individual elements of the array, and the AoA is calculated based on these delays. Line-of-Sight (LoS) propagation is a characteristic of electromagnetic radiation or acoustic wave propagation, which means waves that travel in a direct path from the source to the receiver. Electromagnetic transmission includes light emissions traveling in a straight line. The rays or waves may be diffracted, refracted, reflected, or absorbed by atmosphere and obstructions with material and generally cannot travel over the horizon or behind obstacles. Time-of-Arrival (TOA or ToA) (also referred to as Time-of-Flight (ToF), is the travel time of a radio signal from a single transmitter to a remote single receiver. Compared to the TDOA technique, time-of-arrival uses the absolute time of arrival at a certain base station rather than the measured time difference between departing from one and arriving at the other station. The distance can be directly calculated from the time of arrival as signals travel with a known velocity. Time of arrival data from two base stations will narrow a position to a position circle; data from a third base station is required to resolve the precise position to a single point.

Time-of-Flight (TOF) describes a variety of methods that measure the time that it takes for an object, particle or acoustic, electromagnetic or other wave to travel a distance through a medium. This measurement can be used for a time standard (such as an atomic fountain), as a way to measure velocity or path length through a given medium, or as a way to learn about the particle or medium (such as composition or flow rate). The traveling object may be detected directly (e.g., ion detector in mass spectrometry) or indirectly (e.g., light scattered from an object in laser Doppler velocimetry). Symmetrical Double-Sided Two-Way Ranging (SDS-TWR) is a ranging method that uses two delays that naturally occur in signal transmission to determine the range between two stations, using a signal propagation delay between two wireless devices and processing delay of acknowledgements within a wireless device. Near-Field Electromagnetic Ranging (NFER) refers to any radio technology employing the near-field properties of radio waves as a Real Time Location System (RTLS). Near-field Electromagnetic Ranging employs transmitter tags and one or more receiving units. Operating within a half-wavelength of a receiver, transmitter tags must use relatively low frequencies (less than 30 MHz) to achieve significant ranging. Depending on the choice of frequency, NFER has the potential for range resolution of 30 cm (1 ft) and ranges up to 300 m (1,000 ft).

A localization in wireless environment may use triangulation, trilateration, or multilateration. Triangulation, which uses the measurement of absolute angles, is the process of determining the location of a point by forming triangles to it from known points. Specifically in surveying, triangulation per se involves only angle measurements, rather than measuring distances to the point directly as in trilateration; the use of both angles and distance measurements is referred to as triangulateration. Trilateration is the process of determining absolute or relative locations of points by measurement of distances, using the geometry of circles, spheres or triangles. Trilateration typically uses distances or absolute measurements of time-of-flight from three or more sites, and does have practical applications in surveying and navigation, including global positioning systems (GPS). In contrast to triangulation, it does not involve the measurement of angles. In two-dimensional geometry, it is known that if a point lies on two circles, then the circle centers and the two radii provide sufficient information to narrow the possible locations down to two. Additional information may narrow the possibilities down to one unique location. In three-dimensional geometry, when it is known that a point lies on the surfaces of three spheres, then the centers of the three spheres along with their radii provide sufficient information to narrow the possible locations down to no more than two (unless the centers lie on a straight line).

Multilateration (MLAT) is a surveillance technique based on the measurement of the difference in distance to two stations at known locations by broadcast signals at known times. Unlike measurements of absolute distance or angle, measuring the difference in distance between two stations results in an infinite number of locations that satisfy the measurement. When these possible locations are plotted, they form a hyperbolic curve. To locate the exact location along that curve, multilateration relies on multiple measurements: a second measurement taken to a different pair of stations will produce a second curve, which intersects with the first. When the two curves are compared, a small number of possible locations are revealed, producing a “fix”. Multilateration is a common technique in radio navigation systems, where it is known as hyperbolic navigation. These systems are relatively easy to construct as there is no need for a common clock, and the difference in the signal timing can be measured visibly using an oscilloscope.

Wireless indoor positioning systems are described in a paper by Hui Liu (Student Member, IEEE), Houshang Darabi (Member, IEEE), Pat Banerjee, and Jing Liu published in IEEE TRANSACTIONS ON SYSTEMS, MAN, AND CYBERNETICS—PART C: APPLICATIONS AND REVIEWS, VOL. 37, NO. 6, NOVEMBER 2007 [1094-6977/$25.00© 2007 IEEE] entitled: “Survey of Wireless Indoor Positioning Techniques and Systems”, which is incorporated in its entirety for all purposes as if fully set forth herein. The paper describes systems that have been successfully used in many applications such as asset tracking and inventory management, and provides an overview of the existing wireless indoor positioning solutions and attempts to classify different techniques and systems. Three typical location estimation schemes of triangulation, scene analysis, and proximity are described. The paper further discusses location fingerprinting in detail, since it is used in most current system or solutions. A set of properties is examined by which location systems are evaluated, and this evaluation method is used to survey a number of existing systems. Comprehensive performance comparisons including accuracy, precision, complexity, scalability, robustness, and cost are presented.

An overview of various algorithms for wireless position estimation is presented in a paper by Sinan Gezici Published 2 Oct. 2007 by Springer Science+Business Media, LLC [Wireless Pers Commun (2008) 44:263-282, DOI 10.1007/s11277-007-9375-z] entitled: “A Survey on Wireless Position Estimation”, which is incorporated in its entirety for all purposes as if fully set forth herein. Although the position of a node in a wireless network can be estimated directly from the signals traveling between that node and a number of reference nodes, it is more practical to estimate a set of signal parameters first, and then to obtain the final position estimation using those estimated parameters. In the first step of such a two-step positioning algorithm, various signal parameters such as time of arrival, angle of arrival or signal strength are estimated. In the second step, mapping, geometric or statistical approaches are commonly employed. In addition to various positioning algorithms, theoretical limits on their estimation accuracy are also presented in terms of Cramer-Rao lower bounds.

For outdoor positioning service the Global Positioning Systems (GPS) are the earliest widely used modern systems. In GPS technology Satellite signals cannot penetrate in indoor environment since they are blocked by building obstructions thus satellite signal cannot provide good accuracy in indoor environments due to lack of LoS (Line Of Sight). Indoor positioning techniques are described in a paper by Siddhesh Doiphode, J. W. Bakal, and Madhuri Gedam, published in International Journal of Computer Applications (0975-8887) Volume 140—No. 7, April 2016, entitled: “Survey of Indoor Positioning Measurements, Methods and Techniques”, which is incorporated in its entirety for all purposes as if fully set forth herein. The paper describes a large variety of technologies that have been designed for dealing with the problem since the indoor environments are very difficult to track. The paper also provide brief description on various indoor wireless tracking measurements, methodologies and technologies. The paper illustrates the theoretical points, the main tools, and the most promising technologies for indoor tracking infrastructure.

Various localization techniques are described in a paper by Santosh Pandey and Prathima Agrawal, and published in the Journal of the Chinese Institute of Engineers, Vol. 29, No. 7, pp. 1125-1148 (2006), entitled: “A SURVEY ON LOCALIZATION TECHNIQUES FOR WIRELESS NETWORKS”, which is incorporated in its entirety for all purposes as if fully set forth herein. Wireless networks have displaced the well-established and widely deployed wired communication networks of the past. Tetherless access and new services offered to mobile users contribute to the popularity of these networks, thus users have access from many locations and can roam ubiquitously. The knowledge of the physical location of mobile user devices, such as phones, laptops and PDAs, is important in several applications such as network planning, location based services, law enforcement and for improving network performance. A device's location is usually estimated by monitoring a distance dependent parameter such as wireless signal strength from a base station whose location is known. In practical deployments, signal strength varies with time and its relationship to distance is not well defined. This makes location estimation difficult. Many location estimation or localization schemes have been proposed for networks adopting a variety of wireless technologies. This paper reviews a broad class of localization schemes that are differentiated by the fundamental techniques adopted for distance estimation, indoor vs. outdoor environments, relative cost and accuracy of the resulting estimates and ease of deployment.

IP-Based Geolocation. IP-based geolocation (commonly known as geolocation) is a mapping of an IP address (or MAC address) to the real-world geographic location of a computing device or a mobile device connected to the Internet. The IP address based location data may include information such as country, region, city, postal/zip code, latitude, longitude, or Timezone. Deeper data sets can determine other parameters such as domain name, connection speed, ISP, Language, proxies, company name, US DMA/MSA, NAICS codes, and home/business classification. The geolocation is further described in the publication entitled: “Towards Street-Level Client-Independent IP Geolocation” by Yong Wang et al., downloaded from the Internet on July 2014, and in an Information Systems Audit and Control Association (ISACA) 2011 white paper entitled: “Geolocation: Risk, Issues and Strategies”, which are both incorporated in their entirety for all purposes as if fully set forth herein. There are a number of commercially available geolocation databases, such as a web-site http://www.ip2location.com operated by Ip2location.com headquartered in Penang, Malaysia, offering IP geolocation software applications, and geolocation databases may be obtained from IpInfoDB operating web-site http://ipinfodb.com, and by Max Mind, Inc., based in Waltham, Mass., U.S.A., operating the web-site www.maxmind.com/en/home.

Further, the W3C Geolocation API is an effort by the World Wide Web Consortium (W3C) to standardize an interface to retrieve the geographical location information for a client-side device. It defines a set of objects, ECMA Script standard compliant, executing in the client application, give the client's device location through the consulting of Location Information Servers, which are transparent for the Application Programming Interface (API). The most common sources of location information are IP address, Wi-Fi and Bluetooth MAC address, radio-frequency identification (RFID), Wi-Fi connection location, or device Global Positioning System (GPS) and GSM/CDMA cell IDs. The location is returned with a given accuracy depending on the best location information source available. The W3C Recommendation for the geolocation API specifications draft dated Oct. 24, 2013, is available from the web-site http://www.w3.org/TR/2013/REC-geolocation-API-20131024. Geolocation-based addressing is described in U.S. Pat. No. 7,929,535 to Chen et al. entitled: “Geolocation-based Addressing Method for IPv6 Addresses”, and in U.S. Pat. No. 6,236,652 to Preston et al. entitled: “Geo-spacial Internet Protocol Addressing”, and in U.S. Patent Application Publication No. 2005/0018645 to Mustonen et al., entitled: “Utilization of Geographic Location Information in IP Addressing”, which are all incorporated in their entirety for all purposes as if fully set forth herein.

GPS. The Global Positioning System (GPS) is a space-based radio navigation system owned by the United States government and operated by the United States Air Force. It is a global navigation satellite system that provides geolocation and time information to a GPS receiver anywhere on or near the Earth where there is an unobstructed line of sight to four or more GPS satellites. The GPS system does not require the user to transmit any data, and it operates independently of any telephonic or internet reception, though these technologies can enhance the usefulness of the GPS positioning information. The GPS system provides critical positioning capabilities to military, civil, and commercial users around the world. The United States government created the system, maintains it, and makes it freely accessible to anyone with a GPS receiver. In addition to GPS, other systems are in use or under development, mainly because of a potential denial of access by the US government. The Russian Global Navigation Satellite System (GLONASS) was developed contemporaneously with GPS, but suffered from incomplete coverage of the globe until the mid-2000s. GLONASS can be added to GPS devices, making more satellites available and enabling positions to be fixed more quickly and accurately, to within two meters. There are also the European Union Galileo positioning system, China's BeiDou Navigation Satellite System and India's NAVIC.

The Indian Regional Navigation Satellite System (IRNSS) with an operational name of NAVIC (“sailor” or “navigator” in Sanskrit, Hindi and many other Indian languages, which also stands for NAVigation with Indian Constellation) is an autonomous regional satellite navigation system, that provides accurate real-time positioning and timing services. It covers India and a region extending 1,500 km (930 mi) around it, with plans for further extension. NAVIC signals will consist of a Standard Positioning Service and a Precision Service. Both will be carried on L5 (1176.45 MHz) and S band (2492.028 MHz). The SPS signal will be modulated by a 1 MHz BPSK signal. The Precision Service will use BOC(5,2). The navigation signals themselves would be transmitted in the S-band frequency (2-4 GHz) and broadcast through a phased array antenna to maintain required coverage and signal strength. The satellites would weigh approximately 1,330 kg and their solar panels generate 1,400 watts. A messaging interface is embedded in the NavIC system. This feature allows the command center to send warnings to a specific geographic area. For example, fishermen using the system can be warned about a cyclone.

The GPS concept is based on time and the known position of specialized satellites, which carry very stable atomic clocks that are synchronized with one another and to ground clocks, and any drift from true time maintained on the ground is corrected daily. The satellite locations are known with great precision. GPS receivers have clocks as well; however, they are usually not synchronized with true time, and are less stable. GPS satellites continuously transmit their current time and position, and a GPS receiver monitors multiple satellites and solves equations to determine the precise position of the receiver and its deviation from true time. At a minimum, four satellites must be in view of the receiver for it to compute four unknown quantities (three position coordinates and clock deviation from satellite time).

Each GPS satellite continually broadcasts a signal (carrier wave with modulation) that includes: (a) A pseudorandom code (sequence of ones and zeros) that is known to the receiver. By time-aligning a receiver-generated version and the receiver-measured version of the code, the Time-of-Arrival (TOA) of a defined point in the code sequence, called an epoch, can be found in the receiver clock time scale. (b) A message that includes the Time-of-Transmission (TOT) of the code epoch (in GPS system time scale) and the satellite position at that time. Conceptually, the receiver measures the TOAs (according to its own clock) of four satellite signals. From the TOAs and the TOTs, the receiver forms four Time-Of-Flight (TOF) values, which are (given the speed of light) approximately equivalent to receiver-satellite range differences. The receiver then computes its three-dimensional position and clock deviation from the four TOFs. In practice, the receiver position (in three dimensional Cartesian coordinates with origin at the Earth's center) and the offset of the receiver clock relative to the GPS time are computed simultaneously, using the navigation equations to process the TOFs. The receiver's Earth-centered solution location is usually converted to latitude, longitude and height relative to an ellipsoidal Earth model. The height may then be further converted to height relative to the geoid (e.g., EGM96) (essentially, mean sea level). These coordinates may be displayed, e.g., on a moving map display, and/or recorded and/or used by some other system (e.g., a vehicle guidance system).

Although usually not formed explicitly in the receiver processing, the conceptual Time-Differences-of-Arrival (TDOAs) define the measurement geometry. Each TDOA corresponds to a hyperboloid of revolution. The line connecting the two satellites involved (and its extensions) forms the axis of the hyperboloid. The receiver is located at the point where three hyperboloids intersect.

In typical GPS operation as a navigator, four or more satellites must be visible to obtain an accurate result. The solution of the navigation equations gives the position of the receiver along with the difference between the time kept by the receiver's on-board clock and the true time-of-day, thereby eliminating the need for a more precise and possibly impractical receiver based clock. Applications for GPS such as time transfer, traffic signal timing, and synchronization of cell phone base stations, make use of this cheap and highly accurate timing. Some GPS applications use this time for display, or, other than for the basic position calculations, do not use it at all. Although four satellites are required for normal operation, fewer apply in special cases. If one variable is already known, a receiver can determine its position using only three satellites. For example, a ship or aircraft may have known elevation. Some GPS receivers may use additional clues or assumptions such as reusing the last known altitude, dead reckoning, inertial navigation, or including information from the vehicle computer, to give a (possibly degraded) position when fewer than four satellites are visible.

The GPS level of performance is described in a 4th Edition of a document published September 2008 by U.S. Department of Defense (DoD) entitled: “GLOBAL POSITIONING SYSTEM—STANDARD POSITIONING SERVICE PERFORMANCE STANDARD”, which is incorporated in its entirety for all purposes as if fully set forth herein. The GPS is described in a book by Jean-Marie_Zogg (dated 26 Mar. 2002) published by u-blox AG (of CH-8800 Thalwil, Switzerland) [Doc Id GPS-X-02007] entitled: “GPS Basics—Introduction to the system—Application overview”, and in a book by El-Rabbany, Ahmed published 2002 by ARTECH HOUSE, INC. [ISBN 1-58053-183-1] entitled: “Introduction to GPS: the Global Positioning System”, which are both incorporated in their entirety for all purposes as if fully set forth herein. Methods and systems for enhancing line records with Global Positioning System coordinates are disclosed in in U.S. Pat. No. 7,932,857 to Ingman et al., entitled: “GPS for communications facility records”, which is incorporated in its entirety for all purposes as if fully set forth herein. Global Positioning System information is acquired and a line record is assembled for an address using the Global Positioning System information.

GNSS stands for Global Navigation Satellite System, and is the standard generic term for satellite navigation systems that provide autonomous geo-spatial positioning with global coverage. The GPS in an example of GNSS. GNSS-1 is the first generation system and is the combination of existing satellite navigation systems (GPS and GLONASS), with Satellite Based Augmentation Systems (SBAS) or Ground Based Augmentation Systems (GBAS). In the United States, the satellite based component is the Wide Area Augmentation System (WAAS), in Europe it is the European Geostationary Navigation Overlay Service (EGNOS), and in Japan it is the Multi-Functional Satellite Augmentation System (MSAS). Ground based augmentation is provided by systems like the Local Area Augmentation System (LAAS). GNSS-2 is the second generation of systems that independently provides a full civilian satellite navigation system, exemplified by the European Galileo positioning system. These systems will provide the accuracy and integrity monitoring necessary for civil navigation; including aircraft. This system consists of L1 and L2 frequencies (in the L band of the radio spectrum) for civil use and L5 for system integrity. Development is also in progress to provide GPS with civil use L2 and L5 frequencies, making it a GNSS-2 system.

An example of global GNSS-2 is the GLONASS (GLObal NAvigation Satellite System) operated and provided by the formerly Soviet, and now Russia, and is a space-based satellite navigation system that provides a civilian radio-navigation-satellite service and is also used by the Russian Aerospace Defence Forces. The full orbital constellation of 24 GLONASS satellites enables full global coverage. Other core GNSS are Galileo (European Union) and Compass (China). The Galileo positioning system is operated by The European Union and European Space Agency. Galileo became operational on 15 Dec. 2016 (global Early Operational Capability (EOC), and the system of 30 MEO satellites was originally scheduled to be operational in 2010. Galileo is expected to be compatible with the modernized GPS system. The receivers will be able to combine the signals from both Galileo and GPS satellites to greatly increase the accuracy. Galileo is expected to be in full service in 2020 and at a substantially higher cost. The main modulation used in Galileo Open Service signal is the Composite Binary Offset Carrier (CBOC) modulation. An example of regional GNSS is China's Beidou. China has indicated they plan to complete the entire second generation Beidou Navigation Satellite System (BDS or BeiDou-2, formerly known as COMPASS), by expanding current regional (Asia-Pacific) service into global coverage by 2020. The BeiDou-2 system is proposed to consist of 30 MEO satellites and five geostationary satellites.

Mobile phone tracking is the ascertaining of the position or location of a mobile phone, whether stationary or moving. Localization may occur either via multilateration of radio signals between (several) cell towers of the network and the phone. To locate a mobile phone using multilateration of radio signals, it must emit at least the roaming signal to contact the next nearby antenna tower, but the process does not require an active call. The Global System for Mobile Communications (GSM) is based on the phone's signal strength to nearby antenna masts. The technology of locating is commonly based on measuring power levels and antenna patterns and uses the concept that a powered mobile phone always communicates wirelessly with one of the closest base stations, so knowledge of the location of the base station implies the cell phone is nearby. Advanced systems determine the sector in which the mobile phone is located and roughly further estimates the distance to the base station. Further approximation use interpolating signals between adjacent antenna towers. Qualified services may achieve a precision of down to 50 meters in urban areas where mobile traffic and density of antenna towers (base stations) is sufficiently high. Rural and desolate areas may see miles between base stations and therefore determine locations less precisely. The location of a mobile phone can be determined by using network-based, handset-based, or SIM-based methods.

The location of a mobile phone can be determined using the service provider's network infrastructure. The advantage of network-based techniques, from a service provider's point of view, is that they can be implemented non-intrusively without affecting handsets. The accuracy of network-based techniques varies, with cell identification as the least accurate and triangulation as moderately accurate, and newer “advanced forward link trilateration” timing methods as the most accurate. The accuracy of network-based techniques is both dependent on the concentration of cell base stations, with urban environments achieving the highest possible accuracy because of the higher number of cell towers, and the implementation of the most current timing methods.

The location of a mobile phone can be determined using client software installed on the handset. This technique determines the location of the handset by putting its location by cell identification, signal strengths of the home and neighboring cells, which is continuously sent to the carrier. In addition, if the handset is also equipped with GPS then significantly more precise location information can be then sent from the handset to the carrier. Another approach is to use a fingerprinting-based technique, where the “signature” of the home and neighboring cells signal strengths at different points in the area of interest is recorded by war-driving and matched in real-time to determine the handset location.

Using the Subscriber Identity Module (SIM) in GSM and Universal Mobile Telecommunications System (UMTS) handsets, it is possible to obtain raw radio measurements from the handset. Available measurements include the serving Cell ID, round-trip time, and signal strength. The type of information obtained via the SIM can differ from that which is available from the handset. For example, it may not be possible to obtain any raw measurements from the handset directly, yet still obtain measurements via the SIM.

In order to route calls to a phone, the cell towers listen for a signal sent from the phone and negotiate which tower is best able to communicate with the phone. As the phone changes location, the antenna towers monitor the signal, and the phone is “roamed” to an adjacent tower as appropriate. By comparing the relative signal strength from multiple antenna towers, a general location of a phone can be roughly determined. Other means make use of the antenna pattern, which supports angular determination and phase discrimination.

Various location technologies are described in a presentation by Shu Wang, Jungwon Min and Byung K. Yi, in the IEEE International Conference on Communication (ICC) 2008, Beijing, China, entitled: “Location Based Services for Mobiles: Technologies and Standards”, which is incorporated in its entirety for all purposes as if fully set forth herein. An overview of Cellular Positioning Techniques is described in a paper by Balaram Singh, Soumya Pallai, and Susil Kumar published as conference Paper on September 2012, entitled: “A Survey of Cellular Positioning Techniques in GSM Networks”, which is incorporated in its entirety for all purposes as if fully set forth herein. Various methods for estimation of the location of a Mobile Station accurately are described, as a key requirement to effectively provide a wide range of Location Based Services over mobile networks. Applications requiring positioning in mobile networks gained importance in recent years. This gives rise to the various location based services (LBS), hence developing cellular positioning techniques has been a key research problem, with numerous localization solutions been proposed. There are several methods present to find the location, where the main objective is to find the location information more accurately without much modification in existing infrastructure, which ensures low cost.

Several methods are presented for finding the location are described in an article by Balaram Singh, Santosh Kumar Sahoo, and Soumya Ranjan Pradhan (all of JVCCE, B. B. Mahavidyalaya, Utkal University, Odisha, India) published January 2014 in the Journal of Telecommunication, Switching Systems and Networks Volume 1, Issue 1 entitled: “Analysis of Cellular Positioning Techniques in UMTS Networks”, which is incorporated in its entirety for all purposes as if fully set forth herein. The main objective is to find the location information more accurately without much modification in existing infrastructure which ensures low cost. This paper presents a review of location estimation techniques in UMTS Networks in terms of range accuracy in both urban and rural Sectors.

Wi-Fi positioning system (WPS) (or WiPS/WFPS) is commonly used where GPS (or GLONASS) are inadequate due to various causes including multipath and signal blockage indoors, such as in indoor positioning systems. The most common and widespread localization technique used for positioning with wireless access points is based on measuring the intensity of the received signal (Received Signal Strength Indication or RSSI) and the method of “fingerprinting”. Typical parameters useful to geolocate the Wi-Fi hotspot or wireless access point include the SSID and the MAC address of the access point. The accuracy depends on the number of positions that have been entered into the database. The Wi-Fi hotspot database gets filled by correlating mobile device GPS location data with Wi-Fi hotspot MAC addresses. The possible signal fluctuations that may occur can increase errors and inaccuracies in the path of the user. To minimize fluctuations in the received signal, there are certain techniques that can be applied to filter the noise. Accurate indoor localization is becoming more important for Wi-Fi based devices due to the increased use of augmented reality, social networking, health care monitoring, personal tracking, inventory control and other indoor location-aware applications.

The problem of Wi-Fi based indoor localization of a device consists in determining the position of client devices with respect to access points. Many techniques exist to accomplish this, and these may be classified into four main types: received signal strength indication (RSSI), fingerprinting, angle of arrival (AoA) and time of flight (ToF) based techniques. In most cases, the first step to determine a device's position is to determine the distance between the target client device and a few access points. With the known distances between the target device and access points, trilateration algorithms may be used to determine the relative position of the target device, using the known position of access points as a reference. Alternatively, the angle of arriving signals at a target client device can be employed to determine the device's location based on triangulation algorithms.

RSSI. RSSI localization techniques are based on measuring signal strength from a client device to several different access points, and then combining this information with a propagation model to determine the distance between the client device and the access points. Trilateration (sometimes called multilateration) techniques can be used to calculate the estimated client device position relative to the known position of access points.

Fingerprinting. Traditional fingerprinting is also RSSI-based, but it simply relies on the recording of the signal strength from several access points in range and storing this information in a database along with the known coordinates of the client device in an offline phase. This information can be deterministic or probabilistic. During the online tracking phase, the current RSSI vector at an unknown location is compared to those stored in the fingerprint and the closest match is returned as the estimated user location.

Angle of Arrival (AoA). Linear array of antennas are used for receiving a signal, and the phase-shift difference of the received signal arriving at antennas equally separated by a “d” distance is used to compute the angle of arrival of the signal. With the advent of MIMO WiFi interfaces, which use multiple antennas, it is possible to estimate the AoA of the multipath signals received at the antenna arrays in the access points, and apply triangulation to calculate the location of client devices.

Time of Flight (ToF). This localization approach takes timestamps provided by the wireless interfaces to calculate the ToF of signals and then use this information to estimate the distance and relative position of one client device with respect to access points. The granularity of such time measurements is in the order of nanoseconds and systems which use this technique have reported localization errors in the order of 2 m. The time measurements taken at the wireless interfaces are based on the fact that RF waves travel close to the speed of light, which remains nearly constant in most propagation media in indoor environments. Therefore, the signal propagation speed (and consequently the ToF) is not affected so much by the environment as the RSSI measurements are. As in the RSSI approach, the ToF is used only to estimate the distance between the client device and access points. Then a trilateration technique can be used to calculate the estimated position of the device relative to the access points. The greatest challenges in the ToF approach consist in dealing with clock synchronization issues, noise, sampling artifacts and multipath channel effects. Some techniques use mathematical approaches to remove the need for clock synchronization.

WiFi localization is described in a guide published May 20, 2008 by Cisco Systems, Inc. (headquartered in 170 West Tasman Drive San Jose, Calif. 95134-1706 USA) entitled: “Wi-Fi Location-Based Services 4.1 Design Guide” [Text Part Number: OL-11612-01], which is incorporated in its entirety for all purposes as if fully set forth herein. The accuracy of various WiFi positioning and the optimal area of their applications are described in a paper by Robin Henniges presented on TU-Berlin, 2012 as part of SERVICE-CENTRIC NETWORKING—SEMINAR WS2011/2012, entitled: “Current approaches of Wifi Positioning”, which is incorporated in its entirety for all purposes as if fully set forth herein. It will make use of existing WiFi infrastructure, although this was never designed to do so. Methods that were used for other positioning technologies can be adopted for WiFi.

A system built using probabilistic techniques that allows for remarkably accurate localization across our entire office building using nothing more than the built-in signal intensity meter supplied by standard 802.11 cards is described in a paper by Andreas Haeberlen, Eliot Flannery, Andrew M. Ladd, Algis Rudys, Dan S. Wallach, and Lydia E. Kavraki (all of Rice University) published by ACM 2004 in MobiCom '04, Sep. 26-Oct. 1, 2004, Philadelphia, Pa., USA [1-58113-868-7/04/0009 . . . $5.00], entitled: “Practical Robust Localization over Large-Scale 802.11 Wireless Networks”, which is incorporated in its entirety for all purposes as if fully set forth herein. While prior systems have required significant investments of human labor to build a detailed signal map, we can train our system by spending less than one minute per office or region, walking around with a laptop and recording the observed signal intensities of our building's unmodified base stations. We actually collected over two minutes of data per office or region, about 28 man-hours of effort. Using less than half of this data to train the localizer, we can localize a user to the precise, correct location in over 95% of our attempts, across the entire building. Even in the most pathological cases, we almost never localize a user any more distant than to the neighboring office. A user can obtain this level of accuracy with only two or three signal intensity measurements, allowing for a high frame rate of localization results. Furthermore, with a brief calibration period, our system can be adapted to work with previously unknown user hardware. We present results demonstrating the robustness of our system against a variety of untrained time-varying phenomena, including the presence or absence of people in the building across the day. Our system is sufficiently robust to enable a variety of location aware applications without requiring special-purpose hardware or complicated training and calibration procedures.

Geolocation may be used by any network element. The peer devices described above as storing a content (chunks) that is required by a client device, and thus the client device fetches the content from the peer devices rather than directly from the web server (or in addition to it). In some cases, multiple devices are available storing unknown content which may be the content required by a client device. The geolocation may be used to determine which available devices may be, or are expected to be, storing the content that is requested. In this context, two Internet-connected devices, each identified by a respective IP address, for example, are considered as being ‘close’ if there is a likelihood that the same content is stored in both, or that both devices fetched the same content from a data server. Similarly, two devices are considered closer than the other two devices if there is a higher likelihood that they store the same content (from the same data server).

In one example, the selection is based only on the obtained the geographical location. In one example, such selection may be based on the physical geographical location of the requesting device (obtained locally at the requesting device or by using a geolocation), a physical geographical location of the data server storing a content that is requested (obtained locally or by using geolocation), or relating to physical geographical location of IP addressable, Internet connected device. In one example, the devices may be selected based on being in the same location, such as in the same continent, country, region, city, street, or timezone. The devices may be selected from the list based on the physical geographical distance, where ‘closeness’ is defined as based on actual geographical distance between devices, where shorter distance indicates closer devices. For example, is the case where the latitude and the longitude are obtained, the physical distance between each device in the list and the requesting device (or the data server or another device) may be calculated, and the nearest device will be first selected, then the second nearest device, and so on. Alternatively or in addition, devices in the same city (or street) as the requesting device are considered as the closest and may be first selected, then the devices that are in the same region or country may be considered as close and may be selected next.

A software and hardware system capable of operating on a signal controller platform is disclosed in U.S. Patent Application Publication No. 2006/0287807 to Teffer entitled: “Method for incorporating individual vehicle data collection, detection and recording of traffic violations in a traffic signal”, which is incorporated in its entirety for all purposes as if fully set forth herein. The signal controller platform detects and records individual vehicle data including but not limited to dangerous driving behavior such as red light running and speeding. The disclosure teaches sharing of the computing platform and infrastructure of the traffic control system. The disclosure also teaches receiving, interpreting, and organizing data collected through the traffic control system's vehicle detection infrastructure, and driving cameras, video, or other recording devices to provide additional evidence of an individual vehicle's behavior.

A method and apparatus for collecting, uploading and evaluating motor vehicle operation are disclosed in U.S. Pat. No. 6,931,309 to Phelan et al. entitled: “Motor vehicle operating data collection and analysis”, which is incorporated in its entirety for all purposes as if fully set forth herein. The method and apparatus are utilizing on-board diagnostic components (OBDII) and ground positioning satellite (GPS) systems, whereby operator identifiable behavior can be rated for driving safety and other characteristics.

An on-board intelligent vehicle system is disclosed in U.S. Pat. No. 7,421,334 to Dahlgren et al. entitled: “Centralized facility and intelligent on-board vehicle platform for collecting, analyzing and distributing information relating to transportation infrastructure and conditions”, which is incorporated in its entirety for all purposes as if fully set forth herein. The system includes a sensor assembly to collect data and a processor to process the data to determine the occurrence of at least one event. The data may be collected from existing standard equipment such as the vehicle communication bus or add-on sensors. The data may be indicative of conditions relating to the vehicle, roadway infrastructure, and roadway utilization, such as vehicle performance, roadway design, roadway conditions, and traffic levels. The detection of an event may signify abnormal, substandard, or unacceptable conditions prevailing in the roadway, vehicle, or traffic. The vehicle transmits an event indicator and correlated vehicle location data to a central facility for further management of the information. The central facility sends communications reflecting event occurrence to various relevant or interested users. The user population can include other vehicle subscribers (e.g., to provide rerouting data based on location-relevant roadway or traffic events), roadway maintenance crews, vehicle manufacturers, and governmental agencies (e.g., transportation authorities, law enforcement, and legislative bodies).

Systems, methods and computer readable media for determining compliance with recommendations are disclosed in U.S. Patent Application Publication No. 2014/0279707 to Joshua et al. entitled: “System and method for vehicle data analysis”, which is incorporated in its entirety for all purposes as if fully set forth herein. The systems and methods may involve generating a vehicle recommendation; transmitting the vehicle recommendation to at least one output device, wherein the at least one output device communicates the vehicle recommendation to one or more users; collecting vehicle telemetry data from a vehicle sensor device located in a vehicle, wherein the vehicle sensor device is coupled to one or more vehicle sensors; and determining compliance data based on the vehicle recommendation and the vehicle telemetry data, wherein the compliance data indicates compliance with the recommended vehicle action. The compliance data may be used to determine service rates and/or service level coverage for users.

A system for monitoring and reporting incidences of traffic violations at a traffic location is disclosed in U.S. Pat. No. 6,546,119 to Ciolli et al. entitled: “Automated traffic violation monitoring and reporting system”, which is incorporated in its entirety for all purposes as if fully set forth herein. The system comprises a digital camera system deployed at a traffic location. The camera system is remotely coupled to a data processing system. The data processing system comprises an image processor for compiling vehicle and scene images produced by the digital camera system, a verification process for verifying the validity of the vehicle images, an image processing system for identifying driver information from the vehicle images, and a notification process for transmitting potential violation information to one or more law enforcement agencies.

A distributed individual vehicle information capture method for capturing individual vehicle data at traffic intersections and transmitting the data to a central station for storage and processing is disclosed in U.S. Patent Application Publication No. 2005/0122235 to Teffer et al. entitled: “Method and system for collecting traffic data, monitoring traffic, and automated enforcement at a centralized station”, which is incorporated in its entirety for all purposes as if fully set forth herein. The method includes capturing individual vehicle information at a plurality of intersections (122) and transmitting the individual vehicle information from the intersections to a central station (124). Consequently, the individual vehicle information is available to be stored and processed by a device at the central station (126). Traffic intersection equipment for capturing individual vehicle data at traffic intersections and transmitting the data to a central station for storage and processing is also disclosed. The equipment includes a traffic detection device (159) for capturing individual vehicle data at an intersection (158) and a network connection to a central station (174). The traffic detection device (159) is operably configured to transmit to the central station (174) the individual vehicle information.

A system and method for acquiring image evidence of traffic violations are disclosed in U.S. Patent Application Publication No. 2003/0189499 to Stricklin et al. entitled: “System and method for traffic”, which is incorporated in its entirety for all purposes as if fully set forth herein. The system has a controller, an image acquisition system, and sensors. The controller acquires data from the sensors to determine the likelihood of a traffic violation. The controller determines a schedule for acquiring images associated with the violation. Multiple images may be acquired as evidence of the violation. The controller then directs the image acquisition to acquire images in compliance with the schedule. The controller may then package, encrypt, and authenticate data and images associated with the violation. The controller may then transfer the data to a remote location. The system may also determine a schedule to acquire images associated with multiple violations and/or traffic accidents.

A system for monitoring and reporting incidences of traffic violations at a traffic location is disclosed in U.S. Patent Application Publication No. 2004/0252193 to Higgins entitled: “Automated traffic violation monitoring and reporting system with combined video and still-image data”, which is incorporated in its entirety for all purposes as if fully set forth herein. The system comprises one or more digital still cameras and one or more digital video cameras system deployed at a traffic location. The camera system is coupled to a data processing system, which comprises an image processor for compiling vehicle and scene images produced by the digital camera system, a verification process for verifying the validity of the vehicle images, an image processing system for identifying driver information from the vehicle images, and a notification process for transmitting potential violation information to one or more law enforcement agencies. The video camera system is configured to record footage both before and after the offense is detected. The video camera system includes a non-stop video capture buffer that records the preceding few seconds of violation. The buffer holds a number of seconds of video data in memory. When an offense is detected, a timer is started. At the end of the timer period a video clip of the current buffer contents is recorded. The resulting video clip is incorporated with the conventional evidence set comprising the digital still images of the offense with the identifying data of the car and driver.

An example of an electronics architecture in a vehicle 21 is illustrated in a schematic block diagram 20 shown in FIG. 2. The vehicle 21 comprises five ECUs: A Telematics ECU 22b, a Communication ECU 22a, an ECU #1 22c, an ECU #2 22d, and an ECU #3 22e. While five ECUs are shown, any number of ECUs may be employed. Each of the ECUs may comprises, may consists of, or may be part of, Electronic/engine Control Module (ECM), Engine Control Unit (ECU), Powertrain Control Module (PCM), Transmission Control Module (TCM), Brake Control Module (BCM or EBCM), Central Control Module (CCM), Central Timing Module (CTM), General Electronic Module (GEM), Body Control Module (BCM), Suspension Control Module (SCM), Door Control Unit (DCU), Electric Power Steering Control Unit (PSCU), Seat Control Unit, Speed Control Unit (SCU), Telematic Control Unit (TCU), Transmission Control Unit (TCU), Brake Control Module (BCM; ABS or ESC), Battery management system, control unit, and a control module. The ECUs communicates with each other over a vehicle bus 23, which may consists of, comprises, or may be based on, Controller Area Network (CAN) standard (such as Flexible Data-Rate (CAN FD) protocol), Local Interconnect Network (LIN), FlexRay protocol, or Media Oriented Systems Transport (MOST) (such as MOST25, MOST50, or MOST150). In one example, the vehicle bus may consists of, comprises, or may be based on, automotive Ethernet, may use only a single twisted pair, and may consist of, employ, use, may be based on, or may be compatible with, IEEE802.3 100BaseT1, IEEE802.3 1000BaseT1, BroadR-Reach®, or IEEE 802.3bw-2015 standard.

An ECU may connect to, or include, a sensor for sensing a phenomenon in the vehicle or in the vehicle environment. In the exemplary vehicle 21 shown in the arrangement 20, a sensor 24b is connected to the ECU #1 22c, and an additional sensor 24a is connected to the ECU #3 22e. Further, an ECU may connect to, or include, an actuator for affecting, generating, or controlling a phenomenon in the vehicle or in the vehicle environment. In the exemplary vehicle 21 shown in the arrangement 20, an actuator 25b is connected to the ECU #2 22d, and an additional actuator 25a is connected to the ECU #3 22e.

The vehicle 21 may communicate over a wireless network 39 with other vehicles or with stationary devices, directly or via the Internet. The communication with the wireless network 39 uses an antenna 29 and a wireless transceiver 28, which may part of the Communication ECU 22a. The wireless network 39 may be a Wireless Wide Area Network (WWAN), such as WiMAX network or a cellular telephone network (such as Third Generation (3G) or Fourth Generation (4G) network). Alternatively or in addition, the wireless network 39 may be a Wireless Personal Area Network (WPAN) that may be according to, may be compatible with, or may be based on, Bluetooth™ or IEEE 802.15.1-2005 standards, or may be according to, or may be based on, ZigBee™, IEEE 802.15.4-2003, or Z-Wave™ standard. Alternatively or in addition, the wireless network 39 may be a Wireless Local Area Network (WLAN) that may be according to, may be compatible with, or may be based on, IEEE 802.11-2012, IEEE 802.11a, IEEE 802.11b, IEEE 802.11g, IEEE 802.11n, or IEEE 802.11ac.

Alternatively or in addition, the wireless network 39 may use a Dedicated Short-Range Communication (DSRC), that may be according to, compatible with, or based on, European Committee for Standardization (CEN) EN 12253:2004, EN 12795:2002, EN 12834:2002, EN 13372:2004, or EN ISO 14906:2004 standard, or may be according to, compatible with, or based on, IEEE 802.11p, IEEE 1609.1-2006, IEEE 1609.2, IEEE 1609.3, IEEE 1609.4, or IEEE1609.5.

The vehicle 21 may include a GPS receiver for a localization, navigation, or tracking of the vehicle 21. In the exemplary vehicle 21 shown in the arrangement 20, a GPS receiver 27 receives RF signals from the GPS satellites 38a and 38b, and is part of, or connected to, the Telematics ECU 22b. The Telematics ECU 22b may further include, or connect to, a dashboard display 26, (also known as instrument panel (IP), or fascia) that is a control panel located directly ahead, or in plain view, of a vehicle's driver or passenger, displaying instrumentation, infotainment, and controls for the vehicle's operation.

Automotive navigation system. A navigation system generally compares the determined position with a digital map and uses this map to calculate the optimal route to a specified destination. An automotive navigation system is part of the automobile (or vehicle) controls or a third party add-on used to find direction in an automobile (or vehicle). It typically uses a satellite navigation device to get its position data, which is then correlated to a position on a road. When directions are needed, routing can be calculated, and on-the-fly traffic information can be used to adjust the route. Dead reckoning may be used, using distance data from sensors attached to the drivetrain, together with a gyroscope and an accelerometer can be used for greater reliability. Mathematically, automotive navigation is based on the shortest path problem, within graph theory, which examines how to identify the path that best meets some criteria (shortest, cheapest, fastest, etc.) between two points in a large network. Compared with portable devices, permanently installed navigation devices in a vehicle provides better positioning quality and thus better route-guidance quality, since additional sensors for distance and direction signals (such as wheel-speed and yaw sensors) can be evaluated and the antenna can be mounted in a more favorable place for satellite reception. As original equipment, networking with other components is also common, i.e. integration in the operating concept of the vehicle is possible. Voice outputs can be issued via the audio system, and may be muted for telephone calls. The route guidance information may be displayed in the instrument cluster or in the head-up display and thus in the driver's primary field of vision. An example of a navigation system is the iGO navigation application (app), described in a user manual UK English ver. 1.0 dated August 2016 entitled: “User Manual—iGO Navigation app—Navigation software for the iGO Navigation app”, which is incorporated in its entirety for all purposes as if fully set forth herein.

In-car positioning and navigation has been a killer application for Global Positioning System (GPS) receivers, and a variety of electronics for consumers and professionals have been launched on a large scale. Positioning technologies based on stand-alone GPS receivers are vulnerable and, thus, have to be supported by additional information sources to obtain the desired accuracy, integrity, availability, and continuity of service. A survey of the information sources and information fusion technologies used in current in-car navigation systems is presented in a paper authored by Isaac Skog and Peter Handel Published in IEEE Transactions on Intelligent Transportation Systems (Volume: 10, Issue: 1, March 2009) entitled: “In-car positioning and navigation technologies—a survey”, which is incorporated in its entirety for all purposes as if fully set forth herein.

The road database is typically provided as a vector map, and street names or numbers and house numbers, as well as points of interest (waypoints), are encoded as geographic coordinates. This enables users to find a desired destination by street address or as geographic coordinates. A GPS device is typically used in most automobile navigation systems, and may be used in a number of contexts, including: Maps, including street maps, displayed in human readable format via text or in a graphical format, turn-by-turn navigation directions to a human in charge of a vehicle or vessel via text or speech, directions fed directly to an autonomous vehicle such as a robotic probe, traffic congestion maps (depicting either historical or real time data), and suggested alternative directions, information on nearby amenities such as restaurants, fueling stations, and tourist attractions. Further, GPS devices may be able to indicate the roads or paths available, traffic congestion and alternative routes, roads or paths that might be taken to get to the destination, if some roads are busy (now or historically) the best route to take, The location of food, banks, hotels, fuel, airports or other places of interests, the shortest route between the two locations, and the different options to drive on highway or back roads.

Most navigation systems rely on three primary guidance display screens to communicate navigation information to drivers: (1) maps, (2) maneuver lists with sequenced turn directions, and (3) turn-by-turn guidance displays which generally “pop up” in advance of a turn. The overall utility of each depends on the particular task being performed. Maps, for example, can be effectively used to plan a route since they provide a pictorial representation of an area or region, while ordered lists of directions can limit information processing and lead to fast and accurate navigation performance. Systems tend to use or make available all three types of information displays. While some navigation guidance display have very small monochrome screens, most of the systems provided some form of color map display. Typically, it is perceived that drivers will use map-based information not only for trip planning purposes, but also during en-route navigation. Map displays contained the most information (an average of over ten items), and generally served as the default guidance view (the one drivers would see first when operating the system) despite the fact that they rely heavily on spatial processing capabilities of the driver. Most systems, however, provided supplemental turn-by-turn guidance displays. Systems also enabled drivers to change the default view, and/or access alternative views directly (often via a single button press).

Some systems also allowed the display screen to be blanked-out while driving, allowing drivers to receive audio guidance only. Although turn-by-turn guidance displays generally contained fewer information items than map displays, they still presented a considerable amount of information. General types of information on these displays tended to include turn arrows, countdown bars to indicate the distance to the next maneuver, an indication of the current and next turn street name, and an abbreviated map depicting the intersection roadway geometry at the next maneuver point. One design adopted by several systems was to integrate display elements such as the turn arrow, countdown bar, map, and vehicle position indicator. This arrangement allows drivers to focus on a single overall graphic representation rather than several individual display elements to extract the information (exercising Gestalt principles). Another characteristic common to turn-by-turn displays was the redundant audio component announcing the upcoming maneuver. Some systems only announced the direction and distance of the next turn, rather than the specific street name.

GPS device. A GPS navigation device, GPS receiver, or simply GPS is a device that is capable of receiving information from GPS satellites and then to calculate the device's geographical position. Using suitable software, the device may display the position on a map, and it may offer directions. A GPS device can retrieve from the GPS system location and time information in all weather conditions, anywhere on or near the Earth. A GPS reception typically requires an unobstructed line of sight to four or more GPS satellites, and is subject to poor satellite signal conditions. In exceptionally poor signal conditions, for example in urban areas, satellite signals may exhibit multipath propagation where signals bounce off structures, or are weakened by meteorological conditions. Obstructed lines of sight may arise from a tree canopy or inside a structure, such as in a building, garage or tunnel. Today, most standalone GPS receivers are used in automobiles. The GPS capability of smartphones may use assisted GPS (A-GPS) technology, which can use the base station or cell towers to provide the device location tracking capability, especially when GPS signals are poor or unavailable. However, the mobile network part of the A-GPS technology would not be available when the smartphone is outside the range of the mobile reception network, while the GPS aspect would otherwise continue to be available.

Consumer GPS navigation devices include Dedicated GPS navigation devices, GPS modules that need to be connected to a computer to be used; and GPS loggers that record trip information for download. Such GPS tracking is useful for trailblazing, mapping by hikers and cyclists, and the production of geocoded photographs. Converged devices, including GPS Phones and GPS cameras, in which GPS is a feature rather than the main purpose of the device. The majority of GPS devices are now converged devices, and may use assisted GPS or standalone (not network dependent) or both. The vulnerability of consumer GPS to radio frequency interference from planned wireless data services is controversial.

Dedicated devices have various degrees of mobility. Hand-held, outdoor, or sport receivers have replaceable batteries that can run them for several hours, making them suitable for hiking, bicycle touring and other activities far from an electric power source. Their screens are small, and some do not show color, in part to save power. Some use transflective liquid-crystal displays, allowing use in bright sunlight. Cases are rugged and some are water resistant. Other receivers, often called mobile are intended primarily for use in a car, but have a small rechargeable internal battery that can power them for an hour or two away from the car. Special purpose devices for use in a car may be permanently installed and depend entirely on the automotive electrical system.

POI. A Point-Of-Interest, or POI, is a specific point location that someone may find useful or interesting. An example is a point on the Earth representing the location of the Space Needle, or a point on Mars representing the location of the mountain, Olympus Mons. Most consumers use the term when referring to hotels, campsites, fuel stations or any other categories used in modern (automotive) navigation systems. Users of a mobile devices can be provided with geolocation and time aware POI service, that recommends geolocations nearby and with a temporal relevance (e.g., POI to special services in a Ski resort are available only in winter). A GPS point of interest specifies, at minimum, the latitude and longitude of the POI, assuming a certain map datum. A name or description for the POI is usually included, and other information such as altitude or a telephone number may also be attached. GPS applications typically use icons to represent different categories of POI on a map graphically. Typically, POIs are divided up by category, such as dining, lodging, gas stations, parking areas, emergency services, local attractions, sports venues, and so on. Usually, some categories are subdivided even further, such as different types of restaurants depending on the fare. Sometimes a phone number is included with the name and address information.

Digital maps for modern GPS devices typically include a basic selection of POI for the map area. However websites exist that specialize in the collection, verification, management and distribution of POI which end-users can load onto their devices to replace or supplement the existing POI. While some of these websites are generic, and will collect and categorize POI for any interest, others are more specialized in a particular category (such as speed cameras) or GPS device (e.g. TomTom/Garmin). End-users also have the ability to create their own custom collections.

As GPS-enabled devices as well as software applications that use digital maps become more available, so too the applications for POI are also expanding. Newer digital cameras for example can automatically tag a photograph using Exif with the GPS location where a picture was taken; these pictures can then be overlaid as POI on a digital map or satellite image such as Google Earth. Geocaching applications are built around POI collections. In common vehicle tracking systems, POIs are used to mark destination points and/or offices so that users of GPS tracking software would easily monitor position of vehicles according to POIs.

Many different file formats, including proprietary formats, are used to store point of interest data, even where the same underlying WGS84 system is used. Some of the file formats used by different vendors and devices to exchange POI (and in some cases, also navigation tracks), are: ASCII Text (.asc .txt .csv .plt), Topografix GPX (.gpx), Garmin Mapsource (.gdb), Google Earth Keyhole Markup Language (.kml .kmz), Pocket Street Pushpins (.psp), Maptech Marks (.msf), Maptech Waypoint (.mxf), Microsoft MapPoint Pushpin (.csv), OziExplorer (.wpt), TomTom Overlay (.ov2) and TomTom plain text format (.asc), and OpenStreetMap data (.osm). Furthermore, many applications will support the generic ASCII text file format, although this format is more prone to error due to its loose structure as well as the many ways in which GPS co-ordinates can be represented (e.g., decimal vs degree/minute/second).

A flow chart 30 illustrating the operation of a navigation system or device, such as operating a vehicle navigation system, is shown in FIG. 3. In a “Location Select” step 31, the user or operator, such as a driver or passenger in a vehicle, enters the required location destination to the device. The device uses a geolocation sensor, such as a GPS receiver, to ascertain the current local location of the device as part of a “Local Location” step 32. In addition to a geolocation sensor, the system may use a speed sensor (such as a vehicle speed sensor), for detecting or measuring travelled distance. Using local stored maps, or external maps database, the device calculates the optimal route according to a pre-defined criteria, as part of a “Route Calculate” step 33. The route calculation as part of the “Route Calculate” step 33 typically uses detailed local or remote database that stores and provides maps, road networks, geographical features, waypoints, and POIs information. The calculated route is displayed to the user or operator as part of a “Route Display” step 34, and upon confirming the route by the user or operator (or upon selective from alternative suggested routes), the device instructs the user how to reach the destination location as part of a “Navigate” step 35. As part of the “Navigate” step 35, the user or operator may be guided using visual or audible notifications (or any combination thereof). The device may calculate various routes, allowing the user to select one of the suggested possible routes, and the selected route will be used for the navigation as part of the “Navigate” step 35. The guidance as part of the “Navigate” step 35 may include voice prompts, but may include also other forms of user notification, such as textual messages or different audible, visual, or other signals. For example, the navigation prompt may be stored and sent as audio files (assuming voice prompt), such as .WAV (Waveform Audio File Format) file or encoded as an another audio coding format for digital audio, such as MPEG-1 or MPEG-2 Audio Layer III, more commonly referred to as MP3 (or mp3). In another example, the guidance may be based on text form that is displayed or converted to audio using Text-To-Speech (TTS) scheme. In such a case, a speech synthesizer may be used and may be of a concatenative type, using unit selection, diphone synthesis, or domain-specific synthesis. Alternatively or in addition, the speech synthesizer may be a formant type, and may be based on articulatory synthesis or Hidden Markov Models (HMM) based. The navigation prompts could also include recordings of common words such as “turn,” “left,” “onto,” “street,” and “avenue,” or segments of words (i.e., “turn left onto”). The guidance of the trip plan table may include a location voice prompt (i.e., “Howell Street”) and an address identifier, generated by a voice direction instruction by combining the stored word or segment recording associated with the address identifier and the location voice prompt.

Transportation costs are minimized with a novel system for optimizing a route for a service vehicle that is disclosed in U.S. Pat. No. 7,778,773 to Yaqub et al. entitled: “Optimum route planning for service vehicles”, which is incorporated in its entirety for all purposes as if fully set forth herein. For example, a service vehicle may be a package delivery van. Based upon static and dynamic information, a computer on board the service vehicle determines an optimum route for the vehicle to travel between multiple locations. The computer on board the service vehicle communicates wirelessly to receive any pertinent dynamic information, which has changed (e.g., traffic congestion, the presence of a customer at a deliver location, or a modification of location). The computer then recalculates the optimum route for the vehicle and guides the driver of the vehicle in accordance with the newly determined optimum route. The on board computer continues to check for any updates, and recalculates the optimum route throughout the day. Thus, the optimum route may be selected based upon the latest available information white avoiding heavy signal traffic on the wireless network.

A vehicle navigation system and method is disclosed in U.S. Pat. No. 7,330,786 to Odinak et al. entitled: “Vehicle navigation system and method”, which is incorporated in its entirety for all purposes as if fully set forth herein. The system includes a unit located in a vehicle and coupled to a first network, a traffic information center coupled to a second network, and a server coupled to the first and second networks. A trip plan is generated according to navigation information, vehicle coordinates and trip request information received from the unit, and road information received from the traffic information center. The trip plan is sent to the unit for presentation. The trip plan includes trip overview information and voice prompts associated with one or more landmarks. A trip plan may be a tourist trip plan.

A route planning system and method for a navigation system, which allows the driver to intelligently plan the route when adding waypoints, is disclosed in U.S. Pat. No. 8,560,227 to Feng entitled: “Route planning apparatus and method for navigation system”, which is incorporated in its entirety for all purposes as if fully set forth herein. The route planning navigation system includes a route planning processor which allows the driver to add and prioritize multiple POIs as waypoints. When one or more new waypoints are added, the driver is allowed to prioritize the waypoints if adding new waypoints does not significantly increase the cost of the route, and an optimized route is generated accordingly. In another aspect, if adding new waypoint significantly increases the cost of the route, a notifying message will be generated by the route planning processor so that the driver is able to make a decision whether to proceed to the new waypoint.

A navigation method and apparatus finds a location and a route to a plurality of destinations with the minimum number of stops or the shortest overall distance is disclosed in U.S. Pat. No. 7,239,960 to Yokota entitled: “Navigation method and system for visiting multiple destinations by minimum number of stops”, which is incorporated in its entirety for all purposes as if fully set forth herein. The navigation method includes the steps of: specifying a plurality of destinations in a navigation system; searching a one-stop location where two or more specified destinations exist or searching a location of each destination; displaying results of search for prompting a user to decide whether recommended locations of the destinations in the search result is acceptable; repeating the above steps of searching locations and displaying the search results until the user accepts recommended locations of the destinations; and guiding the user to the destinations accepted by the user.

A system that provides personalized traffic information and route planning capabilities to users of the system is disclosed in U.S. Patent Application Publication No. 2003/0065442 to Touney entitled: “Navigation system and travel coordinator with dynamic traffic data”, which is incorporated in its entirety for all purposes as if fully set forth herein. The system uses existing wireless personal telephone and communication systems that allow for the geo-location of users in the network. This system uses standard geo-location methods and telecommunication equipment to triangulate the position of a user and transfer data between them and the central system. This user information is collected and used to compute real-time system wide model of the street segments in the traffic network. This model can then be used to create individual routing information for any user of the system. This computed travel time information is used to determine the most efficient route for a user and can be transmitted to the user. As a user travels, their location is constantly obtained and their travel route information is updated and relayed to them.

An example for a vehicle navigation system is Maestro™ 4200 by Magellan® described in a User Manual Published 2007 [Document No. 604-0046-001 A], which is incorporated in its entirety for all purposes as if fully set forth herein. Another example for a vehicle navigation system is nuvi 2707/2708 Series by Garmin described in an Owner Manual dated March 2013 [Document No. 190-01589-00_0A], which is incorporated in its entirety for all purposes as if fully set forth herein.

A method and system for dynamic and interactive navigation is presented in U.S. Pat. No. 6,484,092 to Seibel entitled: “Method and system for dynamic and interactive route finding”, which is incorporated in its entirety for all purposes as if fully set forth herein. A navigation request is received from a user. The navigation request comprises an originating location description, a destination location description, and at least one criterion to be satisfied by a desired route. Dynamic condition information associated with at least one route between the originating location and the destination location is retrieved. Based on the dynamic condition information, a desired route between the originating location and the destination location is determined.

Directory service results responsive to a request for a desired good or service provider may be provided based on one or more user-selected locations as described in in U.S. Pat. No. 7,761,350 to Ridgeway entitled: “Biasing of search result clustering to ensure more effective point of interest (POI) targeting”, which is incorporated in its entirety for all purposes as if fully set forth herein. The user may seek a desired good or service provider that is proximate to a location from which the user may begin traveling to the point of interest, referred to as a source location, and satisfies a beneficial objective held by the user. The beneficial objective may relate to, for example, a directional travel preference, avoiding rush hour traffic or proximity to a specific location or another type of good or service provider that differs from the user's desired good or service provider that is the subject of the user's request. A sequence of geometrical representations, such as, for example, Delauney Triangles, may be generated to provide directory service results that satisfy the user's request.

A computer-implemented method for identifying a route that is configured to travel through multiple points of interest is described in U.S. Pat. No. 8,467,959 to Nesbitt et al. entitled: “Identifying a route configured to travel through multiple points of interest”, which is incorporated in its entirety for all purposes as if fully set forth herein. The method includes receiving a query that includes an origin location, a destination location, and at least a first point of interest and a second point of interest. The method also includes identifying a perimeter that surrounds the received origin and destination locations in response to the query. The perimeter is then used to identify a set of locations for each of the first and second points of interest.

Systems and methods of for providing various services, such as parking services, flight services, and fuel services, to a user using a satellite digital audio radio system are provided in U.S. Patent Application Publication No. 2010/0106514 to Cox entitled: “Travel related services via SDARS”, which is incorporated in its entirety for all purposes as if fully set forth herein. Each data service can be provided independently or in any combination to a user, and each can be independently subscribed to by a user, in various exemplary business models. In exemplary embodiments of the present invention, a parking data service, providing, for example, information on parking garages near a certain location and the availability of parking spaces in parking garages can be provided. In exemplary embodiments of the present invention, a flight data services, providing, for example, information such as near real-time updates to changes in arrival and departure statuses of one or more commercial airline flights. In exemplary embodiments of the present invention, a fuel data service, providing, for example, information on fueling stations and the prices and fuel types available at fueling stations, can be provided. In exemplary embodiments of the present invention, such data services can be embedded in an SDARS data stream and made available to users on an SDARS receiver.

A navigation system-based optimal passing point selection method with limited constraint conditions is described in Chinese Patent Application Publication No. CN107525513A entitled: “Existing navigation system-based optimal passing point selection method with limited constraint conditions”, which is incorporated in its entirety for all purposes as if fully set forth herein. The method is technically characterized by comprising the following steps: after inputting a start position, a destination and traveling preference, setting passing points, and constraint conditions by using an optimal passing point selection module; automatically searching on an electronic map to find all passing point positions meeting requirements; according to the travelling preference of a user, planning all routes including the start position, the passing points and the destination; calculating the evaluation value of each route under the measurement criteria of the travelling preference and ranking according to the evaluation values; selecting the optimal route, so that the user drives according to an optimal passing point and the optimal route. The method disclosed by the invention can help the user to automatically select the optimal passing point that meets the traveling preference from a great number of passing points that satisfy the limited constraint conditions and plan the optimal route including the passing point, so as to save time, spent in selecting and comparing the passing points, of the user, greatly facilitate the travel of people, and realize practical significance and value.

A user that uses a portable electronic device to select an image representative of a brand is disclosed in U.S. Pat. No. 8,451,114 to Gold entitled: “Brand mapping”, which is incorporated in its entirety for all purposes as if fully set forth herein. In response to the user's selection of the image representative of the brand, the device automatically presents the user with an image of a map that indicates a current location of the device and shows one or more images representative of brand purchase sites where the selected brand may be accessed by the user.

A Point of Interest (POI) icon display method in a navigation system that is described for displaying a POI icon at a POI point on a map is disclosed in U.S. Pat. No. 6,983,203 to Wako entitled: “POI icon display method and navigation system”, which is incorporated in its entirety for all purposes as if fully set forth herein. For every POI in a POI category, the location point and type of POI are stored. Each POI is identified on the displayed map by the same POI icon, and when a POI icon of a POI is selected, the type of POI is displayed. Accordingly, it is possible to reduce the number of POI icons, recognize the type of POI, such as the type of food of a restaurant (classified by country, such as Japanese food, Chinese food, Italian food, and French food), and provide a guide route to a desired POI quickly.

A method and apparatus for a navigation system for generating a reminder message by applying predefined validation rule to display and/or voice announce the reminder message associated with a particular location, is disclosed in U.S. Pat. No. 7,889,101 to Yokota entitled: “Method and apparatus for generating location based reminder message for navigation system”, which is incorporated in its entirety for all purposes as if fully set forth herein. The method includes the steps of creating reminder message data which include a reminder message, a primary location, a secondary location, and a validation rule; comparing a reference location with the primary location; applying the validation rule in the reminder message data to determine whether a relationship between the primary location and the reference location satisfies the condition in the validation rule; displaying the reminder message when the condition is satisfied; and conducting a route guidance operation to reach a location selected by the user.

A navigation system is described in U.S. Patent Application Publication No. 2006/0129314 to Gi Ryoong entitled: “Navigation system”, which is incorporated in its entirety for all purposes as if fully set forth herein. The navigation system includes a path analyzer, a weight generator, an algorithm pre-processor, a genetic algorithm processor, and a path selector. The path analyzer combines a plurality of inputted intermediate point information to analyze movement path information, and the weigh generator generates weight information according to duration between the intermediated points. The algorithm pre-processor combines the intermediate point information to generate an initial solution group. The genetic algorithm processor generates a new candidate solution using a candidate solution contained in the initial solution group and replaces a candidate solution contained in the initial solution group by the new candidate solution depending on movement path information of the new candidate solution. The path selector selects a candidate solution having optimized movement path information from the candidate solutions contained in the solution group.

A navigation system and various methods of using the system are described in U.S. Pat. No. 9,043,148 to Bourque et al. entitled: “Navigation system and methods for generating enhanced search results”, which is incorporated in its entirety for all purposes as if fully set forth herein. Search query results are refined by the system and are prioritized based at least in part upon sub-search categories selected during the searching process. Sub-searches can be represented by graphical icons displayed on the user interface.

An example of a vehicle navigation system is Sync Navigation System by Ford Motor Company, described in April 2010, Second Printing, Owner's Guide Supplement (Document No. BA5J 19A285 AB) entitled: “2011 Centerstack (ng1) Supplement, 2nd Printing USA (fus)”, which is incorporated in its entirety for all purposes as if fully set forth herein. Another example of a vehicle navigation system is described in 2005 Pontiac Grand Prix Navigation Manual, published 2004 by General Motors Corporation [Part No. 10382568 A First Edition], which is incorporated in its entirety for all purposes as if fully set forth herein.

A system and method for searching and retrieving location information associated with one or more points of interests are described in U.S. Pat. No. 7,082,365 to Sheha et al. entitled: “Point of interest spatial rating search method and system”, which is incorporated in its entirety for all purposes as if fully set forth herein. The search criteria can be dependent upon the location of a point of interest with respect to the real-time position of the user, and any preferences or search restrictions selected by the user, such as rating information about the point of interest. Upon selecting a point of interest from the search result, the user is then given further information regarding the selected point of interest, including but not limited to directions for traveling to the point of interest. Additionally, preferred embodiments of the present invention can provide to the user a proximity notification once the user is within a certain distance from the point interest. Finally, while at a point of interest, the user can provide to the system information regarding the point of interest, such as rating of the food of a restaurant, without having to specifically identify the point of interest as the system can self-identify the point of interest by using the position information of the user.

A method for navigation is described in U.S. Pat. No. 9,726,510 to Peri et al. entitled: “Route optimization including points of interest”, which is incorporated in its entirety for all purposes as if fully set forth herein. The method includes receiving in a mobile computing device (24) a designation of an origin (32, 92) and a destination (34, 94) of an itinerary of a user of the device. An optimal primary route (96) is computed from the origin to the destination. Multiple points of interest (40, 98, 100) are identified in proximity to the optimal primary route. A respective first optimal sub-route (42) is computed between the origin and each of the points of interest, and a respective second optimal sub-route (44) is computed between the destination and each of the points of interest. One or more alternative routes (102, 104) from the origin to the destination via one or more of the points of interest are presented to the user on the mobile computing device, by combining the respective first and second optimal sub-routes computed for the one or more of the points of interest.

Method and device for calculating a navigation route is described in European Patent Office Patent Application Publication No. EP 2288872 A1 to Dayananda et al. entitled: “Method and device for calculating a navigation route to associated destinations”, which is incorporated in its entirety for all purposes as if fully set forth herein. The invention relates to a method for calculating a navigation route to associated destinations (points of interest POI), comprising the following steps: definition of at least one reference position; definition of a quantity of at least two destination categories of POIs, a first POI destination category being first selected and at least one second POI destination category being selected; determination of the POIs of the first and second destination categories in close proximity to the reference position and calculation of a route, which from a starting position leads at least to one POI of the first category and/or one POI of the second category, the determination and route calculation being determined in accordance with a pre-definable optimization criterion. The method is characterized in that the optimized POI determination and route calculation uses at least one item of information that is assigned to each POI of a destination category and that has been stored in advance, said information containing details of at least one POI of another destination category in close proximity. The invention also relates to a navigation device for carrying out the aforementioned method. Further, an optimization of the order of fix points on the map is described in a Google article published Mar. 10, 2010 and entitled: “A good day for salesmen that travel on bicycles”, which is incorporated in its entirety for all purposes as if fully set forth herein.

A method of selecting at least one trip from a plurality of possible trips, each of the plurality of possible trips being for travel from an origin location and comprising stops at a plurality of destinations, is described in U.S. Patent Application Publication No. 2011/0145025 to Jiang et al. entitled: “Multi-destination trip selection”, which is incorporated in its entirety for all purposes as if fully set forth herein. The method is performed in computer apparatus configured to execute the method. The method comprises: determining a fare for each of a plurality of different leg options for each leg, each leg being between one of: the origin location and a destination; and two destinations; selecting a plurality of candidate leg options for each leg based on comparative amounts of the determined fares, the plurality of candidate leg options being fewer in number than the plurality of different leg options; and determining at least one trip based on the plurality of candidate leg options for each leg.

TSP. The traveling salesman problem consists of a salesman and a set of cities. The salesman has to visit each one of the cities starting from a certain one (e.g., the hometown) and returning to the same city. The challenge of the problem is that the traveling salesman wants to minimize the total length of the trip. The Traveling Salesman Problem (TSP) can simply be stated as: if a traveling salesman wishes to visit exactly once each of a list of m cities (where the cost of traveling from city i to city j is cij) and then return to the home city, what is the least costly route the traveling salesman can take?. The TSP problem is a NP problem that is actually NP-Hard, and belongs in the class of such problems known as NP-complete. TSP is usually modeled using graphs. A graph is an ordered pair G=(V, E), where V is a set of vertices and E is a set of edges. Graphs can be drawn using points for vertices and lines for edges. In the case of TSP every city is a vertex and edges has weight which represents the length between two cities. For this problem all vertex are connected with each other, this is call a complete graph. Having this property guarantees that the circle exists (with Hamiltonian Cycle you have to find if the circle exists).

TSP can be modelled as an undirected weighted graph, such that cities are the graph's vertices, paths are the graph's edges, and a path's distance is the edge's weight. It is a minimization problem starting and finishing at a specified vertex after having visited each other vertex exactly once. Often, the model is a complete graph (i.e., each pair of vertices is connected by an edge). If no path exists between two cities, adding an arbitrarily long edge will complete the graph without affecting the optimal tour.

A TSP may be asymmetric or symmetric. In the symmetric TSP, the distance between two cities is the same in each opposite direction, forming an undirected graph. This symmetry halves the number of possible solutions. In the asymmetric TSP, paths may not exist in both directions or the distances might be different, forming a directed graph. Traffic collisions, one-way streets, and airfares for cities with different departure and arrival fees are examples of how this symmetry could break down.

One way to sole a TSP is by devising exact algorithms, which work reasonably fast only for small problem sizes. The most direct solution would be to try all permutations (ordered combinations) and see which one is cheapest (using brute force search). Other approach for solving TSP is using “suboptimal” or heuristic algorithms, i.e., algorithms that deliver either seemingly or probably good solutions, but which could not be proved to be optimal. Heuristics are algorithms which try to do the best possible to find the solution, but there is no guarantee that the solution found is the best. Another approach involves finding special cases for the problem (“subproblems”) for which either better or exact heuristics are possible. Various heuristics and approximation algorithms, which quickly yield good solutions have been devised. Modern methods can find solutions for extremely large problems (millions of cities) within a reasonable time which are with a high probability just 2-3% away from the optimal solution. Heuristics solutions may involve constructive heuristics, the nearest neighbour (NN) algorithm (a greedy algorithm) which lets the salesman choose the nearest unvisited city as his next move, and the Christofides' algorithm for the TSP that follows a similar outline but combines the minimum spanning tree with a solution of another problem, minimum-weight perfect matching, and the pairwise exchange or 2-opt technique that involves iteratively removing two edges and replacing these with two different edges that reconnect the fragments created by edge removal into a new and shorter tour.

An introduction to the Traveling Salesman Problem that includes current research is described in a paper entitled: “THE TRAVELING SALESMAN PROBLEM” by Corinne Brucato published 2013 by the University of Pittsburgh, which is incorporated in its entirety for all purposes as if fully set forth herein. Although a global solution for the Traveling Salesman Problem does not yet exist, there are algorithms for an existing local solution. There are also necessary and sufficient conditions to determine if a possible solution does exist when one is not given a complete graph. Additionally, the algorithms are used to and a route traveling through twenty US colleges. As well, we use the Geometric Algorithm to assign scouts for the Pittsburgh Pirates.

The Traveling Salesman Problem (TSP) has been an early proving ground for many approaches to combinatorial optimization, including classical local optimization techniques as well as many of the more recent variants on local optimization, such as simulated annealing, tabu search, neural networks, and genetic algorithms. A chapter entitled: “The Traveling Salesman Problem: A Case Study in Local Optimization” by David S. Johnson and Lyle A. McGeoch published Nov. 20, 1995, which is incorporated in its entirety for all purposes as if fully set forth herein, discusses how these various approaches have been adapted to the TSP and evaluates their relative success in this perhaps atypical domain from both a theoretical and an experimental point of view.

Solving a Traveling Salesman Problem (TSP) is described in U.S. Patent Application Publication No. 2003/0084011 to Shetty entitled: “Methods for solving the traveling salesman problem”, which is incorporated in its entirety for all purposes as if fully set forth herein. The TSP solving is by selecting a set of locations to visit, selecting a starting point and an ending point from the set of locations, applying a search method to the set of locations, and providing a route as a solution to the TSP, where the search method is a combinatoric approach to a genetic search and the search method simultaneously minimizes distance and time. The route starts and ends in different locations and completes in polynomial time, such as O(n+k), where k is a constant. The solution to the TSP has many applications, including finding distribution chains to satisfy customer demand for an Internet enterprise.

In consideration of the foregoing, it would be an advancement in the art to provide a method or a system for improving the convenience, the time saving, or planning such as route planning. Preferably, such methods or systems may be providing an improved, simple, adaptive, more convenient, automatic, secure, cost-effective, reliable, versatile, time-saving, easy to install, use or monitor, has a minimum part count, portable, handheld, enclosed in a small or portable housing or vehicular, minimum hardware, and/or using existing and available components, protocols, programs and applications, and providing a better user experience, for suggesting or recommending a multi-location route or satisfying a product or a service requirement.

### SUMMARY

Any method herein may optimize a route to multiple locations, and may be used with a products database that may associate each one of the multiple locations with multiple items (or attributes). Any method herein, may be used with, or may be performed partly or in full by, a device that may comprise an input component, an output component, or a location sensor. Any method herein may comprise receiving, from a user by the input component, identifiers of two or more items (or attributes); estimating, by the device, the current location of the device; identifying, by using the products database, for each of the identified items (or attributes), one or more locations that are associated with the identified item (or attribute); calculating multiple routes from the current location, where each route of calculated multiple routes may arrive at a set of locations selected from the identified locations, so that each of the identified items (or attributes) may correspond to at least one location in the set; associating a cost to each of the calculated multiple routes; selecting one of the calculated routes according to the respective associated cost; notifying, to the user by the output component, of the selected route; and guiding, the user by the output component in the device, to navigate according to the selected route. A non-transitory computer readable medium may be having computer executable instructions stored thereon, and any instructions herein may include part of, or all of, the steps of any method herein.

Any device herein may store the products database. The number of items (or attributes) identified by the user may be equal to, or more than, 2, 3, 4, 5, 8, 10, 12, 15, 20, 25, 30, 40, 50, 80, or 100 items (or attributes). Alternatively or in addition, the number of items (or attributes) identified by the user may be equal to, or less than, 3, 4, 5, 8, 10, 12, 15, 20, 25, 30, 40, 50, 80, 100, or 150 items (or attributes).

Any identifying herein of the one or more locations may comprise identifying, for each of the identified items (or attributes) by using the products database, all of the locations that may be associated with the identified item (or attribute) in the products database. Each at least one of the sets may include a respective single identified location for each one of the identified items (or attributes). Alternatively or in addition, each at least one of the sets may include a respective single identified location for two or more of the identified items (or attributes). Any calculating of multiple routes herein may comprise calculating the routes for all possible sets.

Any method herein may be performed partly or in full by the device. Alternatively or in addition, any identifying herein by using the products database may be performed by the device. Alternatively or in addition, any calculating herein of the multiple routes may be performed by the device. Alternatively or in addition, any associating herein of a cost to any of the calculated multiple routes may be performed by the device. Alternatively or in addition, any selecting herein of any one of the calculated routes may be performed by the device.

Any method herein may be used with an Internet-connected server, and any method herein may further comprise communicating, by the device over the Internet, with the server. Any method herein may further comprise sending, by the device to the server over the Internet, the identified items (or attributes) and the current location; and may further comprise receiving, by the server, the identified items (or attributes) and the current location. Any identifying herein of the one or more locations, any calculating herein of the multiple routes, any selecting herein of one of the calculated routes, or any combination thereof, may be performed by the server. Any method herein may further comprise sending, by the server to the device over the Internet, the selected calculated route, and any server herein may store the products database.

Any method herein may further comprise generating multiple non-ordered sets, and any set herein may comprise an identified location for each of the identified items (or attributes). The number of any identified items (or attributes) may be N, and for each item (or attribute) i (1≤i≤N) L(i) locations may be identified, and L(1)*L(2)* . . . L(N) sets may be generated. Any method herein may further comprise generating multiple ordered sets by generating all permutations of each of the generated non-ordered set, so that [L(1)*L(2)* . . . L(N)]*N! ordered sets may be generated.

Any calculating herein may comprise calculating a route for each of the generated ordered sets, and any method herein may be used with a destination location, and any routes herein may be calculated ending at the destination location. Any calculating herein, or any selecting of one of the calculated routes herein, may comprise solving a Travelling Salesman Problem (TSP) for the non-ordered sets. Further, any non-ordered set locations may replace the cities in the TSP, and any associated costs for each route segment may comprise estimated travel distance, estimated travel time, estimated fuel efficiency, or any combination thereof. Any TSP herein may be a symmetric or asymmetric TSP, and any TSP herein may be solved using an exact or a heuristic algorithm. Any method herein may be used with a destination location, and any of the multiple routes herein may be calculated to end at the destination location. Any method herein may further comprise receiving, from the user by the user component, the destination location, and the destination location may be the current location or may be different from the current location.

Any method herein may use, or may be used, with an opening hours database that may be associating a daily time interval for each of the plurality of locations. Any calculating herein of any multiple routes or any selecting herein of any of the calculated routes may be based on, or may use, the opening hours database.

Any calculating herein of any multiple routes may comprise calculating or estimating the arrival time to each of the identified locations of the respective set for each of the multiple routes. Further, any method herein may comprise comparing the arrival times to each of the identified locations with the time interval associated with the identified locations for each of the multiple routes, and may further comprise deleting any routes from the multiple routes, such as routes that the arrival time of at least one of the identified location of the route is not within the associated time interval, so that the deleted routes may not be selectable as part of the selecting of one of the calculated routes. Any method herein may comprise calculating or estimating the arrival time to each of the identified locations for the selected one of the calculated routes, and may further comprise comparing the arrival times to each of the identified locations with the time interval associated with the identified locations for the selected one of the calculated routes. Any method herein may further comprise selecting another one of the calculated routes if the arrival time at least one of the identified location of the route is not within the associated time interval, and the notifying and the guiding may use the another selected route. Any device herein may store the opening-hours database.

Any method herein may be used with an Internet-connected server that stores, or is connected to, the opening-hours database, and may comprise communicating, by the device, over the Internet with the server, for using or accessing the opening hours database. Any communicating with the server herein may be via a wireless network using a wireless transceiver and an antenna in the device, and any method herein may comprise sending, via the wireless network to the server, part of, or all of, the identified locations. Any identifying herein of the multiple locations may be performed by the server, and any method herein may further comprise sensing, by the server, the multiple location to the device.

Any products database herein may comprise at least 5, 10, 50, 100, 200, 500, 1,000, 2,000, 5,000, 10,000, 20,000, 50,000, 100,000, 200,000, 500,000, 1,000,000, 2,000,000, 5,000,000, 10,000,000, 20,000,000, 50,000,000, or 100,000,000 distinct locations, and at least one of the multiple locations in the products database may be associated with at least 5, 10, 20, 50, 100, 200, 500, 1,000, 2,000, 5,000, 10,000, 20,000, 50,000, or 100,000 items. Most of, or all of, the multiple locations in the products database may be associated with at least 5, 10, 20, 50, 100, 200, 500, 1,000, 2,000, 5,000, 10,000, 20,000, 50,000, or 100,000 items. Any products database herein may further comprise a name or another identifier associated with each of the multiple locations that may uniquely identify the location, and any notifying herein to the user may comprise notifying of the names associated with the identified locations in the selected calculated route. Each of the multiple locations in the products database may be a store, and any associated items may be tangible products sold in the respective store. Alternatively or in addition, at least one of the multiple locations may correspond with a supermarket, a convenience store, a grocery store, or a superstore. Any items herein may comprise groceries, household goods, or consumer products, or may comprise Convenience goods, Shopping goods, Specialty goods, or Unsought goods. Each of the multiple locations in the database may be a location or an establishment that may provide a service, and any the respective items may comprise services.

Any method herein may be used with an Internet-connected server that stores a database and communicates with the device. Any database herein may comprise the products database, an opening-hours database, or a maps database, and any device herein may use the database. Any server herein may be storing, operating, or using, a server operating system, which may consist of, may comprise, or may be based on, one out of Microsoft Windows Server®, Linux, or UNIX, or may consist of, may comprise, or may be based on, one out of Microsoft Windows Server® 2003 R2, 2008, 2008 R2, 2012, or 2012 R2 variant, Linux™ or GNU/Linux-based Debian GNU/Linux, Debian GNU/kFreeBSD, Debian GNU/Hurd, Fedora™, Gentoo™, Linspire™, Mandriva, Red Hat® Linux, SuSE, and Ubuntu®, UNIX® variant Solaris™, AIX®, Mac™ OS X, FreeBSD®, OpenBSD, and NetBSD®.

Any selecting herein, such as of one of the identified locations, may be based on a minimum or maximum cost, and any cost herein may be based on, or may use, estimated travel distance, estimated travel time, estimated fuel efficiency, or any combination thereof. Any part of, or all of, the multiple locations herein, may comprise a geographical location that may be defined by a latitude and a longitude, or by a country, a region or state, a city, a street, an apartment number, or a building number. Any method herein may be used with a maps database that may comprise digital maps, and any calculating herein, such as of the multiple routes, may use, or may be based on, the maps database. Any guiding herein, such as of the user, may use, or may be based on, the maps database, and any maps database herein may be based on, may uses, may be according to, or may be compatible with, the Navigation Data Standard (NDS).

Any method herein may further comprise detecting an event, and may in response to the detecting of the event estimating, by the device, the updated location of the device; calculating an updated route using the locations of the set of the selected set; notifying, to the user by the output component, of the updated selected route; and guiding, the user by the output component in the device, to navigate according to the updated route. Any method herein may further comprise, in response to the detecting of the event, repeating all of, or part of, the steps of the method. Any event herein may further comprise receiving, from a user by the input component, a command. Any method herein may be used with a wireless network using a wireless transceiver and an antenna in the device, and any event herein may comprise receiving, from the wireless network, an information, and the information may be associated with the calculated optimal route.

Any information herein may be associated with travelling information along the calculated optimal route. Any method herein may further comprise estimating, such as by the device, the updated location of the device; and comparing the calculated distance to a minimum threshold distance, and any event herein may comprise the determining that the calculated distance is longer than the minimum threshold distance. Any minimum threshold distance herein may be more than 1 meter, 2 meters, 5 meters, 10 meters, 20 meters, 50 meters, 100 meters, 200 meters, 500 meters, 1 Kilometer (Km), 2 Km, 5 Km, 10 Km, 20 Km, 50 Km, or 100 Km, or any minimum threshold distance herein may be less than 2 meters, 5 meters, 10 meters, 20 meters, 50 meters, 100 meters, 200 meters, 500 meters, 1 Km, 2 Km, 5 Km, 10 Km, 20 Km, 50 Km, 100 Km, or 200 Km. Alternatively or in addition, any event herein may comprise lapsing of a time period, or may comprises repeating after a time period from a former event. Any event herein may be repeated using a time period that may be longer than 10 seconds, 20 seconds, 30 seconds, 1 minute, 2 minutes, 5 minutes, 10 minutes, 20 minutes, 30 minutes, 1 hour, 2 hours, 5 hours, or 10 hours, or using a time period that may be shorter than 20 seconds, 30 seconds, 1 minute, 2 minutes, 5 minutes, 10 minutes, 20 minutes, 30 minutes, 1 hour, 2 hours, 5 hours, 10 hours, or 20 hours.

Any method herein may use, or may be used, with a virtualization, and at least one of the steps herein may be executed as part of a virtualized application as part of a Virtual Machine (VM). Any device herein (such as a client device) or any part thereof, any server herein or any part thereof, may be implemented as virtual hardware. Any method herein may be used with an host computer that implements the VM, and any method herein may further comprise executing, by the host computer, a hypervisor or a Virtual Machine Monitor (VMM), and any virtualized application or hardware herein may use or interface virtual hardware. Any virtualization herein may include, may be based on, or may use, full virtualization, para-virtualization, or hardware assisted virtualization, and any device or server herein may be implemented as virtual hardware.

Any method herein may comprise storing, operating, or using, an operating system, and any operating system herein may be implemented as part of any device. Any method herein may be used with a virtualization, and any operating system herein may be executed as a guest operating system as part of a Virtual Machine (VM). Further, any method herein may be used with a host computer that may implement the VM, and may further comprise executing, by the host computer, a hypervisor or a Virtual Machine Monitor (VMM), and any guest operating system herein may use or may interface virtual hardware. Any virtualization herein may include, may be based on, or may use, full virtualization, para-virtualization, or hardware assisted virtualization.

Any method herein may comprise communicating, such as by the device, with an Internet-connected server. Any server herein may comprise a database, and any method herein may further comprise communicating with the server for using or accessing the database. Any communicating herein with the server may be via a wireless network that may use a wireless transceiver and an antenna in the device. Any method herein may further comprise sending, via the wireless network to the server, the identified items (or attributes) or the estimated current location of the device.

Any wireless network herein may comprise a Wireless Wide Area Network (WWAN), any wireless transceiver herein may comprise a WWAN transceiver, and any antenna herein may comprise a WWAN antenna, and any WWAN herein may be a wireless broadband network. Further, any WWAN herein may be a WiMAX network, any antenna herein may be a WiMAX antenna and any wireless transceiver herein may be a WiMAX modem, and any WiMAX network herein may be according to, may be compatible with, or may be based on, IEEE 802.16-2009. Alternatively or in addition, any WWAN herein may be a cellular telephone network, any antenna herein may be a cellular antenna, and any wireless transceiver herein may be a cellular modem. Any cellular telephone network herein may be a Third Generation (3G) network that may use a protocol selected from the group consisting of UMTS W-CDMA, UMTS HSPA, UMTS TDD, CDMA2000 1×RTT, CDMA2000 EV-DO, and GSM EDGE-Evolution, or any cellular telephone network herein may use a protocol selected from the group consisting of a Fourth Generation (4G) network that uses HSPA+, Mobile WiMAX, LTE, LTE-Advanced, MBWA, or is based on IEEE 802.20-2008.

Alternatively or in addition, any wireless network herein may comprise a Wireless Personal Area Network (WPAN), any wireless transceiver herein may comprise a WPAN transceiver, and any antenna herein may comprise a WPAN antenna. Any WPAN herein may be according to, may be compatible with, or may be based on, Bluetooth™, Bluetooth Low Energy (BLE), or IEEE 802.15.1-2005 standards, or any WPAN herein may be a wireless control network that may be according to, or based on, Zigbee™, IEEE 802.15.4-2003, or Z-Wave™ standards.

Alternatively or in addition, any wireless network herein may comprise a Wireless Local Area Network (WLAN), any wireless transceiver herein may comprise a WLAN transceiver, and any antenna herein may comprise a WLAN antenna. Any WLAN herein may be according to, may be compatible with, or may be based on, a standard selected from the group consisting of IEEE 802.11-2012, IEEE 802.11a, IEEE 802.11b, IEEE 802.11g, IEEE 802.11n, and IEEE 802.11ac. Any wireless network herein may be over a licensed or unlicensed radio frequency band. Any wireless network may be over the unlicensed radio frequency band that may be an Industrial, Scientific and Medical (ISM) radio band.

Alternatively or in addition, any wireless network herein may comprise a Dedicated Short-Range Communication (DSRC) that may be according to, may be compatible with, or may be based on, European Committee for Standardization (CEN) EN 12253:2004, EN 12795:2002, EN 12834:2002, EN 13372:2004, or EN ISO 14906:2004 standard. Any DSRC herein may be according to, compatible with, or based on, IEEE 802.11p, IEEE 1609.1-2006, IEEE 1609.2, IEEE 1609.3, IEEE 1609.4, or IEEE1609.5.

Any method herein may use, or may be used with, a virtualization, and any communication herein, such as between the device and the server, may be executed as a virtualized network as part of a Virtual Machine (VM). Any method herein may use, or may be used with, a host computer that may implement the VM, and any method herein may further comprise executing, by the host computer, a hypervisor or a Virtual Machine Monitor (VMM), and any virtualized network herein may use or may interface virtual hardware, and the virtualization may include, may be based on, or may use, full virtualization, para-virtualization, or hardware assisted virtualization.

Any method herein may be used with a location sensor in the device, and any estimating herein of any current geographical location may use the location sensor. Any method herein may be used with multiple RF signals transmitted by multiple sources, and any current location may be estimated by receiving the RF signals from the multiple sources via one or more antennas, and processing or comparing the received RF signals. Any multiple sources herein may comprise satellites that may be part of Global Navigation Satellite System (GNSS), and the GNSS may be the Global Positioning System (GPS), and any location sensor herein may comprise a GPS antenna coupled to a GPS receiver for receiving and analyzing the GPS signals. Alternatively or in addition, any GNSS may be the GLONASS (GLObal NAvigation Satellite System), the Beidou-1, the Beidou-2, the Galileo, or the IRNSS/VAVIC.

Any location estimation, calculating, processing, or comparing herein may comprise, or may be based on, performing TOA (Time-Of-Arrival) measurement, performing TDOA (Time Difference-Of-Arrival) measurement, performing an AoA (Angle-Of-Arrival) measurement, performing a Line-of-Sight (LoS) measurement, performing a Time-of-Flight (ToF) measurement, performing a Two-Way Ranging (TWR) measurement, performing a Symmetrical Double Sided—Two Way Ranging (SDS-TWR) measurement, performing a Near-field electromagnetic ranging (NFER) measurement, or performing triangulation, trilateration, or multilateration (MLAT).

Any RF signals herein may be part of the communication over a wireless network. And the wireless network may be a cellular telephone network, and the sources may be cellular towers or base-stations. Alternatively or in addition, the wireless network may be a WLAN, and the sources may be hotspots or Wireless Access Points (WAPs). Any geographical location herein may be estimated using, or based on, geolocation, and any geolocation may be based on W3C Geolocation Application Programming Interface (API). Any geographical location herein may consist of, or may comprise, at least one of a country, a region, a city, a street, a ZIP code, a latitude, and a longitude.

Any method herein may be used with an automotive navigation system in a vehicle, and any device herein may be part of, or may comprise, automotive navigation system and is installable, or mountable, in a vehicle, and any user herein may be a driver, operator, or a passenger, in the vehicle. Any device herein may be mounted onto, may be attached to, may be part of, or may be integrated in, the vehicle. Any vehicle herein may be a ground vehicle adapted to travel on land, and may be selected from the group consisting of a bicycle, a car, a motorcycle, a train, an electric scooter, a subway, a train, a trolleybus, and a tram. Further, any ground vehicle herein may consist of, or may comprise, an autonomous car. Any autonomous car herein may be according to levels 0, 1, or 2 of the Society of Automotive Engineers (SAE) J3016 standard, or may be according to levels 3, 4, or 5 of the Society of Automotive Engineers (SAE) J3016 standard.

Any vehicle herein may be a buoyant or submerged watercraft adapted to travel on or in water, and any watercraft herein may be selected from the group consisting of a ship, a boat, a hovercraft, a sailboat, a yacht, and a submarine. Alternatively or in addition, any vehicle herein may be an aircraft adapted to fly in air, and any aircraft herein may be a fixed wing or a rotorcraft aircraft, and may be selected from the group consisting of an airplane, a spacecraft, a glider, a drone, or an Unmanned Aerial Vehicle (UAV).

Any device herein may be housed in a single enclosure that may be a hand-held enclosure or a portable enclosure, or the single enclosure may be a surface mountable enclosure. Alternatively or in addition, any device herein may be further integrated with at least one of a wireless device, a notebook computer, a laptop computer, a media player, a Digital Still Camera (DSC), a Digital video Camera (DVC or digital camcorder), a Personal Digital Assistant (PDA), a cellular telephone, a digital camera, a video recorder, or a smartphone. Further, any device herein may be integrated with a smartphone that may comprise, or may be based on, an Apple iPhone 6 or a Samsung Galaxy S6. Any method herein may further comprise operating of an operating system that may be a mobile operating system. Any mobile operating system herein may comprise Android version 2.2 (Froyo), Android version 2.3 (Gingerbread), Android version 4.0 (Ice Cream Sandwich), Android Version 4.2 (Jelly Bean), Android version 4.4 (KitKat)), Apple iOS version 3, Apple iOS version 4, Apple iOS version 5, Apple iOS version 6, Apple iOS version 7, Microsoft Windows® Phone version 7, Microsoft Windows® Phone version 8, Microsoft Windows® Phone version 9, or Blackberry® operating system. Any operating system herein may be a Real-Time Operating System (RTOS), such as FreeRTOS, SafeRTOS, QNX, VxWorks, or Micro-Controller Operating Systems (μC/OS).

Any device herein may be wearable on a person, such as on an organ of the person head, and the organ may be an eye, ear, face, cheek, nose, mouth, lip, forehead, or chin. Any device herein may include an enclosure that may be constructed to have a form substantially similar to, may be constructed to have a shape allowing mounting or wearing identical or similar to, or may be constructed to have a form to at least in part substitute for, headwear, eyewear, or earpiece.

Any headwear herein may consist of, may be structured as, or may comprise, a bonnet, a cap, a crown, a fillet, a hair cover, a hat, a helmet, a hood, a mask, a turban, a veil, or a wig. Any eyewear herein may consist of, may be structured as, or may comprise, glasses, sunglasses, a contact lens, a blindfold, or a goggle. Any earpiece herein may consist of, may be structured as, or may comprise, a hearing aid, a headphone, a headset, or an earplug. Any enclosure herein may be permanently or releasably attachable to, or is part of, a clothing piece of a person, and any attaching herein may use taping, gluing, pinning, enclosing, encapsulating, a pin, or a latch and hook clip. Any clothing piece herein may be a top, bottom, or full-body underwear, or a headwear, a footwear, an accessory, an outwear, a suit, a dress, a skirt, or a top. Any device herein may comprise an annular member defining an aperture therethrough that is sized for receipt therein of a part of a human body. Any human body part herein may be part of a human hand that may consist of, or may comprise, an upper arm, elbow, forearm, wrist, or a finger. Alternatively or in addition, any human body part herein may be part of a human head or neck that may consist of, or may comprise, a forehead, ear, skull, or face. Alternatively or in addition, any human body part herein may be a part of a human thorax or abdomen that may consist of, or may comprise, a waist or hip. Alternatively or in addition, any human body part herein may be part of a human leg or foot that may consist of, or may comprise, a thigh, calf, ankle, instep, knee, or toe.

A method for route planning and guidance to multiple locations may be used with a device that may comprise an input component, an output component, and a location sensor. The method may comprise receiving, from a user by the input component, N multiple locations; estimating the device current location by the device; generating N! sets, where each set comprises a distinct sequence of the N multiple locations; for each set, calculating, the optimal route from the current location sequentially to all the N locations in the set; selecting one of the sets; notifying the selected set to the user by the output component; and guiding by the device, to navigate according to the selected set by the output component. The generating of the N! sets, the calculating for each set of the optimal route, or the selecting of one of the sets, may be performed by the device. The number of locations N may be N=2, N=3, N=4, N=5, or N=6, or may be higher than 6. A non-transitory computer readable medium may comprise computer executable instructions stored thereon, and the instructions may include one or more of the steps the method.

The selecting of one of the sets may be based on a minimum value of a metric or a criterion, and the metric or criterion may be based on, or may use, estimated travel distance, estimated travel time, estimated fuel efficiency, or any combination thereof. The optimal route for each set may be calculated based on a minimum value of a metric or a criterion, and the metric or criterion may be based on, or may use, estimated travel distance, estimated travel time, estimated fuel efficiency, or any combination thereof. Each of the multiple locations may be a geographical location that may be defined by a latitude and a longitude, or by a country, a region or state, a city, a street, and a building number. The calculating of the optimal route for each set may further comprise the route from the last location in the set to the current location. The selecting of one of the sets may be by the user using the input component in the device. The guiding by the device may be guiding the user using the output component.

The method may be used with a maps database that may comprise digital maps, and the receiving from the user by the input component of the N multiple locations may use, or may be based on, the maps database. Alternatively or in addition, the calculating of the optimal route for each set from the current location sequentially to all the N locations in the set may use, or may be based on, the maps database. Alternatively or in addition, the guiding by the device to navigate according to the selected set by the output component may use, or may be based on, the maps database. Alternatively or in addition, the maps database may be based on, may use, may be according to, or may be compatible with, the Navigation Data Standard (NDS).

The method may be used with an Internet-connected server that may store, or may be connected to, a maps database that comprises digital maps, and the method may further comprise communicating, by the device, over the Internet with the server for accessing the map database, where the communicating with the server may be via a wireless network using a wireless transceiver and an antenna in the device. The method may further comprise sending, via the wireless network to the server, the received N multiple points, sending, or the estimated current location of the device, via the wireless network to the server. The generating of the N! sets, the calculating for each set of the optimal route, or the selecting of one of the sets, may be performed by the server. Further, the method may further comprise receiving, by the device via the wireless network from the server, the selected set.

A method may be used for route planning to an optimal location associated with an item (or attribute), and may be used with a database associating each one of multiple locations with multiple items (or attributes). The method may further by used with a device that comprises an input component, an output component, and a location sensor. The method may comprise receiving, from a user by the input component, an identification of an item (or attribute); estimating the device current location by the device; identifying, by using the database, at least one location out of the multiple locations that is associated with the item (or attribute); calculating, an optimal route from the current location to each of the identified locations; selecting one of the identified locations in response to the calculated optimal routes; notifying, the route associated with the selected one of the identified locations to the user by the output component; and guiding, by the output component in the device, the user to navigate according to the optimal route to the selected one of the identified locations. A single location may be identified as part of the identifying of the at least one location, and the calculating may consist of calculating of an optimal route from the current location to the identified single location, and the selecting may consist of selecting the identified single location.

The database may comprise at least 5, 10, 50, 100, 200, 500, 1,000, 2,000, 5,000, 10,000, 20,000, 50,000, 100,000, 200,000, 500,000, 1,000,000, 2,000,000, 5,000,000, 10,000,000, 20,000,000, 50,000,000, or 100,000,000 distinct locations. Further, one of, most of, or all of, the multiple location in the database may be associated with at least 5, 10, 20, 50, 100, 200, 500, 1,000, 2,000, 5,000, 10,000, 20,000, 50,000, or 100,000 items. Each of the multiple locations in the database may be a store, and the associated items may be tangible products sold in the respective store. The at least one of the multiple locations may correspond with a supermarket, a convenience store, a grocery store, or a superstore, and the items may comprise groceries, household goods, consumer products, Convenience goods, Shopping goods, Specialty goods, or Unsought goods. Alternatively or in addition, each of the multiple locations in the database may be a store that provides a service, and the items may comprise services or attributes.

The identifying of the at least one location out of the multiple locations that is associated with the item (or attribute) may be performed by the device or by a server. The calculating of an optimal route from the current location to each of the identified locations may be performed by the device or by a server. The selecting of one of the identified locations in response to the calculated optimal routes may be performed by the device or by a server. The database may comprise a name associated with each of the multiple locations that uniquely identifies the location, and the identifying of the at least one location out of the multiple locations may comprise notifying the user of the names associated with the identified locations. Further, the selecting of one of the identified locations may comprise notifying the user of the name associated with the selected location.

The method may be used with an Internet-connected server that stores, or is connected to, the database. The method may further comprise communicating, by the device, over the Internet with the server for using or accessing the database, and the communicating with the server may be via a wireless network using a wireless transceiver and an antenna in the device.

The method may further comprise sending, via the wireless network to the server, the received item (or attribute) identification, or sending, via the wireless network to the server, the estimated current location of the device. The identifying of the at least one location out of the multiple locations that is associated with the item (or attribute) may be performed by the server. Alternatively or in addition, the calculating of an optimal route from the current location to each of the identified locations may be performed by the server. Further, the selecting of one of the identified locations in response to the calculated optimal routes may be performed by the server.

Any server herein may be storing, operating, or using, a server operating system, that may consist of, may comprise, or may be based on, one out of Microsoft Windows Server®, Linux, or UNIX. Alternatively or in addition, the server operating system may consist of, may comprise, or may be based on, one out of Microsoft Windows Server® 2003 R2, 2008, 2008 R2, 2012, or 2012 R2 variant, Linux™ or GNU/Linux-based Debian GNU/Linux, Debian GNU/kFreeBSD, Debian GNU/Hurd, Fedora™, Gentoo™, Linspire™, Mandriva, Red Hat® Linux, SuSE, and Ubuntu®, UNIX® variant Solaris™, AIX®, Mac™ OS X, FreeBSD®, OpenBSD, and NetBSD®.

Any wireless network herein may comprise a Wireless Wide Area Network (WWAN), any wireless transceiver herein may comprise a WWAN transceiver, and any antenna herein may comprise an WWAN antenna. Any WWAN herein may be a wireless broadband network. The WWAN may be a WiMAX network, the antenna may be a WiMAX antenna and the wireless transceiver may be a WiMAX modem, and the WiMAX network may be according to, compatible with, or based on, IEEE 802.16-2009. Alternatively or in addition, the WWAN may be a cellular telephone network, the antenna may be a cellular antenna, and the wireless transceiver may be a cellular modem, where the cellular telephone network may be a Third Generation (3G) network that may use a protocol selected from the group consisting of UMTS W-CDMA, UMTS HSPA, UMTS TDD, CDMA2000 1×RTT, CDMA2000 EV-DO, and GSM EDGE-Evolution, or the cellular telephone network may use a protocol selected from the group consisting of a Fourth Generation (4G) network that use HSPA+, Mobile WiMAX, LTE, LTE-Advanced, MBWA, or may be based on IEEE 802.20-2008.

Any wireless network herein may comprise a Wireless Personal Area Network (WPAN), the wireless transceiver may comprise a WPAN transceiver, and the antenna may comprise an WPAN antenna. The WPAN may be according to, compatible with, or based on, Bluetooth™, Bluetooth Low Energy (BLE), or IEEE 802.15.1-2005 standards, or the WPAN may be a wireless control network that may be according to, or may be based on, Zigbee™, IEEE 802.15.4-2003, or Z-Wave™ standards. Any wireless network herein may comprise a Wireless Local Area Network (WLAN), \ the wireless transceiver may comprise a WLAN transceiver, and the antenna may comprise an WLAN antenna. The WLAN may be according to, may be compatible with, or may be based on, a standard selected from the group consisting of IEEE 802.11-2012, IEEE 802.11a, IEEE 802.11b, IEEE 802.11g, IEEE 802.11n, and IEEE 802.11ac. Any wireless network herein may be over a licensed or unlicensed radio frequency band that may be an Industrial, Scientific and Medical (ISM) radio band.

Any wireless network herein may be using, or may be based on, Dedicated Short-Range Communication (DSRC) that may be according to, may be compatible with, or may be based on, European Committee for Standardization (CEN) EN 12253:2004, EN 12795:2002, EN 12834:2002, EN 13372:2004, or EN ISO 14906:2004 standard. Alternatively or in addition, the DSRC may be according to, may be compatible with, or may be based on, IEEE 802.11p, IEEE 1609.1-2006, IEEE 1609.2, IEEE 1609.3, IEEE 1609.4, or IEEE1609.5.

Any device herein may be wearable on a person, such as being wearable on an organ of the person head, and the organ may be an eye, ear, face, cheek, nose, mouth, lip, forehead, or chin. Alternatively or in addition, any device or apparatus herein may be enclosed in an enclosure that may be constructed to have a form substantially similar to, may be constructed to have a shape allowing mounting or wearing identical or similar to, or may be constructed to have a form to at least in part substitute for, headwear, eyewear, or earpiece. The headwear may consists of, may be structured as, or may comprise, a bonnet, a cap, a crown, a fillet, a hair cover, a hat, a helmet, a hood, a mask, a turban, a veil, or a wig. The eyewear may consist of, may be structured as, or may comprise, glasses, sunglasses, a contact lens, a blindfold, or a goggle. The earpiece may consist of, may be structured as, or may comprise, a hearing aid, a headphone, a headset, or an earplug. Alternatively or in addition, any device or apparatus herein may be enclosed in an enclosure that may be permanently or may be releasably attachable to, or may be part of, a clothing piece of a person, and the attaching may use taping, gluing, pinning, enclosing, encapsulating, a pin, or a latch and hook clip. Further, the clothing piece may be a top, bottom, or full-body underwear, or a headwear, a footwear, an accessory, an outwear, a suit, a dress, a skirt, or a top.

Alternatively or in addition, any device or apparatus herein may be enclosed in an enclosure that may comprise an annular member defining an aperture therethrough that may be sized for receipt therein of a part of a human body, that may be part of a human hand that may consist of, or may comprise, an upper arm, elbow, forearm, wrist, or a finger. Alternatively or in addition, the human body part may be part of a human head or neck that may consist of, or may comprise, a forehead, ear, skull, or face. Alternatively or in addition, the human body part may be part of a human thorax or abdomen that may consist of, or may comprise, a waist or hip. Alternatively or in addition, the human body part may be part of a human leg or foot that may consist of, or may comprise, a thigh, calf, ankle, instep, knee, or toe.

Any vehicle, apparatus, or device herein may be operative for estimating its geographical location. Such localization may be used with multiple RF signals transmitted by multiple sources, and the geographical location may be estimated by receiving the RF signals from the multiple sources via one or more antennas, and processing or comparing the received RF signals. The multiple sources may comprise satellites, that may be Global Positioning System (GPS), and the RF signals may be received using a GPS antenna coupled to a GPS receiver for receiving and analyzing the GPS signals. Alternatively or in addition, the multiple sources may comprise satellites that may be part of any Global Navigation Satellite System (GNSS), such as the GLONASS (GLObal NAvigation Satellite System), the Beidou-1, the Beidou-2, the Galileo, or the IRNSS/VAVIC.

Alternatively or in addition, the processing or comparing may comprise, or may be based on, performing TOA (Time-Of-Arrival) measurement, performing TDOA (Time Difference-Of-Arrival) measurement, performing an AoA (Angle-Of-Arrival) measurement, performing a Line-of-Sight (LoS) measurement, performing a Time-of-Flight (ToF) measurement, performing a Two-Way Ranging (TWR) measurement, performing a Symmetrical Double Sided—Two Way Ranging (SDS-TWR) measurement, performing a Near-field electromagnetic ranging (NFER) measurement, or performing triangulation, trilateration, or multilateration (MLAT). Alternatively or in addition, the RF signals may be part of the communication over a wireless network in which the vehicle, apparatus, or device may be communicating over. The wireless network may be a cellular telephone network, and the sources may be cellular towers or base-stations. Alternatively or in addition, the wireless network may be a WLAN, and the sources may be hotspots or Wireless Access Points (WAPs). Alternatively or in addition, the geographical location may be estimated using, or based on, geolocation, which may be may be based on W3C Geolocation API. Any geographical location herein may consist of, or may comprise, a country, a region, a city, a street, a ZIP code, latitude, or longitude.

Any vehicle herein may be a ground vehicle adapted to travel on land, such as a bicycle, a car, a motorcycle, a train, an electric scooter, a subway, a train, a trolleybus, or a tram. Alternatively or in addition, the vehicle may be a buoyant or submerged watercraft adapted to travel on or in water, and the watercraft may be a ship, a boat, a hovercraft, a sailboat, a yacht, or a submarine. Alternatively or in addition, the vehicle may be an aircraft adapted to fly in air, and the aircraft may be a fixed wing or a rotorcraft aircraft, such as an airplane, a spacecraft, a glider, a drone, or an Unmanned Aerial Vehicle (UAV). Any vehicle herein may be a ground vehicle that may consist of, or may comprise, an autonomous car, which may be according to levels 0, 1, 2, 3, 4, or 5 of the Society of Automotive Engineers (SAE) J3016 standard.

Any apparatus, device, sensor, or actuator herein, or any part thereof, may be mounted onto, may be attached to, may be part of, or may be integrated with, a rear or front view camera, chassis, lighting system, headlamp, door, car glass, windscreen, side or rear window, glass panel roof, hood, bumper, cowling, dashboard, fender, quarter panel, rocker, or a spoiler of a vehicle. Any vehicle herein may further comprise an Advanced Driver Assistance Systems (ADAS) functionality, system, or scheme, and any apparatus, device, sensor, or actuator herein may be part of, may be integrated with, may be communicating with, or may be coupled to, the ADAS functionality, system, or scheme. The ADAS functionality, system, or scheme may consist of, may comprise, or may use, Adaptive Cruise Control (ACC), Adaptive High Beam, Glare-free high beam and pixel light, Adaptive light control such as swiveling curve lights, Automatic parking, Automotive navigation system with typically GPS and TMC for providing up-to-date traffic information, Automotive night vision, Automatic Emergency Braking (AEB), Backup assist, Blind Spot Monitoring (BSM), Blind Spot Warning (BSW), Brake light or traffic signal recognition, Collision avoidance system, Pre-crash system, Collision Imminent Braking (CIB), Cooperative Adaptive Cruise Control (CACC), Crosswind stabilization, Driver drowsiness detection, Driver Monitoring Systems (DMS), Do-Not-Pass Warning (DNPW), Electric vehicle warning sounds used in hybrids and plug-in electric vehicles, Emergency driver assistant, Emergency Electronic Brake Light (EEBL), Forward Collision Warning (FCW), Heads-Up Display (HUD), Intersection assistant, Hill descent control, Intelligent speed adaptation or Intelligent Speed Advice (ISA), Intelligent Speed Adaptation (ISA), Intersection Movement Assist (IMA), Lane Keeping Assist (LKA), Lane Departure Warning (LDW) (a.k.a. Line Change Warning—LCW), Lane change assistance, Left Turn Assist (LTA), Night Vision System (NVS), Parking Assistance (PA), Pedestrian Detection System (PDS), Pedestrian protection system, Pedestrian Detection (PED), Road Sign Recognition (RSR), Surround View Cameras (SVC), Traffic sign recognition, Traffic jam assist, Turning assistant, Vehicular communication systems, Autonomous Emergency Braking (AEB), Adaptive Front Lights (AFL), or Wrong-way driving warning.

Any vehicle herein may further employ an Advanced Driver Assistance System Interface Specification (ADASIS) functionality, system, or scheme, and any sensor or actuator herein may be part of, integrated with, communicates with, or coupled to, the ADASIS functionality, system, or scheme. Further, any message herein may comprise a map data relating to the location of a respective vehicle.

Any single enclosure herein may be a hand-held enclosure or a portable enclosure, or may be a surface mountable enclosure. Any device or apparatus herein may further be integrated with at least one of a wireless device, a notebook computer, a laptop computer, a media player, a Digital Still Camera (DSC), a Digital video Camera (DVC or digital camcorder), a Personal Digital Assistant (PDA), a cellular telephone, a digital camera, a video recorder, a smartphone, or any combination thereof. The smartphone may consist of, comprise, or may be based on, Apple iPhone 6 or Samsung Galaxy S6.

Any software or firmware herein may comprise an operating system that may be a mobile operating system. The mobile operating system may consist of, may comprise, may be according to, or may be based on, Android version 2.2 (Froyo), Android version 2.3 (Gingerbread), Android version 4.0 (Ice Cream Sandwich), Android Version 4.2 (Jelly Bean), Android version 4.4 (KitKat)), Apple iOS version 3, Apple iOS version 4, Apple iOS version 5, Apple iOS version 6, Apple iOS version 7, Microsoft Windows® Phone version 7, Microsoft Windows® Phone version 8, Microsoft Windows® Phone version 9, or Blackberry® operating system. Any Operating System (OS) herein, such as any server or client operating system, may consists of, include, or be based on a real-time operating system (RTOS), such as FreeRTOS, SafeRTOS, QNX, VxWorks, or Micro-Controller Operating Systems (μC/OS).

Any apparatus or device herein may be operative to connected to, coupled to, communicating with, an automotive electronics in a vehicle, or may be part of, or may be integrated with, an automotive electronics in a vehicle. The first vehicle may comprise an Electronic Control Unit (ECU) that may comprise, or may connect to, the sensor. Alternatively or in addition, the second vehicle may comprise an Electronic Control Unit (ECU) that may comprise, or may connect to, the actuator.

An Electronic Control Unit (ECU) may comprise, or may be part of, any apparatus or device herein. Alternatively or in addition, any apparatus or device herein may consist of, may be part of, may be integrated with, may be connectable to, or may be coupleable to, an Electronic Control Unit (ECU) in the vehicle. Any Electronic Control Unit (ECU) herein may be Electronic/engine Control Module (ECM), Engine Control Unit (ECU), Powertrain Control Module (PCM), Transmission Control Module (TCM), Brake Control Module (BCM or EBCM), Central Control Module (CCM), Central Timing Module (CTM), General Electronic Module (GEM), Body Control Module (BCM), Suspension Control Module (SCM), Door Control Unit (DCU), Electric Power Steering Control Unit (PSCU), Seat Control Unit, Speed Control Unit (SCU), Telematic Control Unit (TCU), Transmission Control Unit (TCU), Brake Control Module (BCM; ABS or ESC), Battery management system, control unit, or a control module. Alternatively or in addition, the Electronic Control Unit (ECU) may comprise, may use, may be based on, or may execute a software, an operating-system, or a middleware, that may comprise, may be based on, may be according to, or may use, OSEK/VDX, International Organization for Standardization (ISO) 17356-1, ISO 17356-2, ISO 17356-3, ISO 17356-4, ISO 17356-5, or AUTOSAR standard. Any software herein may comprise, may use, or may be based on, an operating-system or a middleware, that may comprise, may be based on, may be according to, or may use, OSEK/VDX, International Organization for Standardization (ISO) 17356-1, ISO 17356-2, ISO 17356-3, ISO 17356-4, ISO 17356-5, or AUTOSAR standard.

Any wireless network herein may be a Wireless Wide Area Network (WWAN), any wireless transceiver herein may be a WWAN transceiver, and any antenna herein may be a WWAN antenna. The WWAN may be a wireless broadband network, or may be a WiMAX network. Any antenna herein may be a WiMAX antenna, and any wireless transceiver herein may be a WiMAX modem, and the WiMAX network may be according to, may be compatible with, or may be based on, IEEE 802.16-2009. Alternatively or in addition, any wireless network herein may be a cellular telephone network, any antenna may be a cellular antenna, and any wireless transceiver may be a cellular modem. The cellular telephone network may be a Third Generation (3G) network that may use UMTS W-CDMA, UMTS HSPA, UMTS TDD, CDMA2000 1×RTT, CDMA2000 EV-DO, or GSM EDGE-Evolution, or the cellular telephone network may be a Fourth Generation (4G) network that uses HSPA+, Mobile WiMAX, LTE, LTE-Advanced, MBWA, or may be based on IEEE 802.20-2008.

Any wireless network herein may be a Wireless Personal Area Network (WPAN), any wireless transceiver may be a WPAN transceiver, and any antenna herein may be a WPAN antenna. The WPAN may be according to, may be compatible with, or may be based on, Bluetooth™ or IEEE 802.15.1-2005 standards, or the WPAN may be a wireless control network that may be according to, or may be based on, ZigBee™, IEEE 802.15.4-2003, or Z-Wave™ standard.

Any wireless network herein may be a Wireless Local Area Network (WLAN), any wireless transceiver may be a WLAN transceiver, and any antenna herein may be a WLAN antenna. The WLAN may be according to, may be compatible with, or may be based on, IEEE 802.11-2012, IEEE 802.11a, IEEE 802.11b, IEEE 802.11g, IEEE 802.11n, or IEEE 802.11ac. Any wireless network herein may use a licensed or unlicensed radio frequency band, and the unlicensed radio frequency band may be an Industrial, Scientific and Medical (ISM) radio band.

Any network herein may be a wireless network, the first port may be an antenna for transmitting and receiving first Radio-Frequency (RF) signals over the air, and the first transceiver may be a wireless transceiver coupled to the antenna for wirelessly transmitting and receiving first data over the air using the wireless network. Alternatively or in addition, the network may be a wired network, the first port may be a connector for connecting to the network medium, and the first transceiver may be a wired transceiver coupled to the connector for transmitting and receiving first data over the wireless medium.

Any wireless network herein may use a Dedicated Short-Range Communication (DSRC), that may be according to, compatible with, or based on, European Committee for Standardization (CEN) EN 12253:2004, EN 12795:2002, EN 12834:2002, EN 13372:2004, or EN ISO 14906:2004 standard, or may be according to, compatible with, or based on, IEEE 802.11p, IEEE 1609.1-2006, IEEE 1609.2, IEEE 1609.3, IEEE 1609.4, or IEEE1609.5.

Any system, device, module, or circuit herein may be addressable in a wireless network (such as the Internet) using a digital address that may be a MAC layer address that may be MAC-48, EUI-48, or EUI-64 address type, or may be a layer 3 address and may be a static or dynamic IP address that may be of IPv4 or IPv6 type address. Any system, device, or module herein may be further configured as a wireless repeater, such as a WPAN, WLAN, or a WWAN repeater.

Any network herein may be a vehicle network, such as a vehicle bus or any other in-vehicle network. A connected element comprises a transceiver for transmitting to, and receiving from, the network. The physical connection typically involves a connector coupled to the transceiver. The vehicle bus may consist of, may comprise, may be compatible with, may be based on, or may use a Controller Area Network (CAN) protocol, specification, network, or system. The bus medium may consist of, or comprise, a single wire, or a two-wire such as an UTP or a STP. The vehicle bus may employ, may use, may be compatible with, or may be based on, a multi-master, serial protocol using acknowledgement, arbitration, and error-detection schemes, and may further use synchronous, frame-based protocol.

Any system or device herein may use a virtualization. Any system or device herein may further comprise a Virtual Machine (VM) executing a virtualized application. Any device herein may be implemented as virtual hardware as part of the VM. At least one of any action or step herein by any device may be executed as part of the virtualized application.

Any network herein may be used with a virtualization, and any network herein may be executed as a virtualized network as part of a Virtual Machine (VM). The virtualization may be implemented by a host computer that may implement the VM, and any method herein may further comprise executing, by the host computer, a hypervisor or a Virtual Machine Monitor (VMM), and the virtualized may use or interface virtual hardware. Any virtualization herein may include, may be based on, or may use, full virtualization, para-virtualization, or hardware assisted virtualization. For example, any communication between two entities herein may be executed as a virtualized network as part of a Virtual Machine (VM).

Any method herein, any step herein, any flow-chart herein, or any part thereof, may be used with a virtualization, and at least one of the steps or methods herein may be executed as part of a virtualized application as part of a Virtual Machine (VM). Any device herein, such as the analyzer device, the first device, or any part thereof, may be implemented as virtual hardware. Any virtualization herein may be used with an host computer that implement the VM, and may further comprising executing, by the host computer, a hypervisor or a Virtual Machine Monitor (VMM). Any virtualized application herein or any or hardware virtualization herein may use or may interface virtual hardware. Any virtualization herein may include, may be based on, or may use, full virtualization, para-virtualization, or hardware assisted virtualization.

Any operating system herein may be used with a virtualization, and any operating system herein may be executed as a guest operating system as part of a Virtual Machine (VM). The virtualization may be implemented by a host computer that may implement the VM, and any method herein may further comprise executing, by the host computer, a hypervisor or a Virtual Machine Monitor (VMM), and the guest operating system may use or interface virtual hardware. Any such virtualization herein may include, may be based on, or may use, full virtualization, para-virtualization, or hardware assisted virtualization.

Any element or entity herein may be implemented as virtualized entity. Any virtualization may include, may be based on, or may use, desktop virtualization, network virtualization, storage virtualization, application virtualization, server virtualization, or any combination thereof. Further, any virtualization herein may include, may be based on, or may use, full virtualization, para-virtualization, or hardware assisted virtualization. Further, any virtualization herein may include, may be based on, or may use, a virtual machine (VM) on a host computer that executes a hypervisor or Virtual Machine Monitor (VMM), and the operating system may be a guest operating system that may use or interface a virtual hardware.

Any method herein may be used with a virtualization, where at least one of the steps may be executed as part of a virtualized application as part of a Virtual Machine (VM). Alternatively or in addition, any device or server herein may be implemented as virtual hardware. Further, any method herein may be used with a host computer that may implement the VM, and any method herein may further comprise executing, by the host computer, a hypervisor or a Virtual Machine Monitor (VMM), and any virtualized application herein or any hardware herein may use or may interface virtual hardware. Any virtualization herein may include, may be based on, or may uses, full virtualization, para-virtualization, or hardware assisted virtualization. At least two devices may be virtualized by the same host computer that implements the VM.

The above summary is not an exhaustive list of all aspects of the present invention. Indeed, the inventor contemplates that his invention includes all systems and methods that can be practiced from all suitable combinations and derivatives of the various aspects summarized above, as well as those disclosed in the detailed description below, and particularly pointed out in the claims filed with the application. Such combinations have particular advantages not specifically recited in the above summary.

### BRIEF DESCRIPTION OF THE DRAWINGS

Various aspects of the system and method are herein described, by way of non-limiting examples only, with reference to the accompanying drawings, wherein like designations denote like elements. Understanding that these drawings only provide information concerning typical embodiments of the invention and are not therefore to be considered limiting in scope:

FIG. 1 illustrates schematically a block diagram of a prior-art computer connected to the Internet;

FIG. 1a illustrates schematically prior-art servers, clients, and a computer workstation connected via the Internet;

FIG. 2 illustrates a simplified schematic block diagram of a prior-art electronics architecture in a vehicle;

FIG. 2a illustrates a table of the various classification levels of autonomous car is according to the Society of Automotive Engineers (SAE) J3016 standard;

FIG. 2b illustrates schematically a prior-art arrangement of virtualization;

FIG. 2c illustrates schematically a prior-art arrangement of hosted architecture of virtualization;

FIG. 2d illustrates schematically a prior-art arrangement of bare-metal (hypervisor) architecture of virtualization;

FIG. 3 illustrates a simplified schematic flow chart of a prior art method of navigation system operation;

FIG. 4 illustrates a simplified schematic flow chart of a method for optimal navigation involving routing to two locations;

FIG. 4a illustrates a simplified schematic flow chart of a method for optimal navigation involving routing to three locations;

FIG. 4b illustrates a simplified schematic flow chart of a method for optimal navigation involving routing to three locations and back;

FIG. 5 illustrates a simplified schematic flow chart of a method for optimal navigation involving routing to N locations;

FIG. 6 illustrates schematically a block diagram of an arrangement that includes a device for multi-locations navigation storing a maps database;

FIG. 6a illustrates schematically a block diagram of an arrangement that includes a device for multi-locations navigation and a server storing a maps database;

FIG. 7 illustrates a simplified schematic flow chart of a method for optimal navigation involving routing to multiple locations using a server storing a maps database;

FIG. 8 illustrates schematically a table associating store names to their respective addresses;

FIG. 8a illustrates schematically a table associating store names and their respective addresses with items offered for sale in the respective store;

FIG. 8b illustrates schematically a table associating store names and their respective addresses with attributes relating to the respective store;

FIG. 9 illustrates schematically a block diagram of an arrangement that includes a device for navigation storing a maps database and a products database;

FIG. 9a illustrates schematically a block diagram of an arrangement that includes a device for navigation storing a products database and a server storing a maps database;

FIG. 9b illustrates schematically a block diagram of an arrangement that includes a device for navigation and a server storing a maps database and a products database;

FIG. 9c illustrates schematically a block diagram of an arrangement that includes a device for navigation storing a maps database and a server storing a products database;

FIG. 10 illustrates a simplified schematic flow chart of a method for optimal navigation involving routing to a store based on a requested item using a device storing a products database;

FIG. 10a illustrates a simplified schematic flow chart of a method for optimal navigation involving routing to a store based on a requested item using a server storing a products database for identifying stores;

FIG. 10b illustrates a simplified schematic flow chart of a method for optimal navigation involving routing to a store based on a requested item using a server storing a products database for identifying stores and maps database for calculating routes;

FIG. 10c illustrates a simplified schematic flow chart of a method for optimal navigation involving routing to a store based on a requested item using a server storing a products database for identifying stores and maps database for calculating routes and selecting an optimal route/store;

FIG. 11 illustrates a simplified schematic flow chart of a method for optimal navigation involving routing to multiple stores based on multiple requested items;

FIG. 11a illustrates a simplified schematic flow chart of a method for optimal navigation involving routing to multiple stores based on three requested items;

FIG. 11b illustrates a simplified schematic flow chart of a method for optimal navigation involving routing to multiple stores based on multiple requested items using a server storing a products database for identifying stores and maps database for calculating routes and selecting an optimal route;

FIG. 12 depicts schematically a map with an origin point location;

FIG. 12a depicts schematically a map with an origin point and multiple stores locations;

FIG. 12b depicts schematically a map with an origin point and multiple stores locations and an optimal route to three stores;

FIG. 13 illustrates a simplified schematic flow chart of a method for identifying sets relating to multiple stores based on multiple requested items;

FIG. 14 illustrates a simplified schematic flow chart of a method for optimal navigation involving routing to multiple stores based on multiple requested items and ending at a destination point;

FIG. 14a illustrates a simplified schematic flow chart of a method for identifying sets relating to multiple stores based on multiple requested items and ending at a destination point;

FIG. 15 depicts schematically a map with an origin point and multiple stores locations and an optimal route to three stores and ending at the origin point;

FIG. 15a depicts schematically a map with an origin point and multiple stores locations and another optimal route to three stores and ending at the origin point;

FIG. 15b depicts schematically a map with an origin point and multiple stores locations and another optimal route to three stores and ending at a destination point;

FIG. 16 illustrates schematically a table associating store names to their opening hours;

FIGS. 17 and 17a illustrate a simplified schematic flow chart of a method for optimal navigation involving routing to multiple stores based on multiple requested items based on opening hours;

FIG. 18 illustrates schematically a block diagram of an arrangement that includes a device for navigation and a server storing an opening-hours database;

FIGS. 19, 19a, and 19b illustrate a simplified schematic flow chart of a method for optimal navigation involving routing to multiple stores based on multiple requested items and rerouting based on an event; and

FIGS. 20 and 20a depicts schematically a map with an origin point and multiple stores locations and an optimal route to three stores and ending at the origin point that includes a rerouting.

### DETAILED DESCRIPTION

The principles and operation of an apparatus according to the present invention may be understood with reference to the figures and the accompanying description wherein similar components appearing in different figures are denoted by identical reference numerals. The drawings and descriptions are conceptual only. In actual practice, a single component can implement one or more functions; alternatively or in addition, each function can be implemented by a plurality of components and devices. In the figures and descriptions, identical reference numerals indicate those components that are common to different embodiments or configurations. Identical numerical references (even in the case of using different suffix, such as 5, 5a, 5b and 5c) refer to functions or actual devices that are either identical, substantially similar, or having similar functionality. It will be readily understood that the components of the present invention, as generally described and illustrated in the figures herein, could be arranged and designed in a wide variety of different configurations. Thus, the following more detailed description of the embodiments of the apparatus, system, and method of the present invention, as represented in the figures herein, is not intended to limit the scope of the invention, as claimed, but is merely the representative embodiments of the invention. It is to be understood that the singular forms “a,” “an,” and “the” herein include plural referents unless the context clearly dictates otherwise. Thus, for example, reference to “a component surface” includes reference to one or more of such surfaces. By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “outer”, “beneath”, “below”, “right”, left”, “upper”, “lower”, “above”, “front”, “rear”, “left”, “right” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Any vehicle herein may be a ground vehicle adapted to travel on land, such as a bicycle, a car, a motorcycle, a train, an electric scooter, a subway, a train, a trolleybus, or a tram. Alternatively or in addition, the vehicle may be a buoyant or submerged watercraft adapted to travel on or in water, and the watercraft may be a ship, a boat, a hovercraft, a sailboat, a yacht, or a submarine. Alternatively or in addition, the vehicle may be an aircraft adapted to fly in air, and the aircraft may be a fixed wing or a rotorcraft aircraft, such as an airplane, a spacecraft, a glider, a drone, or an Unmanned Aerial Vehicle (UAV).

Any apparatus, system, or device herein or any part thereof, may be mounted onto, may be attached to, may be part of, or may be integrated with, a rear or front view camera, chassis, lighting system, headlamp, door, car glass, windscreen, side or rear window, glass panel roof, hood, bumper, cowling, dashboard, fender, quarter panel, rocker, or a spoiler of a vehicle.

Any vehicle herein may further comprise an Advanced Driver Assistance Systems (ADAS) functionality, system, or scheme, and any apparatus, device, sensor, or actuator herein may be part of, may be integrated with, may be communicating with, or may be coupled to, the ADAS functionality, system, or scheme. The ADAS functionality, system, or scheme may consist of, may comprise, or may use, Adaptive Cruise Control (ACC), Adaptive High Beam, Glare-free high beam and pixel light, Adaptive light control such as swiveling curve lights, Automatic parking, Automotive navigation system with typically GPS and TMC for providing up-to-date traffic information, Automotive night vision, Automatic Emergency Braking (AEB), Backup assist, Blind Spot Monitoring (BSM), Blind Spot Warning (BSW), Brake light or traffic signal recognition, Collision avoidance system, Pre-crash system, Collision Imminent Braking (CIE), Cooperative Adaptive Cruise Control (CACC), Crosswind stabilization, Driver drowsiness detection, Driver Monitoring Systems (DMS), Do-Not-Pass Warning (DNPW), Electric vehicle warning sounds used in hybrids and plug-in electric vehicles, Emergency driver assistant, Emergency Electronic Brake Light (EEBL), Forward Collision Warning (FCW), Heads-Up Display (HUD), Intersection assistant, Hill descent control, Intelligent speed adaptation or Intelligent Speed Advice (ISA), Intelligent Speed Adaptation (ISA), Intersection Movement Assist (IMA), Lane Keeping Assist (LKA), Lane Departure Warning (LDW) (a.k.a. Line Change Warning—LCW), Lane change assistance, Left Turn Assist (LTA), Night Vision System (NVS), Parking Assistance (PA), Pedestrian Detection System (PDS), Pedestrian protection system, Pedestrian Detection (PED), Road Sign Recognition (RSR), Surround View Cameras (SVC), Traffic sign recognition, Traffic jam assist, Turning assistant, Vehicular communication systems, Autonomous Emergency Braking (AEB), Adaptive Front Lights (AFL), or Wrong-way driving warning.

Any vehicle herein may further employ an Advanced Driver Assistance System Interface Specification (ADASIS) functionality, system, or scheme, and any sensor or actuator herein may be part of, integrated with, communicates with, or coupled to, the ADASIS functionality, system, or scheme. Further, any message herein may comprise a map data relating to the location of a respective vehicle.

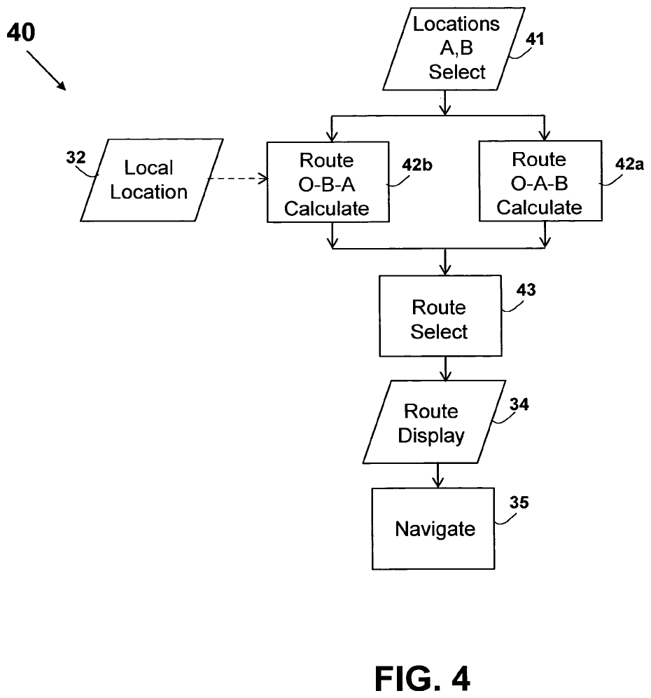

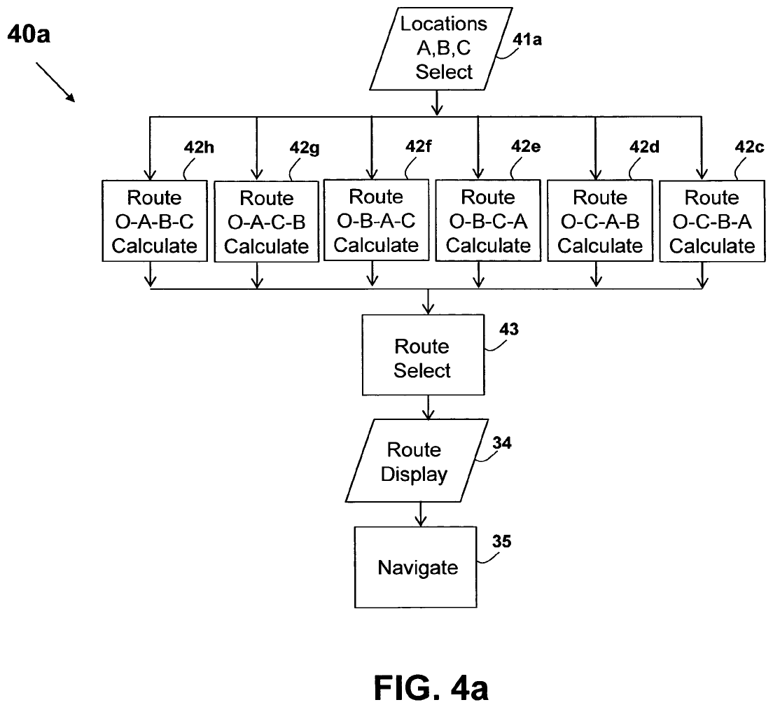

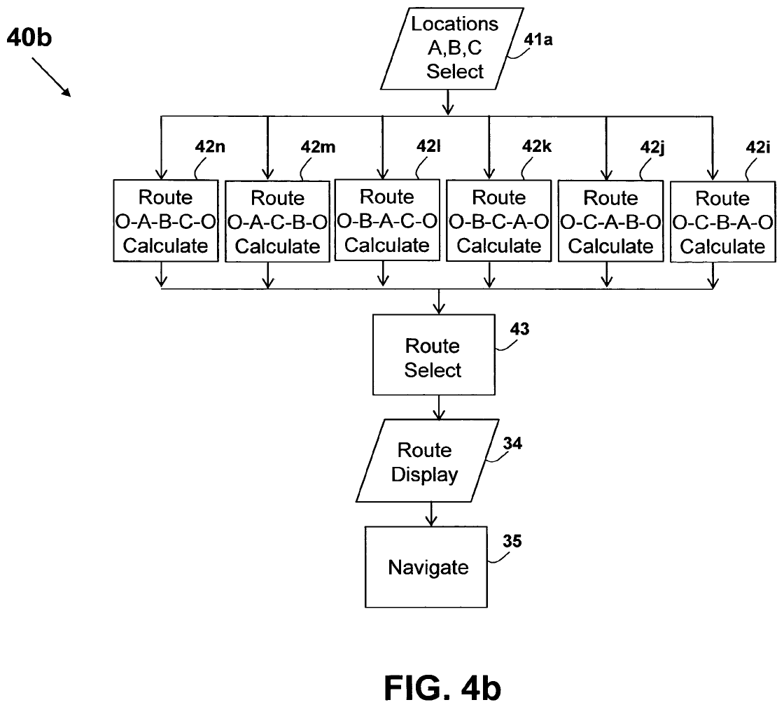

An example of a flow chart 40 is shown in FIG. 4, and illustrates optimal navigation taking into account two destinations, referred to as ‘A’ and ‘B’. The current location of the device or system is referred to as ‘origin’ and is marked as ‘O’. While a single destination is provided in the “Location Select” step 31 shown above as part of the flow chart 30, in a “Locations A, B Select” step 41 the user or operator selects two distinct locations as destinations that the user intends to arrive at. Each of the destination may be entered, for example, via the navigation device panel with buttons, directly via a touchscreen, or by voice input. The user may enter destinations from a menu or in response to prompting by acoustically output instructions. It is assumed that the order of arriving at the locations is not important to the user. Any way of selecting a single location may apply to selecting each of the two locations. Each of the locations may be defined by a latitude and a longitude. Alternatively or in addition, each of the locations may be defined by a country, a region, a city, a street, and a building number.

Unlike the navigation to the single location described in the flow chart 30 above, there are two main navigation option when two destinations are involved: To arrive first to location ‘A’ and then to location ‘B’, or to arrive first to location ‘B’ and then to ‘location ‘A’. As part of a “Route O-A-B Calculate” step 42a, the optimal route to get first to location ‘A’ and then to location ‘B’ is calculated, where the location ‘B’ serves as the final destination and the location ‘A’ serves as an intermediate point (or waypoint). In one example, the calculation involves two separate calculations: From the origin (‘O’) to the position ‘A’ (O-A), and from the location ‘A’ to the destination ‘B’ (A-B), thereafter adding the relevant features, such as adding the travel time or travel distance of each segment to calculate the respective total travel time or travel distance. Sequentially or in parallel, as part of a “Route O-B-A Calculate” step 42b, the optimal route to get first to location ‘B’ and then to location ‘A’ is calculated where the location ‘A’ serves as the final destination and the location ‘B’ serves as an intermediate point (or waypoint). In one example, the calculation involves two separate calculations: From the origin (‘O’) to the position ‘B’ (O-B), and from the location ‘B’ to the destination ‘A’ (B-A), thereafter adding the relevant features, such as adding the travel time or travel distance of each segment to calculate the respective total travel time or travel distance. Both calculation use the local location as described above regarding the “Local Location” step 32. Then, as part of a “Route Select” step 43, one of the routes O-A-B or O-B-A is selected. In one example, the route is selected by the user. Alternatively or in addition, the route to be actually used is selected based on a pre-defined criteria, such as minimum travel distance, minimum travel time, a combination thereof, or any known criteria to select between multiple suggested routes. Upon selecting the route to be used for navigation direction, the selected route may be displayed to the user as part of the “Route Display” step 34 and actually used for assisting in navigation as part of the “Navigate” step 35 similarly to the flow chart 30 described above.

While the flow chart 40 involved two destinations, any number of destinations may equally apply. A flow chart 40a shown in FIG. 4a illustrates optimal routing to three locations, referred to as ‘A’, 13′, and ‘C’. The requested three locations are input to the system by the user as part of a “Locations A, B, C Select’ step 41a. Assuming that there is no difference of the order of arriving to the three destinations, there are six possible permutations, namely A-B-C, A-C-B, B-A-C, B-C-A, C-A-B, and C-B-A. The optimal route for the order A-B-C is calculated as part of a “Route O-A-B-C Calculate” step 42h. In one example, the calculation involves three separate calculations: Calculation of the first segment from the origin (‘0’) to the position ‘A’ (O-A), calculation of the second segment from the location ‘A’ to the destination ‘B’ (A-B), and calculation of the third segment from the location ‘B’ to the destination ‘C’ (B-C), thereafter adding the relevant features, such as adding the travel time or travel distance of each segment to calculate the respective total travel time or travel distance. Similarly, the optimal route for the order A-C-B is calculated as part of a “Route O-A-C-B Calculate” step 42g, the optimal route for the order B-A-C is calculated as part of a “Route O-B-A-C Calculate” step 42f, the optimal route for the order B-C-A is calculated as part of a “Route O-B-C-A Calculate” step 42e, the optimal route for the order C-A-B is calculated as part of a “Route O-C-A-B Calculate” step 42d, and the optimal route for the order C-B-A is calculated as part of a “Route O-C-B-A Calculate” step 42c. These six optimal route calculations may be calculated in parallel or sequentially, or any combination thereof, and each calculation uses as origin ‘O’ the local location (current position) corresponding to the “Local Location” step 32 as described above. A single route is selected from the six calculated routes as part of the “Route Select” step 43 as described above, either selected manually by the user or automatically by the system based on any pre-defined criteria, such as pre-defined user preferences. In one example, the possible routes are displayed to the user for selection, for example in a prioritized manner according to a pre-defined criterion, such as minimum travel distance or time. Upon selecting the route to be used for navigation direction, the selected route may be displayed to the user as part of the “Route Display” step 34 and actually used for assisting in navigation as part of the “Navigate” step 35 similarly to the flow chart 30 described above.

The route may be selected as part of the “Route Select” step 43 according to a pre-defined metric or criterion, such as minimum travel distance, minimum travel time, or best fuel efficiency.

The estimation of the local geographic location as part of the “Local Location” step 32 may use multiple RF signals transmitted by multiple sources, and the geographical location may be estimated by receiving the RF signals from the multiple sources via one or more antennas, and processing or comparing the received RF signals. The multiple sources may comprise geo-stationary or non-geo-stationary satellites, that may be Global Positioning System (GPS), and the RF signals may be received using a GPS antenna coupled to the GPS receiver 27 for receiving and analyzing the GPS signals from GPS satellites 38a and 38b. Alternatively or in addition, the multiple sources comprises satellites may be part of a Global Navigation Satellite System (GNSS), such as the GLONASS (GLObal NAvigation Satellite System), the Beidou-1, the Beidou-2, the Galileo, or the IRNSS/VAVIC.

Alternatively or in addition, the processing or comparing may comprise, or may be based on, performing TOA (Time-Of-Arrival) measurement, performing TDOA (Time Difference-Of-Arrival) measurement, performing an AoA (Angle-Of-Arrival) measurement, performing a Line-of-Sight (LoS) measurement, performing a Time-of-Flight (ToF) measurement, performing a Two-Way Ranging (TWR) measurement, performing a Symmetrical Double Sided—Two Way Ranging (SDS-TWR) measurement, performing a Near-field electromagnetic ranging (NFER) measurement, or performing triangulation, trilateration, or multilateration (MLAT). Alternatively or in addition, the RF signals may be part of the communication over a wireless network in which the vehicle, apparatus, or device is communicating over. The wireless network may be a cellular telephone network, and the sources may be cellular towers or base-stations. Alternatively or in addition, the wireless network may be a WLAN, and the sources may be hotspots or Wireless Access Points (WAPs). Alternatively or in addition, the geographical location may be estimated using, or based on, geolocation, which may be is based on W3C Geolocation API. Any geographical location herein may consist of, or may comprise, a country, a region, a city, a street, a ZIP code, latitude, or longitude.

The flow chart 40 shown in FIG. 4 and the flow chart 40a shown in FIG. 4a were described to optimize the route from the origin to multiple locations. Alternatively or in addition, the user may desire to return to its origin after completing the navigation to the required multiple destinations. For example, a user may want to get from home to various locations, such as various shopping places, and return home afterwards. In such a case, the optimal route, and the order of arriving at the required locations, may take into account the returning to the origin. Such an operation is described in a flow chart 40b shown in FIG. 4b, which is based on the flow chart 40a shown in FIG. 4a, where each of the six possible calculated routes includes returning to the origin. The optimal route for the order A-B-C that was calculated as part of a “Route O-A-B-C Calculate” step 42h, is modified to include returning to the origin as part of a “Route O-A-B-C-O Calculate” step 42n. Similarly, the optimal route for the order A-C-B-O (including returning to the origin point ‘O’) is calculated as part of a “Route O-A-C-B-O Calculate” step 42m, the optimal route for the order B-A-C-O is calculated as part of a “Route O-B-A-C-O Calculate” step 42l, the optimal route for the order B-C-A-O is calculated as part of a “Route O-B-C-A-O Calculate” step 42k, the optimal route for the order C-A-B is calculated as part of a “Route O-C-A-B-O Calculate” step 42j, and the optimal route for the order C-B-A is calculated as part of a “Route O-C-B-A-O Calculate” step 42i.

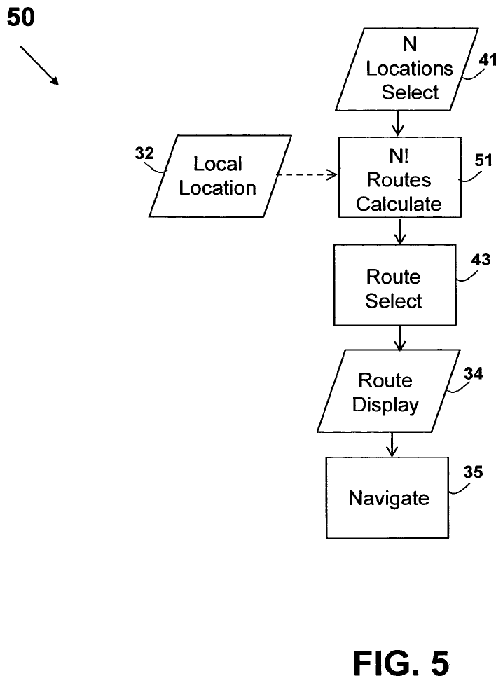

While the flow chart 40 involved two destinations, and the flow chart 40a involved three destinations, any number N of destination may equally apply. A flow chart 50 shown in FIG. 5 illustrates optimal routing to N locations, where N may be 2 (such as described in the flow chart 40), N may be 3 (such as described in the flow chart 40a), 4, 5, 6, 7, 8, 9, 10, or any other number higher than 10. The requested N locations are input to the system by the user as part of a “N Locations Select’ step 41. Assuming that there is no difference of the order of arriving to the N destinations, there are N! number possible arrangement for the orders of arriving to the N locations, all calculated as part of a “N! Routes Calculate” step 51, from which a single (best or optimal) route (and the arriving order) is determined as part of the “Route Select” step 43. Starting from the current location, the navigation device calculates a route leading to the first destination, followed by the first to second destinations, and so forth. The way in which the route is calculated can be adapted to suit the user (such as the driver in a vehicular system) preferences. The user can stipulate different options, such as optimizing the route (or any part thereof) based on driving time, based on economic mean of driving time and driving distance, based on an estimated minimum fuel consumption, or based on avoiding interstates/expressways, ferry crossings, or toll roads. The route recommendations are expected within a few seconds of the destinations being entered. A more critical scenario is re-computing the route if the driver departs from the recommended route. The new route recommendations must be supplied, for example, before the driver reaches the next intersection or junction.

The navigation as part of the “Navigate” step 35 may be a dynamic routing, where the route is being continuously updated. Many radio stations transmit traffic messages not only as spoken text, but also in encoded form, which may be used to update the suggested route. For example, the ALERT-C standard for the Traffic Message Channel (TMC) content is transmitted via the Radio Data System (RDS) of FM radio. The encoded messages contain, among other things, the location of a holdup, its extent, the actual length, and the reason for it. The system can receive such an encoded message and determine whether the holdup is situated on a planned route. If this is the case, the route may be recalculated, similar or identical to the “N! Routes Calculate” step 51 and the “Route Select” step 43, where the held-up section is evaluated with a longer driving time. A new route bypassing the holdup may then be obtained, and the updated route recommendations will follow in accordance with the new route in the “Navigate” step 35.

The route guidance as part of the “Navigate” step 35 may be performed by comparing the present position with the selected route, and the user (such as driver) is directed along a route by interaction with the navigation system, commonly using auditory, visual, or haptic interface. Route recommendations are mainly reproduced acoustically (voice output), which allows the user (such as the driver) to follow the directions without being distracted from the task of driving. Graphics, preferably positioned in the primary field of vision (e.g., in the instrument cluster), support the driver in understanding the directions. These graphics range from simple arrow symbols through to the display of a map excerpt optimally adapted in size.

The calculation of an optimal route for any part of the “N! Routes Calculate” step 51, such as between the current location and the first destination, between the first and second destination, and so forth, may use any known algorithm for optimum route between two locations. For example, the calculation may use, or may be based on, the calculation or selection described in a paper by Dalip and Vijay Kumar, both from MMEC, Maharishi Markandeshwar University, Ambala, India entitled: “Optimum Route Selection for Vehicle Navigation”, published in (IJACSA) International Journal of Advanced Computer Science and Applications, Vol. 7, No. 2, 2016, the calculation or selection may be as described in an handbook entitled: “Alternate Route Handbook”, Report No. FHWA-HOP-06-092 published May 2006 by Federal Highway Administration, the calculation or selection may be as described in a paper by Zhiyong Wang and Sisi Zlatanova, both of Delft University of Technology, Delft, The Netherlands, published 2013 by Springer—Verlag Berlin Heidelberg [ISBN: 978-3-642-33217-3] entitled: “An A*-Based Search Approach for Navigation Among Moving Obstacles”, the calculation or selection may be as described in an article entitled: “Route Planning Algorithms for Car Navigation” by Ingrid C. M. Flinsenberg of the Eindhoven University published 2004 [ISBN: 90-386-0902-7], the calculation or selection may be as described in an paper by W. Wen & S. W. Hsu of the Department of Information Management, LungHwa University of Science and Technology, Taiwan R.O.C. entitled: “A route navigation system with a new revised shortest path routing algorithm and its performance evaluation”, published 2005 in WTT Transaction on The Built Environment, Vol. 77 [ISSN 1743-3509], or the calculation or selection may be as described in a thesis by Xueyuan Song of the State University of New Jersey entitled: “ON MY WAY: SYSTEM FOR OPTIMIZING DRIVING ROUTES FOR CROWDSOURCING APPLICATIONS”, published May 2014, which are all incorporated in their entirety for all purposes as if fully set forth herein.

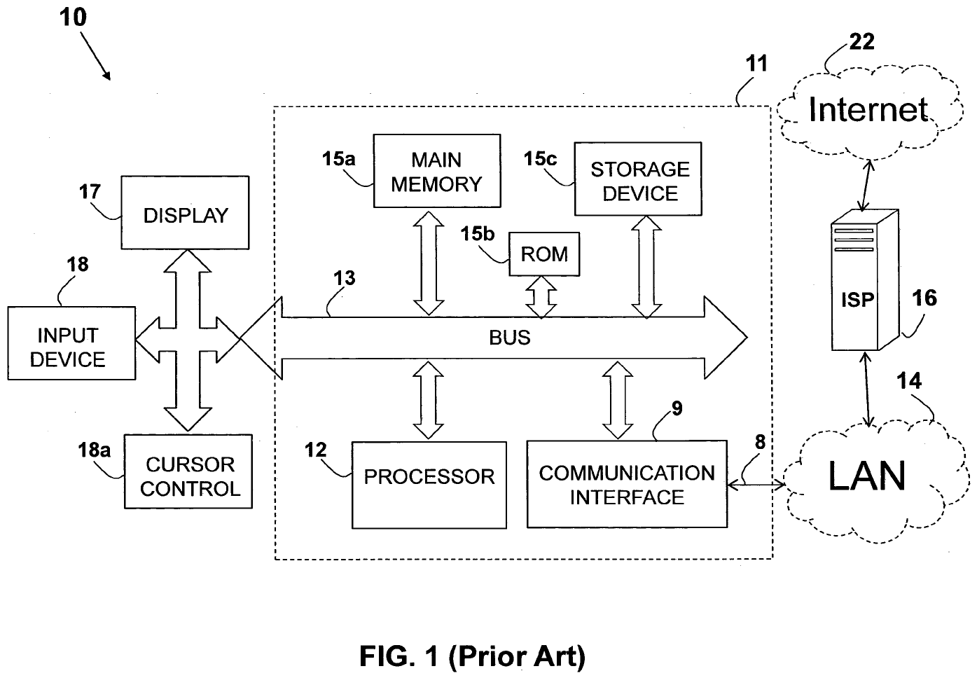

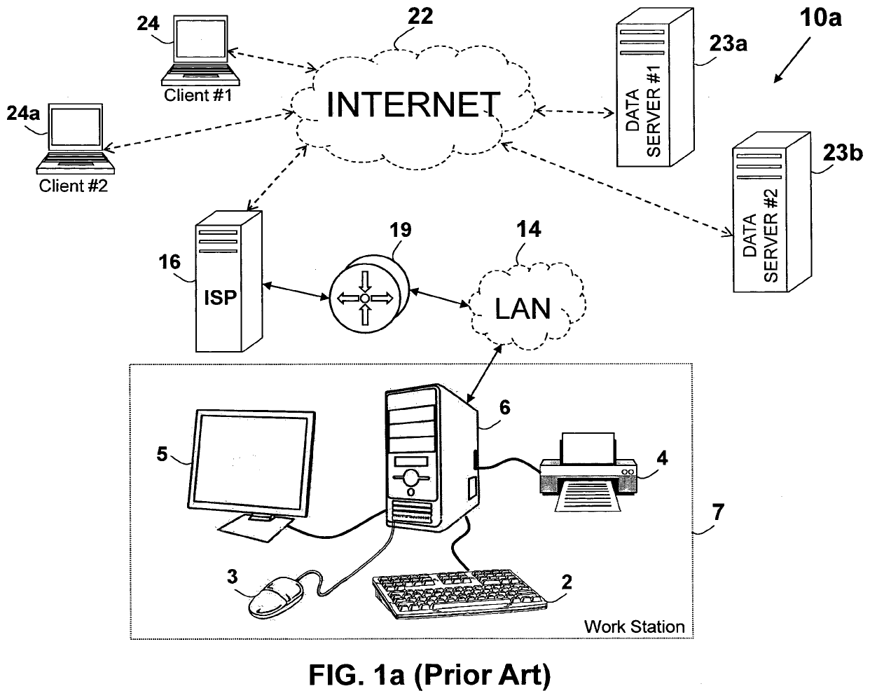

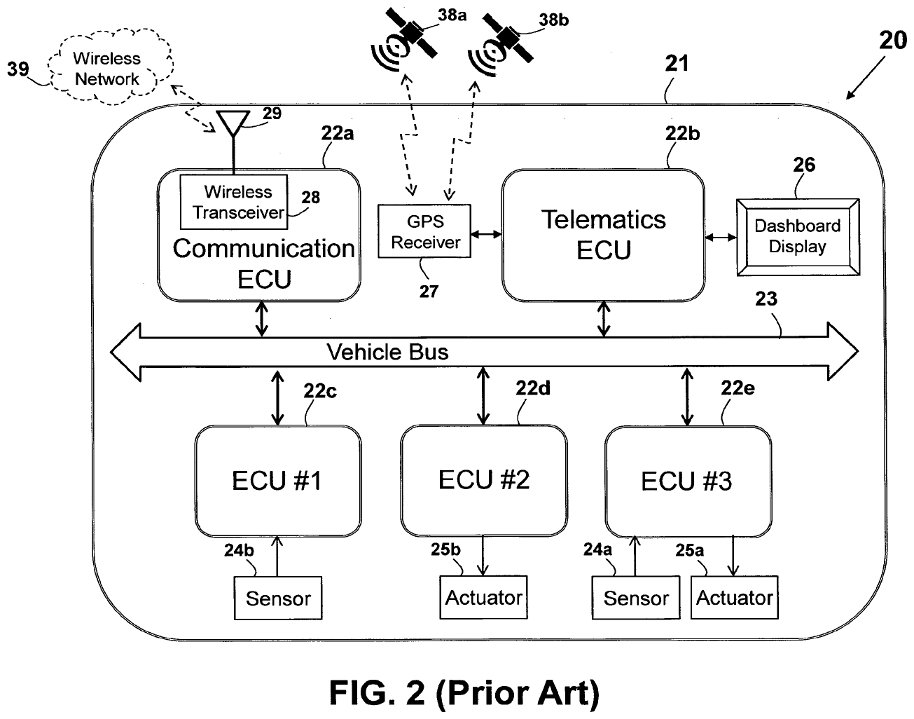

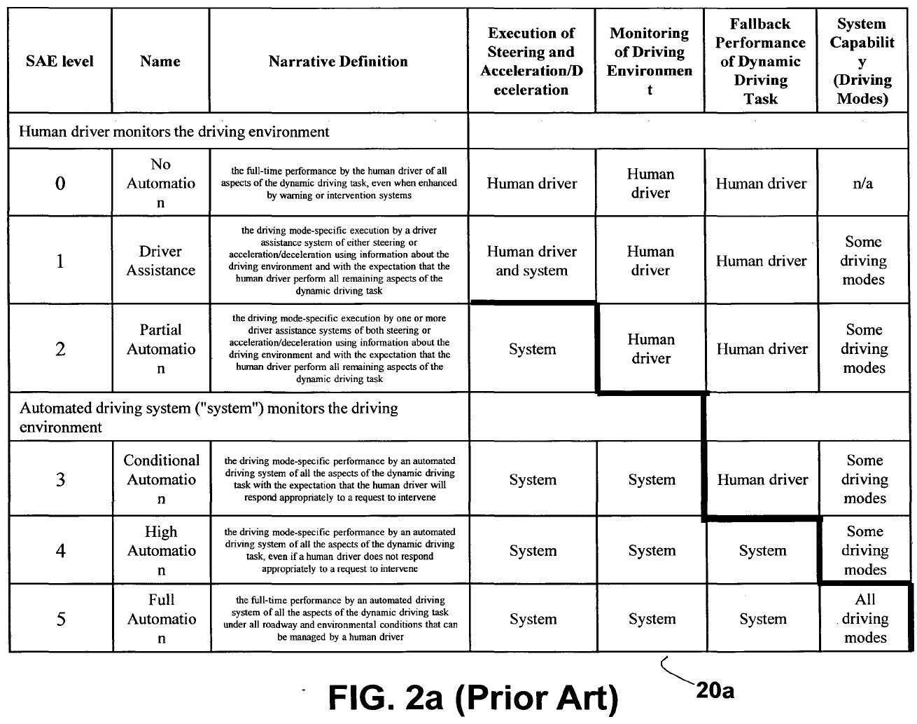

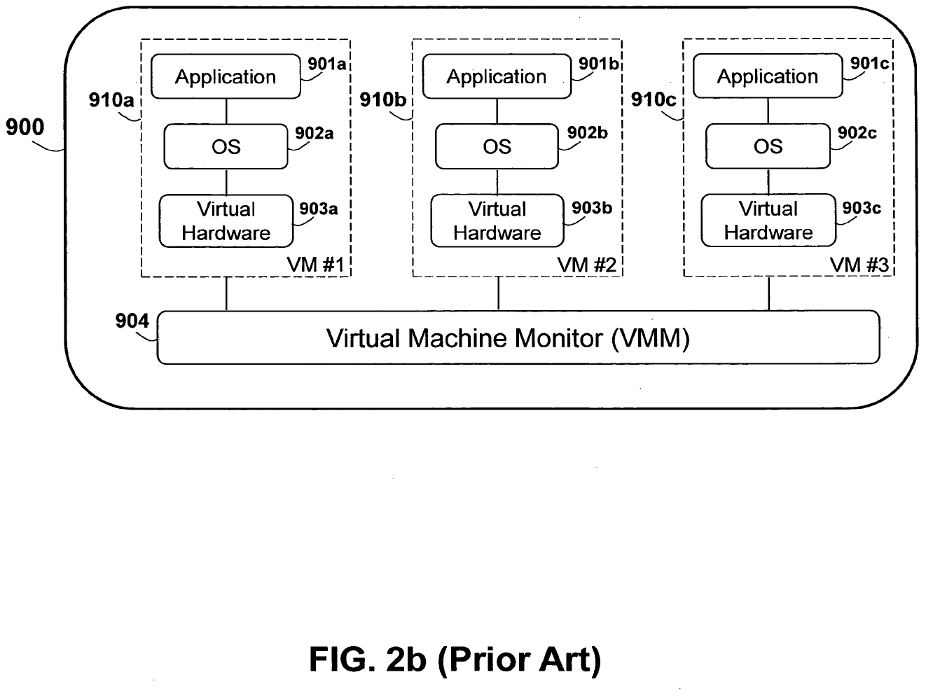

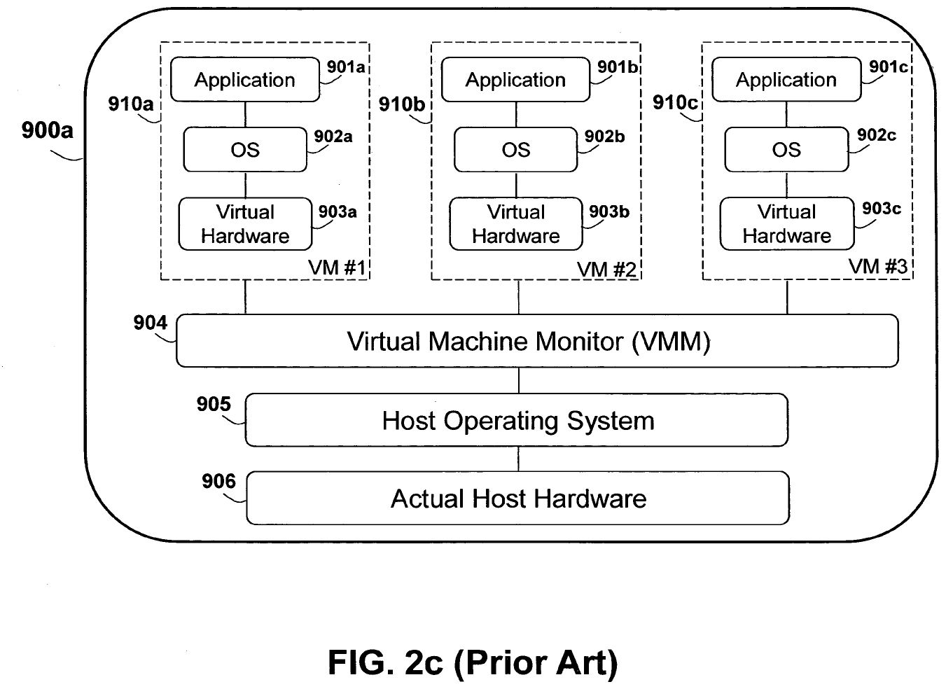

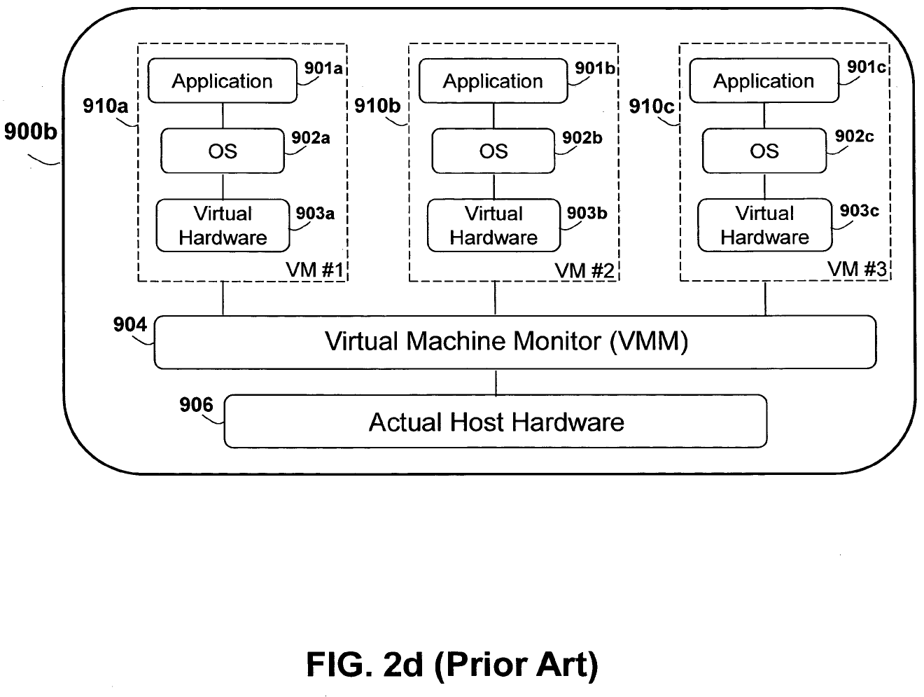

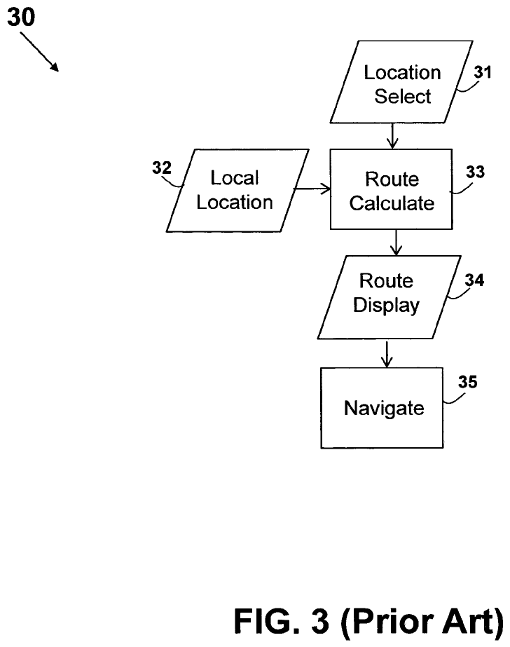

Any of the methods, steps, or flow charts herein may be performed as part of a device, a system, or a network element, which may comprise, consists of, or include a Personal Computer (PC), a desktop computer, a mobile computer, a laptop computer, a notebook computer, a tablet computer, a server computer, a handheld computer, a handheld device, a Personal Digital Assistant (PDA) device, a cellular handset, a handheld PDA device, an on-board device, an off-board device, a hybrid device, a vehicular device, a non-vehicular device, a mobile or portable device, a non-mobile or a non-portable device. In one example, the device or system comprises, is based on, of is part of a computer system 10 or computer device 11 shown in FIG. 1. In such an arrangement, the display 17 may be used as an output component for displaying to the user as part of the “Route Display” step 34, and the input device 18 may be used for locations select as part of the “Location Select” 31. The computer system 11 may be implemented as a portable electronic device or a mobile device such as a notebook/laptop computer, a media player (e.g., MP3 based or video player), a desktop computer, a laptop computer, a cellular phone, a Personal Digital Assistant (PDA), an image processing device (e.g., a digital camera or video recorder), any other handheld or fixed location computing devices, or a combination of any of these devices.

The mobile devices may combine video, audio and advanced communications capabilities, such as PAN and WLAN. A mobile phone (also known as a cellular phone, cell phone, smartphone, and a hand phone) is a device which can make and receive telephone calls over a radio link whilst moving around a wide geographic area, by connecting to a cellular network provided by a mobile network operator. The calls are to and from the public telephone network, which includes other mobiles and fixed-line phones across the world. The Smartphones may combine the functions of a personal digital assistant (PDA), and may serve as portable media players and camera phones with high-resolution touch-screens, web browsers that can access, and properly display, standard web pages rather than just mobile-optimized sites, GPS navigation, Wi-Fi and mobile broadband access. In addition to telephony, the Smartphones may support a wide variety of other services such as text messaging, MMS, email, Internet access, short-range wireless communications (infrared, Bluetooth), business applications, gaming and photography.

Any smartphone herein may consist of, comprise, or may be based on, Apple iPhone 6 or Samsung Galaxy S6. Any software or firmware herein, such as in a mobile device or a smartphone, may comprise an operating system that may be a mobile operating system. The mobile operating system may consist of, may comprise, may be according to, or may be based on, Android version 2.2 (Froyo), Android version 2.3 (Gingerbread), Android version 4.0 (Ice Cream Sandwich), Android Version 4.2 (Jelly Bean), Android version 4.4 (KitKat)), Apple iOS version 3, Apple iOS version 4, Apple iOS version 5, Apple iOS version 6, Apple iOS version 7, Microsoft Windows® Phone version 7, Microsoft Windows® Phone version 8, Microsoft Windows® Phone version 9, or Blackberry® operating system. Any Operating System (OS) herein, such as any server or client operating system, may consists of, include, or be based on a real-time operating system (RTOS), such as FreeRTOS, SafeRTOS, QNX, VxWorks, or Micro-Controller Operating Systems (μC/OS).

Any device, component, or apparatus herein, may be structured as, may be shaped or configured to serve as, or may be integrated with, a wearable device. For example, any apparatus or device herein may be wearable on an organ such as on the person head, and the organ may be eye, ear, face, cheek, nose, mouth, lip, forehead, or chin. Alternatively or in addition, any apparatus or device herein may be constructed to have a form substantially similar to, may be constructed to have a shape allowing mounting or wearing identical or similar to, or may be constructed to have a form to at least in part substitute for, headwear, eyewear, or earpiece. Any headwear herein may consist of, may be structured as, or may comprise, a bonnet, a headband, a cap, a crown, a fillet, a hair cover, a hat, a helmet, a hood, a mask, a turban, a veil, or a wig. Any eyewear herein may consist of, may be structured as, or may comprise, glasses, sunglasses, a contact lens, a blindfold, or a goggle. Any earpiece herein may consist of, may be structured as, or may comprise, a hearing aid, a headphone, a headset, or an earplug. Alternatively or in addition, any enclosure herein may be permanently or releasably attachable to, or may be part of, a clothing piece of a person. The attaching may use taping, gluing, pinning, enclosing, encapsulating, a pin, or a latch and hook clip, and the clothing piece may be a top, bottom, or full-body underwear, or a headwear, a footwear, an accessory, an outwear, a suit, a dress, a skirt, or a top.

Alternatively or in addition, any of the methods, steps, or flow charts herein may be performed as part of a device, a system that is part of, or mounted in, a vehicle. For example, the device or system may be part of an ECU in the vehicle 21, such as being part of, or comprising, the Telematics ECU 22b. In such an arrangement, the dashboard display 26 may be used as an output component for displaying to the user as part of the “Route Display” step 34. The vehicle may be a ground vehicle adapted to travel on land, such as a bicycle, a car, a motorcycle, a train, an electric scooter, a subway, a train, a trolleybus, or a tram. Alternatively or in addition, the vehicle may be a buoyant or submerged watercraft adapted to travel on or in water, and the watercraft may be a ship, a boat, a hovercraft, a sailboat, a yacht, or a submarine. Alternatively or in addition, the vehicle may be an aircraft adapted to fly in air, and the aircraft may be a fixed wing or a rotorcraft aircraft, such as an airplane, a spacecraft, a glider, a drone, or an Unmanned Aerial Vehicle (UAV).

Any vehicle herein may be identified using an identifier uniquely identifying the vehicle, which may comprise a Vehicle Identification Number (VIN) or a license plate number, or may comprise a code that identifies the vehicle make, model, color, model year, engine size, or vehicle type. Alternatively or in addition, the identifier of a vehicle may be a digital address such as a layer 3 address that may be a static or dynamic IP address, preferably using IPv4 or IPv6 type address. Alternatively or in addition, the digital address is a MAC layer address selected from the group consisting of MAC-48, EUI-48, and EUI-64 address type.

Any vehicle may estimate its geographical location. Such localization may be used with multiple RF signals transmitted by multiple sources, and the geographical location may be estimated by receiving the RF signals from the multiple sources via one or more antennas, and processing or comparing the received RF signals. The multiple sources may comprise geo-stationary or non-geo-stationary satellites, that may be Global Positioning System (GPS), and the RF signals may be received using a GPS antenna coupled to the GPS receiver 27 for receiving and analyzing the GPS signals. Alternatively or in addition, the multiple sources comprises satellites may be part of a Global Navigation Satellite System (GNSS), such as the GLONASS (GLObal NAvigation Satellite System), the Beidou-1, the Beidou-2, the Galileo, or the IRNSS/VAVIC.

Alternatively or in addition, the processing or comparing may comprise, or may be based on, performing TOA (Time-Of-Arrival) measurement, performing TDOA (Time Difference-Of-Arrival) measurement, performing an AoA (Angle-Of-Arrival) measurement, performing a Line-of-Sight (LoS) measurement, performing a Time-of-Flight (ToF) measurement, performing a Two-Way Ranging (TWR) measurement, performing a Symmetrical Double Sided—Two Way Ranging (SDS-TWR) measurement, performing a Near-Field Electromagnetic Ranging (NFER) measurement, or performing triangulation, trilateration, or MultiLATeration (MLAT). Alternatively or in addition, the RF signals may be part of the communication over a wireless network in which the vehicle, apparatus, or device is communicating over. The wireless network may be a cellular telephone network, and the sources may be cellular towers or base-stations. Alternatively or in addition, the wireless network may be a WLAN, and the sources may be hotspots or Wireless Access Points (WAPs). Alternatively or in addition, the geographical location may be estimated using, or based on, geolocation, which may be is based on W3C Geolocation API. Any geographical location herein may consist of, or may comprise, a country, a region, a city, a street, a ZIP code, latitude, or longitude.

Any apparatus (such as devices, systems, modules, sensor, actuator, or any other arrangement) described herein may consist of, be integrated with, be connected to, or be communicating with, an ECU, which may be an Electronic/engine Control Module (ECM) or Engine Control Unit (ECU), Powertrain Control Module (PCM), Transmission Control Module (TCM), Brake Control Module (BCM or EBCM), Central Control Module (CCM), Central Timing Module (CTM), General Electronic Module (GEM), Body Control Module (BCM), Suspension Control Module (SCM), Door Control Unit (DCU), Electric Power Steering Control Unit (PSCU), Seat Control Unit, Speed control unit (SCU), Telematic Control Unit (TCU), Transmission Control Unit (TCU), Brake Control Module (BCM; ABS or ESC), Battery management system, control unit, or control module.

Any ECU herein may comprise a software, such as an operating system or middleware that may use, may comprise, or may be according to, a part or whole of the OSEK/VDX, ISO 17356-1, ISO 17356-2, ISO 17356-3, ISO 17356-4, ISO 17356-5, or AUTOSAR standards, or any combination thereof.

Any device herein may serve as a client device in the meaning of client/server architecture, commonly initiating requests for receiving services, functionalities, and resources, from other devices (servers or clients). Each of the these devices may further employ, store, integrate, or operate a client-oriented (or end-point dedicated) operating system, such as Microsoft Windows® (including the variants: Windows 7, Windows XP, Windows 8, and Windows 8.1, available from Microsoft Corporation, headquartered in Redmond, Wash., U.S.A.), Linux, and Google Chrome OS available from Google Inc. headquartered in Mountain View, Calif., U.S.A. Further, each of the these devices may further employ, store, integrate, or operate a mobile operating system such as Android (available from Google Inc. and includes variants such as version 2.2 (Froyo), version 2.3 (Gingerbread), version 4.0 (Ice Cream Sandwich), Version 4.2 (Jelly Bean), and version 4.4 (KitKat), iOS (available from Apple Inc., and includes variants such as versions 3-7), Windows® Phone (available from Microsoft Corporation and includes variants such as version 7, version 8, or version 9), or Blackberry® operating system (available from BlackBerry Ltd., headquartered in Waterloo, Ontario, Canada). Alternatively or in addition, each of the devices that are not denoted herein as servers may equally function as a server in the meaning of client/server architecture. Any one of the servers herein may be a web server using Hyper Text Transfer Protocol (HTTP) that responds to HTTP requests via the Internet, and any request herein may be an HTTP request. Any Operating System (OS) herein, such as any server or client operating system, may consists of, include, or be based on a real-time operating system (RTOS), such as FreeRTOS, SafeRTOS, QNX, VxWorks, or Micro-Controller Operating Systems (μC/OS).

Examples of web browsers include Microsoft Internet Explorer (available from Microsoft Corporation, headquartered in Redmond, Wash., U.S.A.), Google Chrome that is a freeware web browser (developed by Google, headquartered in Googleplex, Mountain View, Calif., U.S.A.), Opera™ (developed by Opera Software ASA, headquartered in Oslo, Norway), and Mozilla Firefox® (developed by Mozilla Corporation headquartered in Mountain View, Calif., U.S.A.). The web-browser may be a mobile browser, such as Safari (developed by Apple Inc. headquartered in Apple Campus, Cupertino, Calif., U.S.A.), Opera Mini™ (developed by Opera Software ASA, headquartered in Oslo, Norway), and Android web browser.

Any apparatus herein, which may be any of the systems, devices, modules, or functionalities described herein, may be integrated with a smartphone. The integration may be by being enclosed in the same housing, sharing a power source (such as a battery), using the same processor, or any other integration functionality. In one example, the functionality of any apparatus herein, which may be any of the systems, devices, modules, or functionalities described here, is used to improve, to control, or otherwise be used by the smartphone. In one example, a measured or calculated value by any of the systems, devices, modules, or functionalities described herein, is output to the smartphone device or functionality to be used therein. Alternatively or in addition, any of the systems, devices, modules, or functionalities described herein is used as a sensor for the smartphone device or functionality.

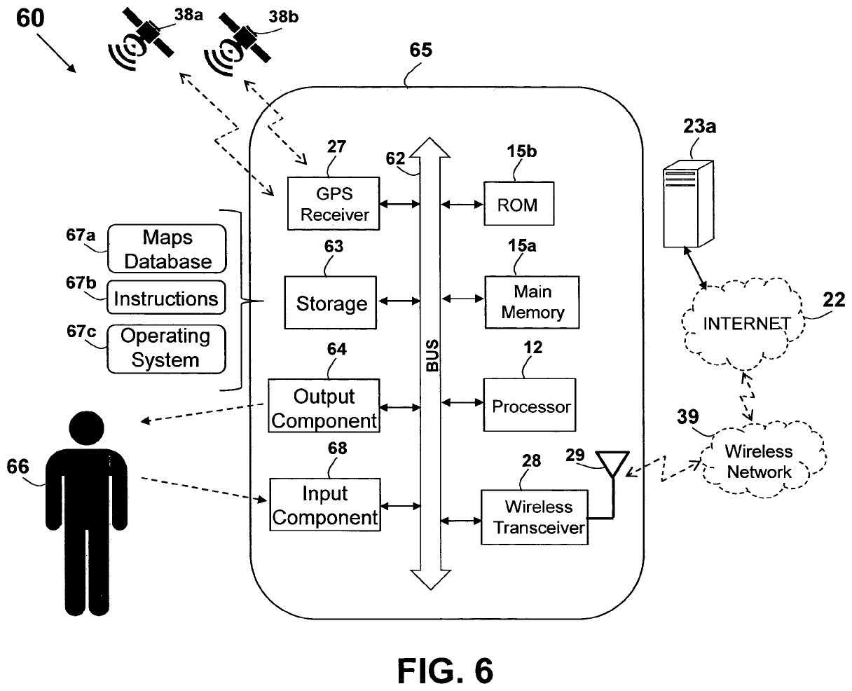

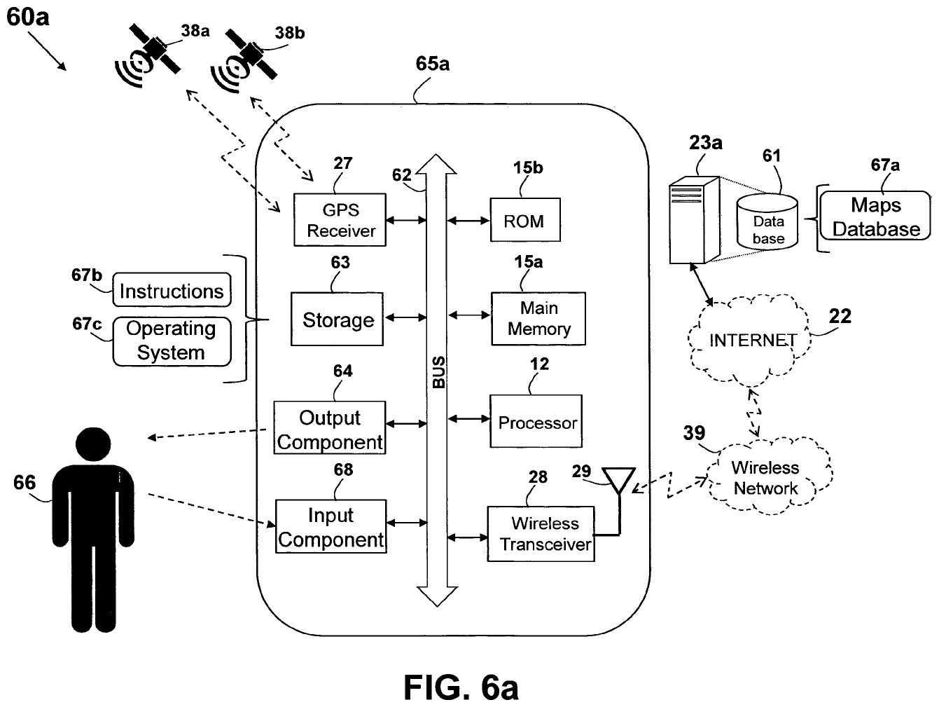

A diagrammatic representation of a machine in the example form of the computing device 65 within which a set of instructions, for causing the machine to perform any one or more of the methods discussed herein, may be executed. An example of the device 65 that may be used with any of the steps, methods, or flow-charts herein is schematically described as part of an arrangement 60 shown in FIG. 6. The components in the device 65 communicate over a bus 62, which may correspond with the bus 13 in the computer 11. The computing device 65 may include a mobile phone, a smart phone, a netbook computer, a rackmount server, a router computer, a server computer, a personal computer, a mainframe computer, a laptop computer, a tablet computer, a desktop computer etc., within which a set of instructions, for causing the machine to perform any one or more of the methods discussed herein, may be executed. In alternative embodiments, the machine may be connected (e.g., networked) to other machines in an LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The device 65 may also include an interface bus for facilitating communication from various interface devices (for example, one or more output components 64, one or more peripheral interfaces, and one or more communication components such as the wireless transceiver 28) to the basic configuration via the bus/interface controller that controls the bus 62. Some of the example output components include a graphics processing unit and an audio processing unit, which may be configured to communicate to various external devices such as a display or speakers via one or more A/V ports. One or more example peripheral interfaces may include a serial interface controller or a parallel interface controller, which may be configured to communicate with external devices such as input components (for example, keyboard, mouse, pen, voice input device, touch input device, etc.) or other peripheral output devices (for example, printer, scanner, etc.) via one or more I/O ports.

The device 65 may be part of, may include, or may be integrated with, a general purpose computing device, arranged in accordance with at least some embodiments described herein. In an example basic configuration, the device 65 may include one or more processors 12 and one or more memories or any other computer readable media. A dedicated memory bus may be used to communicate between the processor 12 and the device memories, such as the ROM 15b, the main memory 15a, and a storage 63. Depending on the desired configuration, the processor 12 may be of any type, including but not limited to a microprocessor (μP), a microcontroller (μC), a digital signal processor (DSP), or any combination thereof. The processor 12 may include one or more levels of caching, such as a cache memory, a processor core, and registers. The example processor core may include an arithmetic logic unit (ALU), a floating point unit (FPU), a digital signal processing core (DSP Core), or any combination thereof. An example memory controller may also be used with the processor 12, or in some implementations, the memory controller may be an internal part of the processor 12.

Depending on the desired configuration, the device memories may be of any type including but not limited to volatile memory (such as RAM), non-volatile memory (such as ROM, flash memory, etc.) or any combination thereof. The storage 63 may correspond to the storage device 15c, and may be part of, may comprise, or may be integrated with the ROM 15b and the main memory 15a. The storage 63 may include an operating system 67c, instruction set 67b that may include steps or part or whole of the flow-charts described herein, and maps database 67a, which is used for calculating routes as part of the “N! Routes Calculate” step 51. The storage 63 may further include a control module, and program data, which may include path data. Any of the memories or storages of the device 65 may include read-only memory (ROM), such as ROM 15b, flash memory, dynamic random access memory (DRAM) such as synchronous DRAM (SDRAM)), a static memory (e.g., flash memory, static random access memory (SRAM)) and a data storage device, which communicate with each other via the bus 62.

The device 65 may have additional features or functionality, and additional interfaces to facilitate communications between the basic configuration shown in FIG. 6 and any desired devices and interfaces. For example, a bus/interface controller may be used to facilitate communications between the basic configuration and one or more data storage devices via a storage interface bus. The data storage devices may be one or more removable storage devices, one or more non-removable storage devices, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The device 65 may receive inputs from a user 66 via an input component 68, which may correspond with the input device 18 or cursor control 18a shown as part of the computer 11 in FIG. 1, or may correspond with the pointing device 3 or the keyboard 2 shown as part of the computer system 7 in FIG. 1a. In one example, the input component 68 may be used for receiving locations from the user 66 as part of the “N Locations Select” step 41. The device 65 notifies or outputs information to the user 66 using an output component 64, which may correspond to the display 17 shown as part of the computer 11 in FIG. 1, or may correspond with the printer 4 or the screen 5 shown as part of the computer system 7 in FIG. 1a. In one example, the output component 64 may be used for displaying the selected route to the user 66 as part of the “Route Display” step 34, or to provide navigation guidance to the user 66 as part of the “Navigate” step 35.

The interface with the user 66 may be based on the input component 68 and the output component 64. For example, receiving input (visually or acoustically) from the user 66 via the input component 68 may be part of the “N Locations Select” step 41 or “Route Select” step 43. Similarly, outputting data (visually or acoustically) to the user 66 via the output component 64 may be part of the “Route Select” step 43, the “Route Display” step 34, or the guiding as part of the “Navigate” step 35. Such user 66 interface may be according to, or based on, a paper authored by Christopher Nowakowski (of California PATH, University of California, Berkeley), and Paul Green and Omer Tsimhoni (both of University of Michigan Transportation Research Institute (UMTRI)) entitled: “Common Automotive Navigation System Usability Problems and a Standard Test Protocol to Identify Them” [doi=10.1.1.458.1475] (downloaded from the Internet on October 2017), or may be according to, or based on, Society of Automotive Engineers, Inc. (SAE) standard J2365 (issued May 2002) and entitled: “Calculation of the Time to Complete In-Vehicle Navigation and Route Guidance Tasks”, which are both incorporated in their entirety for all purposes as if fully set forth herein. Further, the user 66 interface may be according to, or based on, SAE standard J2364 (Document No. J2364_201506 published and stabilized 2015 Jun. 18 entitled: “Navigation and Route Guidance Function Accessibility While Driving”.

The input component 68 may be a piece of computer hardware equipment used to provide data and control signals to an information processing system such as a computer or information appliance. Such input component 68 may be an integrated or a peripheral input device (e.g., hard/soft keyboard, mouse, resistive or capacitive touch display, etc.). Examples of input components include keyboards, mouse, scanners, digital cameras and joysticks. Input components 68 can be categorized based on the modality of input (e.g., mechanical motion, audio, visual, etc.), whether the input is discrete (e.g. pressing of key) or continuous (e.g., a mouse's position, though digitized into a discrete quantity, is fast enough to be considered continuous), the number of degrees of freedom involved (e.g., two-dimensional traditional mice, or three-dimensional navigators designed for CAD applications). Pointing devices (such as ‘computer mouse’), which are input components used to specify a position in space, can further be classified according to whether the input is direct or indirect. With direct input, the input space coincides with the display space, i.e., pointing is done in the space where visual feedback or the pointer appears. Touchscreens and light pens involve direct input. Examples involving indirect input include the mouse and trackball, and whether the positional information is absolute (e.g., on a touch screen) or relative (e.g., with a mouse that can be lifted and repositioned). Direct input is almost necessarily absolute, but indirect input may be either absolute or relative. For example, digitizing graphics tablets that do not have an embedded screen involve indirect input and sense absolute positions and are often run in an absolute input mode, but they may also be set up to simulate a relative input mode like that of a touchpad, where the stylus or puck can be lifted and repositioned.

The output component 64 may include a color display for displaying screen elements or for organizing on-screen items and controls for data entry. Further, the device may support the display of split-screen views (e.g., map view and turn-by-turn, map view and turn list, etc.), as is common in many navigation systems. The input component 68 may include dedicated hard controls for frequently used/accessed functions (e.g., repeat system message). Many systems used re-configurable keys/buttons whose function change depending on the application. Typically, a switch is used to activate the voice recognition system and it may increase system reliability. The input component 68 and the output component 64 may further cooperate to provide both auditory and visual feedback to confirm driver inputs and availability of the speech command. Further, a strategy to alert drivers through auditory tones/beeps in advance of the presentation of information, and/or changes in display status, may be used. This may limit the need for drivers to continuously monitor the system, or repeat system messages.

The device 65 may serve as a client device and may access data, such as retrieving data from, or sending data to, the server 23a over the Internet 22, such as via the ISP 16 as described in FIG. 1 above. The communication with the server 23a may be via a wireless network 39, by using the antenna 29 and the wireless transceiver 28 in the device 65.

In the case of wireless networking, the wireless network 39 may use any type of modulation, such as Amplitude Modulation (AM), a Frequency Modulation (FM), or a Phase Modulation (PM). Further, the wireless network 39 may be a control network (such as ZigBee or Z-Wave), a home network, a WPAN (Wireless Personal Area Network), a WLAN (wireless Local Area Network), a WWAN (Wireless Wide Area Network), or a cellular network. An example of a Bluetooth-based wireless controller that may be included in a wireless transceiver is SPBT2632C1A Bluetooth module available from STMicroelectronics NV and described in the data sheet DocID022930 Rev. 6 dated April 2015 entitled: “SPBT2632C1A—Bluetooth® technology class-1 module”, which is incorporated in its entirety for all purposes as if fully set forth herein.

Some embodiments may be used in conjunction with one or more types of wireless communication signals and/or systems, for example, Radio Frequency (RF), Infra-Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth (RTM), Global Positioning System (GPS), Wi-Fi, Wi-Max, ZigBee™, Ultra-Wideband (UWB), Global System for Mobile communication (GSM), 2G, 2.5G, 3G, 3.5G, Enhanced Data rates for GSM Evolution (EDGE), or the like. Further, a wireless communication may be based on, or may be compatible with, wireless technologies that are described in Chapter 20: “Wireless Technologies” of the publication number 1-587005-001-3 by Cisco Systems, Inc. (7/99) entitled: “Internetworking Technologies Handbook”, which is incorporated in its entirety for all purposes as if fully set forth herein.

Alternatively or in addition, the networking or the communication with the of the wireless-capable device 65 with the server 23a over the wireless network 39 may be using, may be according to, may be compatible with, or may be based on, Near Field Communication (NFC) using passive or active communication mode, and may use the 13.56 MHz frequency band, and data rate may be 106Kb/s, 212Kb/s, or 424 Kb/s, and the modulation may be Amplitude-Shift-Keying (ASK), and may be according to, may be compatible with, or based on, ISOIIEC 18092, ECMA-340, ISO/IEC 21481, or ECMA-352. In such a case, the wireless transceiver 28 may be an NFC transceiver and the respective antenna 29 may be an NFC antenna.

Alternatively or in addition, the networking or the communication with the of the wireless-capable device 65 with the server 23a over the wireless network 39 may be using, may be according to, may be compatible with, or may be based on, a Wireless Personal Area Network (WPAN) that may be according to, may be compatible with, or based on, Bluetooth™ or IEEE 802.15.1-2005 standards, and the wireless transceiver 28 may be a WPAN modem, and the respective antenna 29 may be a WPAN antenna. The WPAN may be a wireless control network according to, may be compatible with, or based on, ZigBee™ or Z-Wave™ standards, such as IEEE 802.15.4-2003.

Alternatively or in addition, the networking or the communication with the of the wireless-capable device 65 with the server 23a over the wireless network 39 may be using, may be according to, may be compatible with, or may be based on, a Wireless Local Area Network (WLAN) that may be according to, may be compatible with, or based on, IEEE 802.11a, IEEE 802.11b, IEEE 802.11g, IEEE 802.11n, or IEEE 802.11ac standards, and the wireless transceiver 28 may be a WLAN modem, and the respective antenna 29 may be a WLAN antenna.

Alternatively or in addition, the networking or the communication with the of the wireless-capable device 65 with the server 23a over the wireless network 39 may be using, may be according to, may be compatible with, or may be based on, a wireless broadband network or a Wireless Wide Area Network (WWAN), and the wireless transceiver 28 may be a WWAN modem, and the respective antenna 29 may be a WWAN antenna. The WWAN may be a WiMAX network such as according to, may be compatible with, or based on, IEEE 802.16-2009, and the wireless transceiver 28 may be a WiMAX modem, and the respective antenna 29 may be a WiMAX antenna. Alternatively or in addition, the WWAN may be a cellular telephone network and the wireless transceiver 28 may be a cellular modem, and the respective antenna 29 may be a cellular antenna. The WWAN may be a Third Generation (3G) network and may use UMTS W-CDMA, UMTS HSPA, UMTS TDD, CDMA2000 1×RTT, CDMA2000 EV-DO, or GSM EDGE-Evolution. The cellular telephone network may be a Fourth Generation (4G) network and may use HSPA+, Mobile WiMAX, LTE, LTE-Advanced, MBWA, or may be based on, or may be compatible with, IEEE 802.20-2008. Alternatively or in addition, the WWAN may be a satellite network, and the wireless transceiver 28 may be a satellite modem, and the respective antenna 29 may be a satellite antenna.

Alternatively or in addition, the networking or the communication with the of the wireless-capable device 65 with the server 23a over the wireless network 39 may be using, may be according to, may be compatible with, or may be based on, a licensed or an unlicensed radio frequency band, such as the Industrial, Scientific and Medical (ISM) radio band. For example, an unlicensed radio frequency band may be used that may be about 60 GHz, may be based on beamforming, and may support a data rate of above 7 Gb/s, such as according to, may be compatible with, or based on, WiGig™, IEEE 802.11ad, WirelessHD™ or IEEE 802.15.3c-2009, and may be operative to carry uncompressed video data, and may be according to, may be compatible with, or based on, WHDI™. Alternatively or in addition, the wireless network may use a white space spectrum that may be an analog television channel consisting of a 6 MHz, 7 MHz or 8 MHz frequency band, and allocated in the 54-806 MHz band. The wireless network may be operative for channel bonding, and may use two or more analog television channels, and may be based on Wireless Regional Area Network (WRAN) standard using OFDMA modulation. Further, the wireless communication may be based on geographically-based cognitive radio, and may be according to, may be compatible with, or based on, IEEE 802.22 or IEEE 802.11af standards.

Alternatively or in addition, the wireless network 39 may use a Dedicated Short-Range Communication (DSRC), that may be according to, compatible with, or based on, European Committee for Standardization (CEN) EN 12253:2004, EN 12795:2002, EN 12834:2002, EN 13372:2004, or EN ISO 14906:2004 standard, or may be according to, compatible with, or based on, IEEE 802.11p, IEEE 1609.1-2006, IEEE 1609.2, IEEE 1609.3, IEEE 1609.4, or IEEE1609.5. In such a case, the wireless transceiver 28 may be a DSRC modem, and the respective antenna 29 may be a DSRC antenna.

Any calculation of a route, such as in the “N! Routes Calculate” step 51, may use maps that are stored in the Maps Database 67a that is stored in the memory 63 of the device 65. Alternatively or in addition, the Maps Database 67a is used for the “Navigate” step 35, as well as in the “Route Display” step 34, where the maps may represented on color displays (such as on a display that is part of the output component 64) using scales as of approximately 1:2,000 in 2D, perspective 2D (pseudo 3D), or read 3D. Such presentation is helpful for obtaining a general overview of the route in the immediate locality or over a wider area. Additional information in the maps database 67a may be used for presenting bodies of water, railroads, and forests for providing added orientation. Maps in the Maps Database 67a are typically based on high-precision official maps and satellite and aerial photographs. A process known as ‘map matching’ continuously compares the located position with the route on the digital map. In this way, the exact vehicle (or the device 65) position can also be shown on the map, even if the located position is inaccurate (such as due to lack of GPS signal or errors in a dead-reckoning scheme). Route guidance driving recommendation as part of the “Navigate” step 35 can thus be output (such as via the output component 64) at the best possible location. Further, sensors errors and cumulative dead-reckoning errors may be compensated. The digital maps typically contain directories so that a destination or location can be entered as an address. Lists of all known place names may be used for this purpose, where all locations are allocated lists containing the names of the stored street names. To pinpoint a destination even further, the user can select road/street intersection, or the number of a building. POIs, such as airports, train stations, fuel filling stations, or multi-stories parking garages, are stored in thematic directories. These directories makes it possible, for example, to locate a nearby POI (such as a fuel filling station), and to mark it on the displayed map. In one example, the Maps Database 67a comprises road network data, such as road configuration, including connections conditions and other attributes, background data such as rivers, shores, railroads, contours, site information data such as building names, addresses, and representative structures, and voice data files for voice guidance.

In one example, the Maps Database 67a may be according to the Navigation Data Standard (NDS) described in the web-site nds-association.org (preceded by www.). The NDS is standardized format for automotive-grade navigation databases, jointly developed by automobile manufacturers and suppliers. NDS is an association registered in Germany. Members are automotive OEMs, map data providers, and navigation device/application providers. NDS aims to develop a standardized binary database format that allows the exchange of navigation data between different systems. NDS separates navigation software from navigation data, thus enhancing flexibility for creating various navigation products for end users. In addition to this interoperability, NDS databases support incremental updates, protection against illegal use, and compactness. NDS uses the SQLite Database File Format. An NDS database can consist of several product databases, and each product database may be divided further into update regions. This concept supports a flexible and consistent versioning concept for NDS databases and makes it possible to integrate databases from different database suppliers into one NDS database. The inner structure of databases complying with NDS is further characterized by building blocks, levels and the content itself. All navigation data in an NDS database belongs a specific building block. Each building block addresses specific functional aspects of navigation, such as names for location input, routing, or map display. To cover specific use cases, navigation systems and applications may be required to filter and aggregate data from different building blocks, e.g., from both Routing and Map Display in order to calculate a route and show it to the user. Each update region may contain data from multiple building blocks. Within a product database, which has several update regions, there may thus be several instances of the same building block. Example: In a Europe product database, there may be a Basic Map Display building block in the update region “France” and a Basic Map Display building block in the update region “Germany”.

In one example, part of, or all of, the steps, methods, or flow charts described herein are executed (independently or in cooperation) by a client device, or any device such as the device 65 shown in FIG. 6. Alternatively or in addition, part of, or all of, the steps, methods, or flow charts described herein are executed (independently or in cooperation) by a server device, such as server 23a shown as part on the arrangement 60 shown in FIG. 6. In one example, a client device (such as the device 65) and a server (such as the server 23a) cooperatively perform part of, or all of, the steps, methods, or flow charts described herein. For example, some of the required processing, such as required for calculating routes as part of the “N! Routes Calculate” step 51, may be performed by a server (such as the server 23a), offloading, saving, or reserving processing resources in the client device. For example, lower computing power processor 12 may be used in the device 65, since the heavy or resourceful computations are performed at a remote server. Such scheme may obviate the need for expensive and resourceful device. In another example, memory resources may be saved at the client device by using data stored at a server. Such an example is illustrated in an arrangement 60a shown in FIG. 6a, where the Maps Database 67a is stored as part of the memory 61, which is part of, or connected to, the server 23a. In such a case, the storage 63 in a device 65a is relieved from storing the Maps Database 67a, and may only be required to store the Instructions 67b and the Operating System 67c. In such a case, the device 65a may mainly be used for interfacing the user 66, while the major storing and processing resources and activities are provided by the server 23a.

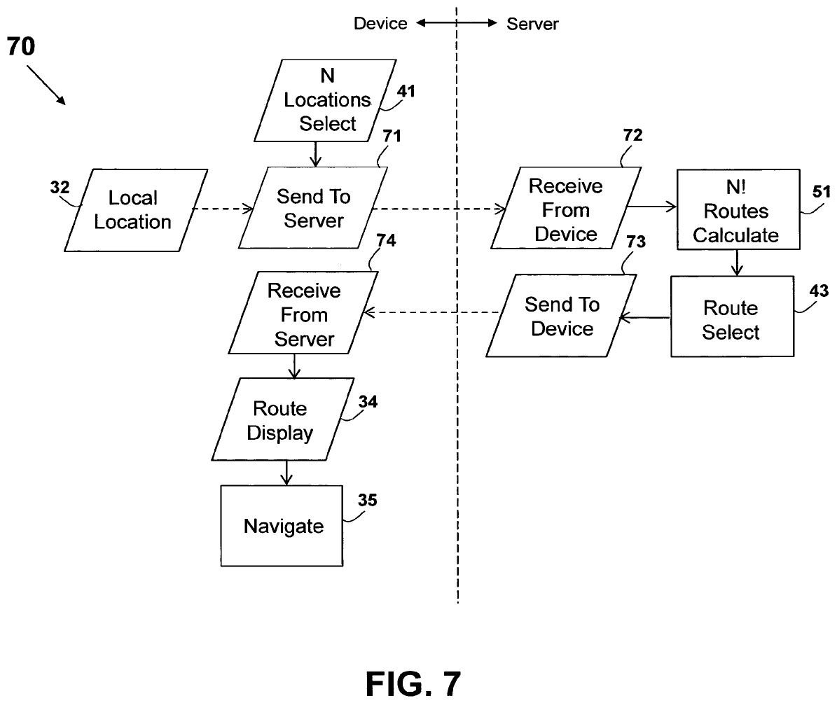

An example of a flow chart 70 involving cooperation between the device 65a and the server 23a is shown in FIG. 7. The locations selected by the user in the “N Locations Select” step 41 and the current device 65a position estimated as part of the “Local Location” step 32 are sent to the server 23a as part of a “Send to Server” step 71, such as by using the wireless transceiver 28 and the antenna 29. Upon receiving this data from the device 65a as part of a “Receive From Device” step 72, the server 23a, using the stored (or connected to) Maps Database 67a performs the “N! Routes Calculate” step 51, followed by selecting the optimal route as part of the “Route Select” step 43. Then the selected route is sent back to the device 65a as part of a “Send To Device” step 73, and received by the device 65a as part of a “Receive From Server” step 74 (such as by using the wireless transceiver 28 and the antenna 29). The device 65a then continues with displaying the selected route as part of the “Route Display” step 34 followed by the actual navigation guidance as part of the “Navigate” step 35. It is noted that in such a scenario, the server 23a may serve multiple devices concurrently (or sequentially), offering the associated savings of the common server/client resources sharing approach.

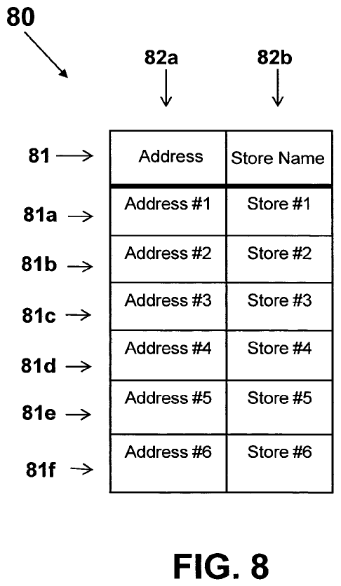

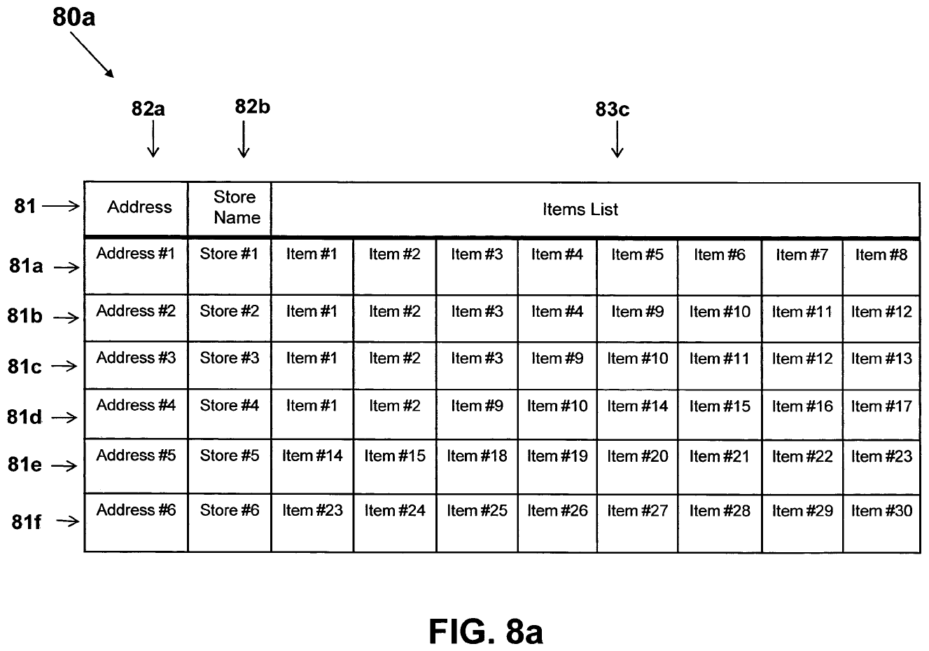

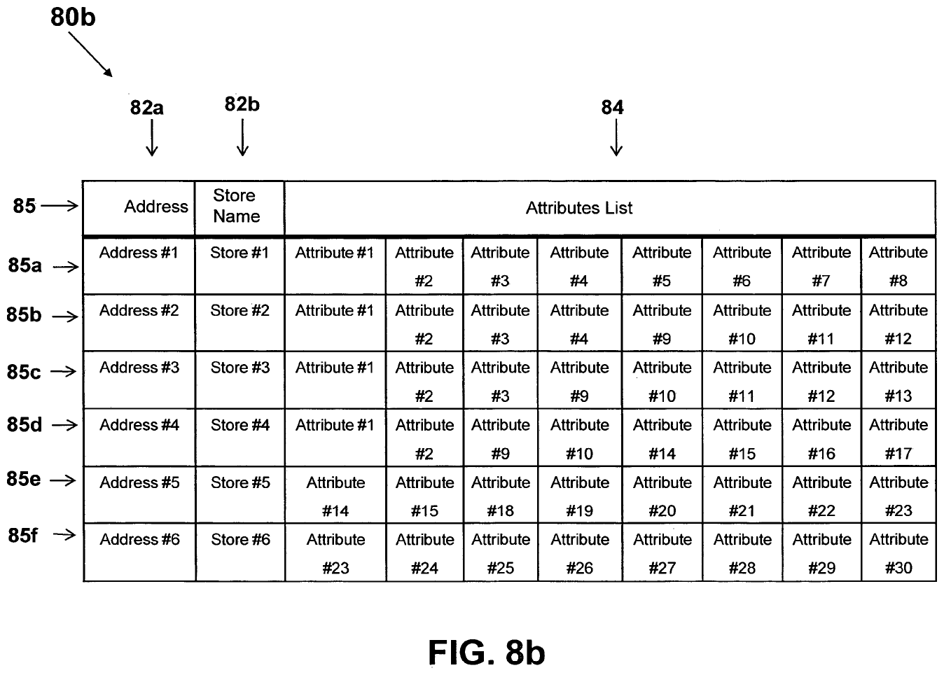

The user 66 may input a single destination location (or multiple locations) to a navigation system, such as in the “Location Select” step 31 or in the “N Locations Select” step 41, using the destination geographical coordinates, such as an address or intersection. Alternatively or in addition, the destination location (such as a POI) may be identified by a name or place. In such a case, a database, such as a database 80 shown as a table in FIG. 8, associates the location or place name to the geographical physical address that is actually used by the navigation system for calculating the route to that destination. For example, the table 80 may include entries that relate to multiple stores. In such a case, the table 80 may contain multiple entries (represented as rows in the table 80), each for a store (or unique place, location, or POI), and includes a first column ‘Address’ 82a that includes the address for each place, and a second column ‘Store Name’ 82b that uniquely identifies a specific store. An entry (or row) 81 for each store included in the table 80 includes its name and address, such as an Address #1 for Store #1 81a, an Address #2 for Store #2 81b, an Address #3 for Store #3 81c, an Address #4 for Store #4 81d, an Address #5 for Store #5 81e, and an Address #6 for Store #6 81f. Upon input of a store name from the user 66 via the input component 68, the relevant entry is identified in the table 80, and the associated address is used for calculating the route. For example, if the name entered by the user 66 is identified as the Store #4 name, the record 81d is identified, and the associated Address #4 is actually used for any navigation related activity. While 6 stores are shown as part of the database represented as the table 80 in FIG. 8, any number of distinct stores may be used, such as over 5, 10, 20, 50, 100, 200, 500, 1,000, 2,000, 5,000, 10,000, 20,000, 50,000, or 100,000 distinct stores. The database 80 may be part of, or included in, the Maps Database 67a, that may be stored in the device 65 (or 65a). Alternatively or in addition, the database 80 may be part of, or included in, the Maps Database 67a, that may be stored in the database memory 61 that may be part of, or connected to, the server 23a.

When a user 66 is in need for an item or product, he needs to determine what stores stocks or offers the product for sale, then to enter the store name (or address) to the system, such as by the input component 64, for being guided to selected store via the navigation system. However, the user 66 may not know which store indeed offers the required item, or which store that offers the item is the closest one. In one example, as an alternative (or as an addition) to defining a destination by a name (such as the store name 82b) or by a geographical location (such as the store address 82a), the user 66 may only define the required product for purchase, and the navigation system will guide him to the nearest store where the required product may be purchased.

Product based navigation scheme may use an example of a Product Database 80a shown as a table in FIG. 8a, based on the table 80 shown in FIG. 8. In addition to the store name 82b and the geographical address 82a, each entry (represented as a row in the table 80a) further comprises a list of items 83c that are available for purchase in the store identified by this entry. In the example of table 80a, the store #1 that corresponds to the first entry 81a offers for sale Item #1, Item #2, Item #3, Item #4, Item #5, Item #6, Item #7, and Item #8. Similarly, the store #2 that corresponds to the second entry 81b offers for sale Item #1, Item #2, Item #3, Item #4, Item #9, Item #10, Item #11, and Item #12, and the store #3 that corresponds to the third entry 81c offers for sale Item #1, Item #2, Item #3, Item #9, Item #10, Item #11, Item #12, and Item #13. While the same number of items is exampled in the table 80a, different number of items may be offered by each store. Further, while each store is shown to offer 8 items for sale, any number of items may equally be used, and each of the stores may offer at least 5, 10, 20, 50, 100, 200, 500, 1,000, 2,000, 5,000, 10,000, 20,000, 50,000, or 100,000 distinct items.

Alternatively or in addition to product-based database, the navigation may be based on any attribute of a location, such as stores, as exampled by an Attributes Database 80b shown as a table in FIG. 8b, based on the table 80 shown in FIG. 8. In addition to the store name 82b and the geographical address 82a, each entry (represented as a row in the table 80b) further comprises a list of attributes 84 that relates to the store (or any location/POI) identified by this entry. In the example of table 80b, the store #1 that corresponds to the first entry 85a is associated with Attribute #1, Attribute #2, Attribute #3, Attribute #4, Attribute #5, Attribute #6, Attribute #7, and Attribute #8. Similarly, the store #2 that corresponds to the second entry 85b is associated with Attribute #1, Attribute #2, Attribute #3, Attribute #4, Attribute #9, Attribute #10, Attribute #11, and Attribute #12, and the store #3 that corresponds to the third entry 85c Attribute #1, Attribute #2, Attribute #3, Attribute #9, Attribute #10, Attribute #11, Attribute #12, and Attribute #13. While the same number of attributes is exampled in the table 80b, different number of attributes may be offered by each store. Further, while each store is associated with 8 attributes, any number of attributes may equally be used, and each of the stores may be associated with at least 5, 10, 20, 50, 100, 200, 500, 1,000, 2,000, 5,000, 10,000, 20,000, 50,000, or 100,000 distinct attributes. In one example, an attribute is a category or identifier that relates to multiple stores or locations, and may involve any feature or characteristics that may define such multiple stores or locations.

In one example, part or all of the attributes may be associated with the store type. For example, is being part of a chain, the chain name may be used as an attribute, such as McDonald's and Walmart. Alternatively or in addition, part or all of the attributes may be associated with the store structure and place, such as indoor or outdoor physical structure, if parking is available or if there a ‘drive-thru’ facility. Similarly, part or all of the attributes may be associated with the area around the store, such as street based, in mall, or shopping district or center. Similarly, the price level may be used as attribute, such as being a discount or wholesale store, or otherwise defining the store level in a supply chain. Further, part or all of the attributes may be associated with the store size, either by means of physical size or by the number of products that are stored or offered.

Alternatively or in addition, part or all of the attributes may be associated with the category or type or products (or services) that may be supplied by the associated store (or location). For example, assuming that the products are food products, the attributes may include ‘restaurant’, ‘fast food’, or ‘dairy’ for dairy products. Other products groups may be defined as clothes, consumer goods, or appliances.

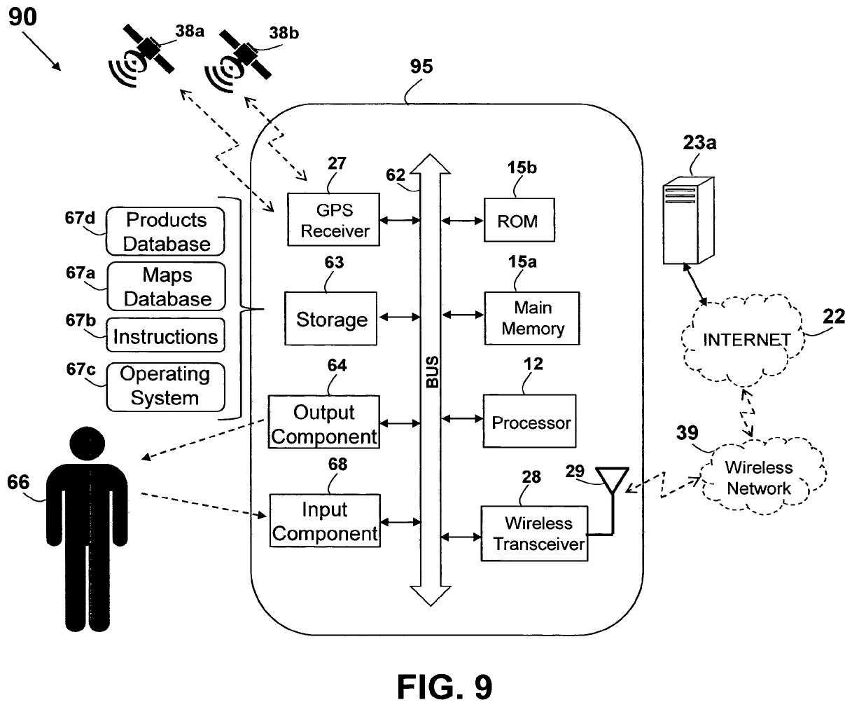

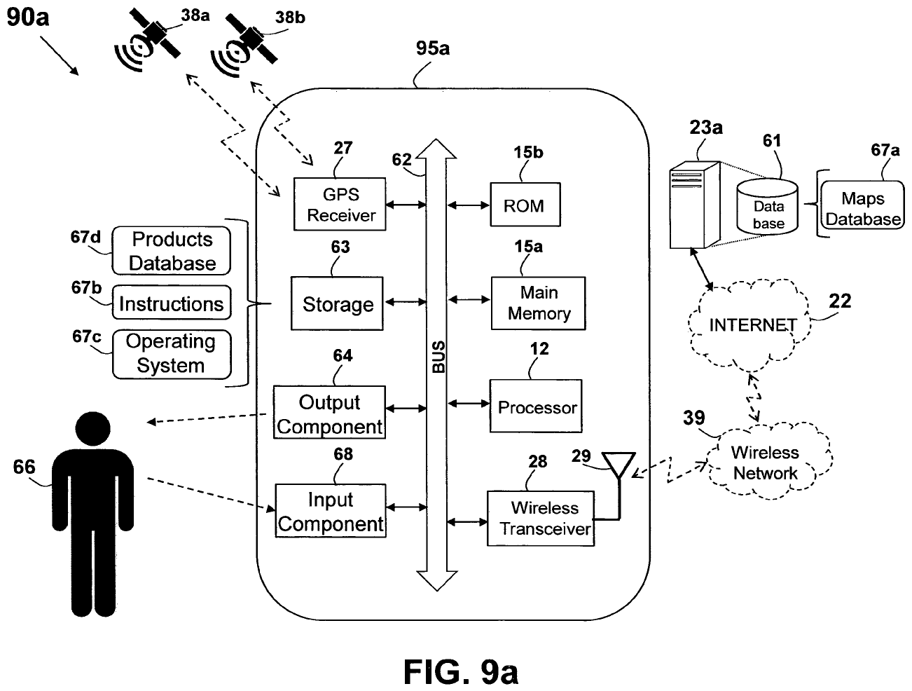

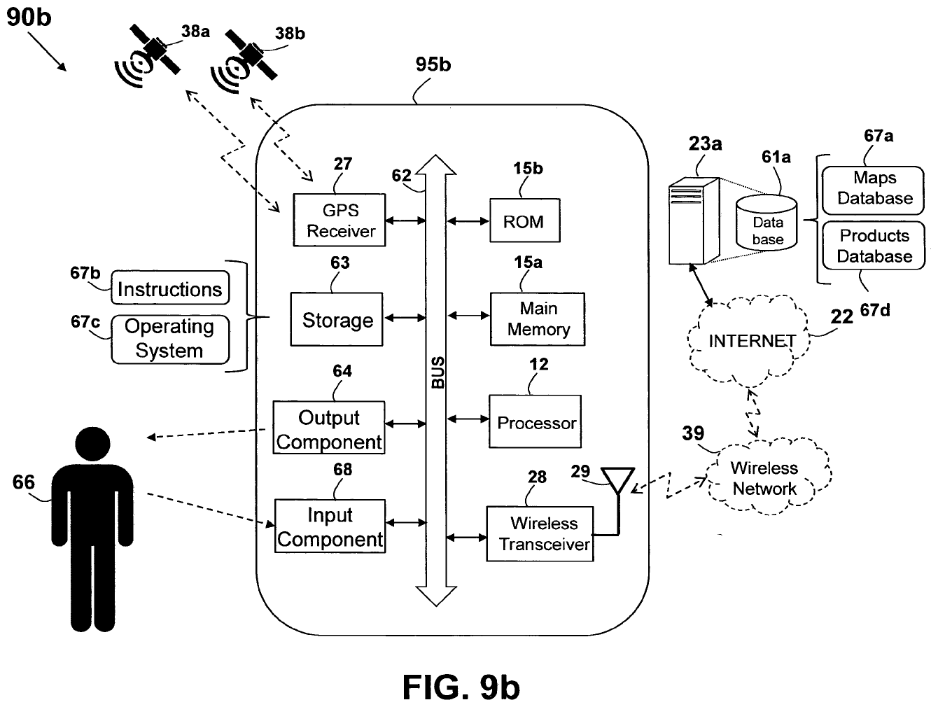

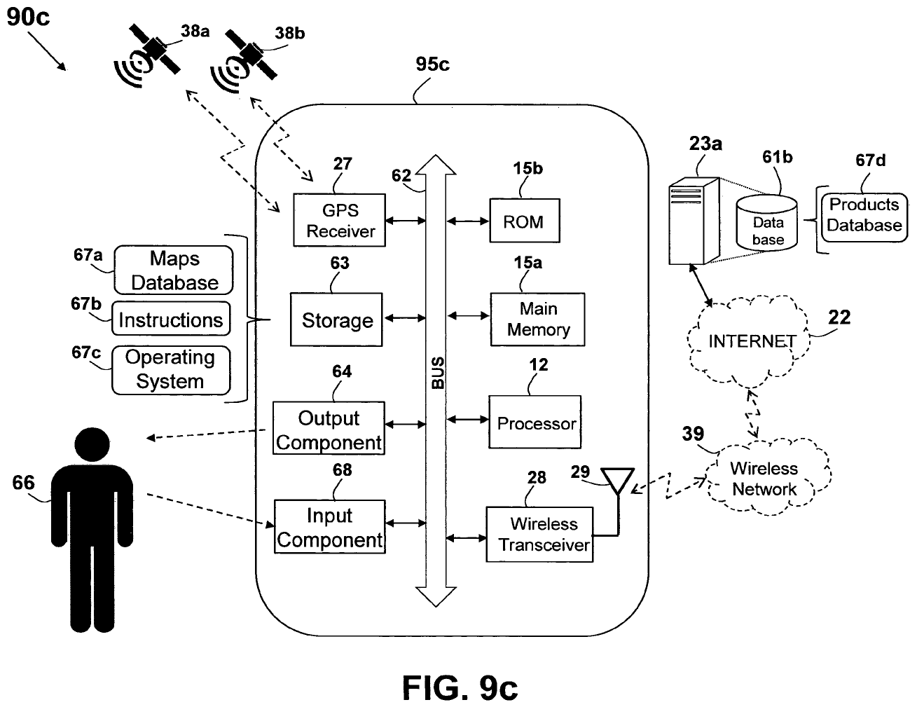

An example of a navigation device 95, which is based on the navigation device 65 shown in FIG. 6 and that use a Products Database 67d, that may correspond to the table 80a shown in FIG. 8a, is shown in FIG. 9, as part of an arrangement 90. In addition to the Maps Database 67a, the storage 63 in the device 95 further stores the Product Database 67d, allowing for an operation independent of any external device, such as the external server 23a.

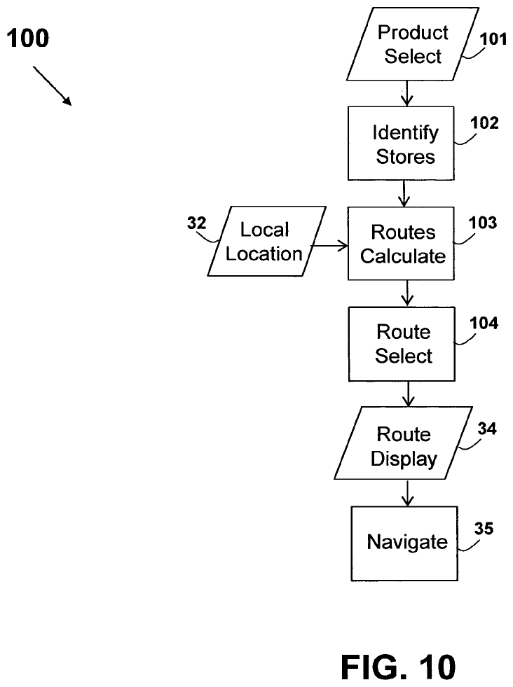

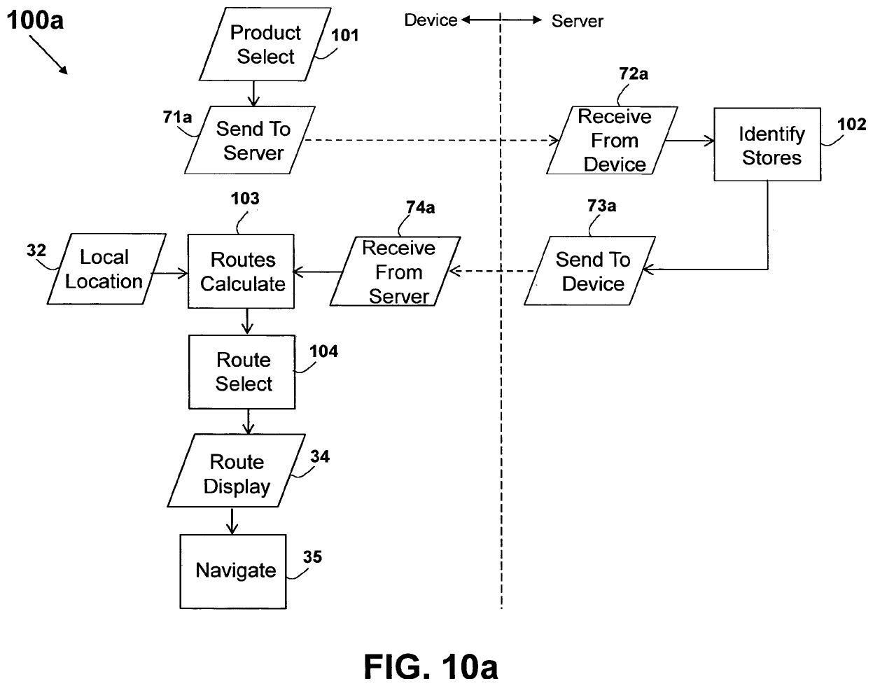

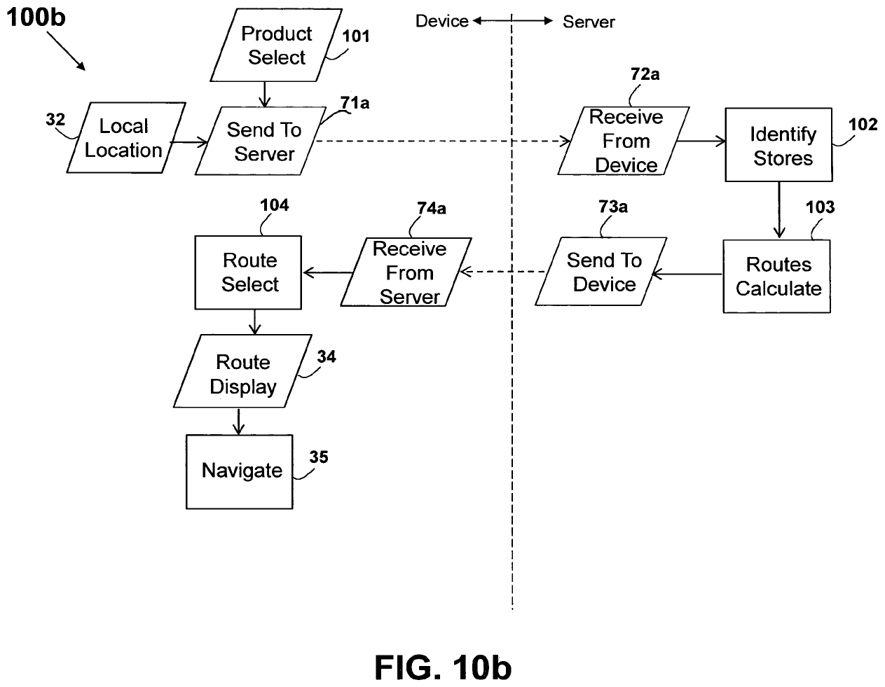

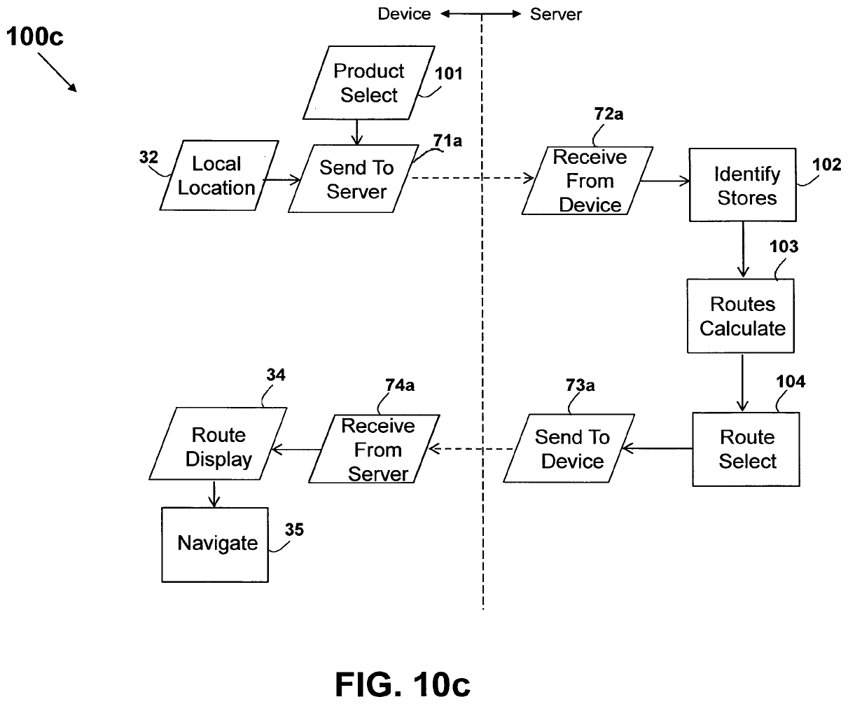

A flow chart 100 that uses the Product Database 67d, that may, for example, include the table 80a, is shown in FIG. 10. While explained regarding the navigation device 95, the flow chart 100 may be executed by any navigation device. As part of a first “Product Select” step 101, the user 66, for example by using the input component 68, identifies to the device 95 a required product (or item). Such action is in contrast to entering a geographic location or a location name as known in the art. For example, the user 66 may identify as part of the “Product Select” step 101 an identification of any of the Items #1 to #30 shown in the Items entries 83c as part of the table 80a. As part of an “Identify Stores” step 102, the navigation device 95 identifies the entries of the table 80a that corresponds to the stores that offer the required product for sale. In one example, the requested item is offered only by a single store. The store names shown as part of the column 82b may be presented to the user, such as by the output component 64, for example for identifying the stores as part of the “Identify Stores” step 102, and the selected store name may be presented as part of the “Route Select” step 104 or as part of the “Route Display” step 34.

In the example of the table 80a shown in FIG. 8a, if the requested product is Item #8, it is only offered by the Store #1 relating to the first entry 81a. Similarly, if the requested product is Item #17, it is only offered by the Store #4 as part of fourth entry 81d, and if the requested product is Item #29, it is only offered by the Store #6 relating to the sixth entry 81f. In a case where only a single store is identified, the corresponding address is used for calculation as part of a “Routes Calculate” step 103. For example, if the requested product is Item #8, the route is calculated as part of a “Routes Calculate” step 103 using Address #1 as the destination, if the requested product is Item #17, the route is calculated as part of a “Routes Calculate” step 103 using Address #4 as the destination, and if the requested product is Item #29, the route is calculated as part of a “Routes Calculate” step 103 using Address #6 as the destination. However, some products may be available at multiple stores or locations. For example, Item #10 is available at the Store #2 (shown as part of the second entry 81b), at the Store #3 (shown as part of the third entry 81c), and at the Store #4 (shown as part of the fourth entry 81d). Similarly, Item #23 is available at the Store #5 (shown as part of the fifth entry 81e) and at the Store #6 (shown as part of the sixth entry 81f).

If the product is available in multiple locations or stores, it is assumed that the user 66 wishes to select a store according to a criterion or a rule, such as the closest store. In case of availability in multiple stores, the route to each of the stores is calculated as part of the “Routes Calculate” step 103. Based on the calculated routes, a single route is selected, manually by the user 66 or automatically by the system itself, without the user intervention. The user 66 can stipulate different options that may serve as criteria for selecting a store based on the corresponding calculated route, such as optimizing the route (or any part thereof) based on driving time, based on economic mean of driving time and driving distance, based on an estimated minimum fuel consumption, or based on avoiding interstates/expressways, ferry crossings, or toll roads. For example, in the above example of Item #10, which is available at the Store #2, at the Store #3, and at the Store #4, the routes to the three corresponding locations Address #2, Address #3, and Address #4 are calculated as part of the “Routes Calculate” step 103, and one of the stores is selected based on the respective calculated route as part of a “Route Select” step 104. For example, Store #3 may be selected since the driving distance from the origin to the Address #3 according to the calculated route is less than the driving distance from the origin to the Address #2 and to Address #4. The route associated with the store selected as part of the “Route Select” step 104 is presented to the user 66 as part of the “Route Display” step 34 as described herein, and the user 66 is guided to the selected store as part of the “Navigate” step 35, as described herein.

In one example, part of, or all of, the steps, methods, or flow charts described herein are executed (independently or in cooperation) by a client device, or any device such as the device 95 shown as part of the arrangement 90 in FIG. 9. Alternatively or in addition, part of, or all of, the steps, methods, or flow charts described herein are executed (independently or in cooperation) by a server device, such as server 23a shown as part on the arrangement 90a shown in FIG. 9a. In one example, a client device (such as a device 95a) and a server (such as the server 23a) cooperatively perform part of, or all of, the steps, methods, or flow charts described herein. In the example shown in the arrangement 90a, the Maps Database 67a is stored in the database 61 that is part of, or connected to, the server 23a, similar to the arrangement 60a shown in FIG. 6a, and corresponding to the flow chart 70 shown in FIG. 7.

Alternatively or in addition, part of, or all of, the steps, methods, or flow charts described herein are executed (independently or in cooperation) by a server device, such as server 23a shown as part on the arrangement 90b shown in FIG. 9b. In one example, a client device (such as a device 95b) and a server (such as the server 23a) cooperatively perform part of, or all of, the steps, methods, or flow charts described herein. In the example shown in the arrangement 90b, the Products Database 67d (in addition to the Maps Database 67a) is stored in the database 61a that is part of, or connected to, the server 23a. In such a scenario, some of the required processing, such as required for calculating routes as part of the “Identify Stores” step 102, may be performed by the server (such as the server 23a), offloading, saving, or reserving processing or storage resources in the client device. For example, lower computing power processor 12 may be used in the device 95b, since the heavy or resourceful computations are performed at a remote server. Such scheme may obviate the need for expensive and resourceful device. In another example, memory resources may be saved at the client device by using data stored at a server. In such a case, the storage 63 in a device 95b is relieved from storing the Products Database 67d, and may only be required to store the Instructions 67b and the Operating System 67c. In such a case, the device 95b may mainly be used for interfacing the user 66, while the major storing and processing resources and activities are provided by the server 23a. Alternatively or in addition, the Products Database 67d is stored in the database 61b that is part of, or connected to, the server 23a, while the Maps database 67a is stored in a navigation device 95c, shown as part of an arrangement 90c in FIG. 9c.

An example of a flow-chart 100a involving cooperation between the device 95b (or the device 95c that is part of the arrangement 90c) and the server 23a is shown in FIG. 10a. The selection of the requested product as part of the “Product Select” step 101 is sent to the server 23a as part of a “Send to Server” step 71a, such as by using the wireless transceiver 28 and the antenna 29. Upon receiving this data from the device 95b (or the device 95c that is part of the arrangement 90c) as part of a “Receive From Device” step 72a, the server 23a, using the stored (or connected to) Products Database 67d performs the “Identify Stores” step 102. Then the identified stores (or only a single store, where applicable) that offer the required product are sent back to the device 95b (or the device 95c that is part of the arrangement 90c) as part of a “Send To Device” step 73a, and received by the device 95b as part of a “Receive From Server” step 74a (such as by using the wireless transceiver 28 and the antenna 29). The device 95b (or the device 95c that is part of the arrangement 90c) then continues with calculating the routes to the identified stores as part of the “Routes Calculate” step 103, followed by selecting the optimal destination/store based on the calculated routes as part of the “Route Select” step 104, which is followed by the actual navigation guidance as part of the “Navigate” step 35. It is noted that in such a scenario, the server 23a may serve multiple devices concurrently (or sequentially), offering the associated savings of the common server/client resources sharing approach.

In order to further relieve the navigation device 95b (or the device 95c) from excessive processing, the “Routes Calculate” step 103 may be performed by the server 23a, rather than in the device itself as described in the flow chart 100a, as described in a flow chart 100b shown in FIG. 10b. Such a scheme is in particular useful when the Maps Database 67a is stored by, or accessed via, the server 23a, in addition to the Products Database 67d, as shown in the arrangement 90b shown in FIG. 9b. Furthermore, the server 23a may further store the route selection criteria and use these criteria to select the optimal store/route pair as part of the “Route Select” step 104, as shown in a flow chart 100c shown in FIG. 10c.

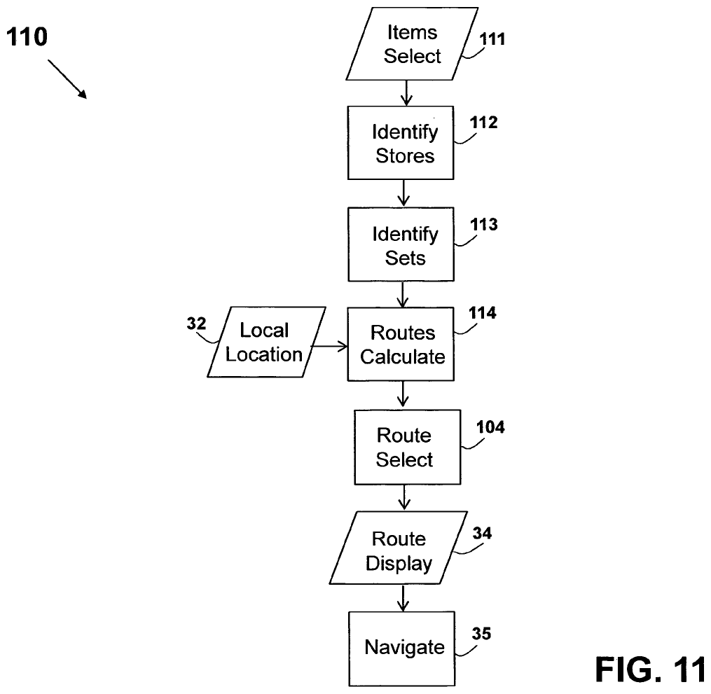

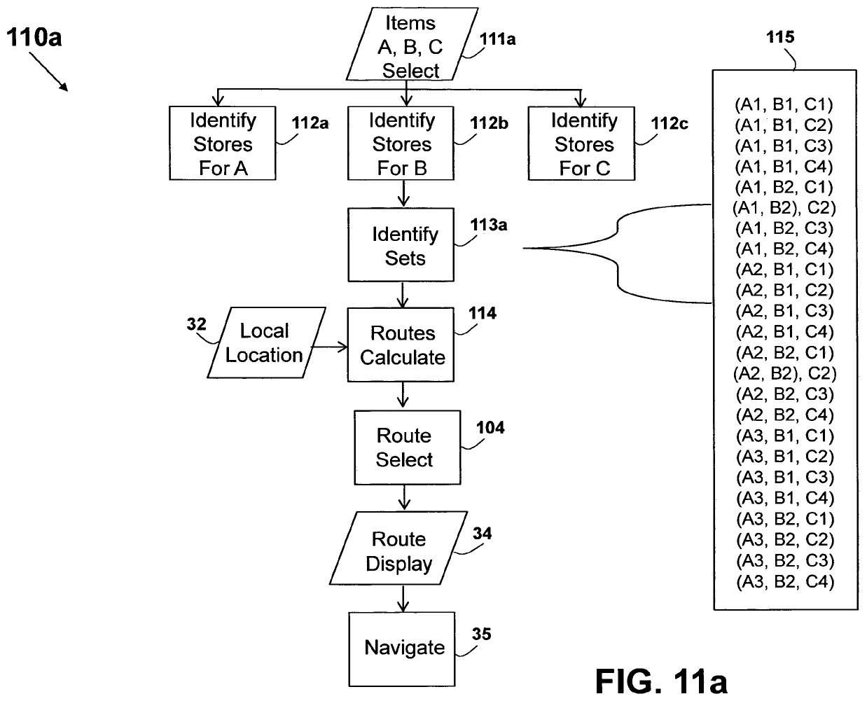

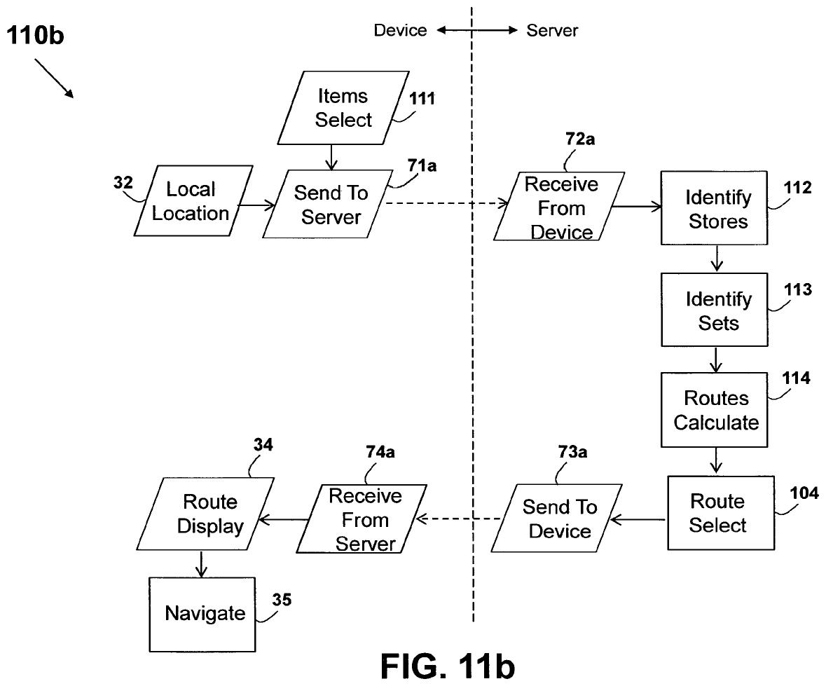

The method exampled in the flow-chart 100 shown in FIG. 10 provides a user the optimal route to fetch a single item, such as a product, service, or to perform any other single task. Similarly, a flow-chart 110 shown in FIG. 11 provides the user the optimal route for fetching multiple items, where each item may be a product, service, or any other attribute associated with a location. Such a method relieves a human user from the burden to define or select concrete locations when planning a trip, but rather to define the required goals or targets, such as the products or services, where the optimal route is automatically calculated, based on minimal cost route, such as minimum total distance or minimum travel time.

Similar to the “Product Select” step 101 where a single item (such as a product) is selected by the user, the multi-items fetching flow-chart 110 starts with the user defining the required items as part of an “Items Select” step 111. Then, similar to the “Identify Stores” step 102, the available locations for fetching each of the items that are defined as part of the “Items Select” step 111 are defined as part of an “Identify Stores” step 112. For example, a data base may be used, such as the table 80a in FIG. 8a or the table 80b in FIG. 8b. Based on the possible locations of stores identified as part of the “Identify Stores” step 112, a collection of sets is defined, where each set includes all of the locations (such as stores) that satisfy the fetching of the items defined in the “Items Select” step 111. The count of items that may be selected by the user as part of the “Items Select” step 111 may be at least 2, 3, 4, 5, 8, 10, 12, 15, 20, 25, 30, 40, 50, 80, or 100 items. Further, the number of items that may be selected by the user as part of the “Items Select” step 111 may be less than 3, 4, 5, 8, 10, 12, 15, 20, 25, 30, 40, 50, 80, 100, or 150 items.

In one example, all steps, functionalities and action as part of the flow chart 110 are performed by a navigation device, such as the device 95 shown in FIG. 9. Alternatively or in addition, part of the steps (or part thereof), action, or functionalities are performed by the navigation device, such as the navigation device 95c, and part by a server, such as server 23a. For example, the navigation device may perform the user interaction steps, while the server performs all non-interaction actions, as exampled in a flow chart 110b shown in FIG. 11b. The server, such as the server 23a, may store the maps database 67a (as shown in the arrangement 60a shown in FIG. 6a), the products database 67d, or both, as shown in the arrangement 90b shown in FIG. 9b.

The routing of each of the sets in the collection is calculated as part of a “Routes Calculate” step 114, which may corresponds to the “Routes Calculate” step 103 in the flow chart 100, or the routes calculation steps 42a and 42b in the flow chart 40. The routes are calculated from an origin point, which is commonly the existing location of a device. The order of the locations of each set is also checked for an optimal order or arriving, and a cost is associated with each calculated route, such as total distance to travel, estimated travel time, or any other cost associated with a specific calculated route. Similar to the “Route Select” step 43, the set associated with the optimal route, according to a pre-set criterion or rule such as minimum calculated cost, is selected as part of the “Route Select” step 104, and then the selected route is displayed to the user as part of the “Route Display” step 34, followed by the actual navigation as part of the “Navigate” step 35.

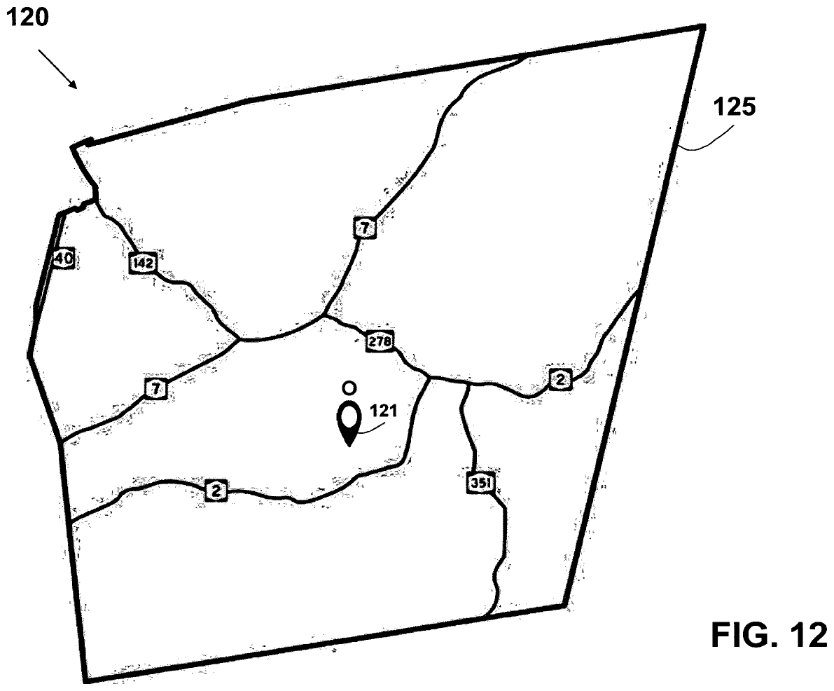

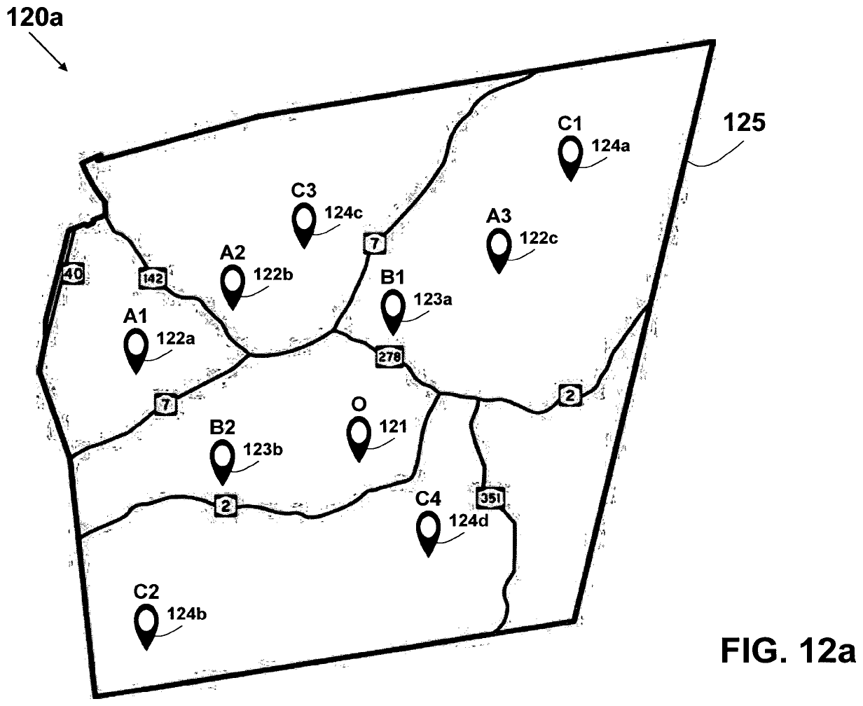

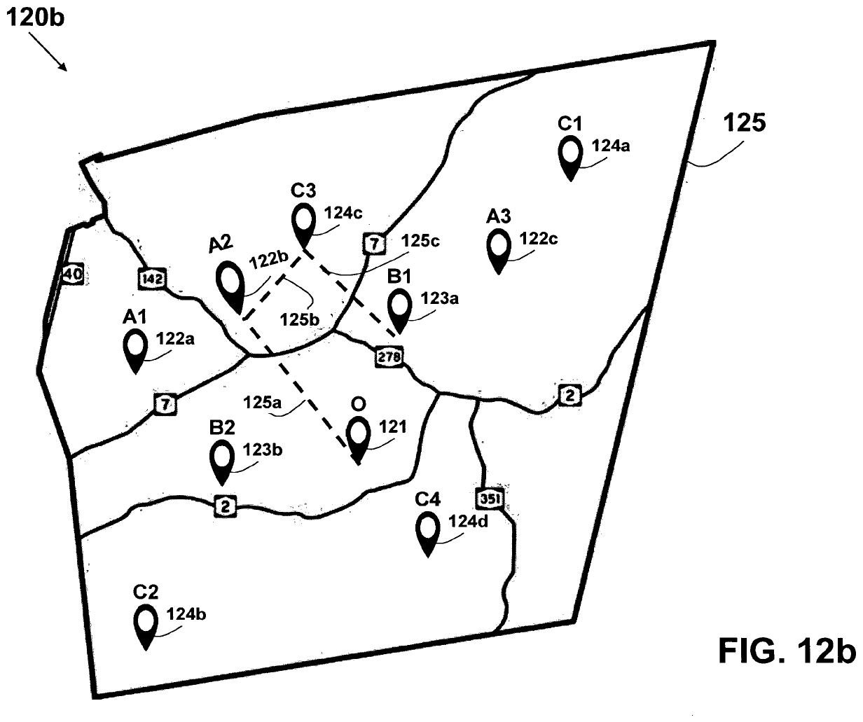

A flow chart 110a shown in FIG. 11a describes the flow chart 110 exampled with three items or products, referred to as ‘A’, and ‘C’. The planning may be exampled with a map 125 shown in FIG. 12, where the origin ‘O’ location 121 is marked. As part of a “Items A, B, C Select” step 111a, corresponding to “Items Select” step 111, the three products or items ‘A’, and ‘C’ are defined to the system by the user, available in various stores shown in a view 120a shown in FIG. 12a. As part of an “Identify Stores For A” step 112a, corresponding to the “Identify Stores” step 112, the stores (or locations) where item ‘A’ may be fetched or bought are retrieved, such as from a data base associating items (or products) with locations (or stores). For example, three stores may be available for satisfying the requirement for item ‘A’, designated as ‘A1’ (shown as a location A1 122a on the map 125 in FIG. 12a), ‘A2’ (shown as a location A2 122b on the map 125 in FIG. 12a), and ‘A3’ (shown as a location A3 122c on the map 125 in FIG. 12a), each associated with a specific location of the respective store. Similarly, as part of an “Identify Stores For B” step 112b, corresponding to the “Identify Stores” step 112, the stores (or locations) where item ‘B’ may be fetched or bought are retrieved, such as from a data base associating items (or products) with locations (or stores). For example, two stores may be available for satisfying the requirement for item designated as ‘B1’ (shown as a location B1 123a on the map 125 in FIG. 12a) and ‘B2’ (shown as a location B2 123b on the map 125 in FIG. 12a), each associated with a specific location of the respective store. Further, relating to the third product ‘C’, as part of an “Identify Stores For C” step 112c, which may be corresponding to the “Identify Stores” step 112, the stores (or locations) where item ‘C’ may be fetched or bought are retrieved, such as from a data base associating items (or products) with locations (or stores). For example, four stores may be available for satisfying the requirement for item ‘C’, designated as ‘C1’ (shown as a location C1 124a in map 125 in FIG. 12a), ‘C2’ (shown as a location C2 124b on the map 125 in FIG. 12a), ‘C3’ (shown as a location C3 124c on the map 125 in FIG. 12a), and ‘C4’ (shown as a location C4 124d on the map 125 in FIG. 12a), each associated with a specific location of the respective store.

As part of an “Identify Sets” step 113a, which corresponds to the “Identify Sets” step 113, all possible sets of locations that satisfy the requirement for the items selected as part of the “Items A, B, C Select” step 111a are defined. At first, only non-ordered sets are defined (where the order in the set is not relevant), shown as a collection 115 of sets. In the above example, the possible non-ordered sets include 3×2×4=24 sets that include (A1, B1, C1), (A1, B1, C2), (A1, B1, C3), (A1, B1, C4), (A1, B2, C1), (A1, B2, C2), (A1, B2, C3), (A1, B2, C4), (A2, B1, C1), (A2, B1, C2), (A2, B1, C3), (A2, B1, C4), (A2, B2, C1), (A2, B2, C2), (A2, B2, C3), (A2, B2, C4), (A3, B1, C1), (A3, B1, C2), (A3, B1, C3), (A3, B1, C4), (A3, B2, C1), (A3, B2, C2), (A3, B2, C3), and (A3, B2, C4). In the general case N items may be involved and the number of locations of each item may be designated as L(i), where T is one of the selected items. In such a case, the number of the relevant ordered sets is calculated as L(1)×L(2)×L(3) . . . L(N). In the example above, N=3, L(1)=3, L(2)=2, and L(3)=4.

In one example, it is assumed that the order of fetching the items, relating to the order of reaching the corresponding location, is not of importance. In such a case, the optimal route for each set of the collection (such as the collection 115) may further involve finding the optimal order within the set itself, as described above relating to the “N! Routes Calculates” step 51 shown in FIG. 5 above. For example, the ordered set (A1, B1, C1) relates to all permutation of the locations in the set, which include 2×3=6 sets, which include (A1, B1, C1), (A1, C1, B1), (C1, A1, B1), (B1, A1, C1), (C1, B1, A1), and (B1, C1, A1). Similarly, the set (A2, B2, C2) effectively relates to the 6 sets: (A2, B2, C2), (A2, C2, B2), (C2, A2, B2), (B2, A2, C2), (C2, B2, A2), and (B2, C2, A2). In this example, the total number of sets that are checked as part of the “Routes Calculate” step 114 is 24×6=144. In the general case, since the number of permutations of N elements is N!, the number of sets that are checked is calculated as [L(1)×L(2)×L(3) . . . L(N)]×N!.

As part of a “Routes Calculate” step 114, corresponding to the “Routes Calculate” step 114 of the flow chart 110, the 144 possible sets are calculated and a ‘cost’ (such as total distance or travel time) is associated with each checked possible set. The routes are calculated from an origin location designated ‘O’, which may be the current location of the device. For example, the first 6 sets associated with stores A1, B1, and C1 are calculated as routes in the order of (O, A1, B1, C1), (O, A1, C1, B1), (O, C1, A1, B1), (O, B1, A1, C1), (O, C1, B1, A1), and (O, B1, C1, A1). Similarly, the first 6 sets associated with stores A3, B2, and C4 are calculated as routes in the order of (O, A3, B2, C4), (O, A3, C4, B2), (O, C4, A3, B2), (O, B2, A3, C4), (O, C4, B2, A3), and (O, B2, C4, A3).

In one example, the optimal route having the best ‘cost’ that is selected is (O, A2, C3, B1), shown in a view 120b in FIG. 12b. This means that the selected stores are A2, B1, and C3, and the best order of arriving to these locations is first from origin to A2 location over a route segment 125a for fetching product or item A, then to C3 location over a route segment 125b for fetching product or item C, and finally to B1 location over a route segment 125c for fetching product or item B. It is noted that the best route that includes the route segments 125a, 125b, and 125c, may not include the closest locations to the origin point ‘O’ 121. For example, the point C4 124d may be closer to the origin point O 121 than the selected point C3 124c, and similarly the point A3 122c may be closer to the origin point O 121 than the selected point A2 122b, but yet the total route may be the most optimal one. While the route segments 125a, 125b, and 125c are shown as straight lines only schematically, while practically the actual route segments may need to follow the actually used, available, or recommended roads or tracks.

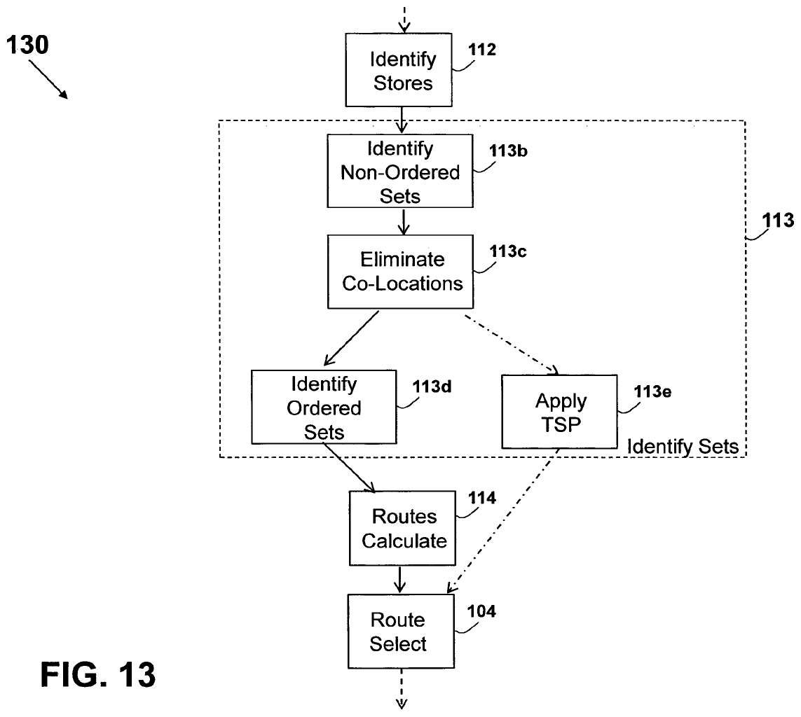

An example of a detailed description of the “Identify Sets” step 113 of the flow chart 110 is shown in a flow chart 130 shown in FIG. 13. At first, the data base is queried as part of an “Identify Non-Ordered Sets” step 113b, and the available locations for each of the items selected by the user as part of the “Items Select” step 111. The order of arriving to these locations is not yet determined, but only the relevant locations themselves. As explained above regarding the example of the flow chart 110a, the non-ordered sets 115 include 3×2×4=24 sets, namely (A1, B1, C1), (A1, B1, C2), (A1, B1, C3), (A1, B1, C4), (A1, B2, C1), (A1, B2, C2), (A1, B2, C3), (A1, B2, C4), (A2, B1, C1), (A2, B1, C2), (A2, B1, C3), (A2, B1, C4), (A2, B2, C1), (A2, B2, C2), (A2, B2, C3), (A2, B2, C4), (A3, B1, C1), (A3, B1, C2), (A3, B1, C3), (A3, B1, C4), (A3, B2, C1), (A3, B2, C2), (A3, B2, C3), and (A3, B2, C4).

In some cases, two or more items of the items selected by the user as part of the “Items Select” step 111 may be obtained in a same location. For example, assuming both A and B are grocery products, such as milk and sugar respectively, these two products are commonly available in all grocery stores or supermarkets. Similarly, assuming item A is gas for fueling the vehicle available at gas stations and item B is milk, both items may be obtained in co-located establishment, such as a convenience store in a gas station. In such a case, the co-located or same locations may be considered as a single location, and such redundancy is preferably eliminated, as part of an “Eliminate Co-Locations” step 113c. For example, if the locations B2 and C4 are the same location or are affectively co-located (such as in the same address, establishment, building, neighborhood, or campus), any set containing both may be optimized to include this location only once, since the set (A3, B2, C4) is equivalent, for all practical purposes, to the set (A3, B2) (or the set (A3, C4)). Such a set that include only 2 locations is clearly advantageous as it saves the time and hassle to reach another location. In such a case, the non-ordered set 115 may be simplified, as part of the “Eliminate Co-Locations” step 113c, to include the sets (A1, B1, C1), (A1, B1, C2), (A1, B1, C3), (A1, B1, B2), (A1, B2, C1), (A1, B2, C2), (A1, B2, C3), (A1, B2), (A2, B1, C1), (A2, B1, C2), (A2, B1, C3), (A2, B1, B2), (A2, B2, C1), (A2, B2, C2), (A2, B2, C3), (A2, B2), (A3, B1, C1), (A3, B1, C2), (A3, B1, C3), (A3, B1, B2), (A3, B2, C1), (A3, B2, C2), (A3, B2, C3), and (A3, B2).

As part of an “Identify Ordered Sets” step 113d, sets are identified that include all possible permutations of each of the non-ordered sets that were identified as part of the “Identify Non-Ordered Sets” step 113b. For each ordered set, the elements order defines the order of arriving to the locations, such as first reaching the first element, followed by the second one, and so forth. For example, an ordered set (A3, B2, C2) means first arriving from the origin point to location A3, then from A3 to B2, and ending by arriving from B2 location to C2 location. For example, permutations of the non-ordered set (A3, B1, C3) results in 6 ordered sets, namely (A3, B1, C3), (A3, C3, B1), (B1, A3, C3), (C3, A3, B1), (B1, C3, A3), and (C3, B1, A3). Similarly, the non-ordered set (A3, B2) results in 2 ordered sets, namely (B2, A3). As part of the “Routes Calculate” step 114, the cost for each of the routes for implementing each of the ordered set is calculated, allowing for selecting the optimal or best route (based on a pre-set criterion) as part of the “Route Select” step 104.

Alternatively or in addition to checking all the permutations of the non-ordered set, a Travelling Salesman Problem (TSP) may be applied as part of an “Apply TSP” step 113e. The problem solution typically provides the optimal ordered set directly (not requiring the calculating of all combinations or permutations), which can be used as part of the “Route Select” step 104. The TSP problem is applied herein by replacing the traditional cities with the relevant locations. For example, the optimal ordered set from a non-ordered set may be found by applying the TSP to the locations in the non-ordered set. Further, the TSP costs may correspond to distance to travel, the travel time, or fuel efficiency. The TSP used may be asymmetric or non-asymmetric, and may be solved using an exact algorithm or a heuristic one.

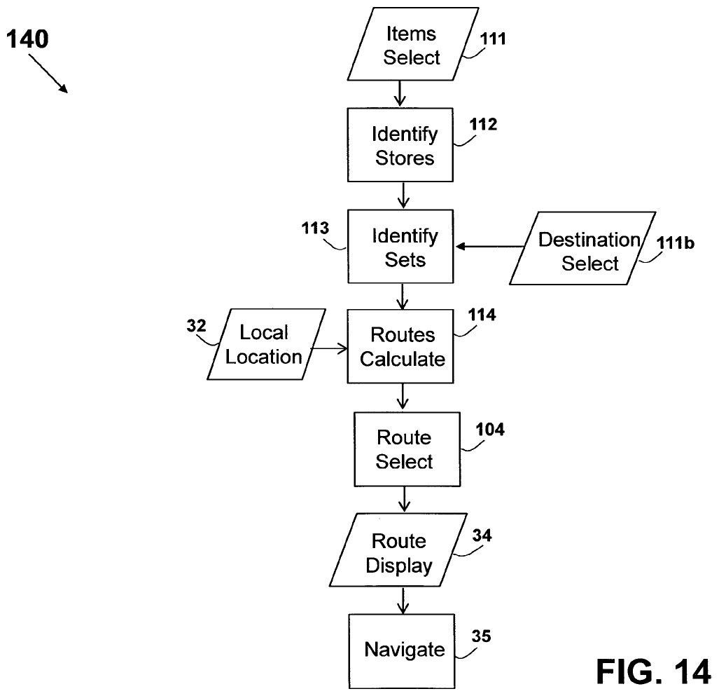

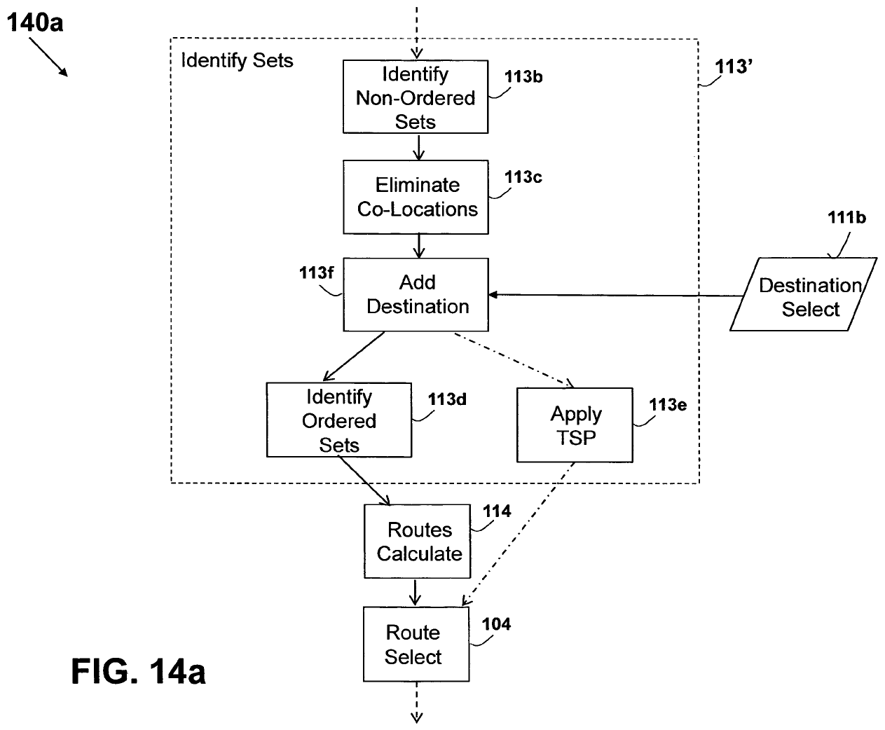

The flow chart 110a exampled the case of finding an optimal route from an origin location (‘O’) 121 to various locations for obtaining required items. In one example, the user further specifies a specific location that should be arrived at as part of the route. For example, such specified location may be the destination or end-point of the required route. A flow chart 140 shown in FIG. 14 is based on the flow chart 110 shown in FIG. 11, and adds a “Destination Select” step 111b, where the user select a specific location as a destination, and the search for optimal route incorporates this requirement in the various calculations. In one example, the selected destination point as part of the “Destination Select” step 111b is the origin point. For example, a user may want to take care of various tasks and errands, such as buying some products, while starting and finalizing the trip at home (serving as both the origin and destination locations). In this case, all ordered sets include the origin point ‘O’ as both starting and ending points, and the routes will be accordingly calculated. In such an example, the first 6 sets associated with stores A1, B1, and C1 are calculated as routes in the order of (O, A1, B1, C1, O), (O, A1, C1, B1, O), (O, C1, A1, B1, O), (O, B1, A1, C1, O), (O, C1, B1, A1, O), and (O, B1, C1, A1, O). Similarly, the first 6 sets associated with stores A3, B2, and C4 are calculated as routes in the order of (O, A3, B2, C4, O), (O, A3, C4, B2, O), (O, C4, A3, B2, O), (O, B2, A3, C4, O), (O, C4, B2, A3, O), and (O, B2, C4, A3, O). An “Identify Sets” step 113′ is described in flow chart 140a shown in FIG. 14a, which is based on the flow chart 130 shown in FIG. 13. The destination location input from the user as part of the “Destination Select” step 111b is added as a final location of any calculated route, such as in each ordered set, as part of an “Add Destination” step 113f.

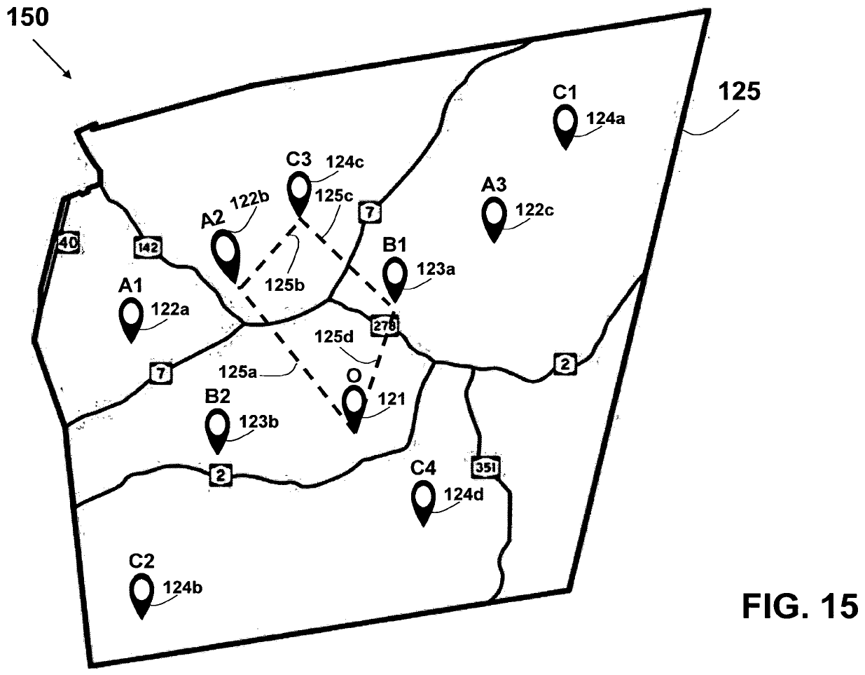

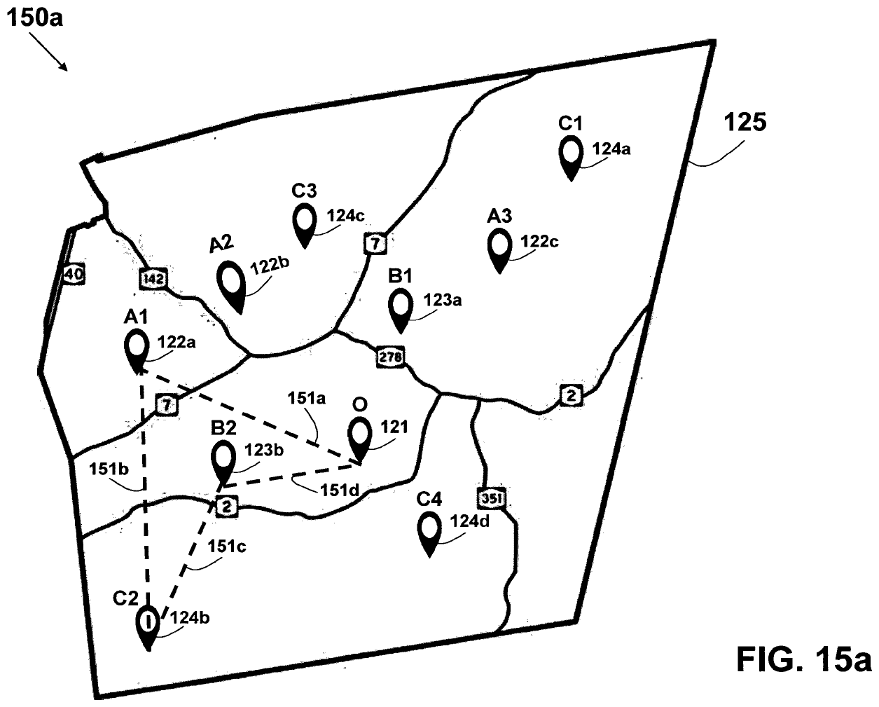

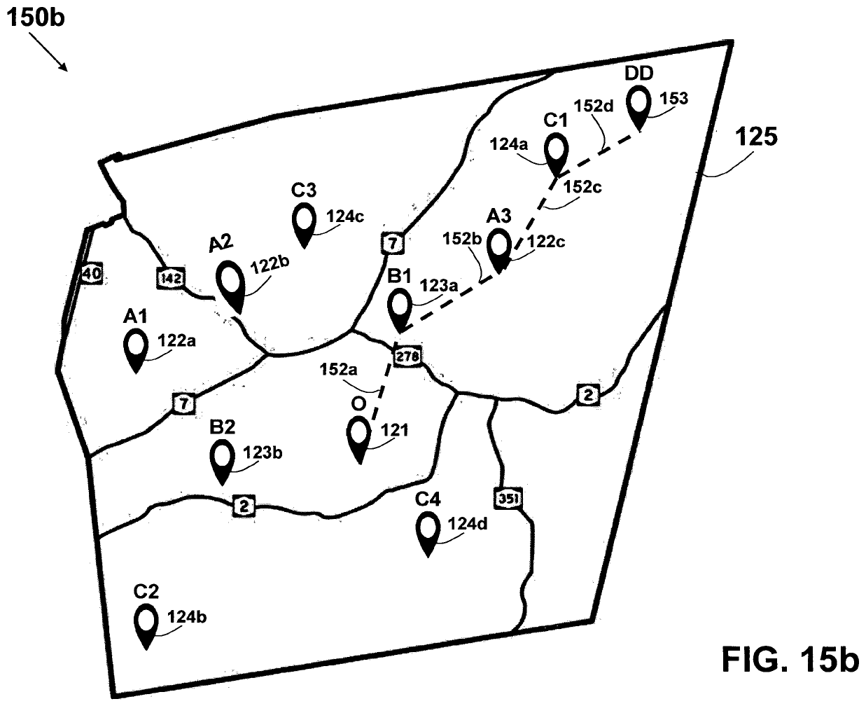

In one example, the route that is associated with ordered set (O, A2, C3, B1, O) is found to be optimal, as shown in a view 150 in FIG. 15, which is based on the view 120b shown in FIG. 12b. The route segment 125d is added from the location B1 123a to the origin location 121, so the user starts and ends the journey in the same location, the origin location 121. However, in some cases, adding the requirement of returning to the origin point 121 may result in other optimal route, involving one or more different locations therebetween. Such as example is shown in a view 150a in FIG. 15a, where assuming the same conditions, the new optimal route is calculated to include the ordered set (O, A1, C2, B2, O), and includes a first route segment 151a for travelling from the origin 121 to the location A1 122a, a second route segment 151b for travelling from the location A1 122a to the location C2 124b, a third route segment 151c from the location C2 124b to the location B2 123b, and a fourth route segment 151d from the location B2 123b back to the origin location 121.

Alternatively or in addition, the destination location selected by the user as part of the “Destination Select” step 111b, designated as ‘DD’ 153, is other than the origin point 121. For example, a user may wish to start a trip at work (as travel origin), and to travel home (as the destination point) via the required locations for doing the tasks or purchasing the required products. In this case, all ordered sets include the origin point ‘O’ as starting point, and DD as the ending points, and the routes will be accordingly calculated. In such an example, the first 6 sets associated with stores A1, B1, and C1 are calculated as routes in the order of (O, A1, B1, C1, DD), (O, A1, C1, B1, DD), (O, C1, A1, B1, DD), (O, B1, A1, C1, DD), (O, C1, B1, A1, DD), and (O, B1, C1, A1, DD). Similarly, the first 6 sets associated with stores A3, B2, and C4 are calculated as routes in the order of (O, A3, B2, C4, DD), (O, A3, C4, B2, DD), (O, C4, A3, B2, DD), (O, B2, A3, C4, DD), (O, C4, B2, A3, DD), and (O, B2, C4, A3, DD). An example of an optimal route in such a case is shown in a view 150b in FIG. 15b, where assuming the same conditions, the new optimal route is calculated to include the ordered set (O, B1, A3, C1, DD), and includes a first route segment 152a for travelling from the origin 121 to the location B1 123a, a second route segment 152b for travelling from the location B1 123a to the location A3 122c, a third route segment 152c from the location A3 122c to the location C1 124a, and a fourth route segment 152d from the location C1 124a to the destination location 153.

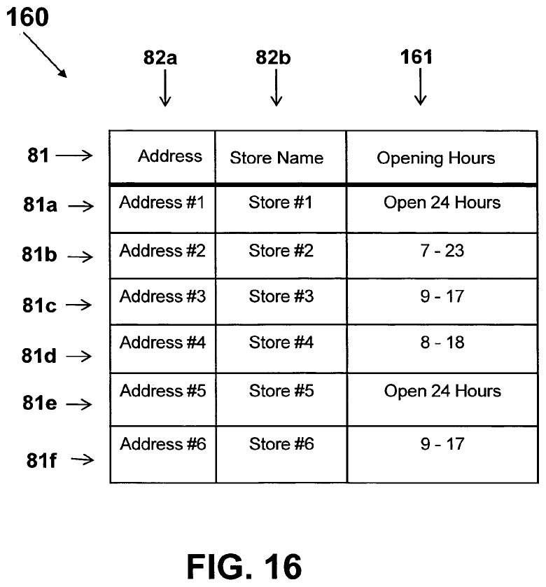

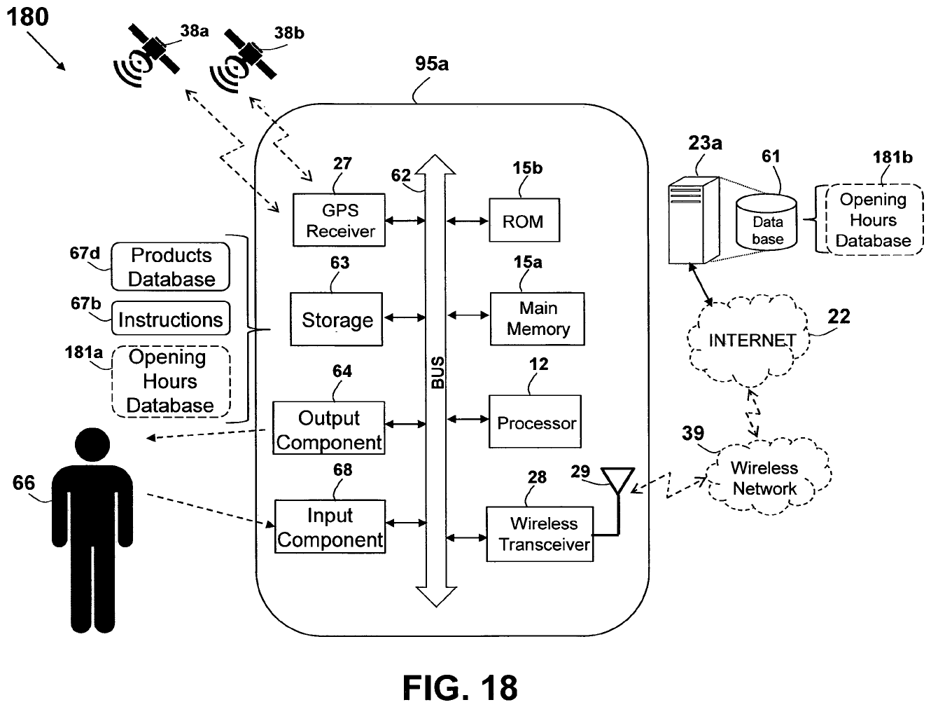

While some stores, gas fueling stations, or other service providing establishments are open or available any time and, usually, every day, known as 24/7 service, many are available only for defined opening hours during a day. When planning a route to various stores or service providing locations, it may be optimal to use these opening hours information, so that a store is not arrived to when it is closed. For example, assuming a route is calculated so that a store is reached at 18.00, however if this store closes at 17.30, this calculated route is rendered useless. In one example, the opening hours of various stores (or other establishments) are available in a database, such as a table 160 shown in FIG. 16, which is based on the table 80 shown in FIG. 8. Another column 161 is added, defining the opening hours for each store, where the Store #1 in the first row 81a and the Store #5 in the fifth row 81e are opened continuously (24/7), the third row 81c and the Store #6 in the sixth row 81f are opened daily from 9.00 am to 5.00 pm (17.00). Similarly, the Store #2 in the second row 81b is opened daily from 7.00 am to 11.00 pm (23.00), and the Store #4 in the fourth row 81d is opened daily from 8.00 am to 6.00 pm (18.00). The opening hours column 161, or the table 160, may be integrated with, or may be part of, the product database 80a shown in FIG. 8a, the attributes database 80b shown in FIG. 8b, the maps database 67a, or any combination thereof. As shown in an arrangement 180 shown in FIG. 18, the Opening Hours Database may be stored in the navigation device 95a, shown as database 181a, may be stored in a server 23a, shown as database 181b, or any combination thereof. In the case of storing the table 181b in the memory 61 in the remote server 23a, the navigation device 95a accesses and fetches the opening-hours data when required over the Internet 22 or over another network.

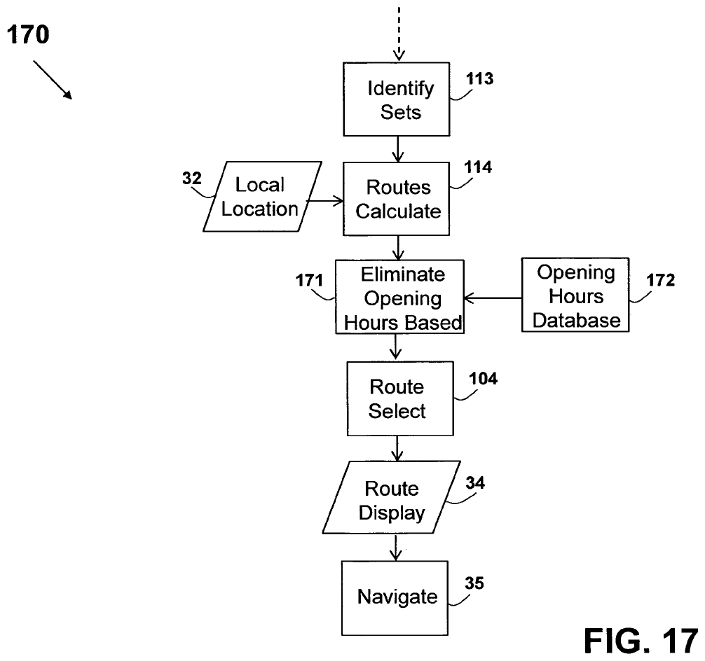

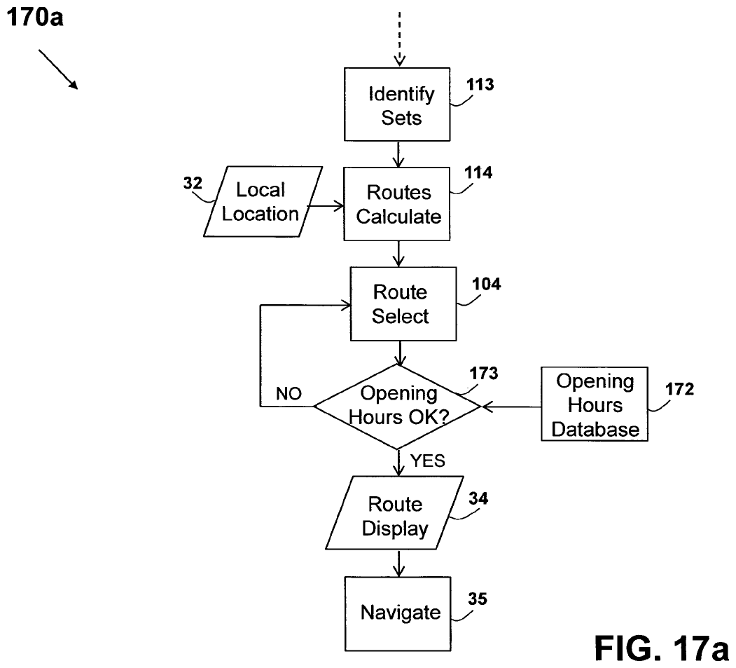

An example of using the opening-hours information is described in a flow chart 170 shown in FIG. 17, which is based on the flow chart 110 shown in FIG. 11. When the possible routes are calculated as part of the “Routes Calculate” step 114, the estimated time of arrival is also calculated and associated with the opening hours of each of the location that is part of a calculated route, using the opening-hours database as part of a “Opening Hours Database” step 172. For example, the required opening-hours information may be requested and received from a server. For example, when calculating the route for the ordered set (O, A3, B2, C4, DD), a timing information is also calculated. If one of the locations of the ordered set is not expected to be open at the arrival time, then this ordered set is eliminated from the sets as part of an “Eliminate Opening Hours Based” step 171, and cannot be selected as the optimal set for routing. For example, the location A1 corresponds to Store #6 81f, the location B2 corresponds with the Store #3 81c, and the location C4 corresponds with the Store #1 81a. Assuming starting the route at the origin point at 16:30, the calculated or estimated time of arrival to the first location A1 is 16:45, the calculated or estimated time of arrival to the second location B2 is 17:12, and the calculated or estimated time of arrival to the third location C4 is 17:43. Since the store #1 81a at location C4 is open all day, this store does not impose any limitation regarding any opening hours. Since the opening hours associated with the store #6 81f at location A1 are 9:00-17:00, arriving at the calculated time of 16:45 is proper since the store is expected to be opened at that time. However, since the opening hours associated with the store #3 81c at location B2 are 9:00-17:00, arriving at the calculated time of 17:12 is improper since the store is expected to be closed at that time, and hence this set is not a valid one and is selected and cannot be selected as an optimal route as part of the “Route Select” step 104.

Alternatively or in addition, the opening hours are taken into account after the optimal route is selected, as described in a flow chart 170a shown in FIG. 17a. The optimal route is selected as part of the “Route Select” step 104 without regarding any opening-hours information, thus simplifying the calculations performed in the “Routes Calculate” step 114. The arrival times for all locations that are part of the route selected as part of the “Route Select” step 104 are estimated or calculated, and then compared to the respective opening hours as part of an “Opening Hours OK?” step 173. If the stores are expected to be open upon the estimated arrival, the selected optimal “Route Display” step 34 and used for the actual navigation as part of the “Navigate” step 35. However, in case where arrival to one of the locations along the selected route is not within the defined opening hours, the selected route is de-selected, and the next best optimal route is selected as part of the “Route Select” step 104. The process is repeated until the best or optimal route that meets the opening-hours requirement for all locations is found.

Part or all of the methods described herein may be used to free a user from the burden of selecting specific and concrete points or locations, by offering the user the capability of only specifying some attributes, such as tasks or products instead of selecting a specific location that satisfy the required attributes or products, where a route planning algorithm finds the optimal (such as minimal cost) locations and the optimal route for arriving to the optimal locations. The general route planning task to be performed involves planning a route that contains one point or location from a first set that satisfy first product (such a store) or a service, a second point or location from a second set that satisfy second product (such a store) or a service, and so forth. The optimal route may be recalculated upon sensing any condition change, such as changing traffic information, or upon the user or vehicle not following the suggested and calculated route.

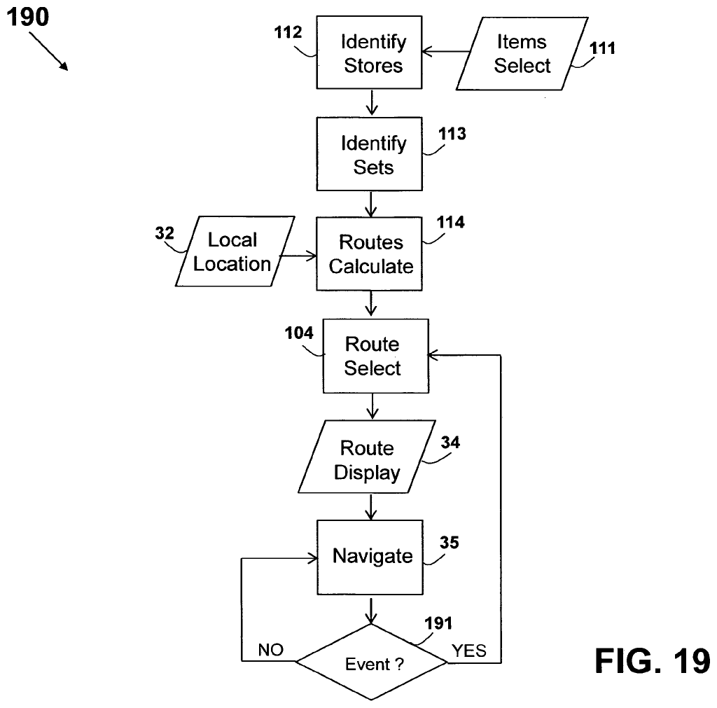

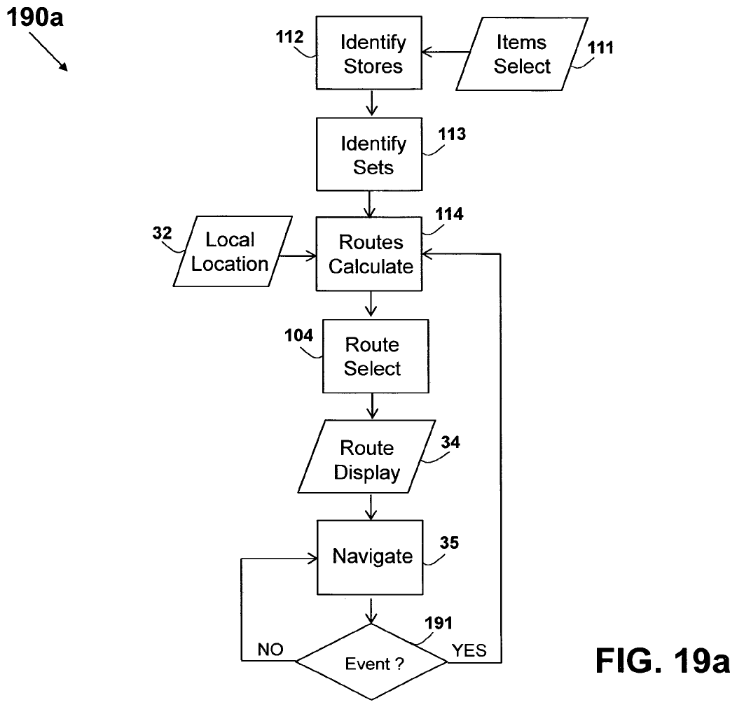

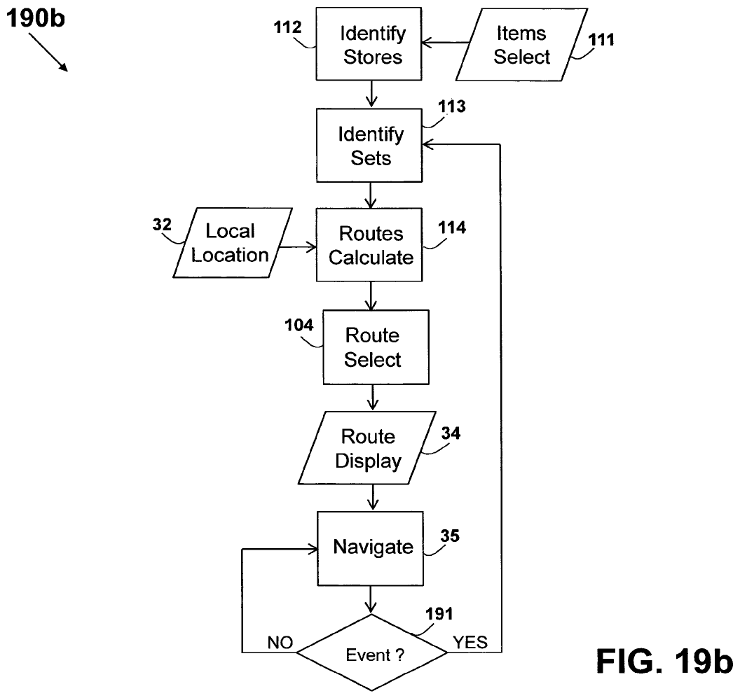

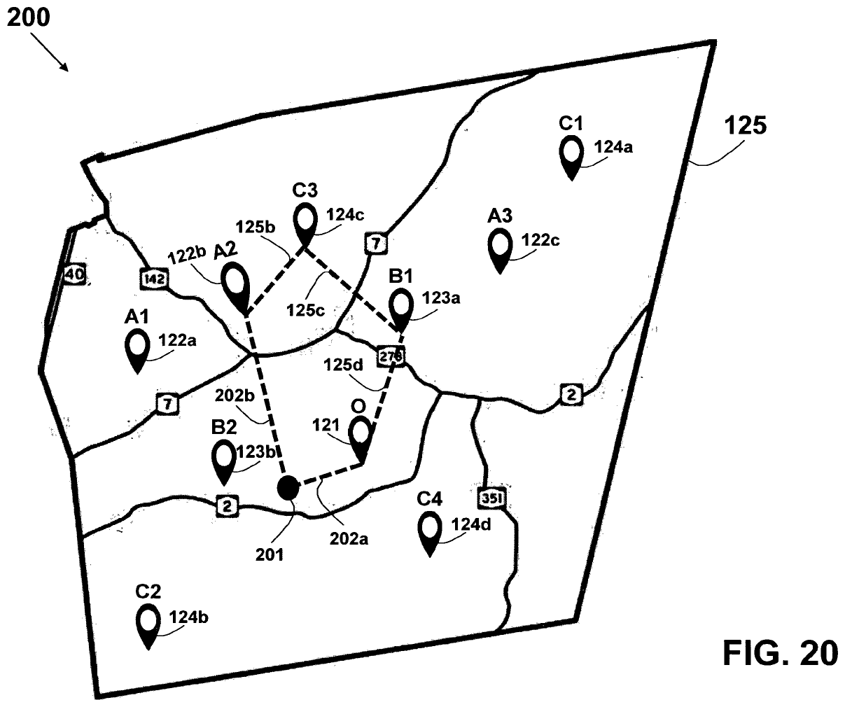

Since the traffic and other environment conditions changes over time, it may be that the calculation of the checked routes that are calculated as part of the “Routes Calculate” step 103, or the selection of the optimal route as part of the “Route Select” step 104 in the flow chart 100 shown in FIG. 10 may not be optimal anymore. Similarly, the route selected as part of the “Route Select” step 104 in the flow chart 110 shown in FIG. 11 may not be optimal anymore. Hence, it may be beneficial or required to recheck the optimal routing during the navigation guidance as part of the “Navigate” step 35. Such dynamic updating is described in a flow chart 190 shown in FIG. 19. The system continuously check for an event that may affect the optimal route selection during the “Navigate” step 35 as part of an “Event?” step 191. In the case no event is declared, such as where the change detected or measured is under a pre-set threshold, the guidance according to the optimal route selected as part of the “Route Select” step 104 continues during the “Navigate” step 35. However, in case where the event detected as part of the “Event?” step 191 is deemed to justify checking for a new optimal route, the system reverts to the “Route Select” step 104, and recalculate the suggested route based on the updated information. Such repetition may be performed multiple times, providing for dynamically updating the optimal route to use.

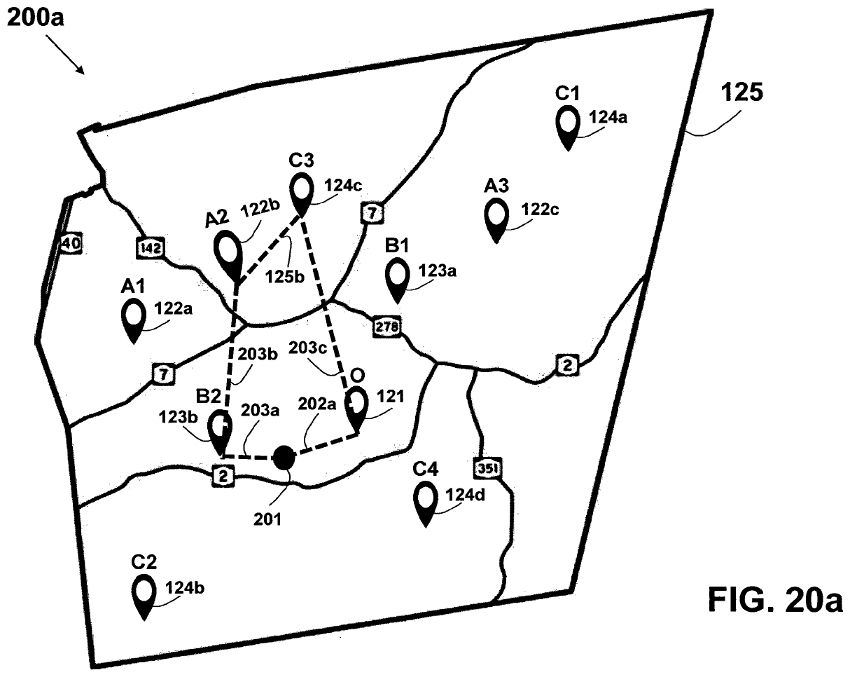

Such re-calculating of a route is schematically illustrated in a view 200 shown in FIG. 20, which is based on the view 150 shown in FIG. 15. The example shown involves driving to a location 201 (over a route segment 202a) that is not part of the selected and displayed route, such as because or road work or navigating mistake by the user driver. Upon reaching this point 201, the route is recalculated, but based on the same optimal ordered set determined as part of the “Route Select” step 104. The recalculated route in this case involves the route segment 202b for arriving to the first point A2 122b over a route segment 202b, where the rest of the route is resumed.

Alternatively or in addition, the selected ordered set that was considered as optimal may not be optimal under the new situation, such as due to the updated location that serves as the origin point, and the optimal route needs to be re-calculated, as shown in a flow chart 190a shown in FIG. 19a. In this case, upon determining in the “Event?” step 191 that recalculation is required, such as due to arriving to point 201, the optimal ordered set is reconsidered as part of the “Routes Calculate” step 114. In one example, the same ordered set, namely (O, A2, C3, B1, O) is still selected as optimal, and the new calculated route suggests the navigation along the resumed route shown in the view 200.

However, in some scenarios the best ordered set may not be relevant anymore, for example due to a starting point that is substantially far from the origin point ‘O’ 121, or upon time lapsing so that one or more locations of the selected ordered set may not be arrived at during opening hours. For example, a new gas-station may be selected during a recalculation, since it is more optimal for the current new configuration, rather than using the formerly less optimal selected gas station. In such a case, it is beneficial to repeat the method from the beginning, such as from the “Identify Sets” step 113, as exampled in a flow chart 190b shown in FIG. 19b. For example, the new optimal selected ordered set, based on the new origin point 201 or taking into account the time lapsed, may be the ordered set (O, B2, A2, C3, O). The new route is shown in a view 200a shown in FIG. 20a, where the selected calculated route involves from the deviation point 201 to the first location B2 123b over a route segment 203a, followed by a route segment 203b from the location B2 123b to the location A2 122b, followed by a route segment 125b from the location A2 122b to the location C3 124c, and returning to the origin point ‘O’ 121 over the route segment 203c.

In one example, the routes calculation is periodically repeated. In such a case, the event checked as part of the “Event?” step 191 comprises the expiration of a timer from the last occasion that the routes were calculated as part of the “Routes Calculate” step 114, the expiration of a timer from the last occasion that the optimal route was selected as part of the “Route Select” step 104, or the expiration of a timer from the start of guidance as part of the “Navigate” step 35. Such a timer may be implemented in software such as being provided as a service of the operating system 67c, or may be implemented in hardware, such as in the processor 12. Such period may be longer than 10 seconds, 20 seconds, 30 seconds, 1 minute, 2 minutes, 5 minutes, 10 minutes, 20 minutes, 30 minutes, 1 hour, 2 hours, 5 hours, or 10 hours. Alternatively or in addition, such period may be shorter than 20 seconds, 30 seconds, 1 minute, 2 minutes, 5 minutes, 10 minutes, 20 minutes, 30 minutes, 1 hour, 2 hours, 5 hours, 10 hours, or 20 hours.

Alternatively or in addition, the routes calculation may be repeated upon receiving a request from the user 66, such as via the input component 68. Alternatively or in addition, the routes calculation is repeated in response to an external received data, such as information received from the wireless network 39 via the antenna 29 and the wireless transceiver 28. For example, the received information may indicate a traffic congestion or traffic jam along the selected optimal route, or may relate to closure of a road, or any other information that may affect the travel along the selected optimal route. Alternatively or in addition, the routes calculation may be repeated upon detecting that the local location (as obtained in the “Local Location” step 32) deviate from the optimal selected route. For example, in case where the local location is related to a distance from the optimal route that is more than a pre-set minimum threshold distance, the system repeat the routes calculation, since the new location may involve a better route. The pre-set minimum threshold may be more than 1 meter, 2 meters, 5 meters, 10 meters, 20 meters, 50 meters, 100 meters, 200 meters, 500 meters, 1 Km, 2 Km, 5 Km, 10 Km, 20 Km, 50 Km, or 100 Km. Alternatively or in addition, the pre-set minimum threshold may be less than 100 meters, 200 meters, 500 meters, 1 Km, 2 Km, 5 Km, 10 Km, 20 Km, 50 Km, 100 Km, or 200 Km.

Guiding a user in need for a product to an optimal (e.g., nearest) store where such a product is available is in particular useful in case where the user is not acquainted with the neighborhood, such as a tourist, a newcomer, or am immigrant. Further, many consumers perform concentrated large buying of groceries in a supermarket on a weekly, bi-weekly, or monthly basis. In such a case, where a single product is required, it is beneficial to get to the nearest or otherwise convenient shop for obtaining the product. In particular, there is a lot of overlapping in today's retailers offerings, in contrast to old-days grocery and dedicated stores. For example, many groceries, such as food items and household products, are available from superstores/hypermarkets, supermarkets, grocery stores, and convenience stores. For example, a milk bottle is available is a superstore (such as Walmart—a chain by Wal-Mart Stores, Inc.), a convenience store (such a 7-Eleven), in a neighborhood supermarket or pharmacy store (such as local Walgreen store—a chain by Walgreen Company), and in a convenience store that is part of a gas/petrol station.

The items in the items list 83c may be groceries, which may comprise non-perishable food that is packaged in bottles, boxes, and cans, as well as bakeries, butchers, delis, and fresh products. Alternatively or in addition, the items may comprise non-food products, such as clothing and household items, pharmacy items, and any other household item. Further, housekeeping items may be included, such as products used for cleaning, cooking, home maintenance, and laundry. Further, the items in the items list 83c may be any consumer products, defined as any article, or component part thereof, produced or distributed for sale to a consumer for use in or around a permanent or temporary household or residence, a school, in recreation, or otherwise, or for the personal use, consumption or enjoyment of a consumer in or around a permanent or temporary household or residence, a school, in recreation, or otherwise.

Alternatively or in addition, the items in the items list 83c may be Fast-moving consumer goods (FMCG) or Consumer Packaged Goods (CPG), which are products that are sold quickly and at relatively low cost. Examples include non-durable goods such as packaged foods, beverages, toiletries, over-the-counter drugs and many other consumables. In contrast, durable goods or major appliances such as kitchen appliances are generally replaced over a period of several years. Some FMCGs, such as meat, fruits and vegetables, dairy products, and baked goods, are highly perishable. Other goods, such as pre-packaged foods, soft drinks, chocolate, candies, toiletries, and cleaning products, have high turnover rates.

Alternatively or in addition, the items in the items list 83c may be household goods, which are goods and products used within households. They are the tangible and movable personal property placed in the living rooms, dining rooms, kitchens, family rooms, great rooms, bedrooms, bathrooms, recreation rooms, hallways, attics, and basements and other rooms of a house. Examples of household goods include air conditioners, baby items, baking dishes, beds/bedframes, blankets, bedding, linens, towels, blenders, mixers, bookcases, books, bureaus, dressers, wardrobes, cabinets, can openers, chairs, clothes dryers, coffee makers, computers, cooking utensils, couches, sofas, love seats, sectionals, sofa beds, curtains, curtain rods, drapes, decorative items, desks, dishes, dishwashers, entertainment centers, fans, freezers, (drinking) glasses, hand tools, hutches, irons and ironing boards, lamps, lawn chairs, (table) linens, mattresses, (home) medical equipment, microwave ovens, mirrors, pillows, pots and pans, refrigerators, rugs, sewing machines and notions, silverware (flatware), sheets, sofas, sectionals, sofa beds/futons, space heaters, stereos and radios, tables toasters and toaster ovens, tools, towels, toys, televisions, vacuum cleaners, umbrellas, robotics, and washer/dryers.

Alternatively or in addition, the items in the items list 83c may be classified into the following categories, which are determined by the consumer's buying habits: Convenience goods, Shopping goods, Specialty goods, and Unsought goods. Convenience goods are goods that are regularly consumed and easily available. Generally convenience goods come in the category of nondurable goods such as fast foods, cigarettes and tobacco with low value. Convenience goods are mostly sold by wholesalers or retailers, so as to make them available to the consumers in good or large volume. Convenience goods can further be categorized into: Staple convenience consumer goods, Impulse convenience consumer Goods, and Staple convenience consumer goods. The latter are those kinds of goods that come under the basic necessities of the consumer. These goods are easily available and in large quantity. Examples include milk, bread, sugar, etc. Impulse convenience consumer goods are the goods that do not belong to the priority list of the consumer. These goods are purchased without any prior planning, just on the basis of the impulse. Examples include potato wafers, candies, ice creams, cold drinks, etc.

Shopping consumer goods are the goods that take lot of time and proper planning before making purchase decision; in this case, the consumer does a lot of selection and comparison based on various parameters such as cost, brand, style, comfort etc., before buying an item. Shopping goods are costlier than convenience goods and are durable in nature. Consumer goods companies usually try to set up their shops and show rooms in active shopping area to attract customer attention and their main focus is to do lots of advertising and promotion so that to attract more customer. Examples include clothing items, televisions, radio, footwear, home furnishing, etc. Specialty goods are unique in nature; these are unusual and luxurious items available in the market. Specialty goods are mostly purchased by the upper class of the society as they are expensive in nature and difficult to be afforded by middle or lower-class people. Companies advertise their goods targeting the upper class. These goods do not fall under the category of necessity; rather they are purchased on the basis personal preference or desire. Brand name, uniqueness, and special features of an item are major attributes that attract customers and make them buy such products. Examples include antiques, jewelry, wedding dresses, cars, etc. Unsought goods neither belong to the necessity group of consumer goods list nor to specialty goods. They are always available in the market but are purchased by very few consumers, either based on their interest or their need for some specific reasons. The general public does not purchase such goods often. Examples include snowshoes, fire extinguishers, flood insurance, etc.

While example above regarding tangible products, the items in the items list 83c may equally be services, such as laundry service, package or mail sending services, repair service, or personal services such as massage or beauty services.

Alternatively or in addition, any system or method herein involving any item may be equally used with an attribute instead of the item, such as any one of the attributes described as part of the attributes 84 shown as part of table 80b. Further, any system or method herein involving multiple items may be equally used with multiple attributes instead of the items. Similarly, any combination of attributes and items may be used as a substitute to attributes only or items only implementation.

The device 65, or any other device (such as the device 95) or apparatus herein, may be a client device that may typically function as a client in the meaning of client/server architecture, commonly initiating requests for receiving services, functionalities, and resources, from other devices (servers or clients). Each of the these devices may further employ, store, integrate, or operate a client-oriented (or end-point dedicated) operating system, such as Microsoft Windows® (including the variants: Windows 7, Windows XP, Windows 8, and Windows 8.1, available from Microsoft Corporation, headquartered in Redmond, Wash., U.S.A.), Linux, and Google Chrome OS available from Google Inc. headquartered in Mountain View, Calif., U.S.A. Further, each of the these devices may further employ, store, integrate, or operate a mobile operating system such as Android (available from Google Inc. and includes variants such as version 2.2 (Froyo), version 2.3 (Gingerbread), version 4.0 (Ice Cream Sandwich), Version 4.2 (Jelly Bean), and version 4.4 (KitKat), iOS (available from Apple Inc., and includes variants such as versions 3-7), Windows® Phone (available from Microsoft Corporation and includes variants such as version 7, version 8, or version 9), or Blackberry® operating system (available from BlackBerry Ltd., headquartered in Waterloo, Ontario, Canada). Alternatively or in addition, each of the devices that are not denoted herein as a server, may equally function as a server in the meaning of client/server architecture. Any Operating System (OS) herein, such as any server or client operating system, may consists of, include, or be based on a real-time operating system (RTOS), such as FreeRTOS, SafeRTOS, QNX, VxWorks, or Micro-Controller Operating Systems (μC/OS).

The steps described herein may be sequential, and performed in the described order. For example, in a case where a step is performed in response to another step, or upon completion of another step, the steps are executed one after the other. However, in the case where two or more steps are not explicitly described as being sequentially executed, these steps may be executed in any order, or may be simultaneously performed. Two or more steps may be executed by two different network elements, or in the same network element, and may be executed in parallel using multiprocessing or multitasking.

The arrangements and methods described herein may be implemented using hardware, software or a combination of both. The term “software integration” or any other reference to the integration of two programs or processes herein, is used herein to include, but not limited to, software components (e.g., programs, modules, functions, processes, etc.) that are (directly or via another component) combined, working or functioning together or form a whole, commonly for sharing a common purpose or set of objectives. Such software integration can take the form of sharing the same program code, exchanging data, being managed by the same manager program, executed by the same processor, stored on the same medium, sharing the same GUI or other user interface, sharing peripheral hardware (such as a monitor, printer, keyboard and memory), sharing data or a database, or being part of a single package. The term “hardware integration” or integration of hardware components is used herein to include, but not limited to, hardware components that are (directly or via another component) combined, working or functioning together or form a whole, usually for sharing a common purpose or set of objectives. Such hardware integration can take the form of sharing the same power source (or power supply) or sharing other resources, exchanging data or control (e.g., by communicating), being managed by the same manager, physically connected or attached, sharing peripheral hardware connection (such as a monitor, printer, keyboard and memory), being part of a single package or mounted in a single enclosure (or any other physical collocating), sharing a communication port, or used or controlled using the same software or hardware. The term “integration” herein is used to include as applicable, but not limited to, software integration, hardware integration, or any combination thereof.

Any networking protocol may be utilized for exchanging information between the network elements (e.g., clients or servers) within the network (such as the Internet). For example, it is contemplated that communications can be performed using TCP/IP. Generally, HTTP and HTTPS are utilized on top of TCP/IP as the message transport envelope. The system described hereinafter is suited for both HTTP/HTTPS, message-queuing systems, and other communications transport protocol technologies. Furthermore, depending on the differing business and technical requirements of the various partners within the network, the physical network may embrace and utilize multiple communication protocol technologies. As used herein, the term “request” includes, but is not limited to, a message describing an operation to be carried out in the context of a specified resource, such as H YIP GET, POST, PUT, and HEAD commands, and the term “response” includes, but is not limited to, a message containing the result of an executed request, such as an HTML document or a server error message. A request may be an explicit web request that is initiated manually by the user, or may be an implicit request that is initiated by a web client and is transparent to the user, as an ancillary event corresponding to an explicit web request.

Application software is typically a set of one, or more programs designed to carry out operations for a specific application. Commonly, an application software is dependent on system software that manages and integrates computer capabilities, but does not directly perform tasks that benefit the user, such as an operating system, to execute. Examples of types of application software may include accounting software, media players, and office suites. Applications may be bundled with the computer and its system software, or may be published separately, and further may be developed and coded as a proprietary, or as an open-source software. Most applications are designed to help people perform an activity.

Where certain process steps are described in a particular order or where alphabetic and/or alphanumeric labels are used to identify certain steps, the embodiments are not limited to any particular order of carrying out such steps. In particular, the labels are used merely for convenient identification of steps, and are not intended to imply, specify or require a particular order for carrying out such steps. Furthermore, other embodiments may use more or less steps than those discussed herein. They may also be practiced in distributed computing environments where tasks are performed by remote processing devices that are linked through a communications network.

In a distributed computing environment, program modules may be located in both local and remote memory storage devices. Any single step, group of steps, or a flow chart herein may be realized as a computer program in a centralized fashion, in one computer system or in a distributed fashion where different elements are spread across several interconnected computer systems. Any kind of computer system, or other apparatus adapted for carrying out the methods described herein, is suited to perform the functions described herein. A typical centralized implementation could include a general purpose computer system with a computer program that, when being loaded and executed, will control the computer system, and carry out the methods described herein.

Computer program or application in the present context means any expression, in any language, code or notation, of a set of instructions intended to cause a system having an information processing capability to perform a particular function either directly or after either, or both of the following a) conversion to another language, code or notation; b) reproduction in a different material form. Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems. Some portions of the above description present the techniques described herein in terms of algorithms and symbolic representations of operations on information. These algorithmic descriptions and representations are used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

The corresponding structures, materials, acts, and equivalents of all means plus function elements in the claims below are intended to include any structure, or material, for performing the function in combination with other specifically claimed elements. The description of the present invention has been presented for purposes of illustration and description, but is not intended to be exhaustive or limited to the invention in the form disclosed. The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure.

Any apparatus herein, which may be any of the systems, devices, modules, or functionalities described herein, may be integrated with a smartphone. The integration may be by being enclosed in the same housing, sharing a power source (such as a battery), using the same processor, or any other integration functionality. In one example, the functionality of any apparatus herein, which may be any of the systems, devices, modules, or functionalities described here, is used to improve, to control, or otherwise be used by the smartphone. In one example, a measured or calculated value by any of the systems, devices, modules, or functionalities described herein, is output to the smartphone device or functionality to be used therein. Alternatively or in addition, any of the systems, devices, modules, or functionalities described herein is used as a sensor for the smartphone device or functionality.

A ‘nominal’ value herein refers to a designed, expected, or target value. In practice, a real or actual value is used, obtained, or exists, which varies within a tolerance from the nominal value, typically without significantly affecting functioning. Common tolerances are 20%, 15%, 10%, 5%, or 1% around the nominal value.

Discussions herein utilizing terms such as, for example, “processing,” “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing art to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical, electronic, or magnetic quantities within memories, registers, or other information storage devices, transmission devices, or display devices of the computing platform.

Throughout the description and claims of this specification, the word “couple” and variations of that word such as “coupling”, “coupled”, and “couplable”, refers to an electrical connection (such as a copper wire or soldered connection), a logical connection (such as through logical devices of a semiconductor device), a virtual connection (such as through randomly assigned memory locations of a memory device) or any other suitable direct or indirect connections (including combination or series of connections), for example, for allowing the transfer of power, signal, or data, as well as connections formed through intervening devices or elements.

The arrangements and methods described herein may be implemented using hardware, software or a combination of both. The term “integration” or “software integration” or any other reference to the integration of two programs or processes herein refers to software components (e.g., programs, modules, functions, processes etc.) that are (directly or via another component) combined, working or functioning together or form a whole, commonly for sharing a common purpose or a set of objectives. Such software integration can take the form of sharing the same program code, exchanging data, being managed by the same manager program, executed by the same processor, stored on the same medium, sharing the same GUI or other user interface, sharing peripheral hardware (such as a monitor, printer, keyboard and memory), sharing data or a database, or being part of a single package. The term “integration” or “hardware integration” or integration of hardware components herein refers to hardware components that are (directly or via another component) combined, working or functioning together or form a whole, commonly for sharing a common purpose or set of objectives. Such hardware integration can take the form of sharing the same power source (or power supply) or sharing other resources, exchanging data or control (e.g., by communicating), being managed by the same manager, physically connected or attached, sharing peripheral hardware connection (such as a monitor, printer, keyboard and memory), being part of a single package or mounted in a single enclosure (or any other physical collocating), sharing a communication port, or used or controlled with the same software or hardware. The term “integration” herein refers (as applicable) to a software integration, a hardware integration, or any combination thereof.

The term “port” refers to a place of access to a device, electrical circuit or network, where energy or signal may be supplied or withdrawn. The term “interface” of a networked device refers to a physical interface, a logical interface (e.g., a portion of a physical interface or sometimes referred to in the industry as a sub-interface—for example, such as, but not limited to a particular VLAN associated with a network interface), and/or a virtual interface (e.g., traffic grouped together based on some characteristic—for example, such as, but not limited to, a device interface). As used herein, the term “independent” relating to two (or more) elements, processes, or functionalities, refers to a scenario where one does not affect nor preclude the other. For example, independent communication such as over a pair of independent data routes means that communication over one data route does not affect nor preclude the communication over the other data routes.

As used herein, the term “portable” herein refers to physically configured to be easily carried or moved by a person of ordinary strength using one or two hands, without the need for any special carriers.

Any mechanical attachment of joining two parts herein refers to attaching the parts with sufficient rigidity to prevent unwanted movement between the attached parts. Any type of fastening means may be used for the attachments, including chemical material such as an adhesive or a glue, or mechanical means such as screw or bolt. An adhesive (used interchangeably with glue, cement, mucilage, or paste) is any substance applied to one surface, or both surfaces, of two separate items that binds them together and resists their separation. Adhesive materials may be reactive and non-reactive adhesives, which refers to whether the adhesive chemically reacts in order to harden, and their raw stock may be of natural or synthetic origin.

The term “processor” is meant to include any integrated circuit or other electronic device (or collection of devices) capable of performing an operation on at least one instruction including, without limitation, Reduced Instruction Set Core (RISC) processors, CISC microprocessors, Microcontroller Units (MCUs), CISC-based Central Processing Units (CPUs), and Digital Signal Processors (DSPs). The hardware of such devices may be integrated onto a single substrate (e.g., silicon “die”), or distributed among two or more substrates. Furthermore, various functional aspects of the processor may be implemented solely as software or firmware associated with the processor. Any of the steps, methods, or flow-charts herein may be executed by a processor, such as the processor 12 in the computer system 11, or a processor in the Telematics ECU 22b (or any other ECU) in the vehicle 21.

A non-limiting example of a processor may be 80186 or 80188 available from Intel Corporation located at Santa-Clara, Calif., USA. The 80186 and its detailed memory connections are described in the manual “80186/80188 High-Integration 16-Bit Microprocessors” by Intel Corporation, which is incorporated in its entirety for all purposes as if fully set forth herein. Other non-limiting example of a processor may be MC68360 available from Motorola Inc. located at Schaumburg, Ill., USA. The MC68360 and its detailed memory connections are described in the manual “MC68360 Quad Integrated Communications Controller—User's Manual” by Motorola, Inc., which is incorporated in its entirety for all purposes as if fully set forth herein. While exampled above regarding an address bus having an 8-bit width, other widths of address buses are commonly used, such as the 16-bit, 32-bit and 64-bit. Similarly, while exampled above regarding a data bus having an 8-bit width, other widths of data buses are commonly used, such as 16-bit, 32-bit and 64-bit width. In one example, the processor consists of, comprises, or is part of, Tiva™ TM4C123GH6PM Microcontroller available from Texas Instruments Incorporated (Headquartered in Dallas, Tex., U.S.A.), described in a data sheet published 2015 by Texas Instruments Incorporated [DS-TM4C123GH6PM-15842.2741, SPMS376E, Revision 15842.2741 June 2014], entitled: “Tiva™ TM4C123GH6PM Microcontroller—Data Sheet”, which is incorporated in its entirety for all purposes as if fully set forth herein, and is part of Texas Instrument's Tiva™ C Series microcontrollers family that provides designers a high-performance ARM® Cortex™-M-based architecture with a broad set of integration capabilities and a strong ecosystem of software and development tools. Targeting performance and flexibility, the Tiva™ C Series architecture offers an 80 MHz Cortex-M with FPU, a variety of integrated memories and multiple programmable GPIO. Tiva™ C Series devices offer consumers compelling cost-effective solutions by integrating application-specific peripherals and providing a comprehensive library of software tools that minimize board costs and design-cycle time. Offering quicker time-to-market and cost savings, the Tiva™ C Series microcontrollers are the leading choice in high-performance 32-bit applications. Targeting performance and flexibility, the Tiva™ C Series architecture offers an 80 MHz Cortex-M with FPU, a variety of integrated memories and multiple programmable GPIO. Tiva™ C Series devices offer consumers compelling cost-effective solutions.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

As used herein, the term “Integrated Circuit” (IC) shall include any type of integrated device of any function where the electronic circuit is manufactured by the patterned diffusion of trace elements into the surface of a thin substrate of semiconductor material (e.g., Silicon), whether single or multiple die, or small or large scale of integration, and irrespective of process or base materials (including, without limitation Si, SiGe, CMOS and GAs) including, without limitation, applications specific integrated circuits (ASICs), field programmable gate arrays (FPGAs), digital processors (e.g., DSPs, CISC microprocessors, or RISC processors), so-called “system-on-a-chip” (SoC) devices, memory (e.g., DRAM, SRAM, flash memory, ROM), mixed-signal devices, and analog ICs.

The circuits in an IC are typically contained in a silicon piece or in a semiconductor wafer, and commonly packaged as a unit. The solid-state circuits commonly include interconnected active and passive devices, diffused into a single silicon chip. Integrated circuits can be classified into analog, digital and mixed signal (both analog and digital on the same chip). Digital integrated circuits commonly contain many of logic gates, flip-flops, multiplexers, and other circuits in a few square millimeters. The small size of these circuits allows high speed, low power dissipation, and reduced manufacturing cost compared with board-level integration. Further, a multi-chip module (MCM) may be used, where multiple integrated circuits (ICs), the semiconductor dies, or other discrete components are packaged onto a unifying substrate, facilitating their use as a single component (as though a larger IC).

The term “computer-readable medium” (or “machine-readable medium”) as used herein is an extensible term that refers to any non-transitory computer readable medium or any memory, that participates in providing instructions to a processor (such as processor 12) for execution, or any mechanism for storing or transmitting information in a form readable by a machine (e.g., a computer). Such a medium may store computer-executable instructions to be executed by a processing element and/or software, and data that is manipulated by a processing element and/or software, and may take many forms, including but not limited to, non-volatile medium, volatile medium, and transmission medium. Transmission media includes coaxial cables, copper wire and fiber optics. Transmission media can also take the form of acoustic or light waves, such as those generated during radio-wave and infrared data communications, or other form of propagating signals (e.g., carrier waves, infrared signals, digital signals, etc.). Common forms of computer-readable media include, for example, a floppy disk, a flexible disk, hard disk, magnetic tape, or any other magnetic medium, a CD-ROM, any other optical medium, punch-cards, paper-tape, any other physical medium with patterns of holes, a RAM, a PROM, and EPROM, a FLASH-EPROM, any other memory chip or cartridge, a carrier wave as described hereinafter, or any other medium from which a computer can read. Any computer-readable storage medium herein, such as the main memory 15a, the storage device 15c, the ROM 15b, or the storage 63, may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Computer-executable instructions may include, for example, instructions and data, which cause a general purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

Any process descriptions or blocks in any logic flowchart herein should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

Each of the methods or steps herein, may consist of, include, be part of, be integrated with, or be based on, a part of, or the whole of, the steps, functionalities, or structure (such as software) described in the publications that are incorporated in their entirety herein. Further, each of the components, devices, or elements herein may consist of, integrated with, include, be part of, or be based on, a part of, or the whole of, the components, systems, devices or elements described in the publications that are incorporated in their entirety herein.

Any part of, or the whole of, any of the methods described herein may be provided as part of, or used as, an Application Programming Interface (API), defined as an intermediary software serving as the interface allowing the interaction and data sharing between an application software and the application platform, across which few or all services are provided, and commonly used to expose or use a specific software functionality, while protecting the rest of the application. The API may be based on, or according to, Portable Operating System Interface (POSIX) standard, defining the API along with command line shells and utility interfaces for software compatibility with variants of Unix and other operating systems, such as POSIX.1-2008 that is simultaneously IEEE STD. 1003.1™—2008 entitled: “Standard for Information Technology—Portable Operating System Interface (POSIX®) Description”, and The Open Group Technical Standard Base Specifications, Issue 7, IEEE STD. 1003.1™, 2013 Edition.

The term “computer” is used generically herein to describe any number of computers, including, but not limited to personal computers, embedded processing elements and systems, software, ASICs, chips, workstations, mainframes, etc. Any computer herein may consist of, or be part of, a handheld computer, including any portable computer that is small enough to be held and operated while holding in one hand or fit into a pocket. Such a device, also referred to as a mobile device, typically has a display screen with touch input and/or miniature keyboard. Non-limiting examples of such devices include a Digital Still Camera (DSC), a Digital video Camera (DVC or digital camcorder), a Personal Digital Assistant (PDA), and mobile phones and Smartphones. The mobile devices may combine video, audio and advanced communication capabilities, such as PAN and WLAN. A mobile phone (also known as a cellular phone, cell phone and a hand phone) is a device that can make and receive telephone calls over a radio link whilst moving around a wide geographic area, by connecting to a cellular network provided by a mobile network operator. The calls are to and from the public telephone network, which includes other mobiles and fixed-line phones across the world. The Smartphones may combine the functions of a personal digital assistant (PDA), and may serve as portable media players and camera phones with high-resolution touch-screens, web browsers that can access, and properly display, standard web pages rather than just mobile-optimized sites, GPS navigation, Wi-Fi and mobile broadband access. In addition to telephony, the Smartphones may support a wide variety of other services such as text messaging, MMS, email, Internet access, short-range wireless communications (infrared, Bluetooth), business applications, gaming and photography.

With respect to the use of substantially any plural and/or singular terms herein, those having skill in the art can translate from the plural to the singular and/or from the singular to the plural as is appropriate to the context and/or application. The various singular/plural permutations can be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Some embodiments may be used in conjunction with various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a cellular handset, a handheld PDA device, an on-board device, an off-board device, a hybrid device, a vehicular device, a non-vehicular device, a mobile or portable device, a non-mobile or non-portable device, a wireless communication station, a wireless communication device, a wireless Access Point (AP), a wired or wireless router, a wired or wireless modem, a wired or wireless network, a Local Area Network (LAN), a Wireless LAN (WLAN), a Metropolitan Area Network (MAN), a Wireless MAN (WMAN), a Wide Area Network (WAN), a Wireless WAN (WWAN), a Personal Area Network (PAN), a Wireless PAN (WPAN), devices and/or networks operating substantially in accordance with existing IEEE 802.11, 802.11a, 802.11b, 802.11g, 802.11k, 802.11n, 802.11r, 802.16, 802.16d, 802.16e, 802.20, 802.21 standards and/or future versions and/or derivatives of the above standards, units and/or devices that are part of the above networks, one way and/or two-way radio communication systems, cellular radio-telephone communication systems, a cellular telephone, a wireless telephone, a Personal Communication Systems (PCS) device, a PDA device that incorporates a wireless communication device, a mobile or portable GNSS such as the Global Positioning System (GPS) device, a device that incorporates a GNSS or GPS receiver or transceiver or chip, a device that incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device (e.g., BlackBerry, Palm Treo), a Wireless Application Protocol (WAP) device, or the like.

Any system or apparatus herein may further be operative for storing, operating, or using, an operating system. Any system herein may comprise a Virtual Machine (VM) for virtualization, and the operating system may be executed as a guest operating system. Any system herein may further comprise a host computer that implements the VM, and the host computer may be operative for executing a hypervisor or a Virtual Machine Monitor (VMM), and the guest operating system may use or may interface virtual hardware. Any virtualization herein, such as any operating system virtualization, may include, may be based on, or may use, full virtualization, para-virtualization, or hardware assisted virtualization.

Any apparatus herein, such as the devices 65, 65a, 95, 95a, or 95b, or such as the server 23a, or any combination thereof, may comprise any element or functionality, described in the “BACKGROUND” section above, including in any of the documents incorporated therein. Further, any method or step herein may comprise any element or functionality, or may execute any step, method, or action, described in the “BACKGROUND” section above, including in any of the documents incorporated therein.

As used herein, the terms “program”, “programmable”, and “computer program” are meant to include any sequence or human or machine cognizable steps, which perform a function. Such programs are not inherently related to any particular computer or other apparatus, and may be rendered in virtually any programming language or environment, including, for example, C/C++, Fortran, COBOL, PASCAL, Assembly language, markup languages (e.g., HTML, SGML, XML, VoXML), and the like, as well as object-oriented environments, such as the Common Object Request Broker Architecture (CORBA), Java™ (including J2ME, Java Beans, etc.) and the like, as well as in firmware or other implementations. Generally, program modules include routines, subroutines, procedures, definitional statements and macros, programs, objects, components, data structures, etc., that perform particular tasks or implement particular abstract data types. A compiler may be used to create an executable code, or a code may be written using interpreted languages such as PERL, Python, or Ruby.

The terms “task” and “process” are used generically herein to describe any type of running programs, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of reading the value, processing the value: the value must be obtained prior to processing it, although some of the associated processing may be performed prior to, concurrently with, and/or after the read operation). Where certain process steps are described in a particular order or where alphabetic and/or alphanumeric labels are used to identify certain steps, the embodiments of the invention are not limited to any particular order of carrying out such steps. In particular, the labels are used merely for convenient identification of steps, and are not intended to imply, specify or require a particular order for carrying out such steps. Furthermore, other embodiments may use more or less steps than those discussed herein. The invention may also be practiced in distributed computing environments where tasks are performed by remote processing devices that are linked through a communications network. In a distributed computing environment, program modules may be located in both local and remote memory storage devices.

As used in this application, the term “about” or “approximately” refers to a range of values within plus or minus 10% of the specified number. As used in this application, the term “substantially” means that the actual value is within about 10% of the actual desired value, particularly within about 5% of the actual desired value and especially within about 1% of the actual desired value of any variable, element or limit set forth herein.

Any steps described herein may be sequential, and performed in the described order. For example, in a case where a step is performed in response to another step, or upon completion of another step, the steps are executed one after the other. However, in case where two or more steps are not explicitly described as being sequentially executed, these steps may be executed in any order or may be simultaneously performed. Two or more steps may be executed by two different network elements, or in the same network element, and may be executed in parallel using multiprocessing or multitasking.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. The present invention should not be considered limited to the particular embodiments described above, but rather should be understood to cover all aspects of the invention as fairly set out in the attached claims. Various modifications, equivalent processes, as well as numerous structures to which the present invention may be applicable, will be readily apparent to those skilled in the art to which the present invention is directed upon review of the present disclosure.

All publications, standards, patents, and patent applications cited in this specification are incorporated herein by reference as if each individual publication, patent, or patent application were specifically and individually indicated to be incorporated by reference and set forth in its entirety herein.

1.-353. (canceled)

354. A method for optimizing a route to multiple locations, for use with an automotive navigation system in a vehicle, for use with a products database associating each one of the multiple locations with multiple items, and for use with a device that comprises an input component, an output component, and a location sensor, the method comprising:
receiving, from a user by the input component, identifiers of two or more items;
estimating, by the device, a current location of the device;
identifying, by using the products database, for each of the identified items, one or more locations that are associated with the identified item;
calculating multiple routes from the current location, where each route of calculated multiple routes arrives at a set of locations selected from the identified locations, so that each of the identified items corresponds to at least one location in the set;
associating a cost to each of the calculated multiple routes;
selecting one of the calculated routes according to the respective associated cost;
notifying, to the user by the output component, of the selected route; and
guiding, the user by the output component in the device, to navigate according to the selected route,
wherein the device is part of, or comprises, automotive navigation system and is installable, or mountable, in a vehicle,
wherein the user is a driver, operator, or a passenger, in the vehicle, and
wherein the device is mounted onto, is attached to, is part of, or is integrated in, the vehicle.

355. The method according to claim 354, wherein the device stores the products database.

356. The method according to claim 354, wherein the number of items identified by the user is equal to, or more than, 2, 3, 4, 5, 8, 10, 12, 15, 20, 25, 30, 40, 50, 80, or 100 items.

357. The method according to claim 354, wherein the number of items identified by the user is equal to, or less than, 3, 4, 5, 8, 10, 12, 15, 20, 25, 30, 40, 50, 80, 100, or 150 items.

358. The method according to claim 354, wherein the identifying of the one or more locations comprises identifying, for each of the identified items by using the products database, all of the locations that are associated with the identified item in the products database.

359. The method according to claim 354, wherein each at least one of the sets includes a respective single identified location for each one of the identified items.

360. The method according to claim 354, wherein each at least one of the sets includes a respective single identified location for two or more of the identified items.

361. The method according to claim 354, wherein the calculating of multiple routes comprises calculating the routes for all possible sets.

362. A non-transitory computer readable medium having computer executable instructions stored thereon, wherein the instructions include part of, or all of, the steps according to claim 354, and wherein the method is performed by the device.

363. The method according to claim 354, wherein the identifying by using the products database is performed by the device.

364. The method according to claim 354, wherein the calculating of the multiple routes is performed by the device.

365. The method according to claim 354, wherein the associating of a cost to each of the calculated multiple routes is performed by the device, or wherein the selecting of one of the calculated routes is performed by the device.

366. The method according to claim 354, for use with an Internet-connected server, the method further comprising communicating, by the device over the Internet, with the server.

367. The method according to claim 366, further comprising sending, by the device to the server over the Internet, the identified items and the current location; and receiving, by the server, the identified items and the current location.

368. The method according to claim 367, wherein the identifying of the one or more locations, the calculating of the multiple routes, the selecting of one of the calculated routes, or any combination thereof, is performed by the server.

369. The method according to claim 368, further comprising sending, by the server to the device over the Internet, the selected calculated route.

370. The method according to claim 366, wherein the server stores the products database.

371. The method according to claim 354, further comprising generating multiple non-ordered sets, wherein each set comprises an identified location for each of the identified items.

372. The method according to claim 371, wherein the number of identified items is N, and for each item i (1≤i≤N) L(i) locations are identified, and wherein L(1)*L(2)* . . . L(N) sets are generated.

373. The method according to claim 372, further comprising generating multiple ordered sets by generating all permutations of each of the generated non-ordered set, so that [L(1)*L(2)* . . . L(N)]*N! ordered sets are generated.

374. The method according to claim 373, wherein the calculating comprises calculating a route for each of the generated ordered sets.

375. The method according to claim 374, for use with a destination location, wherein the routes are calculated ending at the destination location.

376. The method according to claim 371, wherein the selecting one of the calculated routes comprises solving a Travelling Salesman Problem (TSP) for the non-ordered sets, where the non-ordered set locations replaces the cities in the TSP, and where the associated costs for each route segment comprise estimated travel distance, estimated travel time, estimated fuel efficiency, or any combination thereof.

377. The method according to claim 376, wherein the TSP is a symmetric or asymmetric TSP, and wherein the TSP is solving comprises using an exact or a heuristic algorithm.

378. The method according to claim 354, for use with a destination location, wherein the multiple routes are calculated to end at the destination location.

379. The method according to claim 378, further comprising receiving, from the user by the user component, the destination location, wherein the destination location is the current location, or wherein the destination location is different from the current location.

380. The method according to claim 354, for use with an opening hours database associating a daily time interval for each of the multiple locations, wherein the calculating of the multiple routes or the selecting of one of the calculated routes is based on, or uses, the opening hours database.

381. The method according to claim 380, wherein the calculating of the multiple routes comprises calculating or estimating an arrival time to each of the identified locations of the respective set for each of the multiple routes.

382. The method according to claim 381, further comprising comparing the arrival times to each of the identified locations with the time interval associated with the identified locations for each of the multiple routes.

383. The method according to claim 381, further comprising deleting routes from the multiple routes if the arrival time at least one of the identified locations of the route is not within the associated time interval, so that the deleted routes are not selectable as part of the selecting of one of the calculated routes.

384. The method according to claim 380, further comprising calculating or estimating the arrival time to each of the identified locations for the selected one of the calculated routes.

385. The method according to claim 384, further comprising comparing the arrival times to each of the identified locations with the time interval associated with the identified locations for the selected one of the calculated routes.

386. The method according to claim 385, further comprising selecting another one of the calculated routes if the arrival time at least one of the identified location of the route is not within the associated time interval, and notifying and guiding using the another selected route.

387. The method according to claim 380, wherein the device stores the opening-hours database.

388. The method according to claim 354, for use with an Internet-connected server that stores, or is connected to, the opening-hours database.

389. The method according to claim 388, further comprising communicating, by the device, over the Internet with the server for using or accessing the opening-hours database.

390. The method according to claim 389, wherein the communicating with the server is via a wireless network using a wireless transceiver and an antenna in the device.

391. The method according to claim 390, further comprising sending, via the wireless network to the server, part of, or all of, the identified locations.

392. The method according to claim 391, wherein the identifying of the multiple locations is performed by the server.

393. The method according to claim 391, further comprising sensing, by the server, the multiple location to the device.

394. The method according to claim 354, wherein the products database comprises at least 5, 10, 50, 100, 200, 500, 1,000, 2,000, 5,000, 10,000, 20,000, 50,000, 100,000, 200,000, 500,000, 1,000,000, 2,000,000, 5,000,000, 10,000,000, 20,000,000, 50,000,000, or 100,000,000 distinct locations.

395. The method according to claim 354, wherein at least one of the multiple locations in the products database is associated with at least 5, 10, 20, 50, 100, 200, 500, 1,000, 2,000, 5,000, 10,000, 20,000, 50,000, or 100,000 items.

396. The method according to claim 395, wherein most of the multiple locations in the products database are associated with at least 5, 10, 20, 50, 100, 200, 500, 1,000, 2,000, 5,000, 10,000, 20,000, 50,000, or 100,000 items.

397. The method according to claim 396, wherein all of the multiple locations in the products database are associated with at least 5, 10, 20, 50, 100, 200, 500, 1,000, 2,000, 5,000, 10,000, 20,000, 50,000, or 100,000 items.

398. The method according to claim 354, wherein the products database further comprises a name associated with each of the multiple locations that uniquely identifies the location.

399. The method according to claim 398, wherein the notifying to the user comprises notifying of the names associated with the identified locations in the selected calculated route.

400. The method according to claim 354, wherein the vehicle is a ground vehicle adapted to travel on land, that is selected from the group consisting of a bicycle, a car, an autonomous car, a motorcycle, a train, an electric scooter, a subway, a train, a trolleybus, and a tram.

401. The method according to claim 354, wherein the vehicle is an autonomous car that is according to levels 0, 1, or 2 of the Society of Automotive Engineers (SAE) J3016 standard, or wherein the autonomous car is according to levels 3, 4, or 5 of the Society of Automotive Engineers (SAE) J3016 standard.

402. The method according to claim 354, wherein the vehicle is a buoyant or submerged watercraft adapted to travel on or in water, and wherein the watercraft is selected from the group consisting of a ship, a boat, a hovercraft, a sailboat, a yacht, and a submarine.

403. The method according to claim 354, wherein the vehicle is an aircraft adapted to fly in air, and wherein the aircraft is a fixed wing or a rotorcraft aircraft, and wherein the aircraft is selected from the group consisting of an airplane, a spacecraft, a glider, a drone, or an Unmanned Aerial Vehicle (UAV).
